(19) United States
(12) Patent Application Publication
(10) Pub. No.: US 2026/0307019 A1
(43) Pub. Date: Oct. 8, 2026

(54) CONTORTED POLYAMIDE MEMBRANES AND METHODS OF USE THEREOF

(71) Applicant: UNIVERSITY OF HOUSTON SYSTEM, Houston, TX (US)

(72) Inventors: Devin L. SHAFFER, Houston, TX (US); Sayali SHALIGRAM, Naperville, IL (US); Rahul SHEVATE, Naperville, IL (US); Siddhartha PAUL, Houston, TX (US); Parisa TAHERI, Houston, TX (US)

(73) Assignee: UNIVERSITY OF HOUSTON SYSTEM, Houston, TX (US)

(21) Appl. No.: 19/479,434

(22) PCT Filed: May 10, 2024
(86) PCT No.: PCT/US2024/028843

§ 371 Date: Oct. 28, 2025

Related U.S. Application Data
(60) Provisional application No. 63/465,520, filed on May 10, 2023.
(60) Provisional application No. 63/466,539, filed on May 15, 2023.

(51) Int. Cl. B01D 71/56; B01D 61/02; B01D 69/12; C02F 1/44; C08G 69/32; C08J 5/18

(52) U.S. Cl. CPC B01D 71/56; B01D 61/025; B01D 69/1251; C02F 1/441; C08G 69/32; C08J 5/18; B01D 2323/26; B01D 2323/30; B01D 2323/40

(57) ABSTRACT

This invention relates to contorted polyamide polymers. This invention also relates to contorted polyamide membranes, methods of making the contorted polyamide membranes, and methods of using the contorted polyamide membranes.

### CROSS-REFERENCE TO RELATED APPLICATIONS

This application claims the benefit of priority under 35 U.S.C. § 119(e) to U.S. Provisional Patent Application No. 63/465,520 filed May 10, 2023, and U.S. Provisional Patent Application No. 63/466,539 filed May 15, 2023, the contents of both of which are incorporated herein by reference in their entirety.

### STATEMENT REGARDING FEDERALLY SPONSORED RESEARCH OR DEVELOPMENT

This invention was made with government support under Grant No. R21AC10347 awarded by the United States Department of the Interior, Bureau of Reclamation. The government has certain rights in the invention.

### FIELD OF INVENTION

This invention relates to contorted polyamide polymers. This invention also relates to contorted polyamide membranes, methods of making the contorted polyamide membranes, and methods of using the contorted polyamide membranes.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Reverse osmosis (RO) technology, primarily facilitated by asymmetric thin-film composite (TFC) membranes, constitutes a significant share of the global desalination capacity, producing an impressive 21 billion gallons of water per day (U. Caldera, C. Breyer, Water Resources Research 2017, 53, 10523; T. E. Culp, B. Khara, K. P. Brickey, M. Geitner, T. J. Zimudzi, J D. Wilbur, S. D. Jons, A. Roy, M. Paul, B. Ganapathysubramanian, A L. Zydney, M. Kumar, E. D. Gomez, Science 2021, 371, 72) The cornerstone of RO lies in the interfacial polymerization (IP) process, utilizing m-phenylenediamine (MPD) and trimesoyl chloride (TMC) monomers to form a robust, fully-aromatic polyamide (PA) network on a hierarchical porous polymeric support (G. M. Geise, Science 2021, 371, 31; W. Gao, F. She, J. Zhang, L. F. Dumée, L. He, P. D. Hodgson, L. Kong, Journal of Membrane Science 2015, 487, 32). The widespread dominance of interfacial polymerization (IP) membranes is attributed to their scalability, energy efficiency, and capability of fabricating defect-free polyamide (PA) selective layers (Z. Ali, B. S. Ghanem, Y. Wang, F. Pacheco, W. Ogieglo, H. Vovusha, G. Genduso, U. Schwingenschlögl, Y. Han, I. Pinnau, Advanced Materials 2020, 32, 2001132; Z. Ali, Y. Wang, W. Ogieglo, F. Pacheco, H. Vovusha, Y. Han, I. Pinnau, Journal of Membrane Science 2021, 6/8, 118572; J.-E. Gu, S. Lee, C. M. Stafford, J. S. Lee, W. Choi, B.-Y. Kim, K.-Y. Baek, E. P. Chan, J. Y. Chung, J. Bang, J.-H. Lee, Advanced Materials 2013, 25, 4778; I. J. Roh, A. R. Greenberg, V. P. Khare, Desalination 2006, 191, 279)

Since their inception in the 1980s, polyamide membrane chemistry has undergone remarkable development, primarily guided by the utilization of dual-phase monophasic electrospray deposition (MPD) and TMC monomers (J.-E. Gu, S. Lee, C. M. Stafford, J. S. Lee, W. Choi, B.-Y. Kim, K.-Y. Baek, E. P. Chan, J. Y. Chung, J. Bang, J.-H. Lee, Advanced Materials 2013, 25, 4778; V. Freger, G. Z. Ramon, Progress in Polymer Science 2021, 122, 101451). The state-of-the-art membranes fabricated from these monomers show high salt rejection (>99.5%) but relatively low water permeance (~2 L m⁻² h⁻¹ bar⁻¹) (J. R. Werber, A. Deshmukh, M. Elimelech, Environ. Sci. Technol. Lett. 2016, 3, 112). These membranes exhibit an intricate permeability-selectivity tradeoff, wherein heightened water permeance is achieved at the expense of diminished salt rejection and selectivity (Z. Yang, H. Guo, C. Y. Tang, Journal of Membrane Science 2019, 590, 117297). The tradeoff is rooted in the mechanics of solution-diffusion transport within dense polymeric membranes and has been described by both electrostatic forces and polymer free volume (Z. Zhang, G. Kang, H. Yu, Y. Jin, Y. Cao, Desalination 2019, 466, 16). Although MPDTMC-based polyamide membranes have achieved remarkable desalination energy efficiencies, closely approaching the thermodynamic minimum (M. Elimelech, W. A. Phillip, Science 2011, 333, 712), further improvements in membrane permeability and selectivity could intensify desalination processes and improve the system energy efficiency, thus reducing overall desalination costs (J. R. Werber, A. Deshmukh, M. Elimelech, Environ. Sci. Technol. Lett. 2016, 3, 112; D. Cohen-Tanugi, R. K. McGovern, S. H. Dave, J. H. Lienhard, J. C. Grossman, Energy Environ. Sci. 2014, 7, 1134). Specifically, ultra-permeable desalination membranes can significantly reduce the pressure vessel requirements for reverse osmosis systems operating at constant energy consumption and permeate recovery while improvements in membrane selectivity can improve the permeate quality (D. Cohen-Tanugi, R. K. McGovern, S. H. Dave, J. H. Lienhard, J. C. Grossman, Energy Environ. Sci. 2014, 7, 1134). Thus, advances in membrane chemistry beyond MPDTMC are needed to provide control over membrane selective layer structure that will enhance desalination performance compared to conventional polyamide membranes.

As such, there is an ongoing need for improvements in compositions, materials, devices, methods, and systems for desalination. The embodiments of the present invention address that need.

### SUMMARY OF THE INVENTION

Embodiment 50. A polymer comprising repeat units, wherein the repeat units have a structure of Formula (I):

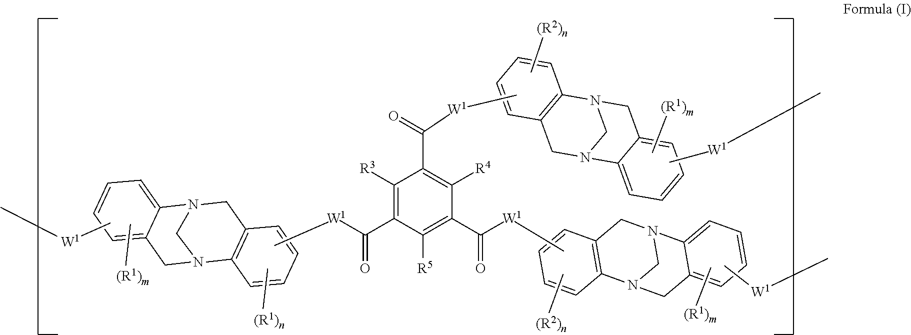

wherein:
each R¹ is independently selected from the group consisting of H, an electron withdrawing group, and an electron donating group;
each R² is independently selected from the group consisting of H, an electron withdrawing group, and an electron donating group;
R³ is H, an electron withdrawing group, or an electron donating group;
R⁴ is H, an electron withdrawing group, or an electron donating group;
R⁵ is H, an electron withdrawing group, or an electron donating group;
each W¹ is independently O or NR⁶, wherein each R⁶ is independently H or optionally substituted alkyl;
m is 3; and
n is 3.

Embodiment 51. The polymer of embodiment 50, wherein the structure of Formula (I) is a structure of Formula (I-A):

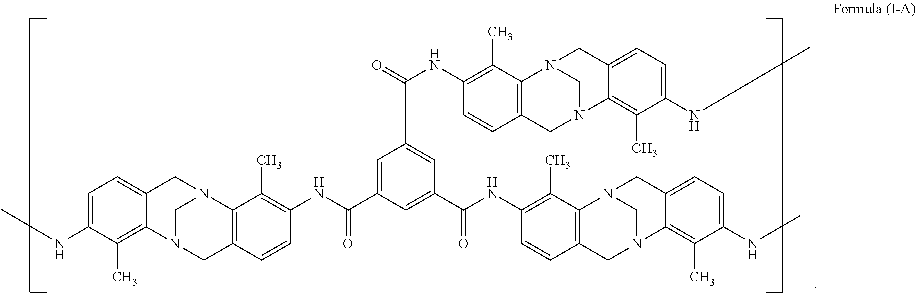

Embodiment 52. A polymer membrane comprising a polymer of embodiment 50.

Embodiment 53. A method of making a polymer membrane of embodiment 52, the method comprising: (a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

Embodiment 54. A method of making a polymer membrane of embodiment 52, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

Embodiment 55. The method of embodiment 53 or embodiment 54, wherein a polymerization reaction between the first monomer and the second monomer occurs, thereby forming a polymer membrane on at least a portion of the substrate surface.

Embodiment 56. The method of embodiment 53 or embodiment 54, wherein the first monomer has a structure of Formula (II).

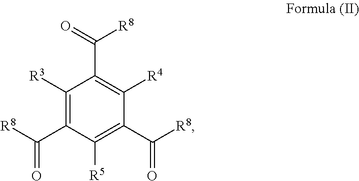

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl; and
wherein the second monomer has a structure of Formula (III):

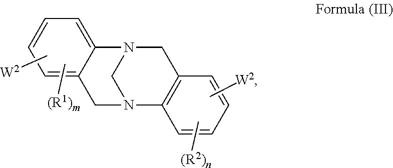

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹ is independently H or optionally substituted alkyl, and wherein each R¹² is independently H or optionally substituted alkyl;
m is 3; and
n is 3.

Embodiment 57. A method for desalination of water, the method comprising: providing a polymer membrane of embodiment 52, and water, wherein the water comprises at least one salt; and passing the water through the polymer membrane to desalinate the water.

Embodiment 58. A polymer comprising repeat units, wherein the repeat units have a structure of Formula (IV):

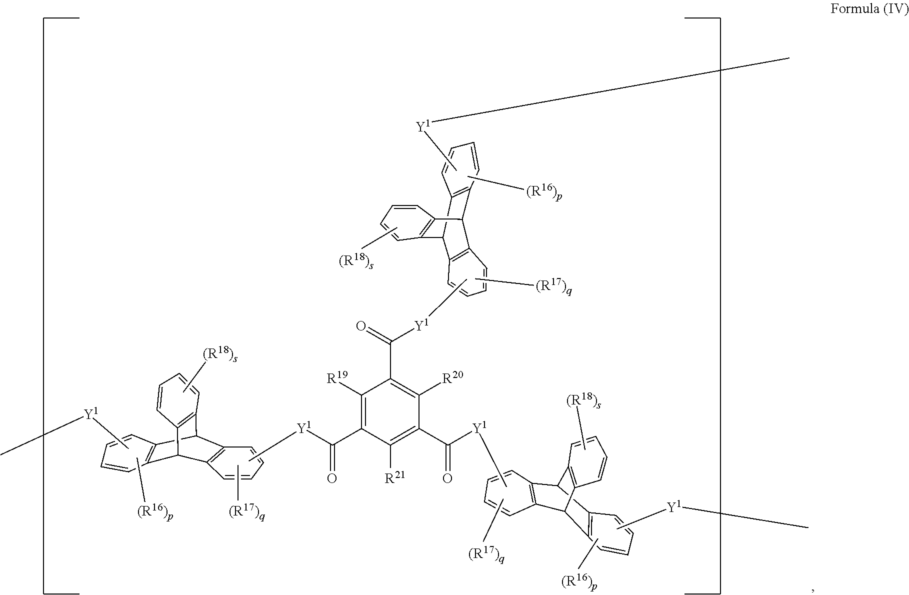

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
R¹⁹ is H, an electron withdrawing group, or an electron donating group;
R²⁰ is H, an electron withdrawing group, or an electron donating group;
R²¹ is H, an electron withdrawing group, or an electron donating group;
each Y¹ is independently O or NR²², wherein each R²² is independently H or optionally substituted alkyl;
p is 3;
q is 3; and
s is 4.

Embodiment 59. The polymer of embodiment 58, wherein the structure of Formula (IV) is a structure of Formula (IV-A):

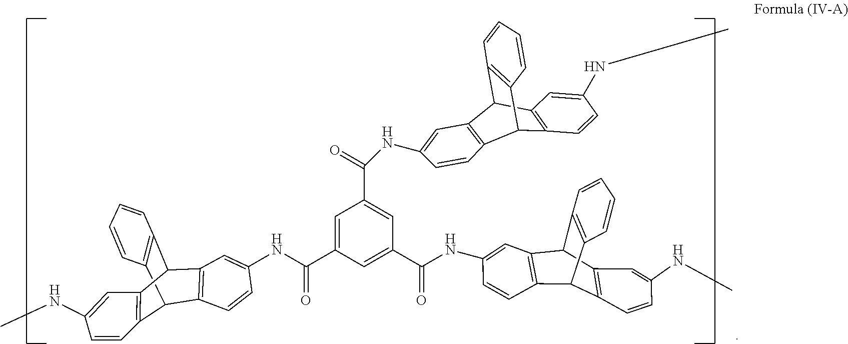

Embodiment 60. A polymer membrane comprising a polymer of embodiment 58.

Embodiment 61. A method of making a polymer membrane of embodiment 60, the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

Embodiment 62. A method of making a polymer membrane of embodiment 60, the method comprising.
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

Embodiment 63. The method of embodiment 61 or embodiment 62, wherein a polymerization reaction between the first monomer and the second monomer occurs, thereby forming a polymer membrane on at least a portion of the substrate surface.

Embodiment 64. The method of embodiment 61 or embodiment 62, wherein the first monomer has a structure of Formula (V):

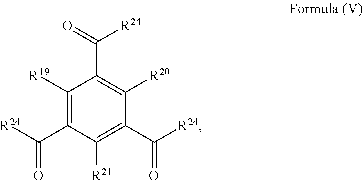

wherein:
R¹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl; and
wherein the second monomer has a structure of Formula (VI):

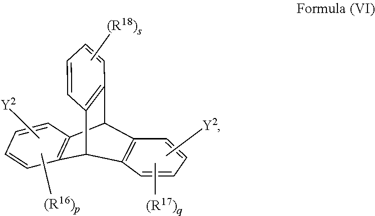

wherein:
each R¹⁶ is independently selected from the group consisting of H, an electron withdrawing group, and an electron donating group;
each R⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 65. A method for desalination of water, the method comprising: providing a polymer membrane of embodiment 60, and water, wherein the water comprises at least one salt; and passing the water through the polymer membrane to desalinate the water.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 depicts in accordance with various embodiments of the invention, synthesis of polyamide thin films using a spin-assisted molecular layer-by-layer deposition technique. Polyamide film is illustrated with a molecular model of a segment of polyamide network containing Tröger's base diamine (TBD) monomer and trimesoyl chloride (TMC) monomers.

FIG. 2A-FIG. 2J depicts in accordance with various embodiments of the invention, characterization of TBDTMC and MPDTMC polyamide powders and thin films (FIG. 2A) FTIR spectra of polyamide films, (FIG. 2B) Nitrogen adsorption isotherms for polyamide powders obtained at 77 K and estimated Brunauer-Emmett-Teller (BET) surface areas, (FIG. 2C) CO₂ adsorption isotherms for PA powders obtained at 273 K and estimated BET surface areas, (FIG. 2D) Thicknesses of polyamide films as a function of number of molecular layer-by-layer (mLbL) deposition cycles, (FIG. 2E) Tapping mode AFM image of TBDTMC film, (FIG. 2F) Height profile of ~20 nm TBDTMC film deposited on SiO2/Si surface, (FIG. 2G) Comparison of surface roughness of TBDTMC (left side) and SW30HR membrane (right side), (FIG. 2H, FIG. 2I) Low and high-resolution (inset) TEM images of the TBDTMC film, (FIG. 2J) Free standing ~20 nm thick TBDTMC film on hollow copper loop.

FIG. 3A-FIG. 3D depicts in accordance with various embodiments of the invention, water permeances and salt rejection properties of the MPDTMC and TBDTMC thin-film composite membranes (FIG. 3A) Time-dependent desalination performance of MPDTMC, (FIG. 3B) Time dependent desalination performance of TBDTMC, (FIG. 3C) Thickness-dependent water permeance and salt rejection of the TBDTMC membrane, (FIG. 3D) Comparison of the permselectivity of the contorted TBDTMC polyamide membrane fabricated in this study with state-of-the-art desalination membranes. Dashed line indicates the apparent permeability-selectivity tradeoff for commercial desalination membranes.

FIG. 4 depicts in accordance with various embodiments of the invention, synthesis of polyamides using various diamine monomers. Three different diamine monomers: m-phenylene diamine (MPD), Tröger's base diamine (TBD) and triptycene diamine (TD) are reacted with trimesoyl chloride (IMC) to form polyamides. The MPD is a planar monomer, while TBD and TD are contorted, rigid monomers. The contortion can be visualized in the 3D molecular model of the monomers and respective polyamide polymers.

FIG. 5 depicts in accordance with various embodiments of the invention, illustration of polyamide membrane fabrication by the monophasic electrospray deposition (MED) process. Liquid monomer solutions are continuously introduced to the metallic syringe. An electrical potential is applied across the metallic syringe and collector plate. As monomer solution is introduced to the syringe, a Taylor cone forms at the tip of the syringe needle, which is then discharged as fine droplets collected on the oppositely charged collector. The collector platform may be a plate or rotating cylinder. The IP polycondensation reaction between microdroplets of the diamine and trimesoyl chloride monomers on the collector results in the deposition of a polyamide layer on the collector.

FIG. 6 depicts in accordance with various embodiments of the invention, schematic of the three-probe cell to conduct the electrochemical impedance spectroscopy measurements of salt permeability in thin contorted polyamide films.

FIG. 7 depicts in accordance with various embodiments of the invention, a custom-built electrospray setup will be modified for polyamide (PA) fabrication. Pumps mounted with syringes containing different monomer solutions will be used to fabricate thin polyamide (PA) films. The distance between collector plate, syringe pumps as well as applied voltage and concentration will be optimized during fabrication. The collector plate will be replaced with rotating drum for lab-scale roll-to-roll manufacturing of polyamide (PA) films.

FIG. 8 depicts in accordance with various embodiments of the invention, a custom-built high-pressure cross-flow membrane filtration testing system.

FIG. 9 depicts in accordance with various embodiments of the invention, thickness growth rate of conventional m-phenylene diamine and trimesoyl chloride (MPDTMC) polyamide films fabricated using the monophasic solution-based molecular layer-by-layer (mLbL) deposition process.

FIG. 10A-FIG. 10B depicts in accordance with various embodiments of the invention, (FIG. 10A) Water permeance and salt rejection as a function of MPDTMC film thickness for thin-film composite MPTDTMC polyamide membranes tested under cross-flow filtration conditions. (FIG. 10B) Comparison of measured water permeances and salt rejections for MPDTMC polyamide membranes fabricated in this work and results reported by Mulhearn and Stafford (ACS Appl. Polym. Mater. 2021, 3, 116-121) for similar MPDTMC membranes.

FIG. 11 depicts in accordance with various embodiments of the invention, dry polyamide film thickness as a function of number of molecular layer-by-layer (mLbL) deposition cycles for conventional MPDTMC polyamide and contorted TBCTMC and TYDTMC polyamides. Growth rates are determined as the slope of a linear fit to data for each polyamide.

FIG. 12A-FIG. 12C depicts in accordance with various embodiments of the invention, apparent solubility of triptycene diamine (TYD) monomer in (FIG. 12A) toluene solvent and (FIG. 12B) toluene with 5% volume N,N-dimethylformamide (DMF) cosolvent. (FIG. 12C) TYDTMC polyamide films fabricated by molecular layer-by-layer (mLbL) deposition at greater than 10 deposition cycles appear cloudy, indicating incomplete monomer rinsing by acetone rinse solvent.

FIG. 13A-FIG. 13B depicts in accordance with various embodiments of the invention, (FIG. 13A) Top-down (10-um scale bar) and (FIG. 13B) cross-section (100-um scale bar) scanning electron micrographs of a thin-film composite membrane with MPDTMC polyamide selective layer and polyacrylonitrile support layer.

FIG. 14 depicts in accordance with various embodiments of the invention, water permeances and salt rejections of thin-film composite MPDTMC membranes with increasing polyamide film thickness measured by dead-end filtration. Results are compared to reference MPDTMC membranes tested under similar conditions reported by Mulhearn and Stafford (ACS Appl. Polym. Mater. 2021, 3, 116-121).

FIG. 15A-FIG. 15C depicts in accordance with various embodiments of the invention, (FIG. 15A) Top-down photograph of monophasic electrospray deposition (MED) system including horizontal linear actuator for controlled motion of syringe pump. (FIG. 15B) MPDTMC polyamide (brown film) deposition on a support membrane by MED. (FIG. 15C) MPDTMC polyamide deposition on silicon substrates to quantify film growth by MED process.

FIG. 16A-FIG. 16C depicts in accordance with various embodiments of the invention, photographs of MPDTMC polyamide films electrosprayed onto silicon wafer substrates at (FIG. 16A) 100 electrospray passes, (FIG. 16B) 200 electrospray passes, and (FIG. 16C) 300 electrospray passes.

FIG. 17 depicts in accordance with various embodiments of the invention, thicknesses of MPDTMC polyamide films electrosprayed onto silicon wafer substrates as a function of number of electrospray passes across the collector.

FIG. 18A-FIG. 18B depicts in accordance with various embodiments of the invention, dry polyamide film thickness as a function of number of molecular layer-by-layer (mLbL) deposition cycles for (FIG. 18A) conventional MPDTMC polyamide and contorted TBDTMC polyamide and (FIG. 18B) contorted TYDTMC polyamide. Dashed lines indicate linear fits to data used to determine growth rates.

FIG. 19 depicts in accordance with various embodiments of the invention, FT-IR transmission spectra of MPDTMC, TBDTMC, and TYDTMC polyamide powders and spectra of corresponding MPD, TBD, and TYD diamine monomers and TMC monomer.

FIG. 20A-FIG. 20B depicts in accordance with various embodiments of the invention, (FIG. 20A) Zeta potential for MPDTMC and TBDTMC polyamide membranes measured as a function of electrolyte solution pH. Dashed lines are fit to measured values as a guide to the eye. (FIG. 20B) Powder X-ray diffraction (XRD) patterns for conventional MPTDTMC and contorted TBDTMC and TYDTMC contorted polyamide powders. Estimated d-spacings for XRD peaks are indicated in angstroms.

FIG. 21A-FIG. 21D depicts in accordance with various embodiments of the invention, water permeance and salt rejection as a function of polyamide films thickness for (FIG. 21A) MPDTMC, (FIG. 21B) TBDTMC, and (FIG. 21C) TYDTMC membranes. (FIG. 21D) Comparison of MPDTMC, TBDTMC, and TYDTMC desalination performance.

FIG. 22 depicts in accordance with various embodiments of the invention, photographs of MPDTMC, TBDTMC, and TYDTMC polyamide films electrosprayed onto silicon wafer substrates at 50, 60, 90, 120, and 200 electrospray passes.

FIG. 23 depicts in accordance with various embodiments of the invention, thicknesses of conventional MPDTMC and contorted TBDTMC and TYDTMC polyamide films electrosprayed onto silicon wafer substrates as a function of number of electrospray passes across the collector.

FIG. 24 depicts in accordance with various embodiments of the invention, CO₂ adsorption-desorption isotherms measured at 273 K for conventional MPDTMC and contorted TBDTMC and TYDTMC polyamide powders.

FIG. 25 depicts in accordance with various embodiments of the invention, Zeta potentials for MPDTMC, TBDTMC, and TYDTMC polyamide membranes measured as a function of electrolyte solution pH. Dashed lines are fit to measured values as a guide to the eye.

FIG. 26 depicts in accordance with various embodiments of the invention, water permeance and salt rejection as a function of polyamide film thickness for MPDTMC, TBDTMC, and TYDTMC polyamide membranes.

FIG. 27 depicts in accordance with various embodiments of the invention, water permeance and salt rejection as a function of time for MPDTMC (~35 nm thick), TBDTMC (~25 nm thick), and TYDTMC (~880 nm thick) polyamide membranes.

FIG. 28 depicts in accordance with various embodiments of the invention, water permeance and NaCl rejection of MPDTMC polyamide membranes fabricated by the monophasic electrospray deposition (MED) process at different monomer mass depositions.

FIG. 29 depicts in accordance with various embodiments of the invention, conductivity of receiving diffusion cell chamber as a function of time for NaCl diffusion tests performed with 400 kDa polyacrylonitrile (PAN) and Novatexx support membrane materials. The starting conductivity of the donor diffusion cell chamber was 90 mS/cm.

FIG. 30 depicts in accordance with various embodiments of the invention, conductivity function (Equation 16) plotted versus time for NaCl diffusion cell test results for Novatexx support material. The slope of the linear fit is the salt permeability Ps=(4.27±0.10)×10⁻⁹ m² s⁻¹.

FIG. 31A-FIG. 31C depicts in accordance with various embodiments of the invention, X-ray photoelectron survey spectra for (FIG. 31A) conventional MPTMC polyamide film and contorted (FIG. 31B) TBTMC and (FIG. 31C) TYDTMC polyamide films.

FIG. 32A-FIG. 32B depicts in accordance with various embodiments of the invention, (FIG. 32A) water permeance and salt rejection as a function of polyamide film thickness for MPDTMC, TBDTMC, and TYDTMC polyamide membranes. (FIG. 32B) Water permeance and salt rejection as a function of time for MPDTMC (~35 nm thick), TBDTMC (~25 nm thick), and TYDTMC (~880 nm thick) polyamide membranes.

FIG. 33 depicts in accordance with various embodiments of the invention, permeability-selectivity tradeoff plot comparing the water-NaCl selectivity of conventional MPDTMC and contorted TBDTMC and TYDTMC polyamide membranes fabricated by molecular layer-by-layer deposition. The dashed line is the upper bound for polyamide desalination membrane permselectivity reported in the literature (Z. Yang, I. Guo, C. Y. Tang, The upper bound of thin-film composite (TFC) polyamide membranes for desalination, Journal of Membrane Science. 590 (2019) 117297).

FIG. 34 depicts in accordance with various embodiments of the invention, conductivity of receiving diffusion cell chamber as a function of time for NaCl diffusion tests performed with MPDTMC, TBDTMC, and TYDTMC polyamide films. The diffusion test data for the supporting Novatexx fabric is included for reference. The starting conductivity of the donor diffusion cell chamber was 90 mS/cm.

FIG. 35A-FIG. 35C depicts in accordance with various embodiments of the invention, conductivity function (Equation 18) plotted versus time for NaCl diffusion cell test results for (FIG. 35A) conventional MPDTMC polyamide, (FIG. 35B) contorted TBDTMC polyamide, and (FIG. 35C) contorted TYDTMC polyamide films. The slopes of the linear fits are the corresponding NaCl permeabilities, Ps (m² s⁻¹).

FIG. 36 depicts various embodiments of the invention.

FIG. 37 depicts in accordance with various embodiments of the invention, experimental fabrication of composite membranes by layer-by-layer deposition and dead-end filtration testing equipment.

FIG. 38 depicts in accordance with various embodiments of the invention, CO₂ sorption-desorption isotherms measured at 273 K for MPDTMC, TBDTMC, and TYDTMC powders and the associated Langmuir surface areas (m² g⁻¹).

FIG. 39 depicts in accordance with various embodiments of the invention, Reactive chemical bonds of diacyl chloride and diamine monomers.

FIG. 40 depicts in accordance with various embodiments of the invention, dry polyamide film thickness as a function of number of molecular layer-by-layer (mLbL) deposition cycles for conventional MPDTMC polyamide and contorted TBDTMC and TYDTMC polyamides. Growth rates are determined as the slope of a linear fit to data for each polyamide.

FIG. 41A-FIG. 41B depicts in accordance with various embodiments of the invention, (FIG. 41A) water permeance (left axis) and salt rejection (right axis) as a function of polyamide film thickness for MPDTMC, TBDTMC, and TYDTMC polyamide membranes. (FIG. 41B) Permeate flux (left axis) and salt rejection (right axis) as a function of time for MPDTMC (~35 nm thick, 100 cycles), TBDTMC (~25 nm thick, 25 cycles), and TYDTMC (~36 nm thick, 25 cycles) polyamide membranes.

FIG. 42 depicts in accordance with various embodiments of the invention, permeability-selectivity tradeoff plot comparing the water-NaCl selectivity of conventional MPDTMC and contorted TBDTMC and TYDTMC polyamide membranes fabricated by molecular layer-by-layer deposition (updated). The red dashed line is the upper bound for polyamide desalination membrane permselectivity reported in the literature (Z. Yang, H. Guo, C. Y. Tang, The upper bound of thin-film composite (TFC) polyamide membranes for desalination, Journal of Membrane Science. 590 (2019) 117297).

FIG. 43A-FIG. 43C depicts in accordance with various embodiments of the invention, conductivity function (H. Luo, J. Aboki, Y. Ji, R. Guo, G. M. Geise, Water and Salt Transport Properties of Triptycene-Containing Sulfonated Polysulfone Materials for Desalination Membrane Applications, ACS Appl. Mater. Interfaces. 10 (2018) 4102-4112) plotted versus time for NaCl diffusion cell test results for (FIG. 43A) conventional MPDTMC polyamide, (FIG. 43B) contorted TBDTMC polyamide, and (FIG. 43C) contorted TYDTMC polyamide films. The slopes of the linear fits are the corresponding NaCl permeabilities, Ps (m² s⁻¹).

FIG. 44 depicts in accordance with various embodiments of the invention, a representative water permeance/permselectivity trade off plot and the desired performance region in the plot to achieve membrane desalination process intensification and improved energy efficiency.

FIG. 45 depicts in accordance with various embodiments of the invention, strategies to design PIM membranes.

FIG. 46 depicts in accordance with various embodiments of the invention, contorted polyamides for desalination.

FIG. 47 depicts in accordance with various embodiments of the invention, photograph of equipment used for monophasic molecular layer-by-layer deposition.

FIG. 48 depicts in accordance with various embodiments of the invention, Troger's base TBDTMC polyamide network by interfacial polymerization.

FIG. 49A-FIG. 49D depicts in accordance with various embodiments of the invention, measured X-ray reflectivity intensity (symbols) as a function of scattering vector q and corresponding reflectivity fits (lines) for a thickness series of (FIG. 49A) MPDTMC and (FIG. 49B) TBDTMC polyamide films. X-ray scattering length density (SLD) profiles for multi-layer X-ray reflectivity fits to a thickness series of (FIG. 49C) MPDTMC and (FIG. 49D) TBDTMC polyamide films.

FIG. 50 depicts in accordance with various embodiments of the invention, water permeance (left axis) and NaCl salt rejection (right axis) as a function of monomer mass deposited for electrosprayed conventional MPDTMC polyamide membranes.

FIG. 51A-FIG. 51B depicts in accordance with various embodiments of the invention, (FIG. 51A) Measured X-ray reflectivity intensity (symbols) as a function of scattering vector q and corresponding reflectivity fits (lines) for a thickness series of TYDTMC polyamide films. (FIG. 51B) X-ray scattering length density (SLD) profiles for multi-layer X-ray reflectivity fits to a thickness series of TYDTMC polyamide films.

FIG. 52A-FIG. 52C depicts in accordance with various embodiments of the invention, scattering intensities from small-angle X-ray scattering (SAXS) measurements as a function of scattering vector q measured at different relative humidity conditions for representative (FIG. 52A) MPDTMC, (FIG. 52B) TBDTMC, and (FIG. 52C) TYDTMC polyamide films.

FIG. 53A-FIG. 53F depicts in accordance with various embodiments of the invention, (FIG. 53A-FIG. 53C) Trimmed and (FIG. 53D-FIG. 53F) baselined intensity peaks at high-q scattering vector from small-angle X-ray scattering (SAXS) measurements made at different relative humidity (RH) conditions for representative (FIG. 53A, FIG. 53D) MPDTMC, (FIG. 53B, FIG. 53E) TBDTMC, and (FIG. 53C, FIG. 53F) TYDTMC polyamide films.

FIG. 54 depicts in accordance with various embodiments of the invention, swelling ratios, S, for different thicknesses (cycles) of conventional MPDTMC and contorted TBDTMC and TYDTMC polyamide films fabricated by molecular layer-by-layer deposition. Swelling ratios were calculated from changes in intensity of the very high-q intensity peak resulting from small-angle X-ray scattering (SAXS) measurements made at 0% and 75% relative humidities.

FIG. 55 depicts in accordance with various embodiments of the invention, permeability-selectivity tradeoff plot comparing the water-NaCl selectivity of commercial polyamide desalination membranes ESPA2 and NF270 to the conventional MPDTMC and contorted TBDTMC and TYDTMC polyamide membranes fabricated by molecular layer-by-layer deposition. The red dashed line is the upper bound for polyamide desalination membrane permselectivity (Z. Yang, H. Guo, C. Y. Tang, The upper bound of thin-film composite (TFC) polyamide membranes for desalination, Journal of Membrane Science. 590 (2019) 117297).

FIG. 56A-FIG. 56D depicts in accordance with various embodiments of the invention, water permeance (left axis) and NaCl salt rejection (right axis) as a function of total monomer mass deposited for electrosprayed (FIG. 56A) MPDTMC, (FIG. 56B) TBDTMC, and (FIG. 56C) TYDTMC polyamide membranes. (FIG. 56D) Comparison of electrosprayed MPDTMC, TBDTMC, and TYDTMC polyamide membrane desalination performance.

FIG. 57 depicts in accordance with various embodiments of the invention, permeability-selectivity tradeoff plot comparing the water-NaCl selectivity of conventional MPDTMC and contorted TBDTMC and TYDTMC polyamide membranes fabricated by electrospray deposition and the commercial ESPA2 polyamide desalination membrane. The red dashed line is the upper bound for polyamide desalination membrane permselectivity (Z. Yang, H. Guo, C. Y. Tang, The upper bound of thin-film composite (TFC) polyamide membranes for desalination, Journal of Membrane Science. 590 (2019) 117297).

FIG. 58 depicts in accordance with various embodiments of the invention, permeability-selectivity tradeoff plot comparing the water-NaCl selectivity of commercial polyamide desalination membranes ESPA2 and NF270 to the conventional MPDTMC and contorted TBDTMC and TYDTMC polyamide membranes fabricated by molecular layer-by-layer deposition. The red dashed line is the upper bound for polyamide desalination membrane permselectivity (Z. Yang, H. Guo, C. Y. Tang, The upper bound of thin-film composite (TFC) polyamide membranes for desalination, Journal of Membrane Science 590 (2019) 117297).

FIG. 59A-FIG. 59B depicts in accordance with various embodiments of the invention, (FIG. 59A) Comparison of water permeance (left axis) and NaCl salt rejection (right axis) as a function of total monomer mass deposited for MPDTMC, TBDTMC, and TYDTMC polyamide membranes. (FIG. 59B) Permeability-selectivity tradeoff plot comparing the water-NaCl selectivity of conventional MPDTMC and contorted TBDTMC and TYDTMC polyamide membranes fabricated by electrospray deposition and the commercial ESPA2 polyamide desalination membrane. The red dashed line is the upper bound for polyamide desalination membrane permselectivity (Z. Yang, H. Guo, C. Y. Tang, The upper bound of thin-film composite (TFC) polyamide membranes for desalination, Journal of Membrane Science 590 (2019) 117297).

FIG. 60 depicts in accordance with various embodiments of the invention, powder X-ray diffraction (XRD) patterns derived from Extended Wide Angle X-ray Scattering (EWAXS) measurements of electrosprayed conventional MPTDTMC (bottom row) and contorted TBDTMC (middle row) and TYDTMC (top row) polyamide films.

FIG. 61 depicts in accordance with various embodiments of the invention, thicknesses of electrosprayed polyamide films as a function of monomer mass deposited during the electrospray process for conventional MPDTMC polyamide and contorted TBDTMC and TYDTMC polyamides.

FIG. 62 depicts in accordance with various embodiments of the invention, photographs of silicon oxide-coated QCM sensors upon which MPDTMC, TBDTMC, and TYDTMC polyamide films were electrosprayed.

FIG. 63A-FIG. 631 depicts in accordance with various embodiments of the invention, transmission electron microscopy (TEM) images and selected area electron diffraction (SAED) patterns of polyamide films (FIG. 63A-FIG. 63C) MPDTMC, (FIG. 63D-FIG. 63F) TBDTMC, and (FIG. 63G-FIG. 63I) TYDTMC.

FIG. 64A-FIG. 64B depicts in accordance with various embodiments of the invention, (FIG. 64A) Comparison of water permeance (left axis) and NaCl salt rejection (right axis) as a function of polyamide thickness for MPDTMC (circles), TBDTMC (squares), and TYDTMC (triangles) polyamide membranes fabricated by electrospray deposition. (FIG. 64B) Permeability-selectivity tradeoff plot comparing the water-NaCl selectivity of conventional MPDTMC and contorted TBDTMC and TYDTMC polyamide membranes fabricated by electrospray deposition and the commercial ESPA2 polyamide desalination membrane. The red dashed line is the upper bound for polyamide desalination membrane permselectivity (Z. Yang, H. Guo, C. Y. Tang, The upper bound of thin-film composite (TFC) polyamide membranes for desalination, Journal of Membrane Science 590 (2019) 117297).

FIG. 65 depicts in accordance with various embodiments of the invention, FT-IR transmission spectra of electrosprayed TYDTMC, TBDTMC, and MPDTMC polyamide films. The spectra of the corresponding TYD, TBD, and MPD diamine monomers are shown. The spectra for TMC monomer is shown.

FIG. 66 depicts in accordance with various embodiments of the invention, dry polyamide film thickness as a function of the total monomer mass deposited during the electrospray deposition process for conventional MPDTMC polyamide and contorted TBDTMC and TYDTMC polyamides. The growth rates are determined as the slope of a linear fit to thickness data for each polyamide film.

FIG. 67 depicts in accordance with various embodiments of the invention, X-ray diffraction (XRD) patterns derived from Extended Wide Angle X-ray Scattering (EWAXS) measurements of electrosprayed conventional MPTDTMC and contorted TBDTMC and TYDTMC polyamide films Estimated d-spacings for XRD intensity peaks are indicated in angstroms.

FIG. 68 depicts in accordance with various embodiments of the invention, photos of polyamide films electrosprayed onto silicon oxide-coated QCM sensors for QCM mass measurements (top row) and onto silicon wafers for thickness measurements (bottom row).

FIG. 69 depicts in accordance with various embodiments of the invention, schematic illustration of the fabrication of polyamide thin film composite membranes via molecular layer-by-layer (mLbL) deposition (a) spin coater machine (b) silicon wafer mounted on vacuum chuck (c) PSS layer coated Si wafer (d) TMC coated on PSS layer (e) diamine coated on TMC layer (f) polyamide film formed after deposition of desired number of cycles (g) immersion of polyamide film in water (h) release of polyamide film after dissolution of PSS layer in water (i) capture of polyamide film on PAN support (j) polyamide TFC membranes (k) chemical structures of synthesized contorted polyamides.

FIG. 70A-FIG. 70G depicts in accordance with various embodiments of the invention, characterization of polyamide films (FIG. 70A) sorption-desorption behavior using CO₂ BET measurements at 273 K for MPDTMC, TBDTMC and TYDTMC powders (FIG. 70B) XRD spectra of MPDTMC, TBDTMC and TYDTMC powders with average d-spacing obtained using Bragg's law (FIG. 70C) XRR (FIG. 70D, FIG. 70E) 3D visualizations of the 30 cycle molecular layer-by-layer (mLbL) polyamide MPDTMC and commercial polyamide surfaces using AFM, plotted using the same height scale (FIG. 70F) low and high-resolution (inset) TEM images of the TBDTMC film (FIG. 70G) Dry polyamide film thickness as a function of number of molecular layer-by-layer (mLbL) deposition cycles for MPDTMC polyamide and TBDTMC and TYDTMC polyamides. Growth rates are determined as the slope of a linear fit to data for each polyamide.

FIG. 71A-FIG. 71D depicts in accordance with various embodiments of the invention, (FIG. 71A) Water permeance (left axis) and NaCl salt rejection (right axis) as a function of polyamide film thickness for MPDTMC, TBDTMC, and TYDTMC polyamide membranes. (FIG. 71B) Permeate flux (left axis) and NaCl salt rejection (right axis) as a function of time for MPDTMC (~35 nm thick, 100 cycles), TBDTMC (~25 nm thick, 25 cycles), and TYDTMC (~36 nm thick, 25 cycles) polyamide membranes (FIG. 71C) permeability-selectivity tradeoff plot comparing the water-NaCl selectivity of commercial polyamide desalination membranes ESPA2 and NF270 to MPDTMC, TBDTMC and TYDTMC polyamide membranes fabricated by molecular layer-by-layer deposition. The red dashed line is the upper bound for polyamide desalination membrane permselectivity (FIG. 71D) comparison of the water permeance and salt rejection of the MPDTMC, TBDTMC and TYDTMC membranes fabricated in this study with state-of-the-art desalination membranes.

FIG. 72 depicts in accordance with various embodiments of the invention, ¹H NMR spectrum of 3,9-Diamino-4,10-dimethyl-6H,12H-5,11-methanodibenzo[1,5]-diazocine (TBD).

FIG. 73 depicts in accordance with various embodiments of the invention, ¹H NMR spectrum of 2,6/2,7 diaminotriptycene (TYD).

FIG. 74A-FIG. 74C depicts in accordance with various embodiments of the invention, IR spectra of PAN support, monomers and polyamides.

FIG. 75 depicts in accordance with various embodiments of the invention, FT-IR transmission spectra of MPDTMC, TBDTMC, and TYDTMC polyamide powders and spectra of corresponding MPD, TBD, and TYD diamine monomers and TMC monomer.

FIG. 76A-FIG. 761 depicts in accordance with various embodiments of the invention, AFM images of (FIG. 76A-76C) MPDTMC, (FIG. 76D-76F) TBDTMC and (FIG. 76G-76I) TYDTMC polyamide films fabricated by molecular layer-by-layer deposition.

FIG. 77A-FIG. 77B depicts in accordance with various embodiments of the invention, AFM images of PAN support membrane used for MPDTMC deposition.

FIG. 78A-FIG. 78B depicts in accordance with various embodiments of the invention, AFM images of composite membrane of 40-layer MPDTMC polyamide on PAN support.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Other features and advantages of the invention will become apparent from the following detailed description, taken in conjunction with the accompanying drawings, which illustrate, by way of example, various features of embodiments of the invention. Indeed, the present invention is in no way limited to the methods and materials described. For purposes of the present invention, the following terms are defined below. For convenience, certain terms employed herein, in the specification, examples and appended claims are collected here.

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. Unless otherwise defined, all technical and scientific terms used herein have the same meaning as commonly understood by one of ordinary skill in the art to which this invention belongs. It should be understood that this invention is not limited to the particular methodology, protocols, and reagents, etc., described herein and as such can vary. The definitions and terminology used herein are provided to aid in describing particular embodiments, and are not intended to limit the claimed invention, because the scope of the invention is limited only by the claims.

As used herein the term “comprising” or “comprises” is used in reference to compositions, methods, systems, articles of manufacture, apparatus, devices, and respective component(s) thereof, that are useful to an embodiment, yet open to the inclusion of unspecified elements, whether useful or not. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Although the open-ended term “comprising,” as a synonym of terms such as including, containing, or having, is used herein to describe and claim the invention, the present invention, or embodiments thereof, may alternatively be described using alternative terms such as “consisting of” or “consisting essentially of.”

Unless stated otherwise, the terms “a” and “an” and “the” and similar references used in the context of describing a particular embodiment of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. The abbreviation, “e.g.” is derived from the Latin exempli gratia, and is used herein to indicate a non-limiting example. Thus, the abbreviation “e.g.” is synonymous with the term “for example.” No language in the specification should be construed as indicating any non-claimed element essential to the practice of the application.

“Optional” or “optionally” means that the subsequently described circumstance may or may not occur, so that the description includes instances where the circumstance occurs and instances where it does not.

In some embodiments, the numbers expressing quantities of reagents, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein the term “electron donating group” is well-known in the art and generally refers to a functional group or atom that pushes electron density away from itself, towards other portions of the molecule, e.g., through resonance and/or inductive effects. Non-limiting examples of electron-donating groups include OR^{c}, NR^{c}R^{d}, alkyl groups, wherein R^{c}, and R^{d} are each independently H, optionally substituted alkyl, optionally substituted heteroalkyl, optionally substituted aryl, optionally substituted heteroaryl, optionally substituted cyclyl, or optionally substituted heterocyclyl.

As used herein the term “electron withdrawing group” is well-known in the art and generally refers to a functional group or atom that pulls electron density towards itself, away from other portions of the molecule, e.g., through resonance and/or inductive effects. Non-limiting examples of electron-withdrawing groups include NO₂, F, Cl, Br, I, CF₃, CN, CO₂R^{a}, C(═O)NR^{a}R^{b}, C(═O)R^{a}, SO₂R^{a}, SO₂OR^{a}, SO₂NR^{a}R^{b}, PO₃R^{a}R^{b}, or NO, wherein R^{a} and R^{b} are each independently H, optionally substituted alkyl, optionally substituted heteroalkyl, optionally substituted aryl, optionally substituted heteroaryl, optionally substituted cyclyl, or optionally substituted heterocyclyl.

As used herein, the term “alkyl” means a straight or branched, saturated aliphatic group having a chain of carbon atoms. Cₓ alkyl and Cₓ-C_{y}alkyl are typically used where X and Y indicate the number of carbon atoms in the chain. For example, C₁-C₆alkyl includes alkyls that have a chain of between 1 and 6 carbons (e.g., methyl, ethyl, propyl, isopropyl, butyl, sec-butyl, isobutyl, tert-butyl, pentyl, neopentyl, hexyl, and the like). Alkyl represented along with another group (e.g., as in arylalkyl) means a straight or branched, saturated alkyl divalent group having the number of atoms indicated or when no atoms are indicated means a bond, e.g., (C₆-C₁₀)aryl(C₀-C₃)alkyl includes phenyl, benzyl, phenethyl, 1-phenylethyl 3-phenylpropyl, and the like. The backbone of the alkyl can be optionally inserted with one or more heteroatoms, such as N, O, or S.

In preferred embodiments, a straight chain or branched chain alkyl has 30 or fewer carbon atoms in its backbone (e.g., C1-C30 for straight chains, C3-C30 for branched chains), and more preferably 20 or fewer. Likewise, preferred cycloalkyls have from 3-10 carbon atoms in their ring structure, and more preferably have 5, 6 or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone.

Unless the number of carbons is otherwise specified, “lower alkyl” as used herein means an alkyl group, as defined above, but having from one to ten carbons, more preferably from one to six carbon atoms in its backbone structure. Likewise, “lower alkenyl” and “lower alkynyl” have similar chain lengths. Throughout the application, preferred alkyl groups are lower alkyls. In preferred embodiments, a substituent designated herein as alkyl is a lower alkyl.

Non-limiting examples of substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like.

As used herein, the term “alkenyl” refers to unsaturated straight-chain, branched-chain or cyclic hydrocarbon group having at least one carbon-carbon double bond. Cₓ alkenyl and Cₓ-C_{y}alkenyl are typically used where X and Y indicate the number of carbon atoms in the chain. For example, C₂-C₆alkenyl includes alkenyls that have a chain of between 2 and 6 carbons and at least one double bond, e.g., vinyl, allyl, propenyl, isopropenyl, 1-butenyl, 2-butenyl, 3-butenyl, 2-methylallyl, 1-hexenyl, 2-hexenyl, 3-hexenyl, and the like). Alkenyl represented along with another group (e.g., as in arylalkenyl) means a straight or branched, alkenyl divalent group having the number of atoms indicated. The backbone of the alkenyl can be optionally inserted with one or more heteroatoms, such as N, O, or S.

As used herein, the term “alkynyl” refers to unsaturated hydrocarbon groups having at least one carbon-carbon triple bond. Cₓ alkynyl and Cₓ-C_{y}alkynyl are typically used where X and Y indicate the number of carbon atoms in the chain. For example, C₂-C₆alkynyl includes alkynyls that have a chain of between 2 and 6 carbons and at least one triple bond, e.g., ethynyl, 1-propynyl, 2-propynyl, 1-butynyl, isopentynyl, 1,3-hexa-diyn-yl, n-hexynyl, 3-pentynyl, 1-hexen-3-ynyl and the like. Alkynyl represented along with another group (e.g., as in arylalkynyl) means a straight or branched, alkynyl divalent group having the number of atoms indicated. The backbone of the alkynyl can be optionally inserted with one or more heteroatoms, such as N, O, or S.

The terms “alkylene,” “alkenylene,” and “alkynylene” refer to divalent alkyl, alkelyne, and alkynylene” groups. Prefixes C, and Cₓ-C_{y} are typically used where X and Y indicate the number of carbon atoms in the chain. For example, C₁-C₆alkylene includes methylene, (—CH₂—), ethylene (—CH₂CH₂—), trimethylene (—CH₂CH₂CH₂—), tetramethylene (—CH₂CH₂CH₂CH₂—), 2-methyltetramethylene (—CH₂CH(CH₃)CH₂CH₂—), pentamethylene (—CH₂CH₂CH₂CH₂CH₂—) and the like).

As used herein, the term “alkylidene” means a straight or branched unsaturated, aliphatic, divalent group having a general formula=CRₐR_{b}. Non-limiting examples of Rₐ and R_{b} are each independently hydrogen, alkyl, substituted alkyl, alkenyl, or substituted alkenyl. Cₓ alkylidene and Cₓ-C_{y}alkylidene are typically used where X and Y indicate the number of carbon atoms in the chain. For example, C₂-C₆alkylidene includes methylidene (═CH₂), ethylidene (═CHCH₃), isopropylidene (═C(CH₃)₂), propylidene (═CHCH₂CH₃), allylidene (═CH—CH═CH₂), and the like).

The term “heteroalkyl”, as used herein, refers to straight or branched chain, or cyclic carbon-containing groups, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

As used herein, the term “halogen” or “halo” refers to an atom selected from fluorine (F), chlorine (Cl), bromine (Br) and iodine (I). The term “halogen radioisotope” or “halo radioisotope” refers to a radionuclide of an atom selected from fluorine (F), chlorine (Cl), bromine (Br) and iodine (I).

In some embodiments, “iodo” refers to the iodine atom (I) when it is used in the context of a halo functional group or halogen functional group or as a halo substituent or halogen substituent.

In some embodiments, “bromo” refers to the bromine atom (Br) when it is used in the context of a halo functional group or halogen functional group or as a halo substituent or halogen substituent.

In some embodiments, “chloro” refers to the chlorine atom (Cl) when it is used in the context of a halo functional group or halogen functional group or as a halo substituent or halogen substituent.

In some embodiments, “fluoro” refers to the fluorine atom (F) when it is used in the context of a halo functional group or halogen functional group or as a halo substituent or halogen substituent.

A “halogen-substituted moiety” or “halo-substituted moiety”, as an isolated group or part of a larger group, means an aliphatic, alicyclic, or aromatic moiety, as described herein, substituted by one or more “halo” atoms, as such terms are defined in this application. For example, halo-substituted alkyl includes haloalkyl, dihaloalkyl, trihaloalkyl, perhaloalkyl and the like (e.g. halosubstituted (C₁-C₃)alkyl includes chloromethyl, dichloromethyl, difluoromethyl, trifluoromethyl (—CF₃), 2,2,2-trifluoroethyl, perfluoroethyl, 2,2,2-trifluoro-1,1-dichloroethyl, and the like).

The term “aryl” refers to monocyclic, bicyclic, or tricyclic fused aromatic ring system. Cₓ aryl and Cₓ-C_{y}aryl are typically used where X and Y indicate the number of carbon atoms in the ring system. For example, C₆-C₁₂ aryl includes aryls that have 6 to 12 carbon atoms in the ring system. Exemplary aryl groups include, but are not limited to, pyridinyl, pyrimidinyl, furanyl, thienyl, imidazolyl, thiazolyl, pyrazolyl, pyridazinyl, pyrazinyl, triazinyl, tetrazolyl, indolyl, benzyl, phenyl, naphthyl, anthracenyl, azulenyl, fluorenyl, indanyl, indenyl, naphthyl, phenyl, tetrahydronaphthyl, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl, and the like. In some embodiments, 1, 2, 3, or 4 hydrogen atoms of each ring can be substituted by a substituent.

The term “heteroaryl” refers to an aromatic 5-8 membered monocyclic, 8-12 membered fused bicyclic, or 11-14 membered fused tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively. Cₓ heteroaryl and Cₓ-C_{y}heteroaryl are typically used where X and Y indicate the number of carbon atoms in the ring system. For example, C₄-C₉ heteroaryl includes heteroaryls that have 4 to 9 carbon atoms in the ring system. Heteroaryls include, but are not limited to, those derived from benzo[b]furan, benzo[b]thiophene, benzimidazole, imidazo[4,5-c]pyridine, quinazoline, thieno[2,3-c]pyridine, thieno[3,2-b]pyridine, thieno[2,3-b]pyridine, indolizine, imidazo[1,2a]pyridine, quinoline, isoquinoline, phthalazine, quinoxaline, naphthyridine, quinolizine, indole, isoindole, indazole, indoline, benzoxazole, benzopyrazole, benzothiazole, imidazo[1,5-a]pyridine, pyrazolo[1,5-a]pyridine, imidazo[1,2-a]pydmidine, imidazo[1,2-c]pyrimidine, imidazo[1,5-a]pydmidine, imidazo[1,5-c]pyrimidine, pyrrolo[2,3-b]pyridine, pyrrolo[2,3c]pyridine, pyrrolo[3,2-c]pyridine, pyrrolo[3,2-b]pyridine, pyrrolo[2,3-d]pyrimidine, pyrrolo[3,2-d]pyrimidine, pyrrolo [2,3-b]pyrazine, pyrazolo[1,5-a]pyridine, pyrrolo[1,2-b]pyridazine, pyrrolo[1,2-c]pyrimidine, pyrrolo[1,2-a]pyrimidine, pyrrolo[1,2-a]pyrazine, triazo[1,5-a]pyridine, pteridine, purine, carbazole, acridine, phenazine, phenothiazene, phenoxazine, 1,2-dihydropyrrolo[3,2,1-hi]indole, indolizine, pyrido[1,2-a]indole, 2(0H)-pyridinone, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. Some exemplary heteroaryl groups include, but are not limited to, pyridyl, furyl or furanyl, imidazolyl, benzimidazolyl, pyrimidinyl, thiophenyl or thienyl, pyridazinyl, pyrazinyl, quinolinyl, indolyl, thiazolyl, naphthyridinyl, 2-amino-4-oxo-3,4-dihydropteridin-6-yl, tetrahydroisoquinolinyl, and the like. In some embodiments, 1, 2, 3, or 4 hydrogen atoms of each ring may be substituted by a substituent.

The term “cyclyl” or “cycloalkyl” refers to saturated and partially unsaturated cyclic hydrocarbon groups having 3 to 12 carbons, for example, 3 to 8 carbons, and, for example, 3 to 6 carbons. Cₓcyclyl and Cₓ-C_{y}cycyl are typically used where X and Y indicate the number of carbon atoms in the ring system. For example, C₃-C₈ cyclyl includes cyclyls that have 3 to 8 carbon atoms in the ring system. The cycloalkyl group additionally can be optionally substituted, e.g., with 1, 2, 3, or 4 substituents. C₃-C₁₀cyclyl includes cyclopropyl, cyclobutyl, cyclopentyl, cyclohexyl, cyclohexenyl, 2,5-cyclohexadienyl, cycloheptyl, cyclooctyl, bicyclo[2.2.2]octyl, adamantan-1-yl, decahydronaphthyl, oxocyclohexyl, dioxocyclohexyl, thiocyclohexyl, 2-oxobicyclo [2.2.1]hept-1-yl, and the like.

Aryl and heteroaryls can be optionally substituted with one or more substituents at one or more positions, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The term “heterocyclyl” refers to a nonaromatic 4-8 membered monocyclic, 8-12 membered bicyclic, or 11-14 membered tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively). Cₓheterocyclyl and Cₓ-C_{y}heterocyclyl are typically used where X and Y indicate the number of carbon atoms in the ring system. For example, C₄-C₉ heterocyclyl includes heterocyclyls that have 4-9 carbon atoms in the ring system. In some embodiments, 1, 2 or 3 hydrogen atoms of each ring can be substituted by a substituent. Exemplary heterocyclyl groups include, but are not limited to piperazinyl, pyrrolidinyl, dioxanyl, morpholinyl, tetrahydrofuranyl, piperidyl, 4-morpholyl, 4-piperazinyl, pyrrolidinyl, perhydropyrrolizinyl, 1,4-diazaperhydroepinyl, 1,3-dioxanyl, 1,4-dioxanyland the like.

The terms “bicyclic” and “tricyclic” refer to fused, bridged, or joined by single bond polycyclic ring assemblies.

The term “cyclylalkylene” means a divalent aryl, heteroaryl, cyclyl, or heterocyclyl.

As used herein, the term “fused ring” refers to a ring that is bonded to another ring to form a compound having a bicyclic structure when the ring atoms that are common to both rings are directly bound to each other. Non-exclusive examples of common fused rings include decalin, naphthalene, anthracene, phenanthrene, indole, furan, benzofuran, quinoline, and the like. Compounds having fused ring systems can be saturated, partially saturated, cyclyl, heterocyclyl, aromatics, heteroaromatics, and the like.

As used herein, the term “carbonyl” means the group —C(O)—. It is noted that the carbonyl group can be further substituted with a variety of substituents to form different carbonyl groups including acids, acid halides, amides, esters, ketones, and the like.

The term “carboxy” means the group —C(O)O—. It is noted that compounds described herein containing carboxy moieties can include protected derivatives thereof, i.e., where the oxygen is substituted with a protecting group. Suitable protecting groups for carboxy moieties include benzyl, tert-butyl, and the like. The term “carboxyl” means —COOH.

The term “cyano” means the group —CN.

The term, “heteroatom” refers to an atom that is not a carbon atom. Particular examples of heteroatoms include, but are not limited to nitrogen, oxygen, sulfur and halogens. A “heteroatom moiety” includes a moiety where the atom by which the moiety is attached is not a carbon. Examples of heteroatom moieties include —N═, —NR^{N}—, —N⁺(O⁻)═, —O—, —S— or —S(O)₂—, —OS(O)₂—, and —SS—, wherein R^{N} is H or a further substituent.

The term “hydroxy” means the group —OH.

The term “imine derivative” means a derivative comprising the moiety —C(NR)—, wherein R comprises a hydrogen or carbon atom alpha to the nitrogen.

The term “nitro” means the group —NO₂.

An “oxaaliphatic,” “oxaalicyclic”, or “oxaaromatic” mean an aliphatic, alicyclic, or aromatic, as defined herein, except where one or more oxygen atoms (—O—) are positioned between carbon atoms of the aliphatic, alicyclic, or aromatic respectively.

An “oxoaliphatic,” “oxoalicyclic”, or “oxoaromatic” means an aliphatic, alicyclic, or aromatic, as defined herein, substituted with a carbonyl group. The carbonyl group can be an aldehyde, ketone, ester, amide, acid, or acid halide.

As used herein, the term “aromatic” means a moiety wherein the constituent atoms make up an unsaturated ring system, all atoms in the ring system are sp² hybridized and the total number of pi electrons is equal to 4n+2. An aromatic ring can be such that the ring atoms are only carbon atoms (e.g., aryl) or can include carbon and non-carbon atoms (e.g., heteroaryl).

As used herein, the term “substituted” refers to independent replacement of one or more (typically 1, 2, 3, 4, or 5) of the hydrogen atoms on the substituted moiety with substituents independently selected from the group of substituents listed below in the definition for“substituents” or otherwise specified. In general, a non-hydrogen substituent can be any substituent that can be bound to an atom of the given moiety that is specified to be substituted. Examples of substituents include, but are not limited to, acyl, acylamino, acyloxy, aldehyde, alicyclic, aliphatic, alkanesulfonamido, alkanesulfonyl, alkaryl, alkenyl, alkoxy, alkoxycarbonyl, alkyl, alkylamino, alkylcarbanoyl, alkylene, alkylidene, alkylthios, alkynyl, amide, amido, amino, aminoalkyl, aralkyl, aralkylsulfonamido, arenesulfonamido, arenesulfonyl, aromatic, aryl, arylamino, arylcarbanoyl, aryloxy, azido, carbamoyl, carbonyl, carbonyls including ketones, carboxy, carboxylates, CF₃, cyano (CN), cycloalkyl, cycloalkylene, ester, ether, haloalkyl, halogen, halogen, heteroaryl, heterocyclyl, hydroxy, hydroxyalkyl, imino, iminoketone, ketone, mercapto, nitro, oxaalkyl, oxo, oxoalkyl, phosphoryl (including phosphonate and phosphinate), silyl groups, sulfonamido, sulfonyl (including sulfate, sulfamoyl and sulfonate), thiols, and ureido moieties, each of which may optionally also be substituted or unsubstituted. In some cases, two substituents, together with the carbon(s) to which they are attached to, can form a ring.

Substituents may be protected as necessary and any of the protecting groups commonly used in the art may be employed. Non-limiting examples of protecting groups may be found, for example, in Greene et al., Protective Groups in Organic Synthesis, 3rd Ed. (New York. Wiley, 1999).

The terms “alkoxyl” or “alkoxy” as used herein refers to an alkyl group, as defined above, having an oxygen atom attached thereto. Representative alkoxyl groups include methoxy, ethoxy, propyloxy, tert-butoxy, n-propyloxy, iso-propyloxy, n-butyloxy, iso-butyloxy, and the like. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined below. The alkoxy and aroxy groups can be substituted as described above for alkyl.

The term “aralkyl”, as used herein, refers to an alkyl group substituted with an aryl group (e.g., an aromatic or heteroaromatic group).

The term “alkylthio” refers to an alkyl group, as defined above, having a sulfur atom attached thereto. In preferred embodiments, the “alkylthio” moiety is represented by one of —S-alkyl, —S-alkenyl, and —S-alkynyl. Representative alkylthio groups include methylthio, ethylthio, and the like. The term “alkylthio” also encompasses cycloalkyl groups, alkene and cycloalkene groups, and alkyne groups. “Arylthio” refers to aryl or heteroaryl groups.

The term “sulfinyl” means the group —SO—. It is noted that the sulfinyl group can be further substituted with a variety of substituents to form different sulfinyl groups including sulfinic acids, sulfinamides, sulfinyl esters, sulfoxides, and the like.

The term “sulfonyl” means the group —SO₂—. It is noted that the sulfonyl group can be further substituted with a variety of substituents to form different sulfonyl groups including sulfonic acids (—SO₃H), sulfonamides, sulfonate esters, sulfones, and the like.

The term “thiocarbonyl” means the group —C(S)—. It is noted that the thiocarbonyl group can be further substituted with a variety of substituents to form different thiocarbonyl groups including thioacids, thioamides, thioesters, thioketones, and the like.

As used herein, the term “amino” means —NH₂. The term “alkylamino” means a nitrogen moiety having at least one straight or branched unsaturated aliphatic, cyclyl, or heterocyclyl groups attached to the nitrogen. For example, representative amino groups include —NH₂, —NHCH₃, —N(CH₃)₂, —NH(C₁-C₁₀alkyl), —N(C₁-C₁₀alkyl)₂, and the like. The term “alkylamino” includes “alkenylamino,” “alkynylamino,” “cyclylamino,” and “heterocyclylamino.” The term “arylamino” means a nitrogen moiety having at least one aryl group attached to the nitrogen. For example —NHaryl, and —N(aryl)₂. The term “heteroarylamino” means a nitrogen moiety having at least one heteroaryl group attached to the nitrogen. For example —NHheteroaryl, and —N(heteroaryl)₂. Optionally, two substituents together with the nitrogen can also form a ring. Unless indicated otherwise, the compounds described herein containing amino moieties can include protected derivatives thereof. Suitable protecting groups for amino moieties include acetyl, tertbutoxycarbonyl, benzyloxycarbonyl, and the like.

The term “aminoalkyl” means an alkyl, alkenyl, and alkynyl as defined above, except where one or more substituted or unsubstituted nitrogen atoms (—N—) are positioned between carbon atoms of the alkyl, alkenyl, or alkynyl. For example, an (C₂-C₆) aminoalkyl refers to a chain comprising between 2 and 6 carbons and one or more nitrogen atoms positioned between the carbon atoms.

The term “alkoxyalkoxy” means —O-(alkyl)-O-(alkyl), such as —OCH₂CH₂OCH₃, and the like.

The term “alkoxycarbonyl” means —C(O)O-(alkyl), such as —C(═O)OCH₃, —C(═O)OCH₂CH₃, and the like.

The term “alkoxyalkyl” means -(alkyl)-O-(alkyl), such as —CH₂OCH₃, —CH₂OCH₂CH₃, and the like.

The term “aryloxy” means —O-(aryl), such as —O-phenyl, —O-pyridinyl, and the like.

The term “arylalkyl” means -(alkyl)-(aryl), such as benzyl (i.e., —CH₂phenyl), —CH₂— pyrindinyl, and the like.

The term “arylalkyloxy” means —O-(alkyl)-(aryl), such as —O-benzyl, —O—CH₂-pyridinyl, and the like.

The term “cycloalkyloxy” means —O-(cycloalkyl), such as —O-cyclohexyl, and the like.

The term “cycloalkylalkyloxy” means —O-(alkyl)-(cycloalkyl, such as —OCH₂cyclohexyl, and the like.

The term “aminoalkoxy” means —O-(alkyl)-NH₂, such as —OCH₂NH₂, —OCH₂CH₂NH₂, and the like.

The term “mono- or di-alkylamino” means —NH(alkyl) or —N(alkyl)(alkyl), respectively, such as —NHCH₃, —N(CH₃)₂, and the like.

The term “mono- or di-alkylaminoalkoxy” means —O-(alkyl)-NH(alkyl) or —O-(alkyl)-N(alkyl)(alkyl), respectively, such as —OCH₂NHCH₃, —OCH₂CH₂N(CH₃)₂, and the like.

The term “arylamino” means —NH(aryl), such as —NH-phenyl, —NH-pyridinyl, and the like.

The term “arylalkylamino” means —NH-(alkyl)-(aryl), such as —NH-benzyl, —NHCH₂— pyridinyl, and the like.

The term “alkylamino” means —NH(alkyl), such as —NHC₃, —NHCH₂CH₃, and the like.

The term “cycloalkylamino” means —NH-(cycloalkyl), such as —NH-cyclohexyl, and the like.

The term “cycloalkylalkylamino” —NH-(alkyl)-(cycloalkyl), such as —NHCH₂— cyclohexyl, and the like.

It is noted in regard to all of the definitions provided herein that the definitions should be interpreted as being open ended in the sense that further substituents beyond those specified may be included. Hence, a C₁ alkyl indicates that there is one carbon atom but does not indicate what are the substituents on the carbon atom. Hence, a C₁ alkyl comprises methyl (i.e., —CH₃) as well as —CRₐR_{b}R_{c} where Rₐ, R_{b}, and R_{c} can each independently be hydrogen or any other substituent where the atom alpha to the carbon is a heteroatom or cyano. Hence, CF₃, CH₂OH and CH₂CN are all C₁ alkyls.

Unless otherwise stated, structures depicted herein are meant to include compounds which differ only in the presence of one or more isotopically enriched atoms. For example, compounds having the present structure except for the replacement of a hydrogen atom by a deuterium or tritium, or the replacement of a carbon atom by a ¹³C- or ¹⁴C-enriched carbon are within the scope of the invention.

In various embodiments, compounds and materials of the present invention as disclosed herein may be synthesized using any synthetic method available to one of skill in the art. Non-limiting examples of synthetic methods used to prepare various embodiments of compounds and materials of the present invention are disclosed in the Examples section herein.

The work described herein aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. Successful completion of the project will be used to achieve control over free volume and enhanced permselectivity in polyamide desalination membranes by incorporating contorted monomers in a scalable fabrication process. The higher throughput and enhanced separation performance of these contorted polyamide membranes are hypothesized to intensify desalination processes and improve their system energy efficiency, thus reducing overall desalination costs. Reducing the cost of desalination will hopefully improve the accessibility and broaden the implementation of membrane desalination technology for increased water supplies, in alignment with the goals of the Desalination and Water Purification Research Program.

The permeability-selectivity tradeoff observed for polymeric desalination membranes limits the performance of reverse osmosis and nanofiltration desalination systems and increases their overall costs. Though membrane desalination separations, such as seawater reverse osmosis, have achieved energy efficiencies approaching the thermodynamic minimum (M. Elimelech, W. A. Phillip, Science 2011, 333, 712), further improvements in membrane permeability and selectivity could intensify desalination processes (D. Cohen-Tanugi, R. K. McGovern, S. H. Dave, J. H. Lienhard, J. C. Grossman, Energy Environ. Sci. 2014, 7, 1134) and improve their system energy efficiency (J. R. Werber, A. Deshmukh, M. Elimelech, Environ. Sci. Technol. Lea. 2016, 3, 112), thus reducing overall desalination costs. Specifically, ultra-permeable desalination membranes can significantly reduce pressure vessel requirements for reverse osmosis systems operating at constant energy consumption and permeate recovery (D. Cohen-Tanugi, R. K. McGovern, S. H. Dave, J. H. Lienhard, J. C. Grossman, Energy Environ. Sci. 2014, 7, 1134). Improvements in membrane selectivity can improve permeate quality and thus expand membrane desalination applications for potable reuse of wastewater and for seawater desalination for agricultural irrigation (J. R. Werber, A. Deshmukh, M. Elimelech, Environ. Sci. Technol. Lett. 2016, 3, 112).

The permeability-selectivity performance of commercially available desalination membranes is governed by their polyamide (PA) selective layer, fabricated via the interfacial polymerization (IP) of orthogonally-soluble m-phenylenediamine (MPD) and trimesoyl chloride (TMC) monomers to form a highly cross-linked, fully-aromatic polyamide (PA) network (J.-E. Gu, S. Lee, C. M. Stafford, J. S. Lee, W. Choi, B.-Y. Kim, K.-Y. Baek, E. P. Chan, J. Y. Chung, J. Bang. J.-H. Lee, Adv. Mater. 2013, 25, 4778). Interfacial polymerization (IP) is commercially successful for fabricating thin film composite (TFC) desalination membranes because the process is scalable to large areas and capable of fabricating defect-free polyamide (PA) selective layers (M. J. T. Raaijmakers, N. E. Benes, Prog. Polym. Sci. 2016, 63, 86). However, difficulty controlling the interfacial polymerization (IP) process, which is influenced by convoluted variables like monomer diffusivity and solvent viscosity, results in heterogeneous polyamide (PA) films with rough surface morphologies and variable thicknesses. The resulting performance of the interfacial polymerization (IP)-assembled polyamide (PA) layer is governed by both its extrinsic and intrinsic properties, which complicates the study of water and salt transport through these materials (W. Choi, J.-E. Gu, S.-H. Park, S. Kim, J. Bang, K.-Y. Baek, B. Park, J S. Lee, E. P. Chan, J.-H. Lee, ACS Nano 2015, 9, 3450). Since the 1980s, polyamide (PA) membrane chemistry has been dominated by the use of dual-phase MPD and TMC monomers (K. P. Lee, T. C. Arnot, D. Mattia, J. Membr. Sci. 2011, 370, 1), which form a dense, cross-linked polyamide (PA) network with high salt rejection (>99.5%) but relatively low water permeance (~2 L m⁻² bar⁻¹) (J. R. Werber, A. Deshmukh, M. Elimelech, Environ. Sci. Technol. Let. 2016, 3, 112). MPDTMC polyamide membranes exhibit a clear permeability-selectivity tradeoff, wherein improved permeability is achieved at the expense of reduced salt rejection and selectivity (G. M. Geise, H. B. Park, A. C. Sagle, B. D. Freeman, J. E. McGrath, J. Membr. Sci. 2011, 369, 130). This tradeoff is inherent to solution-diffusion transport in dense polymeric membranes and has been described by both electrostatic forces and polymer free volume (H. Zhang, G. M. Geise, J. Membr. Sci. 2016, 520, 790).

To reduce the costs of membrane desalination and improve the performance of desalination systems, the permeability-selectivity tradeoff of commercial desalination membranes must be overcome. Advances in membrane chemistry beyond MPDTMC polyamide are needed to provide control over membrane selective layer structure that will enhance desalination performance compared to conventional polyamide (PA) materials. Such advances will require improvements in the conventional dual-phase interfacial polymerization (IP) process, and they must also be scalable for processing large area, defect-free materials. Without these advances in membrane chemistry and processing, polyamide membranes will remain relegated to the MPDTMC chemistry that has persisted for decades. Opportunities to expand the applications of membrane desalination through process intensification and improved system efficiency will remain unmet because of the permeability selectivity tradeoff that limits MPDTMC polyamide membrane performance.

### Contorted Polyamide Membranes for High Performance Desalination

Herein, we report the successful fabrication of highly permeable and selective polyamide TFC membranes using bulky, shape persistent Troger's base and triptycene diamine (TBD and TYD respectively) monomers via molecular layer-by-layer (mLBL) process. The resulting membranes exhibited a remarkable 8-fold increase in water permeance while maintaining excellent salt rejection (>98%), surpassing the tradeoff observed in commercial desalination membranes. The molecular layer-by-layer (mLbL) process demonstrated unparalleled control over polyamide layer characteristics, presenting membranes with controlled thickness, minimal surface roughness, and well-defined chemical composition. Importantly, the molecular layer-by-layer (mLbL) process eliminated the need for specific solvents, expanding the range of chemistries applicable to the selective layer. The ultra-permeable desalination membranes fabricated using versatile molecular layer-by-layer (mLbL) process offer a promising avenue for enhancing system energy efficiency and reducing overall desalination costs.

### Results and Discussion

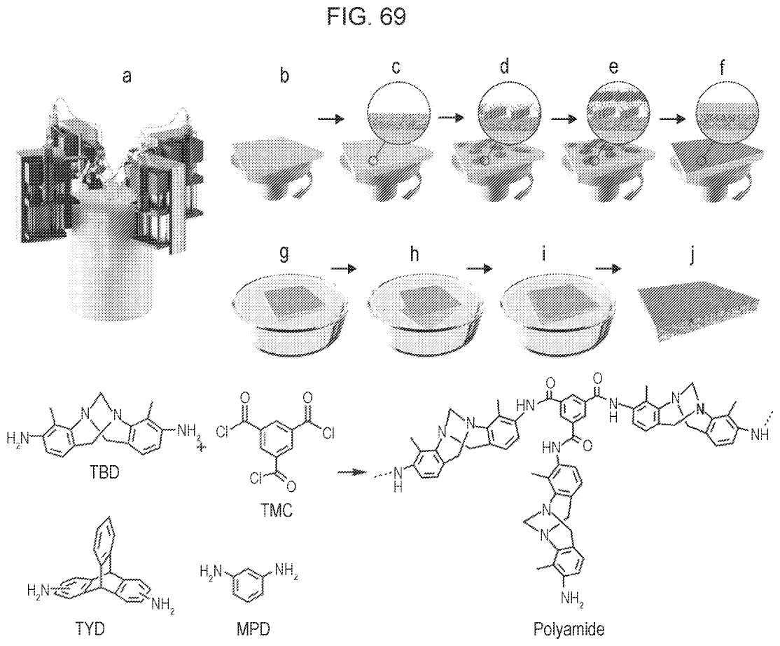

Sterically contorted, shape-persistent Tröger's base and trypticene diamine (TBD) monomers were synthesized by facile and scalable two step synthetic route using a reported procedure (Z. Wang, D. Wang, F. Zhang, J. Jin, ACS Macro Lett. 2014, 3, 597; S. A. Sydlik, Z. Chen, T. M. Swager, Macromolecules 2011, 44, 976). Powdered polyamide polymers from these monomers were synthesized by monophasic (in a single solvent system) polymerization with trimesoyl chloride (TMC). The polyamide thin films were fabricated by a spin-assisted molecular layer-by-layer (mLbL) deposition process (W. D. Mulhearn, V. P. Oleshko, C. M. Stafford, Journal of Membrane Science 2021, 618, 118637), outlined in FIG. 69 (details in Examples section herein)). The chemistry and structure of the resulting contorted polyamide polymers (TBDTMC and TYDTMC) were characterized and compared to conventional polyamide synthesized from m-phenylene diamine (MPDTMC) to understand the influence of diamine monomer structure on polyamide polymer free volume and network structure.

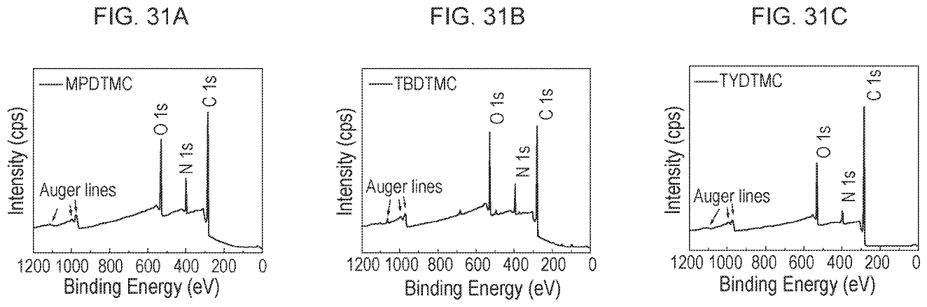

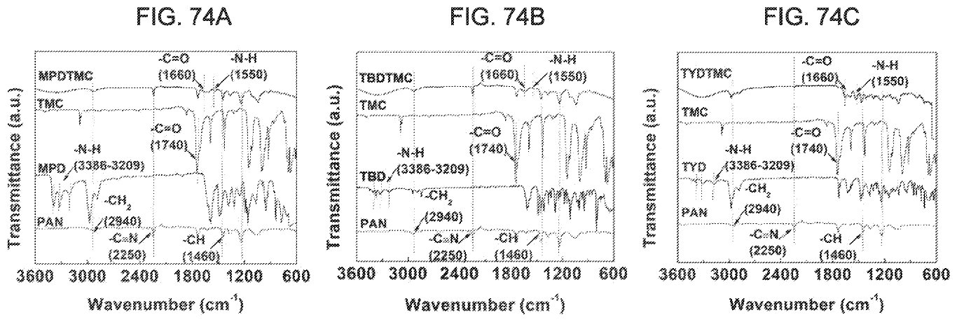

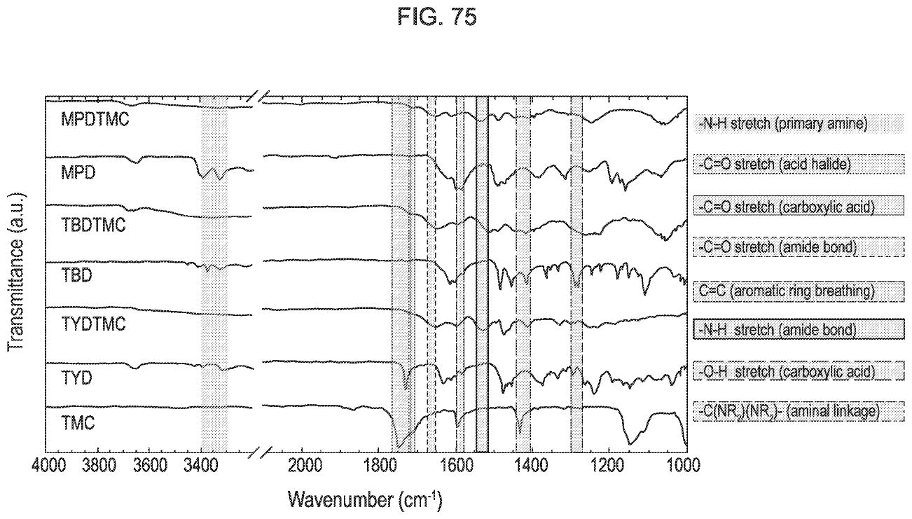

The Fourier-transformed infrared spectroscopy (FTIR) of all polyamides showed the disappearance of the characteristic acyl chloride (—COCl) at 1740 cm⁻¹ and diamine (—N—H) bond stretch between 3386-3209 cm⁻¹ (FIG. 74A-FIG. 74C)), and the emergence of amide carbonyl stretch (—C═O) at 1660 cm⁻¹ indicating complete consumption of diamine and acyl chloride monomers during the course of molecular layer-by-layer (mLbL) polyamide film formation. The degree of crosslinking of the polyamide films were characterized by X-ray photoelectron spectroscopy (XPS) measurements (FIG. 31A-FIG. 31C)). The degree of crosslinking of the polyamides was estimated by comparing the calculated O/N elemental ratio to the theoretical ratios that would be measured for fully crosslinked and fully linear polyamide films of the same chemistry.

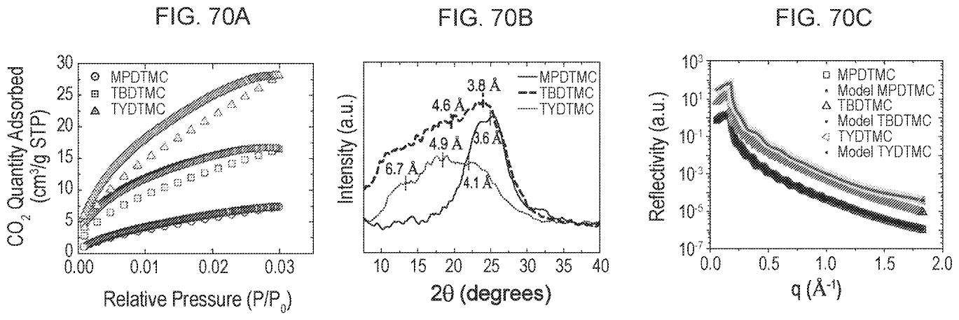

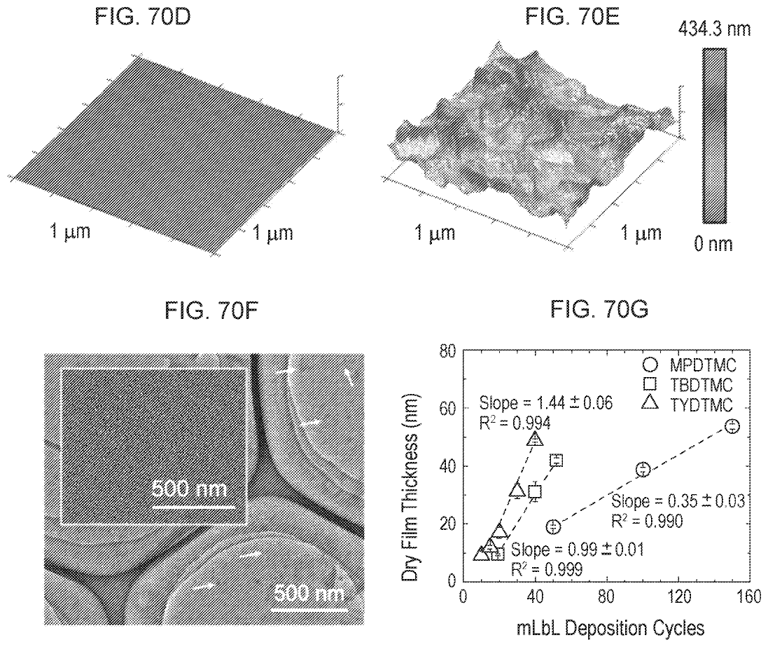

The porosity evaluation of the synthesized polyamide (PA) polymer powders involved assessing gas adsorption isotherms for N₂ at 77K and CO₂ at 273K (FIG. 70A). CO₂ adsorption isotherms were particularly informative about the surface areas of the polymer networks, given smaller kinetic diameter of CO₂ compared to N₂ (3.3 Å and 3.64 Å, respectively). This size difference allows CO₂ molecules to access narrow micropores that may be challenging for N₂ to penetrate. (H. Qian, J. Zheng, S. Zhang, Polymer 2013, 54, 557) As depicted in FIG. 70A, the introduction of Tröger's base and triptycene molecules into the polyamide network led to a substantial two- to three-fold increase (80 m⁻²g⁻¹ and 143 m⁻²g⁻¹ resp.) in surface area compared to conventional polyamide with an m-phenylene group (39.5 m⁻²g⁻¹).

In FIG. 70B, the XRD spectra of polyamides revealed an amorphous structure across all polymers, as evidenced by their broad diffraction spectra. The increased broadening observed in TBDTMC and TYDTMC in comparison to MPDTMC suggested less efficient packing or a lower degree of order in the polymer chains. Furthermore, the average chain d-spacing, calculated using Bragg's law, unveiled submicroporous structural characteristics for all polymers. Specifically, the d-spacing values were measured as follows: MPDTMC=3.6 Å, TBDTMC=3.8 Å and 4.6 Å, and TYDTMC=4.1 Å, 4.9 Å, 6.7 Å. The notably higher d-spacing observed in polyamides containing contorted TBD and TYD groups indicated an enhanced free volume when compared to their conventional counterpart, MPDTMC. Chain packing trends were further supported by the densities of polyamides obtained from X-ray reflectivity (XRR). In FIG. 70C, the experimental and fitted reflectivity curves of all polyamide films deposited on Si-wafer are presented. The densities of polyamide films of varying thicknesses, estimated from the scattering length densities (SLDs), revealing a consistent trend of decreasing densities for all molecular layer-by-layer (mLbL) polyamide films with increasing film thickness. This trend possibly reflects the growth behavior of molecular layer-by-layer (mLbL) polyamide films, where deposited monomers' aromatic rings align parallel to the substrate at low cycle numbers and become more perpendicular and isotropic as film thickness increases. (D. S. Bergsman, R. G. Closser, C. J. Tassone, B. M. Clemens, D. Nordlund, S F. Bent, Chem. Mater. 2017, 29, 1192; T. J. Zimudzi, S. E. Sheffield. K. E. Feldman, P. A. Beaucage, D. M. DeLongchamp, D. I. Kushner, C M. Stafford, M. A. Hickner, Macromolecules 2021, 54, 11296) The lower densities observed in contorted polyamides compared to conventional MPDTMC polyamide suggest an increased free volume introduced by the contorted TBD and TYD monomers. This decreasing density trend (MPDTMC=1.33 gcm⁻³>TBDTMC=0.968 gcm⁻³>TYDTMC=0.918 gcm⁻³) corresponds well with previously measured trends of increasing d-spacing and Langmuir surface areas for contorted versus conventional polyamide.

The measured density of ~1.33 g cm⁻³ for molecular layer-by-layer (mLbL) MPDTMC polyamide film was consistent with a predicted dry film density range of 1.301-1.358 g cm⁻³; from atomistic molecular simulation (T. P. Liyana-Arachchi, J F. Sturnfield, C. M. Colina, J. Phys. Chem. B 2016, 120, 9484). Additionally, it matched with a dry density range of interfacially polymerized MPDTMC (1.21-1.32 g cm⁻³) measured by neutron reflectivity. (F. Foglia, S. Karan, M. Nania, Z. Jiang, A. E. Porter, R. Barker, A. G. Livingston, J. T. Cabral, Advanced Functional Materials 2017, 27, 1701738).

Fabrication of Polyamine Membranes by Molecular Layer-by-Layer (mLbL)

For molecular layer-by-layer (mLbL) deposition 0.4% solutions of TMC in toluene and MPD/TBD in toluene were prepared for the two reaction steps in the deposition cycle. The TYD monomer, was only soluble in toluene when a 5% volume of N,N-dimethylformamide (DMF) cosolvent was added. Therefore, we transitioned the TYD solvent to acetone to enhance its solubility.

The spin-coater sequentially and uniformly distributed the amine and acid chloride solutions onto a silicon wafer, as depicted in FIG. 69. Between deposition cycles, the wafer underwent rinsing to eliminate any residual, unreacted monomers. The details of this process are given in the Examples section herein.

To facilitate the release and the formation of nanometer thick free-standing polyamide films, the silicon wafer was pre-coated with a water-soluble poly(sodium 4-styrene sulfonate) (PSS) release layer before molecular layer-by-layer (mLbL) process. The high density of sulfonate groups in PSS facilitates hydrogen bonding with the TMC monomer in the 1^{st} half molecular layer-by-layer (mLbL) cycle. After depositing a prescribed number of polyamide layers, the polyamide-coated silicon substrate was immersed in water bath where the PA film detached from silicon wafer due to dissolution of the PSS release layer. The free-standing PA film at the air-water interface was captured on either a polyacrylonitrile (PAN) support membrane to form a thin-film composite membrane or on a silicon substrate for further characterization. The resultant chemical structure of highly crosslinked polyamide network is as shown in FIG. 69.

The growth rates of the TBDTMC and MPDTMC polyamide films by the molecular layer-by-layer (mLbL) deposition process were measured by interferometry. All the three films exhibited a linear growth rate as a function of the number of cycles (FIG. 70D), with the MPDTMC growth rate of 0.35 nm/cycle consistent with previous reports in the literature (W. D. Mulhearn, V. P. Oleshko, C. M. Stafford, Journal of Membrane Science 2021, 618, 118637). Varying the diamine monomer backbone from a phenyl ring in MPD to a more rigid and contorted TBD and TYD resulted significant increase in the growth rate from 0.35 to 1.05 nm/cycle and 1.44 nm/cycle respectively. Without being bound by theory a faster growth rate may be observed for these films because of the relatively large size of the TBD and TYD to MPD. Without being bound by theory, additionally, the reduced reactivity of the TBDTMC and TYDTMC system due to stearic factors may impact the crosslinking density of the contorted polyamides, potentially increasing the polymer free volume and, consequently, the film growth rate. Notably, the XPS analysis confirmed the high-crosslinking densities of our polyamide films, suggesting that the observed polyamide film growth-rate is dominated by the internal free volume of the monomers (TBD and TYD). Furthermore, molecular layer deposition chemistries with more flexible backbones tend to exhibit a greater number of interchain termination reactions than those with rigid backbones, leading to an overall reduction in their growth rate. (D. S. Bergsman, R. G. Closser, C. J. Tassone, B. M. Clemens, D. Nordlund, S. F. Bent, Chem. Mater. 2017, 29, 1192, D. S. Bergsman, R. G. Closser, S. F. Bent, Chem. Mater. 2018, 30, 5087). The observed linear growth rates in all three cases affirm the feasibility of fabricating ultrathin functional polyamide films with tunable thicknesses through the molecular layer-by-layer (mLbL) deposition process. These findings contribute to our understanding of the intricacies of polyamide film growth and open avenues for tailoring film properties based on molecular design considerations.

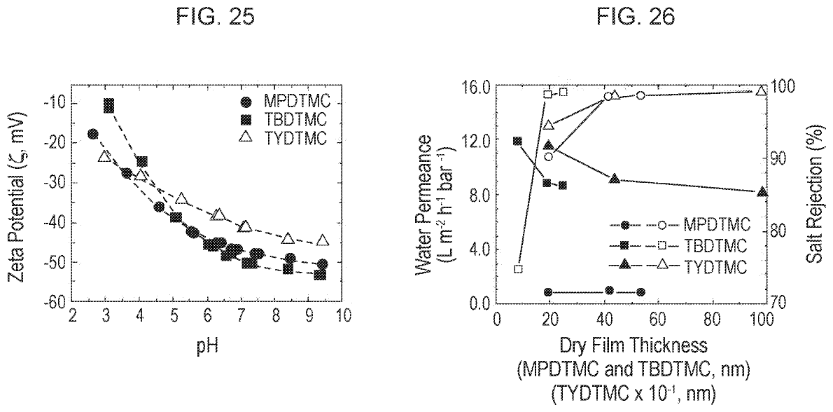

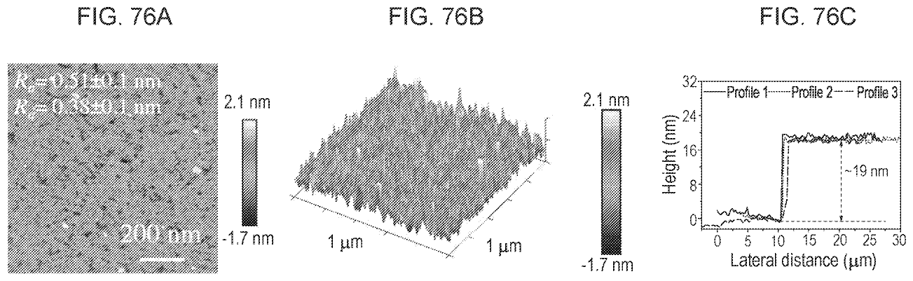

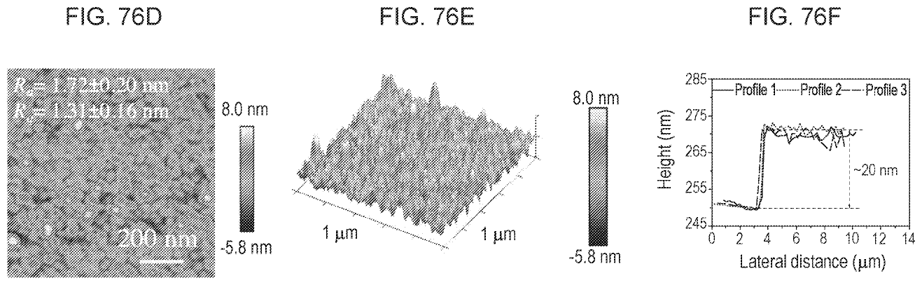

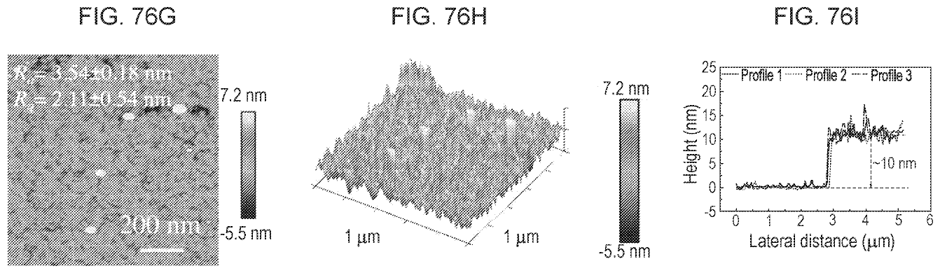

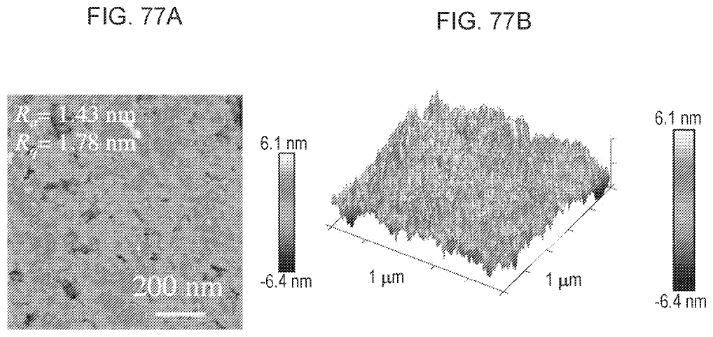

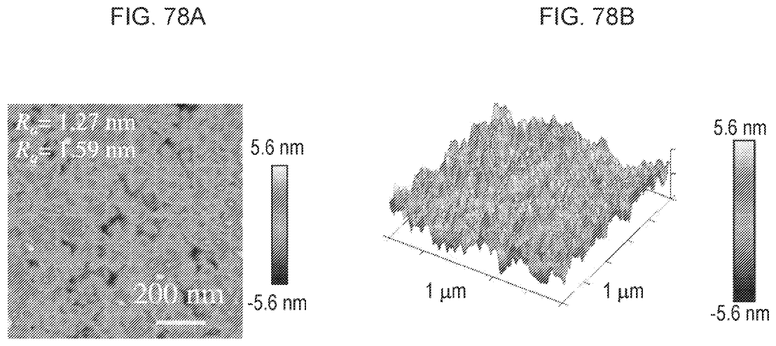

The surface morphology of the PA nanofilms were characterized using atomic force microscopy (AFM) (FIG. 70D-FIG. 70E). Notably, all membranes deposited through molecular layer-by-layer (mLbL) exhibited a root mean squared (RMS) surface roughness an order of magnitude lower (0.31-2.11 nm) than that of commercial IP desalination membranes (39 nm). The pronounced roughness observed for the IP-PA membranes has been attributed to the rapid, uncontrolled reaction rate occurring at multiple interfaces. (J.-E. Gu, S. Lee, C. M. Stafford, J. S. Lee, W. Choi, B.-Y. Kim, K.-Y. Baek, E. P. Chan, J. Y. Chung, J. Bang, J.-H. Lee, Advanced Materials 2013, 25, 4778). In contrast, the molecular layer-by-layer (mLbL) PA membranes exhibited smoother surfaces due to the controlled polymerization at a single monomer layer, facilitated by the stoichiometry-limiting feature of the mLbL approach. Additionally, within the polyamide membranes fabricated through mLbL deposition, contorted polyimides displayed higher roughness values compared to MPDTMC. Without being bound by theory, this difference is attributed to the rigidity of polymer chains which may lead to higher surface roughness due to restricted chain mobility and a higher likelihood of forming surface irregularities. In contrast, the flexible chains can adopt conformations that minimize surface asperities. From a long-term desalination perspective, without being bound by theory the smoother membrane surface may alleviate the fouling propensity unlike the highly rough surfaces of the state-of-the-art membranes. (M. R. Chowdhury, J. Steffes, B. D. Huey, J. R. McCutcheon, Science 2018, 361, 682). Upon transferring the free-standing mLbL-PA membranes onto PAN support, the roughness of the resultant TFC film is largely dictated by the surface roughness of the PAN membrane (FIG. 77A-FIG. 77B). Similar surface morphologies were observed in top-down SEM images which exhibited the rough ridge-and-valley morphology that is typical of interfacially polymerized, fully-aromatic polyamides (FIG. 70E), whereas the mLbL membranes had a significantly smoother surface. The large-area TEM image shows an essentially featureless film lacking any discernable channels available that would allow transport via unhindered pore-flow during operation (FIG. 70G). The selected area electron diffraction pattern from TEM (FIG. 76A-FIG. 76I) indicated the amorphous, rather than crystalline, structure of all the polyamide films, for these cross-linked network polymers. In the present work described herein, we also demonstrated the tunability of mLbL polyamide surface chemistry by strategically selecting terminating monomers for the final deposition steps. This tunability is illustrated through FIG. 25, which compares the zeta potential of membranes using different terminating monomers, namely MPDTMC, TBDTMC, and TBDTMC terminated with 5 cycles of TMC. The —COCl group in TMC undergoes hydrolysis to form —COOH groups upon exposure to moisture, leading to an increase in the membrane's zeta potential. This increase indicates a higher abundance of carboxylic acid groups on the membrane surface terminated with 5 deposition cycles of TMC. While our study primarily focused on model carboxyl group-terminated TFCs, it is noteworthy that mLbL polyamide surfaces can be tailored for diverse functionalities by choosing alternative terminating monomers or incorporating other functional molecules such as hydroxyl groups or zwitterions to address the scaling/fouling of polyamide membranes during desalination, for example, negatively charged surfaces are known to resist silica scaling during long-term RO desalination. (T. Tong, S. Zhao, C. Boo, S. M. Hashmi, M. Elimelech, Environ. Sci. Technol. 2017, 51, 4396). This versatility holds promise for the development of robust, small molecular anti-fouling coatings beyond the scope of our current investigation.

### Desalination Performance

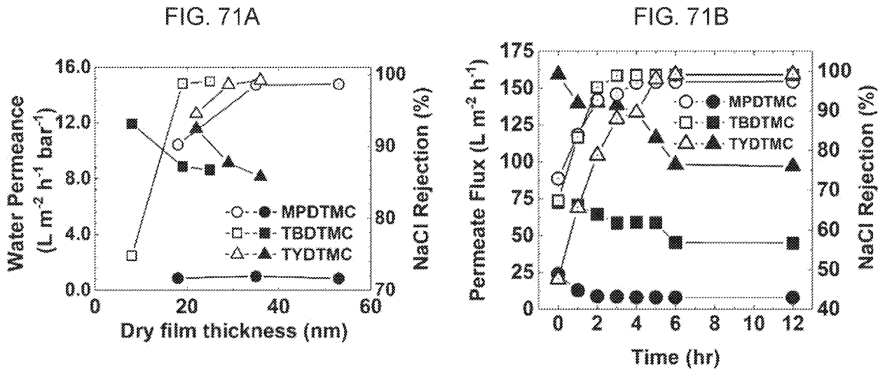

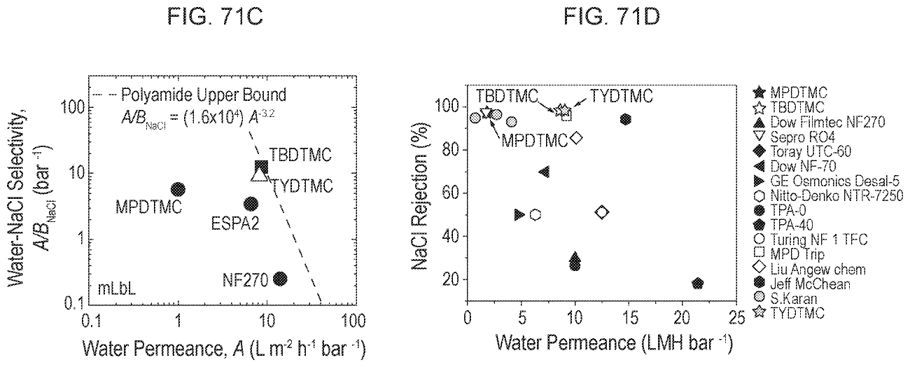

The desalination performance of all TFC polyamide membranes (supported on PAN) was assessed by dead-end filtration testing with a 2,000 mg L⁻¹ aqueous NaCl solution at pressures ranging from 15-20 bar. The thickness and time-dependent water permeances and salt rejections of all three membranes are shown in FIG. 71A-FIG. 71B.

In FIG. 71A, the thickness-dependent variation of water permeance and NaCl rejection for the investigated TFC membranes is presented. The results reveal a notable trend: as the number of deposition cycles increased, water permeance decreased, and NaCl rejection progressively increased. Without being bound by theory, this suggests that the performance of the membranes can be finely tuned by adjusting the number of mLbL bilayers. The data illustrated the tradeoff between flux and solute rejection. Thinner films facilitated rapid water transport but struggled to effectively exclude solvated ions. In contrast, thicker films offered more effective separation at the expense of reduced flux. A critical transition was observed at a selective layer thickness of 20-25 nm, where NaCl rejection became consistently high (90% or greater) and independent of thickness (FIG. 71A). In summary, a minimum thickness of 20-25 nm is crucial for achieving the required NaCl rejection in reverse osmosis (RO) for these polyamide membranes. Within the series, TBDTMC and TYDTMC membranes demonstrated significantly higher water permeance (8.8 L m⁻² h⁻¹ bar⁻¹ and 9.1 L m⁻² h⁻¹ bar⁻¹, respectively) compared to the MPDTMC membrane (1.0 L m⁻² h⁻¹ bar⁻¹). Despite the nine-fold increase in permeance, these contorted polyamide membranes maintained excellent salt rejection (>99%). This enhanced permeance is attributed to increased free volume in the polyamide film, as indicated by density values obtained through XRR, facilitating water transport while preserving the exclusion of larger hydrated ions.

In FIG. 71B, long-term desalination testing data are compared for the MPDTMC (~35 nm thick), TBDTMC (~25 nm thick), and TYDTMC (~36 nm thick) membranes that exhibited 99% NaCl rejection. Permeate flux and NaCl rejection are reported hourly for the 12 h performance test. The water permeances of all membranes rapidly decreased within first 4-5 hours of testing to stable values. This initial period of permeance decline and increasing salt rejection indicates compaction of the polyamide film structures under applied hydraulic pressure. (W. D. Mulhearn, V. P. Oleshko, C. M. Stafford, Journal of Membrane Science 2021, 618, 118637).

The desalination performance of two commercial polyamide RO membranes ESPA2 (Hydranautics) and nanofiltration membrane NF 270 (Dupont FilmTec), were measured in a dead-end cell for comparison to the mLbL polyamide membranes synthesized in the work described herein. Commercial membranes were washed for 30 minutes in 25% volume isopropanol solution before testing to remove coatings and preservatives from the membrane surfaces. From measurements of pure water flux and of salt rejection of ~50 mmol L⁻¹ NaCl solution, water permeance, A (L m⁻¹ h⁻¹ bar⁻¹), NaCl permeance, B_{NaCl} (L m⁻² h⁻¹), and water-NaCl selectivity, A/B_{NaCl} (bar⁻¹) values were calculated. To benchmark our membranes, selectivity A/B_{NaCl} was plotted against water permeance, A, to obtain the well-documented permeability-selectivity tradeoff was observed. The reported upper bound of this permselectivity for polyamide membranes has been defined from an analysis of over 1,200 experimental observations of NaCl rejection and water permeance (Z. Yang, H. Guo, C. Y. Tang, Journal of Membrane Science 2019, 590, 117297). Permselectivities for the TBDTMC and TYDTMC membranes approach the established polyamide upper bound. The permselectivities of the mLbL polyamide membranes and commercial membranes are summarized in Table 1.

TABLE 1
Water-NaCl selectivity of mLbL MPDTMC, TBDTMC, and TYDTMC
membranes compared to commercial polyamide desalination membranes
(NF 270 and ESPA2) and the polyamide upper bound.

| | Water | Water-NaCl | Polyamide Upper |
|---|---|---|---|
| Polyamide | Permeance, A | Selectivity, A/B_{NaCl} | Bound Selectivity, |
| Membrane | (L m⁻² h⁻¹ bar⁻¹) | (bar⁻¹) | A/B_{NaCl} (bar⁻¹) |
| MPDTMC | 1.01 | 5.81 | 15700 |
| TBDTMC | 8.62 | 12.7 | 16.2 |
| TYDTMC | 8.14 | 9.23 | 19.5 |
| NF 270 | 14.0 | 0.25 | 3.40 |
| ESPA2 | 6.61 | 3.43 | 37.9 |

When compared to the water permeances and salt rejections of current state-of-the-art commercial desalination membranes (FIG. 71D), contorted polyamide membranes show excellent performance, as illustrated by their plotted position exceeding the current permeability-selectivity tradeoff line for water permeance and NaCl rejection.

### Solution-Diffusion Transport Modeling.

In this work, diffusivity-dominated free volume-based transport models were applied to measure water and NaCl permeabilities to relate the observed transport behavior of the MPDTMC, TBDTMC, and TYDTMC polyamide films to their structural characteristics. Water and salt transport modeling was based on the classic solution diffusion model that describes penetrant permeability, P, of the polyamide films as the product of a solubility or partitioning coefficient, K, and the penetrant diffusion coefficient in the polymer network, D. For water, the solution-diffusion model is expressed in Equation 1, where the subscript w refers to water, and the superscript D refers to diffusion.

$${P}_{w}^{D} = {K}_{w} {D}_{w} . \qquad ( Equation 1 )$$

In Equation 1, the diffusive water permeability P_{w}^{D} of each polyamide membrane was calculated from the hydraulic water permeability P_{w}^{H}, which is described by measured water permeance A and polyamide film thickness t:

$${P}_{w}^{H} = A \times t \qquad ( Equation 2 )$$

$${P}_{w}^{D} = {P}_{w}^{H} \frac{RT}{{\overline{V}}_{w}} ( 1 - {K}_{w} ) . \qquad ( Equation 3 )$$

The calculation of diffusive water permeability P_{w}^{D} from Equation 3 includes the universal gas constant R, absolute temperature T, partial molar volume of water V (1.8E-05 m³ mol⁻¹), and water partitioning coefficient K_{w}. The water partitioning coefficient K_{w}, which is effectively the volume fraction of water in the polyamide (H. Zhang, G. M. Geise, Journal of Membrane Science 2016, 520, 790) or the free volume of the hydrated polymer network (H. Zhang, G. M. Geise, Journal of Membrane Science 2016, 520, 790), was calculated by Equation 4.

$${K}_{w} = S - 1. \qquad ( Equation 4 )$$

Water partitioning coefficients, K_{w}, of 0.26, 0.40, and 0.58 were defined for MPDTMC, TBDTMC, and TYDTMC membranes, respectively, using the swelling ratios ‘S’ obtained by SAXS measurements made for polyamide films at different relative humidities and thicknesses.

With measured diffusive water permeability P_{w}^{D} and estimated water volume fraction K_{w}, a water diffusion coefficient D_{w} through each polyamide film was then calculated according to solution-diffusion theory (Equation 1). The measured water diffusion coefficients D, were fit with a free-volume based transport model derived by Yasuda et al. (H. Yasuda, C. Lamaze, A. Peterlin, Journal of Polymer Science Part A-2: Polymer Physics 1971, 9, 1117) and applied by Zhang and Geise (H. Zhang, G. M. Geise, Journal of Membrane Science 2016, 520, 790) to polyamide membranes:

$${D}_{w} = {D}_{w}^{0} exp ( - β ( \frac{1}{{V}_{F , m}} - \frac{1}{{V}_{F , w}} ) ) . \qquad ( Equation 5 )$$

In Equation 5, D_{w}^{D} is the self-diffusion coefficient of water (2.8E-09 m² s⁻¹), V_{F,m} is the free volume of the hydrated membrane, and V_{F,w} is the free volume of water. The β term is a characteristic volume parameter that is proportional to the cross-section and diffusional jump length of the diffusing water (H. Zhang, G. M. Geise, Journal of Membrane Science 2016, 520, 790; H. Yasuda, C. Lamaze, A. Peterlin, Journal of Polymer Science Part A-2: Polymer Physics 1971, 9, 1117), and thus, it is descriptive of the polyamide network structure. The free volume of water V_{F,w} was estimated as the van der Waals volume V_{vdw}, assuming a spherical shape and a van der Waals radius of 0.14 nm (M. Shen, S. Keten, R M. Lueptow, Journal of Membrane Science 2016, 506, 95) The membrane free volume V_{F,m} was calculated from the water volume fraction K_{w} and free volume of the dry polymer V_{F,p} according to Equation 6:

$${V}_{F , m} = {V}_{F , w} {K}_{w} + {V}_{F , p} ( 1 - {K}_{w} ) . \qquad ( Equation 6 )$$

The dry polymer free volume V_{F,p} in Equation 6 was calculated from the polymer specific volume Vₚ and the occupied volume V_{oc}, which was estimated from the van der Waals volume V_{vdw}, according to Equation 6. The van der Waals volume of each polymer V_{vdw} was estimated from structural groups present in the polymer networks using group contribution theory (A. X. Wu, S. Lin, K. Mizrahi Rodriguez, F. M. Benedetti, T. Joo, A. F. Grosz, K R. Storme, N. Roy, D. Syar, Z. P. Smith, Journal of Membrane Science 2021, 636, 119526). A single TMC monomer bonded to three diamine monomers (MPD, TBD, or TYD) was used as the molecular unit for calculating polymer V, values.

$${V}_{F , p} = {V}_{p} - {V}_{oc} = {V}_{p} - 1.3 {V}_{vdw} . \qquad ( Equation 7 )$$

The specific volume of the polymer Vₚ was calculated as the reciprocal of the polyamide density ρₚ (Equation 8). The polyamide densities ρₚ calculated from XRR measurements were 1338 kg m⁻³, 968 kg m⁻³, and 918 kg m⁻³ for MPDTMC, TBDTMC, and TYDTMC respectively.

$${V}_{p} = \frac{1}{{ρ}_{p}} . \qquad ( Equation 8 )$$

These characteristic volumes of diffusing water, β, are hypothesized to be larger than the free volume of water (0.38 cm³ g⁻¹) for the assumed diffusivity-dominated solution-diffusion transport. The β values for contorted TBDTMC and TYDTMC membranes are significantly larger than that of conventional MPDTMC, which is also indicated by the higher pure water permeances of these contorted polyamide membranes compared to conventional MPDTMC. The β fitting parameter from transport modeling is sensitive to the K_{w} value, calculated from swelling ratios. The S values for TYDTMC membranes from SAXS measurements ranged from 1.58-2.53, which were significantly greater (two-sided t-test, α=0.05) than the TBDTMC S values, which were in the range 0.75-1.40. The larger β value determined for TYDTMC polyamide is a result of this difference in swelling ratio S and associated water partitioning coefficient, K_{w}.

The solution-diffusion model in Equation 9 was also applied to salt permeability measurements to understand the influence of contorted polyamide free volume on salt diffusion and membrane salt selectivity. In Equation 8, the subscript s refers to NaCl salt.

$${P}_{s} = {K}_{s} {D}_{s} . \qquad ( Equation 9 )$$

The partitioning coefficient for NaCl into polyamide, Kₛ, was estimated to be Kₛ=0.10 based on previously reported measurements (D. L. Shaffer, K. E. Feldman, E. P. Chan, G. R. Stafford, C. M. Stafford, Journal of Membrane Science 2019, 583, 248). Measured salt diffusion coefficients Dⱼ were then calculated from the measured salt permeability Pₛ values using Equation 10.

The measured NaCl salt diffusion coefficients Dₛ were also fit with a free-volume based transport model derived by Yasuda et al. (H. Yasuda, C. Lamaze, A. Peterlin, Journal of Polymer Science Part A-2: Polymer Physics 1971, 9, 1117) and applied by Zhang and Geise (H. Zhang, G. M. Geise, Journal of Membrane Science 2016, 520, 790):

$${D}_{s} = {D}_{s}^{0} exp ( b ( 1 - \frac{1}{{K}_{w}} ) ) . \qquad ( Equation 10 )$$

In Equation 10, Dₛ⁰ is the bulk diffusion coefficient of NaCl (1.5E-09 m² s⁻¹), and K_{w} is the estimated free volume fraction of the hydrated polyamide membranes. The fitting parameter b is descriptive of the size of the diffusing salt penetrant and a characteristic volume required to accommodate the penetrant in the polyamide network (H. Zhang, G. M. Geise, Journal of Membrane Science 2016, 520, 790).

The solution-diffusion modeling results for NaCl permeability using the estimated K_{N} water volume fractions for the polyamide membranes yielded b values, which are descriptive of the characteristic volume of diffusing salt penetrant. The value of b=2.39±0.15 that was reported by Zhang and Geise (H. Zhang, G. M. Geise, Journal of Membrane Science 2016, 520, 790; H. Yasuda, C. Lamaze, A. Peterlin, Journal of Polymer Science Part A-2: Polymer Physics 1971, 9, 1117) for similar modeling of conventional MPDTMC polyamide membranes. The contorted TBDTMC and TYDTMC polyamide membranes have higher b values, which indicate the increased size of diffusing salt penetrants within the increased free volume of the water-swollen contorted polyamide networks. Despite the hypothesis of higher b values reducing NaCl diffusion through the polyamide membranes, the measured NaCl permeability of the contorted TBDTMC and TYDTMC polyamide films was similar to that of conventional MPDTMC polyamide (Table 2). Like the β fitting parameter, the b fitting parameter from the diffusivity-dominated salt transport model is also sensitive to the K_{w} value, calculated from the swelling ratio. Thus, for the similar NaCl permeabilities of the different polyamide films, the differences in swelling behavior and K_{w} explain the different determined b values. Despite similar measured salt permeabilities, contorted TBDTMC and TYDTMC polyamides achieve higher water-NaCl selectivities compared to conventional MPDTMC polyamide because of their enhanced water permeability.

TABLE 2
NaCl permeabilities of polyamide films measured from
diffusion tests compared to reference materials.

| | Estimated Film | |
|---|---|---|
| Polyamide Film | Thickness (nm) | NaCl Permeability, Pₛ (m² s⁻¹) |
| MPDTMC | 38 | (2.72 ± 0.05) × 10⁻¹⁴ |
| TBDTMC | 25 | (2.74 ± 0.09) × 10⁻¹⁴ |
| TYDTMC | 36 | (1.62 ± 0.04) × 10⁻¹⁴ |
| Novatexx Support | — | (4.27 ± 0.10) × 10⁻⁰⁹ |
| NaCl bulk diffusion | | 1.5 × 10⁻⁰⁹ |

### Experimental Details

### Materials

2-methyl-3-nitroaniline (98%), trifluoroacetic acid, Pd/C (Pd, 10%), paraformaldehyde, sodium hydroxide, anhydrous ethanol, anhydrous acetone, anhydrous toluene triptycene, acetic anhydride, nitric acid and hydrazine monohydrate (98%) were purchased from Sigma Aldrich and were used without further purification. Polyacrylonitrile (PAN) membranes and anodized aluminum oxide membranes (AAO, pore size 20 nm) were supplied by Synder filtration, CA, USA and GE Healthcare Life Sciences, UK, respectively. DuramMem® 500 membranes were purchased from Sterlitech, USA. Deionized (DI) water obtained from a Milli-Q system (Millipore, Inc.) at 18.2 MΩ resistivity was used throughout this study.

### Monomer Synthesis

3,9-Dinitro-4,10-dimethyl-6H,12H-5,11-methanodibenzo[1,5]-diazocine: 12 g (78.86 mmol) 2-methyl-4-nitroaniline and 4.98 g (165.62 mmol, 2.1 equiv) paraformaldehyde were dissolved in 150 mL (2.02 mol, 25.5 equiv) trifluoroacetic acid (TFA) in ice-bath giving a dark-brown coloured reaction mixture, which was stirred for 48 hrs at nitrogen atmosphere under room temperature and then poured into 200 mL pure water under continuously stirring giving a yellow precipitate. About 350 ml aqueous NaOH was gradually added to this suspension adjusting pH to 8.5-9, the precipitate was filtered off and refluxed in 300 ml acetone for 1 h. The mixture was cooled down and stored at −20° C. overnight and the yellow product was filtered off giving a yield of 10 g (31.73 mmol, 80%).

3,9-Diamino-4,10-dimethyl-6H, 12H-5,11-methanodibenzo[1,5]-diazocine (TBD). The yellow solid 3,9-Dinitro-4,10-dimethyl-6H,12H-5,11-methanodibenzo[1,5]-diazocine (5 g, 14.7 mol) was dispersed in ethanol (100 ml) followed by mixing with Pd/C (0.5 g, Pd 10 wt %), which was heated to reflux under a nitrogen atmosphere. Then, N₂H₄H₂O (98%, 10 ml) was added dropwise to the hot solution. After refluxing for 8 h, the precipitate was taken off by filtration and the resulting solution was concentrated to half under reduced pressure at 40° C. The product was obtained by adding 100 ml water and recovered by filtration. It was dried in vacuum oven at 40° C. to give a white powder (3.4 g, 87%).

2,6/2,7 dinitrotriptycene: A solution of triptycene (10 g, 39.8 mmol) in acetic anhydride (300 mL) was cooled in an ice-water bath. Nitric acid (5 mL, 82 mmol) was added dropwise over 1 hr. The reaction mixture was allowed to gradually warm to room temperature where it was stirred overnight. It was then poured in to 1000 mL water and stirred vigorously for several hours. The precipitate was collected by vacuum filtration, washed with water, and dried under vacuum. This slightly yellow solid was rinsed with 20 mL benzene. The resulting solid was a 1.1 mixture of 2,6 and 2,7-dinitrotriptycene (50%, 8 g). The mixture was for the synthesis of 2,6/2,7 diaminotriptycene without any separation of isomers.

2,6/2,7 diaminotriptycene (TYD): Purified 2,6-dinitrotriptycene (5 g, 14.54 mmol) was dissolved in anhydrous THF (500 mL). Raney-Ni (spatula tip) and hydrazine hydrate (1mL) were added and the solution was allowed to react at 60° C. overnight. The reaction mixture was then cooled, filtered through a pad of celite, and the solvent was removed in vacuo. The residue was treated with 1:1 DCM/ethyl acetate and the resulting white solid was collected by centrifuge and dried under vacuum to yield clean TYD (90%, 3.65 g).

### Polymer Powder Synthesis

0.4 wt/vol % solutions of diamines in anhydrous toluene (acetone in case of TYD) and 0.4 wt/vol % of TMC in anhydrous toluene were prepared separately and poured in a 1 L flask to begin the monophasic polycondensation reaction. The flask was stirred gently to ensure mixing of monomers. After 30 min, the polymer was removed and washed with 500 ml of acetone followed by vacuum filtration. The washing was repeated twice with DI water and ethanol, consecutively. After final filtration, the polymer was dried under vacuum at 120° C. for 20 h. Finally, the polymer was stored in a desiccator until further testing.

### Membrane Fabrication

Initially, the silicon wafers were thoroughly cleaned and coated with a polystyrene sulfonate (PSS) layer via spin coating. This involved diluting the PSS solution to 1.5% mass in ethanol and applying it at 2000 rpm. Subsequently, monomer solutions and rinse solvents were prepared as summarized in Table 3. Acetone was selected as the solvent for the TYD due to its limited solubility in toluene.

TABLE 3
Monomer solutions and rinse solvents
for mLbL polyamide deposition.

| | Monomer Concentration | Monomer | Rinse |
|---|---|---|---|
| Polyamide | (% mass) | Solution | Solvent |
| MPDTMC | 1% trimesoyl chloride (TMC) | TMC in toluene | Acetone |
| | 1% m-phenylenediamine (MPD) | MPD in toluene | |
| TBDTMC | 0.2% trimesoyl chloride (TMC) | TMC in toluene | Acetone |
| | 0.2% Troger's base diamine | TBD in toluene | |
| | (TBD) | | |
| TYDTMC | 0.2% trimesoyl chloride (TMC) | TMC in toluene | Acetone |
| | 0.2% triptycene diamine (TYD) | TYD in acetone | |

Solutions and rinse solvents were loaded into gas-tight syringes equipped with 0.45-μm PTFE syringe filters. The operation of syringe pumps was programmed with the spin coater operation to automatically deposit monomer solutions and rinse solvents onto the substrate inside an environmental spin coater. Each deposition cycle followed a sequential pattern: application and spin drying of the TMC monomer solution, followed by rinsing with pure toluene; application and spin drying of the diamine monomer solution, followed by rinsing with pure acetone. By adjusting the number of deposition cycles, the film thickness can be precisely tailored, with an average growth rate ranging from approximately 0.35 to 1.44 nm per cycle, depending on the diamine monomer.

### Instrumental Methods

Scanning electron microscopy, Nitrogen adsorption, Wide-angle X-ray scattering (WAXS), Atomic force microscopy (AFM), Transmission electron microscopy (TEM), X-ray photo electron microscopy (XPS), Fourier transform infrared spectroscopy (FTIR), Contact angle goniometry, Atomic Force Microscopy (AFM), Zeta Potential (ζ) measurement, Nuclear Magnetic Resonance (NMR) spectroscopy.

A Leo 1525 Gemini FEG equipped with in-lens annular detector was used to image the surfaces of the membranes. SEM images were acquired with an accelerating voltage of 2 kV. Before SEM analysis, the samples were coated with 3 nm gold layer to avoid charging. Nitrogen physisorption measurements were made on a Micromeritics 3Flex Surface Characterization Analyzer. Approximately 100 mg of sample was degassed (P~10⁻⁴ bar) at 150° C. for 15 h on a Micromeritics Vacprep system. The physisorption experiments were conducted at −160° C. The WAXS data were collected on a Rigaku S-MAX3000 beamline over a wavevector range 0.0091 Å⁻¹<q<2.1566 Å⁻¹. The scattering angle (θ) was obtained from scattering vector (q) using the Equation 11:

$$q = \frac{4 π}{λ sin θ} . \qquad ( 11 )$$

TEM measurements were made with a JOEL 2000 FX from JOEL, USA. Sample specimens for TEM analysis were prepared by dispersing powders into ethyl alcohol. A small aliquot of dispersant (10 μL) was placed on a holey carbon (LC200-Cu-150, Electron Microscopy Sciences) TEM grid. The prepared samples were air dried for several minutes prior to the TEM analysis. The thin polyamide films floating in a water bath were directly lifted on the TEM grid for analysis. XPS analysis was conducted on a model 5700 X-ray from Phi Electronics, USA. A Thermo-Scientific spectrometer (Nicolet iS5 model) was used to measure ATR-FTIR spectra. Measurements were made in 16 scans from 4000 cm⁻¹ to 1000 cm⁻¹ wavenumbers at a resolution of +4 cm⁻¹. Contact angle measurements of various polar and non-polar solvents on the PA. membrane surface were made using a custom-made goniometer equipped with Basler high resolution camera (model acA2040-120uc), capable of capturing a minimum 120 frames per second at 3.2 MP resolution. Contact angles were measured from the captured images using the ImageJ contact angle plugin tool. To minimize the error, 5 measurements were made for each solvent, and the average value was reported. AFM measurements were made on a Bruker Dimension Icon in tapping mode in the resonance frequency range of 270-320 kHz. Streaming potential measurements were made on an Anton Paar SurPASS3 instrument, and ζ-potential was calculated in the instrument software using the Helmholtz-Smoluchowski equation. For all experiments, a 10 mM KCl solution was used as the background electrolyte, and the solution pH was adjusted automatically by addition of 50 mM HCl or 50 mM KOH. liquid state NMR measurements were made on a Bruker 400 MHz instrument in DMSO-d6 as a solvent.

### Desalination Performance

To facilitate desalination performance testing, the PA films were transferred onto a PAN support layer. Prior to floating the mLbL film in deionized water bath, a PAN support was positioned at the bottom of the water bath. The thin film was then gently lifted on a PAN support. The collected membranes were dried overnight under ambient conditions prior to testing. Membrane performance was tested against ~2000 mg/L NaCl aqueous solutions in a stirred dead-end filtration cell (Sterlitech). The active membrane area was 25 mm membrane area reducer and the operating pressure was 15-17 bar. Salt concentrations in feed and permeate were determined using a conductivity meter (Thermo Scientific).

Electrospray Fabrication of Contorted Polyamide Desalination Membranes with Enhanced Permselectivity.

### Electrospray Deposition System

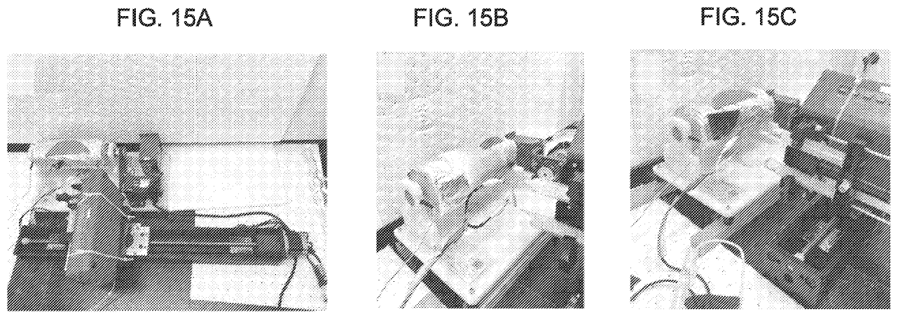

The electrospray deposition system consisted of a dual-channel syringe pump mounted to a motor-driven linear actuator, as shown in FIG. 15A. The linear actuator provided consistent, programmable control over horizontal syringe pump movement to electrospray coverage across the rotating collector. The rotating collector (FIG. 15B) was grounded, and a high voltage was applied to the syringe needles from which monomer solutions were discharged. Substrate materials for the electrospray deposition process included porous polyacrylonitrile (PAN) membrane supports (Synder Filtration) (FIG. 15B) and silicon wafers (University Wafer) (FIG. 15C).

During electrospray deposition, monomer solutions were discharged at a constant rate from syringes mounted in the dual-channel pump. The application of a high potential across the needle-to-collector distance resulted in the monomer solutions forming a Taylor cone and spraying airborne monomer solution droplets onto the collector. Constant rotation of the collector and continuous linear translation of the syringe pump resulted in uniform coverage of electrosprayed monomers across the center width of the collector.

The electrospray deposition process was optimized to fabricate conventional MPDTMC polyamide membranes and contorted TBDTMC and TYDTMC polyamide membranes of the present invention on PAN supports. Applied voltage to the syringe needles, monomer solvents, monomer solution discharge rates, and needle-to-collector distance were independently adjusted to achieve a uniform Taylor cone during electrospray. MPDTMC polyamide was directly deposited on PAN membrane or silicon wafer substrates. Before electrospray deposition of contorted TBDTMC and TYDTMC polyamide membranes of the present invention, the PAN supports were preconditioned by saturating with an electrosprayed solution of TBD or TYD monomer in ethanol solvent (without water) to improve adhesion between the contorted polyamide film and the PAN support. The better interlocking between the polyamide and PAN eliminated problems with polyamide film delamination, which was observed during initial desalination testing of the contorted polyamide membranes. To prevent the formation of powder during electrospraying for the TYDTMC polyamide, the water/ethanol ratio for the diamine monomer solution was higher than that for the TBDTMC polyamide. The optimized electrospray conditions for all three polyamide membranes are summarized in Table 4.

TABLE 4
System parameters for electrospray deposition of
MPDTMC, TBDTMC and TYDTMC polyamide membranes.

| Parameter | Value | | | |
|---|---|---|---|---|
| Monomer solutions | MPD | TBD | TYD | TMC |
| Monomer molecular weight (g | 108.14 | 280.38 | 284.36 | 265.48 |
| mol⁻¹) | | | | |
| Solvent components | water/ethanol | water/ethanol | water/ethanol | hexane |
| Solvent components | 9/1 | 1/11.5 | 8/15 | 1 |
| volumetric ratio | | | | |
| Diamine to TMC monomer | 4 | 0.63 | 0.62 | — |
| molar ratio | | | | |
| Monomer solution | 2.0 | — | — | 1.2 |
| concentration (% wt) | — | 1.0 | 1.0 | 0.5 |
| Total monomer mass | 0.19 | 0.97 | 0.89 | — |
| deposition at 99% NaCl | (MPD + TMC) | (TBD + TMC) | (TYD + TMC) | |
| rejection (mg cm⁻²) | | | | |
| Monomer solution discharge | 2 | — | — | 2 |
| rate (mL h⁻¹) | — | 5 | 5 | 5 |
| Needle-to-collector distance | 5 | | | |
| (cm) | | | | |

| | |
|---|---|
| Applied voltage (kV) | 12 |
| Substrate | Polyacrylonitrile (PAN) membrane (400 kDa MWCO) |
| Collector rotation speed (rpm) | 80-100 |

### Polymer Film Characteristics

Fourier Transform Infrared (FT-IR) spectroscopy measurements were made using a Thermo Scientific Nicolet iS5 FT-IR spectrometer with diamond iD7 ATR accessory. Free standing polyamide films were electrosprayed on aluminum foil and washed with water and ethanol multiple times and dried in oven at 60° C. for three hours before FT-IR measurements.

X-ray diffraction (XRD) patterns for the electrosprayed polyamide films were derived from Extended Wide Angle X-ray Scattering (EWAXS) measurements of electrosprayed conventional MPDTMC and contorted TBDTMC and TYDTMC films of the present invention. The polyamide films were electrosprayed onto Kapton tape for the measurements. The electrosprayed films were washed in ethanol and oven-dried for 2 hours at 60° C. prior to EWAXS measurements. Measurements were made using a Rigaku S-MAX3000 beamline with incident beam wavelength λ=0.154 nm and a detector area of 1024×1024 pixels. Scattering intensities were measured over a wave vector range 0.0091 Å⁻¹<q<2.1566 Å⁻¹. The measured spectra were smoothed using three-point adjacent averaging after subtracting the Kapton tape background. Intensity peaks were identified using the peak analyzer tool in Origin software (OriginLab version 2021b).

### Profilometry Measurements of Polyamide Thin Film Thicknesses.

After electrospraying on silicon substrates, the films were air dried, rinsed in ethanol, and oven-dried at 60° C. for 1 hour prior to thickness measurements. For each film, three thickness step measurements were made across the film and onto the bare silicon wafer substrate that had been masked during electrospraying.

The densities of the electrosprayed polyamide films were calculated from mass measurements made using a quartz crystal microbalance (QCM). In this technique, polyamide film mass was determined by application of the Sauerbrey equation to the observed shift in the resonant frequency of silicon oxide-coated QCM sensors upon coating with electrosprayed polyamide films. Before the QCM measurement of polyamide-coated sensors, the sensors were air dried overnight followed by rinsing with water and ethanol to remove unreacted monomers. The sensors were then dried in oven at 60° C. for three hours before making the QCM measurements. During the measurements, the QCM sensors were purged with dry nitrogen gas.

To reduce measurement noise, the Sauerbrey equation (Equation 12) was applied to the third harmonic overtone of the fundamental frequency rather than the fundamental frequency to calculate polyamide film mass.

$$Δ f = \frac{2 {f}_{3}^{2}}{\sqrt{{ρ}_{q} {μ}_{q}}} \frac{m}{A} . \qquad ( Equation 12 )$$

In Equation 12, f₃ is the third harmonic overtone of the fundamental frequency of the bare quartz sensor (14.86 MHz), □_{q} is the density of the quartz sensor (2.648 g cm⁻¹), and □_{q} is the shear modulus of the quartz sensor (2.95×10¹¹ g cm⁻¹ s⁻²).

Film densities were then calculated from measured masses with knowledge of the film volume, according to Equation 13:

$${ρ}_{film} = \frac{m}{A \times t} \qquad ( Equation 13 )$$

where m is the mass of the polyamide film, A is the surface area of the polyamide film and QCM sensor (1.53 cm²), and t is the film thickness (t=20.7 nm for MPDTMC, t=10.3 nm for TBDTMC; and t=18.2 nm for TYDTMC).

### Cross-Flow Membrane Filtration Testing

The desalination performance of electrosprayed membranes was tested in a custom-built high-pressure cross-flow filtration system. Flat sheet membrane coupons were simultaneously tested in six membrane cells arranged in three parallel pressurized lines that are fed from a common header. Feed solution from a 20 L reservoir was pumped through the system with a positive-displacement pump equipped with variable frequency drive to control pump speed. Pressure-sustaining valves were manually adjusted to maintain pressure in the system, and the cross-flow rate was adjusted by changing pump speed and modulating the flow through a bypass valve.

The desalination performance of each membrane was characterized by three measurements each of deionized water permeance and NaCl rejection, which was measured by electrical conductivity. Feed solutions for salt rejection tests ranged in concentration from 55-65 mmol L⁻¹ NaCl. During testing, the feed solution cross-flow rate was maintained at 1 L min⁻¹, and the applied hydraulic pressure was 31 bar (450 psi). Feed solution temperatures were maintained at room temperature (21° C.±1° C.) using a recirculating chiller coil immersed in the feed solution reservoir.

Calculation of water permeance, A (L m⁻² h⁻¹ bar⁻¹)

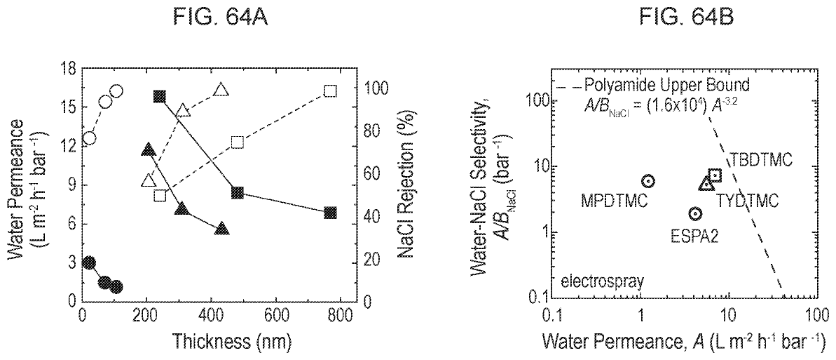

NaCl permeance B_{NaCl} was calculated from measured permeate flux and NaCl rejection (FIG. 64A) according to the solution-diffusion model:

$${B}_{NaCl} = J ( \frac{1}{{R}_{NaCl}} - 1 ) \qquad ( Equation 14 )$$

where J is the permeate flux with NaCl feed solution, and R_{NaCl} is the measured NaCl rejection with the same NaCl feed solution.

The selectivity of the membranes is represented by the ratio of water permeance, A (L m⁻¹ h⁻¹ bar⁻¹) and NaCl permeance, B_{NaCl} (L m⁻² h⁻¹). When selectivity A/IBAc is plotted against water permeance, A, the well-documented permeability-selectivity tradeoff is observed. The reported upper bound of this permselectivity for polyamide membranes has been defined from an analysis of over 1,200 experimental observations of NaCl rejection and water permeance (Z. Yang, H. Guo, C. Y. Tang, The upper bound of thin-film composite (TFC) polyamide membranes for desalination, Journal of Membrane Science 590 (2019) 117297).

### Results and Discussion

### Synthesis of Contorted Polyamide Films and Membranes

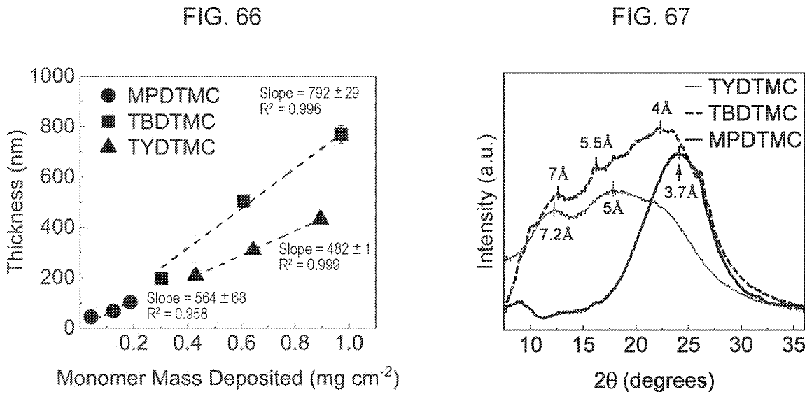

The thicknesses of electrosprayed MPDTMC, TBDTMC, and TYDTMC films were measured by profilometry to construct a growth curve of electrosprayed dry film thickness as a function of monomer mass deposited during the electrospray process. Now we report that we have made linear fits to the thickness data to quantify the different polyamide growth rates. The results are shown in FIG. 66. For the electrosprayed polyamide films, the thickness growth rate is highest for TBDTMC, followed by MPDTMC and TYDTMC, which have similar growth rates.

### Contorted Polyamide Film Characteristics

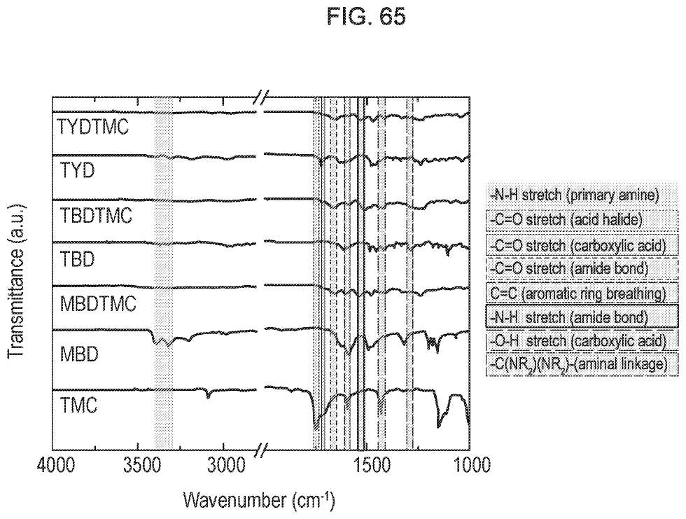

The chemistry of electrosprayed MPDTMC, TBDTMC and TYDTMC polyamide films was verified by FT-IR spectroscopy. Measured FT-IR spectra for the starting monomers and electrosprayed polyamide films are compared in FIG. 65.

The synthesis of the polyamide films is indicated by characteristic absorbance peaks in the amide I (1600-1800 cm⁻¹), amide II (1470-1570 cm⁻¹), and amide III (1250-1350 cm⁻¹) bands (D. Surblys, T. Yamada, B. Thomsen, T. Kawakami, I. Shigemoto, J. Okabe, T. Ogawa, M. Kimura, Y. Sugita, K. Yagi, Amide A band is a fingerprint for water dynamics in reverse osmosis polyamide membranes, Journal of Membrane Science 596 (2020) 117705). The emergence of absorbance peaks in the polyamide spectra at 1667 cm⁻¹ in the amide I band indicates —C═O stretching from amide bonds (T. J. Zimudzi, K. E. Feldman, J. F. Sturnfield, A. Roy, M. A. Hickner, C. M. Stafford, Quantifying Carboxylic Acid Concentration in Model Polyamide Desalination Membranes via Fourier Transform Infrared Spectroscopy, Macromolecules 51 (2018) 6623-6629; T. J. Zimudzi, S. E. Sheffield, K. E. Feldman, P. A. Beaucage, D. M. DeLongchamp, D. I. Kushner, C. M. Stafford, M. A. Hickner, Orientation of Thin Polyamide Layer-by-Layer Films on Non-Porous Substrates, Macromolecules 54 (2021) 11296-11303; S. Dai, R. Liao, H. Zhou, W. Jin, Synthesis of triptycene-based linear polyamide membrane for molecular sieving of N2 from the VOC mixture, Separation and Purification Technology 252 (2020) 117355). The simultaneous disappearance of the peak attributed to —C═O stretching for acid halide (1725-1760 cm⁴) (T. J. Zimudzi, K. E. Feldman, J. F. Sturnfield, A. Roy. M. A. Hickner, C. M. Stafford, Quantifying Carboxylic Acid Concentration in Model Polyamide Desalination Membranes via Fourier Transform Infrared Spectroscopy, Macromolecules 51 (2018) 6623-6629; Y. Li, Z. Guo, S. Li, B. Van der Bruggen, Interfacially Polymerized Thin-Film Composite Membranes for Organic Solvent Nanofiltration, Advanced Materials Interfaces 8 (2021) 2001671) and the reduction of the —C═O stretching peak for carboxylic acid (1710 cm⁻¹) in the TMC monomer (S. Dai, R. Liao, H. Zhou, W. Jin, Synthesis of triptycene-based linear polyamide membrane for molecular sieving of N2 from the VOC mixture, Separation and Purification Technology 252 (2020) 117355; Y. Jin, W. Wang, Z. Su, Spectroscopic study on water diffusion in aromatic polyamide thin film, Journal of Membrane Science 379 (2011) 121-130; Z. Wang, D. Wang, F. Zhang, J. Jin, Tröger's Base-Based Microporous Polyimide Membranes for High-Performance Gas Separation, ACS Macro Lett. 3 (2014) 597-601: A. Yerzhankyzy, B. S. Ghanem, Y. Wang, N. Alaslai, I. Pinnau, Gas separation performance and mechanical properties of thermally-rearranged polybenzoxazoles derived from an intrinsically microporous dihydroxyl-functionalized triptycene diamine-based polyimide, Journal of Membrane Science 595 (2020) 117512) indicates the bonding of TMC acyl chloride functional groups to form polyamides. The disappearance of absorption peaks attributed to the N—H stretch (3300-3400 cm⁻¹) from primary amine groups in MPD. TBD, and TYD monomers when compared to the corresponding polyamide polymers indicates that the free amine functional groups in the diamine monomers have formed amide bonds in the polyamides. The polyamides also exhibit an absorbance peak in the amide II band that is associated with the N—H stretch from the amide bond (1541 cm⁻¹) (M. F. Jimenez Solomon, Y. Bhole, A G. Livingston, High flux membranes for organic solvent nanofiltration (OSN)-Interfacial polymerization with solvent activation, Journal of Membrane Science 423-424 (2012) 371-382; L. Shen, R. Cheng, M. Yi, W.-S. Hung, S. Japip, L. Tian, X. Zhang, S. Jiang, S. Li, Y. Wang, Polyamide-based membranes with structural homogeneity for ultrafast molecular sieving, Nat Commun 13 (2022) 500, B. Khorshidi, T. Thundat, B. A. Fleck, M. Sadrzadeh, A Novel Approach Toward Fabrication of High Performance Thin Film Composite Polyamide Membranes, Sci Rep 6 (2016) 22069) that is absent from the diamine and TMC monomers.

Average polymer chain d-spacings were calculated from the identified XRD intensity peaks by application of Bragg's Law. The XRD patterns for electrosprayed MPDTMC, TBDTMC, and TYDTMC polyamide are compared in FIG. 67, and the d-spacings associated with intensity peaks are identified.

The intensity peaks at large 20 values represent free volume within the polymer matrix. The peaks shift to lower 2□ values (larger free volume element sizes) for contorted TBDTMC and TYDTMC polyamide of the present invention compared to conventional MPDTMC. Additionally, the contorted TBDTMC and TYDTMC polyamides of the present invention show multiple intensity peaks in their XRD patterns, indicating a range of free volume element sizes. This increased distribution of d-spacing indicates increased distance between polymer chains compared to MPDTMC and increased free polymer free volume (Z. Ali, Y. Wang, W. Ogieglo, F. Pacheco, H. Vovusha, Y. Han, I. Pinnau, Gas separation and water desalination performance of defect-free interfacially polymerized para-linked polyamide thin-film composite membranes, Journal of Membrane Science 618 (2021) 118572), which is hypothesized because of the larger, shape-persistent TBD and TYD monomers.

The resulting calculated densities for the MPDTMC, TBDTMC, and TYDTMC films were 1.094 g cm⁻³, 0.832 g cm⁻³, and 0.887 g cm⁻³, respectively. The electrosprayed films are less dense than mLbL films measured by the same QCM technique. Without being bound by theory, the relatively higher density of the mLbL films may reflect the opportunities for monomers to diffuse into the nascent polyamide film and react with unreacted monomers in the polyamide network, which are available because of the sequential deposition of monomer solutions during the mLbL process. In contrast, during electrospray deposition, solvent is almost entirely evaporated before monomer solutions contact the collector and react. Similar opportunities for back-diffusion of monomers into the growing polyamide film are not as prevalent.

### Contorted Polyamide Membrane Desalination Performance

The desalination test results for electrosprayed MPDTMC, TBDTMC, and TYDTMC membranes are summarized in FIG. 64A as a function of dry thickness of the polyamide film. For all three polyamide chemistries, membranes were fabricated that achieved the desalination performance target of 99% NaCl rejection. Desalination results in FIG. 64A show that the performance of the electrosprayed polyamide membranes can be tuned by changing the total mass of monomers deposited on the PAN support during the electrospraying process, thus changing the polyamide thickness. Water permeance decreases and salt rejection increases as a function of monomer mass (membrane thickness) for all three electrosprayed membranes. The permselectivities of the electrosprayed polyamide membranes that achieved 99% NaCl rejection are compared to the commercial ESPA2 polyamide membrane and to the polyamide permselectivity upper bound (Z. Yang, H. Guo, C. Y. Tang, The upper bound of thin-film composite (TFC) polyamide membranes for desalination, Journal of Membrane Science 590 (2019) 117297) in FIG. 64B.

The permselectivities of the electrosprayed contorted TBDTMC and TYDTMC membranes shown in FIG. 64B exceed those of conventional MPDTMC polyamide and commercial ESPA2 polyamide membranes, which was also observed for contorted polyamide membranes fabricated by mLbL deposition. At equivalent ~99% NaCl rejection, the TBDTMC membrane had a water permeance A of 6.90±0.48 L m⁻² h⁻¹ bar⁻¹, which is greater than the TYDTMC membrane (A=5.55±0.17 L m⁻² h⁻¹ bar⁻¹) and conventional MPDTMC membrane (A=1.21±0.02 L m⁻² h⁻¹ bar⁻¹). The water-NaCl selectivities of the electrosprayed contorted TBDTMC and TYDTMC polyamide membranes of the present invention are less than those measured for the mLbL contorted polyamide membranes, which may be the result of a less uniform polyamide network synthesized by electrospray deposition. Together, the performance of TBDTMC and TYDTMC membranes of the present invention confirms the hypothesis that the free volume of polyamide membranes can be controlled through the introduction of sterically hindered monomers and that increased free volume enhances membrane permselectivity.

### Various Non-Limiting Embodiments of the Invention

In various embodiments, the present invention provides a polymer as described herein. In some embodiments, the polymer is a coolymer

In various embodiments, the present invention provides a polymer membrane as described herein.

In various embodiments, the present invention provides a thin film membrane as described herein.

In various embodiments, the present invention provides a polyamide as described herein.

In various embodiments, the present invention provides a polyamide polymer as described herein.

In various embodiments, the present invention provides a desalination membrane as described herein.

In various embodiments, the present invention provides a polyamide desalination membrane as described herein.

In various embodiments, the present invention provides a polymer membrane comprising a polyamide.

In various embodiments, the present invention provides a thin film membrane comprising a polyamide.

In various embodiments, the present invention provides a method for forming a polymer as described herein. In some embodiments, the polymer is a copolymer.

In various embodiments, the present invention provides a method for interfacial polymerization as described herein.

In various embodiments, the present invention provides a method of forming a polymer, wherein the method comprises contacting a first monomer with a second monomer under conditions effective to form the polymer. In some embodiments, the first monomer is a diamine. In some embodiments, the second monomer is an acid halide. In some embodiments the second monomer is an acid chloride. In some embodiments, the acid halide is an acid chloride. In some embodiments, the first monomer is selected from the group consisting of m-phenylene diamine (MPD), Troger's base diamine (TBD), triptycene diamine (TYD), and combinations thereof. In some embodiments, the second monomer is trimesoyl chloride (TMC). In some embodiments, the polymer is a copolymer. In some embodiments, the method further comprises contacting at least one additional monomer with the first monomer and the second monomer. In some embodiments, the first monomer comprises at least one amine group. In some embodiments, the first monomer comprises at least two amine groups. In some embodiments, the second monomer comprises at least one acid halide group. In some embodiments, the second monomer comprises at least two acid halide groups. In some embodiments, the second monomer comprises at least three acid halide groups. In some embodiments, the at least one acid halide group is each an acid chloride. In some embodiments, the at least two acid halide groups are each an acid chloride. In some embodiments, the at least three acid halide groups are each an acid chloride. In some embodiments, the first monomer is a diamine. In some embodiments, the first monomer is selected from the group consisting of m-phenylene diamine (MPD), Troger's base diamine (TBD), triptycene diamine (TYD), and combinations thereof. In some embodiments, the second monomer is trimesoyl chloride (TMC).

In various embodiments, the present invention provides a polymer comprising a polyamide. In some embodiments, the polymer is a copolymer.

Additional embodiments include:

In various embodiments, the present invention provides a polymer comprising repeat units, wherein the repeat units have a structure of Formula (I),

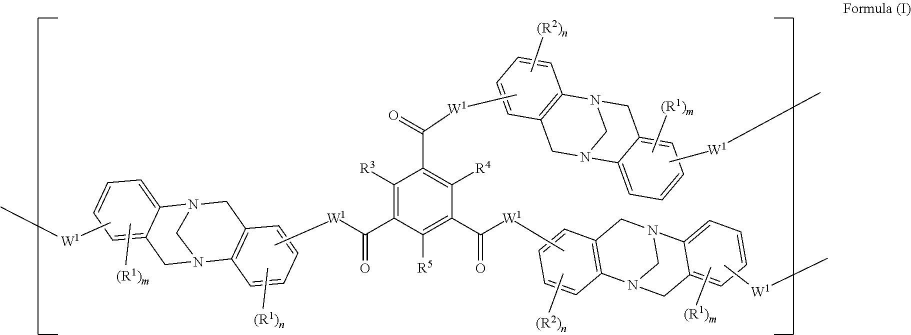

wherein:
each R¹ is independently selected from the group consisting of H, an electron withdrawing group, and an electron donating group;
each R² is independently selected from the group consisting of H, an electron withdrawing group, and an electron donating group;
R³ is H, an electron withdrawing group, or an electron donating group;
R⁴ is H, an electron withdrawing group, or an electron donating group;
R⁵ is H, an electron withdrawing group, or an electron donating group;
each W¹ is independently O or NR⁶, wherein each R⁶ is independently H or optionally substituted alkyl;
m is 3; and
n is 3.

In some embodiments, wherein the repeat units have a structure of Formula (I):
each R¹ is independently selected from the group consisting of H, NO₂, F, Cl, Br, I, CF₃, CN, NO, optionally substituted alkyl;
   OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR³⁶R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl;
   OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁴⁹)R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R³ is selected from the group consisting of H, NO₂, F, Cl, Br, I, CF₃, CN, NO, optionally substituted alkyl; OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶; is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each W¹ is independently O or NR⁶, wherein each R⁶ is independently H or optionally substituted alkyl;
m is 3; and
n is 3.

In some embodiments, wherein the repeat units have a structure of Formula (I):
each R¹ is independently selected from the group consisting of H, optionally substituted alkyl, F, Cl, Br, and I;
each R² is independently selected from the group consisting of H, optionally substituted alkyl, F, Cl, Br, and I;
R³ is selected from the group consisting of H, optionally substituted alkyl, F, Cl, Br, and I;
R⁴ is selected from the group consisting of H, optionally substituted alkyl, F, Cl, Br, and I;
R⁵ is selected from the group consisting of H, optionally substituted alkyl, F, Cl, Br, and I;
each W¹ is independently O or NR⁶, wherein each R⁶ is independently H or optionally substituted alkyl;
m is 3; and
n is 3.

In some embodiments, the structure of Formula (I) is a structure of Formula (I-A):

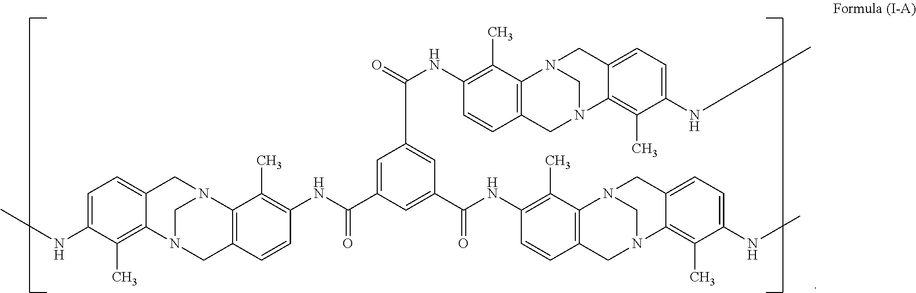

In various embodiments, the present invention provides a polymer membrane comprising a polymer, wherein the polymer comprises repeat units, wherein the repeat units have a structure of Formula (I).

In some embodiments, the polymer membrane further comprising a substrate. In some embodiments the substrate is polyacrylonitrile. In some embodiments, the polymer membrane is a composite membrane or a composite polymer membrane. In some embodiments, the substrate comprises polyacrylonitrile, poly-vinylidene fluoride, nylon, polysulfone, polyethersulfone, polycarbonate, polybenzimidizole, cellulose, silica, siloxane, ceramic, glass, metal, or a fibrous membrane, or any combination thereof. In some embodiments, the polymer membrane is a desalination membrane. In some embodiments, the composite membrane is a desalination membrane. In some embodiments, the composite polymer membrane is a desalination membrane.

In various embodiments, the present invention provides a method of making a polymer membrane comprising a polymer, wherein the polymer comprises repeat units, wherein the repeat units have a structure of Formula (I), the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface. In some embodiments, steps (b)-(e) are repeated at least once, thereby adding one or more additional layers of polymer to the polymer membrane.

In various embodiments, the present invention provides a method of making a polymer membrane comprising a polymer, wherein the polymer comprises repeat units, wherein the repeat units have a structure of Formula (I), the method comprising:
(a) providing a substrate, a first monomer composition, a second monomer composition, a first solvent, and a second solvent, wherein the first monomer composition comprises a first monomer, and wherein the second monomer composition comprises a second monomer;
(b) applying the first monomer composition to the substrate, or applying the second monomer composition to the substrate;
(c) rinsing the substrate with the first solvent;
(d) applying the first monomer composition to the substrate, or applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface. In some embodiments, steps (b)-(e) are repeated at least once, thereby adding one or more additional layers of polymer to the polymer membrane.

In some embodiments, the first monomer has a structure of Formula (II);

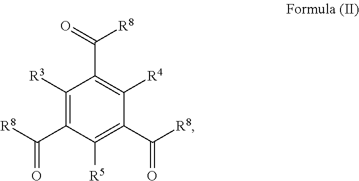

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl.

In some embodiments, wherein in the first monomer has the structure of Formula (II).
R³ is selected from the group consisting of H, NO₂, F, Cl, Br, I, CF₃, CN, NO, optionally substituted alkyl; OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₁, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R⁸ is independently Cl, Br, or OR⁹, where each R⁹ is independently H or optionally substituted alkyl.

In some embodiments, the second monomer has a structure of Formula (III):

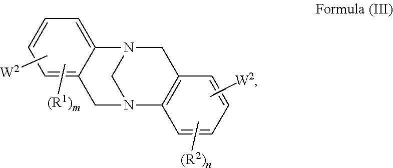

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments, wherein the second monomer has the structure of Formula (III):
each R¹ is independently selected from the group consisting of H, NO₂, F, Cl, Br, I, CF₃, CN, NO, optionally substituted alkyl;
   OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR³⁶R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl;
   OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁴⁹R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In various embodiments, the present invention provides a method of making a polymer membrane comprising a polymer, wherein the polymer comprises repeat units, wherein the repeat units have a structure of Formula (I), the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In various embodiments, the present invention provides a method of making a polymer membrane comprising a polymer, wherein the polymer comprises repeat units, wherein the repeat units have a structure of Formula (I), the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In some embodiments, the first monomer has a structure of Formula (II);

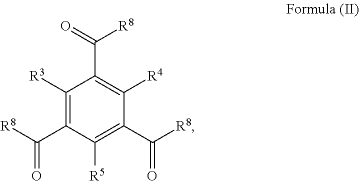

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl.

In some embodiments, wherein the first monomer has the structure of Formula (II):
R³ is selected from the group consisting of H, NO₂, F, Cl, Br, I, CF₃, CN, NO, optionally substituted alkyl; OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R⁸ is independently Cl, Br, or OR⁹, where each R⁹ is independently H or optionally substituted alkyl.

In some embodiments, the second monomer has a structure of Formula (III):

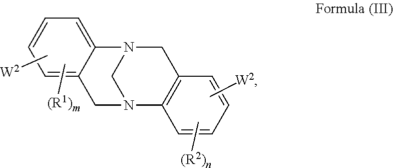

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments, wherein the second monomer has the structure of Formula (II):
each R¹ is independently selected from the group consisting of H, NO₂, F, Cl, Br, I, CF₃, CN, NO, optionally substituted alkyl;
   OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR³⁴R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl;
   OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁴⁹)R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments, the first monomer is:

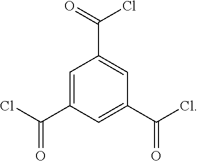 [SMILES: O=C(Cl)c1cc(C(=O)Cl)cc(C(=O)Cl)c1]

In some embodiments, the second monomer is:

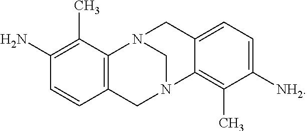 [SMILES: Cc1c(N)ccc2c1N1Cc3ccc(N)c(C)c3N(C2)C1]

In various embodiments, the present invention provides a method for desalination of water, the method comprising: providing a polymer membrane comprising a polymer, wherein the polymer comprises repeat units, wherein the repeat units have a structure of Formula (I); and water, wherein the water comprises at least one salt; and passing the water through the polymer membrane to desalinate the water. In some embodiments, the water is passed through the polymer membrane under conditions effective to desalinate the water. In some embodiments, the water is sea water. In some embodiments, the water is brackish water. In some embodiments, the desalinated water is suitable for human consumption (i.e., drinking water). In some embodiments, the desalinated water is suitable for irrigation (e.g., watering of crops).

In various embodiments, the present invention provides a method for removing at least a portion of at least one salt from water, the method comprising: providing a polymer membrane comprising a polymer, wherein the polymer comprises repeat units, wherein the repeat units have a structure of Formula (I); and water, wherein the water comprises at least one salt; and passing the water through the polymer membrane to remove at least a portion of the at least one salt from the water. In some embodiments, the water is passed through the polymer membrane under conditions effective to remove at least a portion of the at least one salt from the water. In some embodiments, the water is sea water. In some embodiments, the water is brackish water. In some embodiments, the treated water is suitable for human consumption (i.e., drinking water). In some embodiments, the treated water is suitable for irrigation (e.g., watering of crops).

In some embodiments, m is 0-3. In some embodiments, n is 0-3. In some embodiments, p is 0-3. In some embodiments, q is 0-3. In some embodiments, s is 0-4.

In some embodiments, each m is 3. In some embodiments, each n is 3. In some embodiments, each p is 3. In some embodiments, each q is 3. In some embodiments, each s is 4.

In some embodiments, each m is 0-3. In some embodiments, each n is 0-3. In some embodiments, each p is 0-3. In some embodiments, each q is 0-3. In some embodiments, each s is 0-4.

In various embodiments, the present invention provides a polymer comprising repeat units, wherein the repeat units have a structure of Formula (IV); Formula (IV)

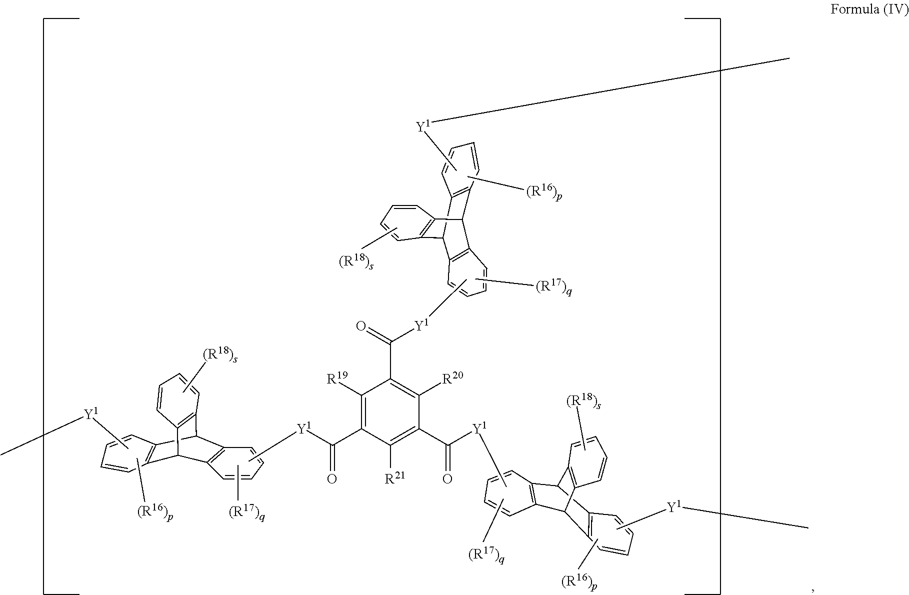

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group:
R¹⁹ is H, an electron withdrawing group, or an electron donating group;
R²⁰ is H, an electron withdrawing group, or an electron donating group;
R²¹ is H, an electron withdrawing group, or an electron donating group;
each Y¹ is independently O or NR²², wherein each R²² is independently H or optionally substituted alkyl;
p is 3;
q is 3; and
s is 4.

In some embodiments, wherein the repeat units have a structure of Formula (IV):
each R¹⁶ is independently selected from the group consisting of H, NO₂, F, Cl, Br, I, CF₃, CN, NO, optionally substituted alkyl;
   OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl;
   OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl;
   OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R¹⁹ is selected from the group consisting of H, NO₂, F, Cl, Br, I, CF₃, CN, NO, optionally substituted alkyl; OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
p is 3;
q is 3; and
s is 4.

In some embodiments, the structure of Formula (IV) is a structure of Formula (IV-A):

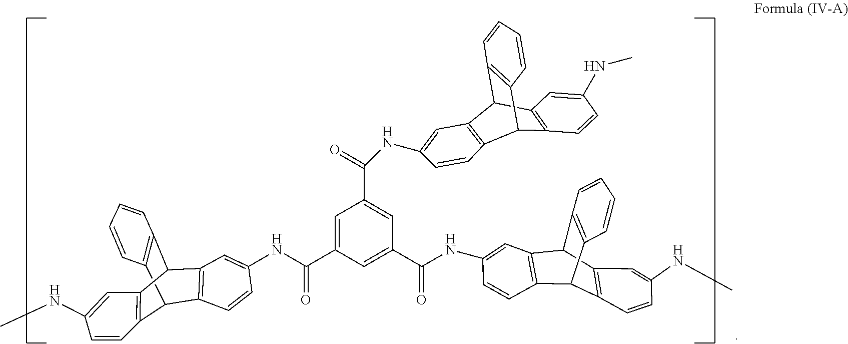

In various embodiments, the present invention provides a polymer membrane comprising a polymer, wherein the polymer comprises repeat units, wherein the repeat units have a structure of Formula (IV).

In some embodiments, the polymer membrane further comprising a substrate. In some embodiments the substrate is polyacrylonitrile. In some embodiments, the polymer membrane is a composite membrane or a composite polymer membrane. In some embodiments, the substrate comprises polyacrylonitrile, polyvinylidene fluoride, nylon, polysulfone, polyethersulfone, polycarbonate, polybenzimidizole, cellulose, silica, siloxane, ceramic, glass, metal, or a fibrous membrane, or any combination thereof. In some embodiments, the polymer membrane is a desalination membrane. In some embodiments, the composite membrane is a desalination membrane. In some embodiments, the composite polymer membrane is a desalination membrane.

In various embodiments, the present invention provides a method of making a polymer membrane comprising a polymer, wherein the polymer comprises repeat units, wherein the repeat units have a structure of Formula (IV), the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface. In some embodiments, steps (b)-(e) are repeated at least once, thereby adding one or more additional layers of polymer to the polymer membrane.

In various embodiments, the present invention provides a method of making a polymer membrane comprising a polymer, wherein the polymer comprises repeat units, wherein the repeat units have a structure of Formula (IV), the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate, or applying the second monomer composition to the substrate:
(c) rinsing the substrate with the first solvent;
(d) applying the first monomer composition to the substrate, or applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface. In some embodiments, steps (b)-(e) are repeated at least once, thereby adding one or more additional layers of polymer to the polymer membrane.

In some embodiments, the first monomer has a structure of Formula (V);

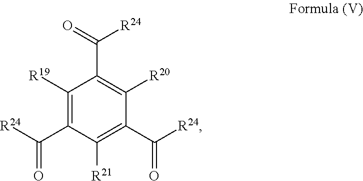

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl.

In some embodiments, wherein the first monomer has the structure of Formula (V):
R¹⁹ is selected from the group consisting of H, NO₂, F, Cl, Br, I, CF₃, CN, NO, optionally substituted alkyl; OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl, OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R²⁴ is independently Cl, Br, or OR²⁵, where each R²⁵ is independently H or optionally substituted alkyl.

In some embodiments, the second monomer has a structure of Formula (VI):

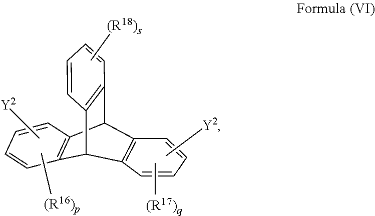

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments, wherein the second monomer has the structure of Formula (VI):
each R¹⁶ is independently selected from the group consisting of H, NO₂, F, Cl, Br, I, CF₃, CN, NO, optionally substituted alkyl;
   OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl;
   OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl;
   OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocycyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments, the first monomer is:

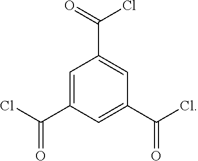 [SMILES: O=C(Cl)c1cc(C(=O)Cl)cc(C(=O)Cl)c1]

In some embodiments, the second monomer is:

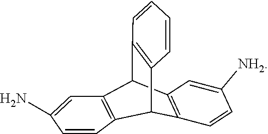 [SMILES: Nc1ccc2c(c1)C1c3ccccc3C2c2ccc(N)cc21]

In various embodiments, the present invention provides a method of making a polymer membrane comprising a polymer, wherein the polymer comprises repeat units, wherein the repeat units have a structure of Formula (IV), the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In various embodiments, the present invention provides a method of making a polymer membrane comprising a polymer, wherein the polymer comprises repeat units, wherein the repeat units have a structure of Formula (IV), the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate:
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In some embodiments, the first monomer has a structure of Formula (V);

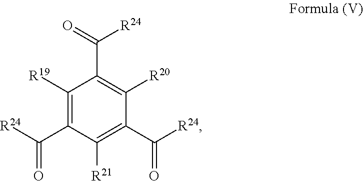

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R² is independently Cl, Br, or OR⁵, where each R²⁵ is independently H or optionally substituted alkyl.

In some embodiments, wherein the first monomer has the structure of Formula (V):
R¹⁹ is selected from the group consisting of H, NO₂, F, Cl, Br, I, CF₃, CN, NO, optionally substituted alkyl; OR¹¹⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R²⁴ is independently Cl, Br, or OR²⁵, where each R² is independently H or optionally substituted alkyl.

In some embodiments, the second monomer has a structure of Formula (VI):

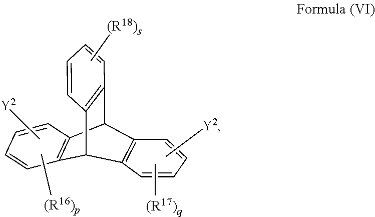

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments, wherein the second monomer has the structure of Formula (VI):
each R¹⁶ is independently selected from the group consisting of H, NO₂, F, Cl, Br, I, CF₃, CN, NO, optionally substituted alkyl;
   OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl,
   OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
   PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl;
   OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
   SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and
   PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocycyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments, the first monomer is:

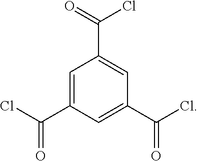 [SMILES: O=C(Cl)c1cc(C(=O)Cl)cc(C(=O)Cl)c1]

In some embodiments, the second monomer is.

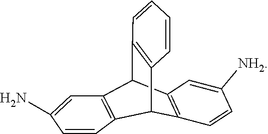 [SMILES: Nc1ccc2c(c1)C1c3ccccc3C2c2ccc(N)cc21]

In various embodiments, the present invention provides a method for desalination of water, the method comprising: providing a polymer membrane comprising a polymer, wherein the polymer comprises repeat units, wherein the repeat units have a structure of Formula (IV); and water, wherein the water comprises at least one salt; and passing the water through the polymer membrane to desalinate the water. In some embodiments, the water is passed through the polymer membrane under conditions effective to desalinate the water. In some embodiments, the water is sea water. In some embodiments, the water is brackish water. In some embodiments, the desalinated water is suitable for human consumption (i.e., drinking water). In some embodiments, the desalinated water is suitable for irrigation (e.g., watering of crops).

In various embodiments, the present invention provides a method for removing at least a portion of at least one salt from water, the method comprising: providing a polymer membrane comprising a polymer, wherein the polymer comprises repeat units, wherein the repeat units have a structure of Formula (IV); and water, wherein the water comprises at least one salt; and passing the water through the polymer membrane to remove at least a portion of the at least one salt from the water. In some embodiments, the water is passed through the polymer membrane under conditions effective to remove at least a portion of the at least one salt from the water. In some embodiments, the water is sea water. In some embodiments, the water is brackish water. In some embodiments, the treated water is suitable for human consumption (i.e., drinking water). In some embodiments, the treated water is suitable for irrigation (e.g., watering of crops).

In some embodiments, m is 0-3. In some embodiments, n is 0-3. In some embodiments, p is 0-3. In some embodiments, q is 0-3. In some embodiments, s is 0-4.

In some embodiments, each m is 3. In some embodiments, each n is 3. In some embodiments, each p is 3. In some embodiments, each q is 3. In some embodiments, each s is 4.

In some embodiments, each m is 0-3. In some embodiments, each n is 0-3. In some embodiments, each p is 0-3 In some embodiments, each q is 0-3. In some embodiments, each s is 0-4.

Additional embodiments include:

Embodiment 1. A polymer comprising repeat units, wherein the repeat units have a structure of Formula (I):

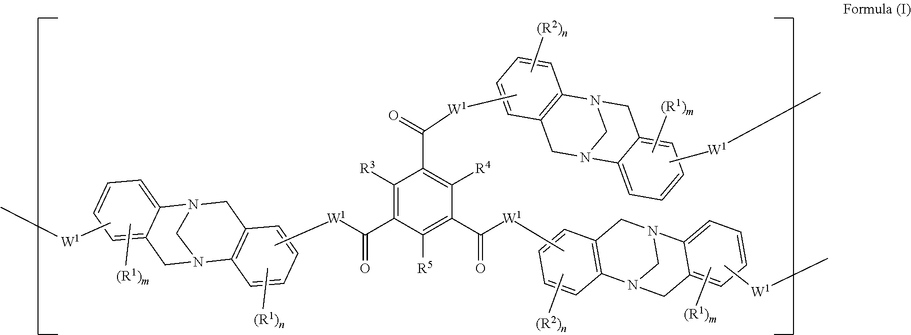

wherein:
each R¹ is independently selected from the group consisting of H, an electron withdrawing group, and an electron donating group;
each R² is independently selected from the group consisting of H, an electron withdrawing group, and an electron donating group;
R³ is H, an electron withdrawing group, or an electron donating group;
R⁴ is H, an electron withdrawing group, or an electron donating group;
R⁵ is H, an electron withdrawing group, or an electron donating group;
each W¹ is independently O or NR⁶, wherein each R⁶ is independently H or optionally substituted alkyl;
m is 3; and
n is 3.

Embodiment 2: The polymer of embodiment 1, wherein:
each R¹ is independently selected from the group consisting of H, NO₂, F, Cl, Br, I, CF₃, CN, NO, optionally substituted alkyl; OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR³⁶R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR^{4I}R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl; OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁴⁹R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R³ is selected from the group consisting of H, NO₂, F, Cl, Br, I, CF₃, CN, NO, optionally substituted alkyl; OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cydyl, or optionally substituted heterocyclyl, and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each W¹ is independently O or NR⁶, wherein each R⁶ is independently H or optionally substituted alkyl;
m is 3; and
n is 3.

Embodiment 3. The polymer of embodiment 1, wherein:
each R¹ is independently selected from the group consisting of H, optionally substituted alkyl, F, Cl, Br, and I;
each R² is independently selected from the group consisting of H, optionally substituted alkyl, F, Cl, Br, and I;
R³ is selected from the group consisting of H, optionally substituted alkyl, F, Cl, Br, and I;
R⁴ is selected from the group consisting of H, optionally substituted alkyl, F, Cl, Br, and I;
R⁵ is selected from the group consisting of H, optionally substituted alkyl, F, Cl, Br, and I;
each W¹ is independently O or NR⁶, wherein each R⁶ is independently H or optionally substituted alkyl;
m is 3; and
n is 3.

Embodiment 4. The polymer of embodiment 1, wherein the structure of Formula (I) is a structure of Formula (I-A):

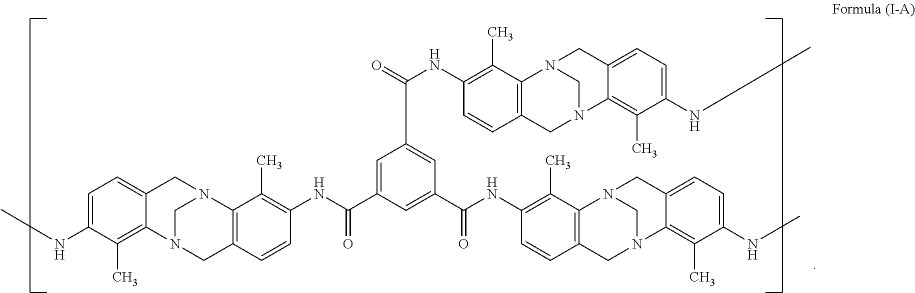

Embodiment 5. A polymer membrane comprising a polymer of embodiment 1.

Embodiment 6. A method of making a polymer membrane of embodiment 5, the method comprising:
(a) providing a substrate, a first monomer composition, a second monomer composition, a first solvent, and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

Embodiment 7. The method of embodiment 6, wherein a polymerization reaction between the first monomer and the second monomer occurs, thereby forming a polymer membrane on at least a portion of the substrate surface.

Embodiment 8. The method of embodiment 6, wherein steps (b)-(e) are repeated at least once, thereby adding one or more additional layers of polymer to the polymer membrane.

Embodiment 9. The method of embodiment 6, wherein the first monomer has a structure of Formula (II):

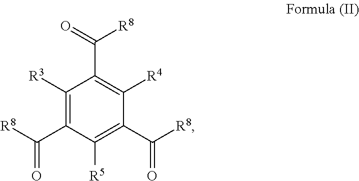

wherein:
R³ is H, an electron withdrawing group, or an electron donating group;
R⁴ is H, an electron withdrawing group, or an electron donating group;
R³ is H, an electron withdrawing group, or an electron donating group; and
each R⁸ is independently Cl, Br, or OR⁹, where each R⁹ is independently H or optionally substituted alkyl.

Embodiment 10. The method of embodiment 9, wherein in the first monomer having the structure of Formula (II):
R³ is selected from the group consisting of H, NO₂, F, Cl, Br, I, CF₃, CN, NO, optionally substituted alkyl; OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl, OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R⁸ is independently Cl, Br, or OR⁹, where each R⁹ is independently H or optionally substituted alkyl.

Embodiment 11. The method of embodiment 6, wherein the second monomer has a structure of Formula (III):

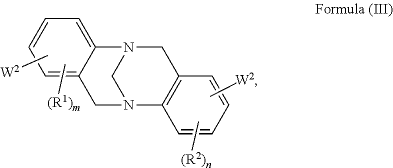

wherein;
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently II or optionally substituted alkyl, wherein each R¹¹ is independently H or optionally substituted alkyl, and wherein each R¹² is independently H or optionally substituted alkyl;
m is 3; and
n is 3.

Embodiment 12. The method of embodiment 11, wherein in the second monomer having the structure of Formula (III):
each R¹ is independently selected from the group consisting of H, NO₂, F, Cl, Br, I, CFs, CN, NO, optionally substituted alkyl; OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR³⁶R³⁷, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl; OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁴⁹R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

Embodiment 13. The method of embodiment 6, wherein the first monomer is:

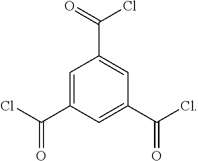 [SMILES: O=C(Cl)c1cc(C(=O)Cl)cc(C(=O)Cl)c1]

Embodiment 14. The method of embodiment 6, wherein the second monomer is:

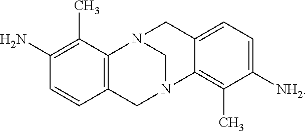 [SMILES: Cc1c(N)ccc2c1N1Cc3ccc(N)c(C)c3N(C2)C1]

Embodiment 15. A method of making a polymer membrane of embodiment 5, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

Embodiment 16. The method of embodiment 15, wherein a polymerization reaction between the first monomer and the second monomer occurs, thereby forming a polymer membrane on at least a portion of the substrate surface.

Embodiment 17. The method of embodiment 15, wherein steps (c) and (d) are repeated at least once, thereby adding one or more additional layers of polymer to the polymer membrane.

Embodiment 18. The method of embodiment 15, wherein the first monomer has a structure of Formula (II);

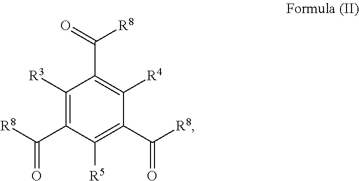

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl.

Embodiment 19. The method of embodiment 18, wherein in the first monomer having the structure of Formula (II):
R³ is selected from the group consisting of H, NO₂, F, Cl, Br, I, CF₃, CN, NO, optionally substituted alkyl, OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cydyl, or optionally substituted heterocyclyl; and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR^{6S}NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R⁸ is independently Cl, Br, or OR⁹, where each R⁹ is independently H or optionally substituted alkyl.

Embodiment 20. The method of embodiment 15, wherein the second monomer has a structure of Formula (III):

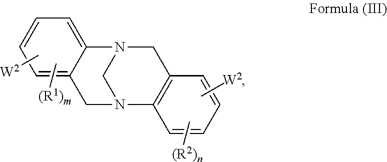

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

Embodiment 21. The method of embodiment 20, wherein in the second monomer having the structure of Formula (III):
each R¹ is independently selected from the group consisting of H, NO₂, F, Cl, Br, I, CFs, CN, NO, optionally substituted alkyl; OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR³⁶R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl; OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁴⁹R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

Embodiment 22. The method of embodiment 15, wherein the first monomer is:

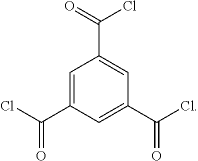 [SMILES: O=C(Cl)c1cc(C(=O)Cl)cc(C(=O)Cl)c1]

Embodiment 23. The method of embodiment 15, wherein the second monomer is.

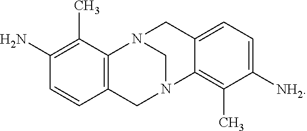 [SMILES: Cc1c(N)ccc2c1N1Cc3ccc(N)c(C)c3N(C2)C1]

Embodiment 24. A polymer comprising repeat units, wherein the repeat units have a structure of Formula (IV);

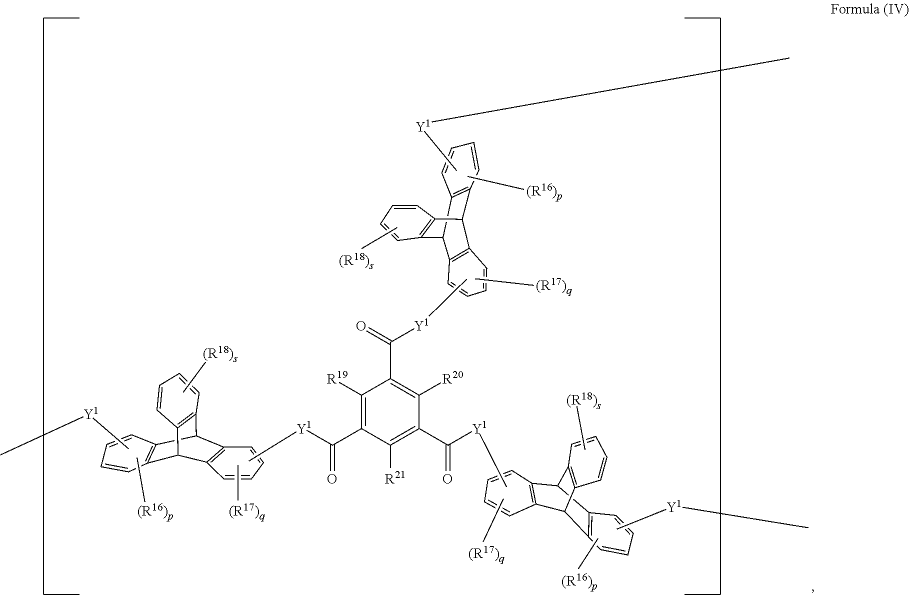

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
R¹⁹ is H, an electron withdrawing group, or an electron donating group;
R²⁰ is H, an electron withdrawing group, or an electron donating group;
R²¹ is H, an electron withdrawing group, or an electron donating group;
each Y¹ is independently O or NR²², wherein each R²² is independently H or optionally substituted alkyl;
p is 3;
q is 3; and
s is 4.

Embodiment 25. The polymer of embodiment 24, wherein:
each R¹⁶ is independently selected from the group consisting of H, NO₂, F, Cl, Br, I, CF₃, CN, NO, optionally substituted alkyl, OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁷⁵, wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl; OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁸⁹R⁹⁰, wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl; OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R¹⁹ is selected from the group consisting of H, NO₂, F, Cl, Br, I, CF₃, CN, NO, optionally substituted alkyl, OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
p is 3;
q is 3; and
s is 4.

Embodiment 26. The polymer of embodiment 24, wherein the structure of Formula (IV) is a structure of Formula (IV-A):

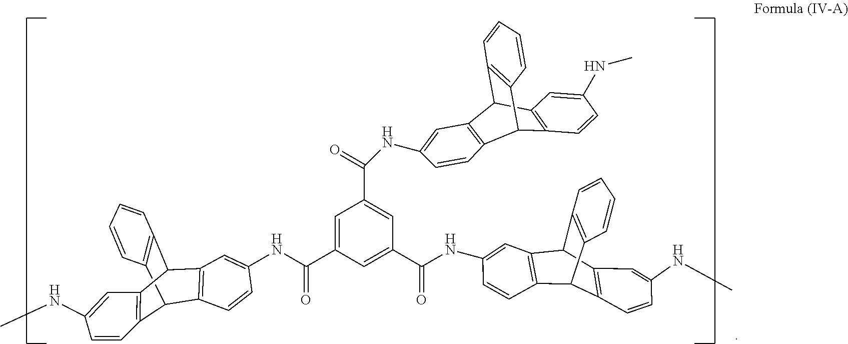

Embodiment 27. A polymer membrane comprising a polymer of embodiment 24.

Embodiment 28. A method of making a polymer membrane of embodiment 27, the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

Embodiment 29. The method of embodiment 28, wherein a polymerization reaction between the first monomer and the second monomer occurs, thereby forming a polymer membrane on at least a portion of the substrate surface.

Embodiment 30. The method of embodiment 28, wherein steps (b)-(e) are repeated at least once, thereby adding one or more additional layers of polymer to the polymer membrane.

Embodiment 31. The method of embodiment 28, wherein the first monomer has a structure of Formula (V);

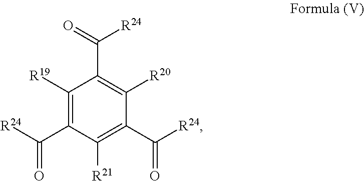

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl.

Embodiment 32. The method of embodiment 28, wherein in the first monomer having the structure of Formula (V):
R¹⁹ is selected from the group consisting of H, NO₂, F, Cl, Br, I, CF₃, CN, NO, optionally substituted alkyl; OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹⁰NR¹¹¹, wherein each R¹, is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R²⁴ is independently Cl, Br, or OR²⁵, where each R²⁵ is independently H or optionally substituted alkyl.

Embodiment 33. The method of embodiment 28, wherein the second monomer has a structure of Formula (VI):

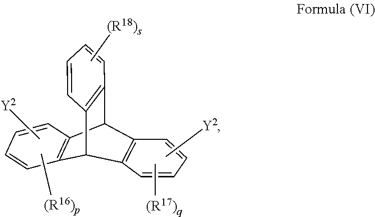

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 34: The method of embodiment 33, wherein in the second monomer having the structure of Formula (VI):
each R¹⁶ is independently selected from the group consisting of H, NO₂, F, Cl, Br, I, CF₃, CN, NO, optionally substituted alkyl; OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁷¹, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl; OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl; OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each Y² is independently OR²⁶ or NR²⁷R²⁸, wherein each R²⁶ is independently H or optionally substituted alkyl, wherein each R²⁷, is independently H or optionally substituted alkyl, and wherein each R²⁸ is independently H or optionally substituted alkyl;
p is 3;
q is 3; and
s is 4.

Embodiment 35. The method of embodiment 28, wherein the first monomer is:

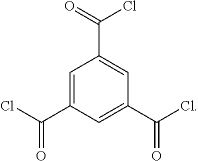 [SMILES: O=C(Cl)c1cc(C(=O)Cl)cc(C(=O)Cl)c1]

Embodiment 36. The method of embodiment 28, wherein the second monomer is:

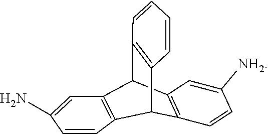 [SMILES: Nc1ccc2c(c1)C1c3ccccc3C2c2ccc(N)cc21]

Embodiment 37. A method of making a polymer membrane of embodiment 27, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

Embodiment 38 The method of embodiment 37, wherein a polymerization reaction between the first monomer and the second monomer occurs, thereby forming a polymer membrane on at least a portion of the substrate surface.

Embodiment 39. The method of embodiment 37, wherein steps (c) and (d) are repeated at least once, thereby adding one or more additional layers of polymer to the polymer membrane.

Embodiment 40. The method of embodiment 37, wherein the first monomer has a structure of Formula (V);

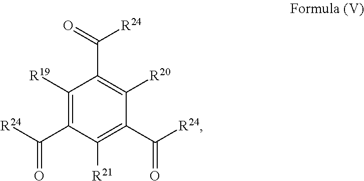

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁵ is independently Cl, Br, or OR²⁵, where each R²⁵ is independently H or optionally substituted alkyl.

Embodiment 41. The method of embodiment 40, wherein in the first monomer having the structure of Formula (V):
R¹⁹ is selected from the group consisting of H, NO₂, F, Cl, Br, I, CF₃, CN, NO, optionally substituted alkyl; OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R²⁴ is independently Cl, Br, or OR²⁵, where each R²⁵ is independently H or optionally substituted alkyl.

Embodiment 42. The method of embodiment 37, wherein the second monomer has a structure of Formula (VI):

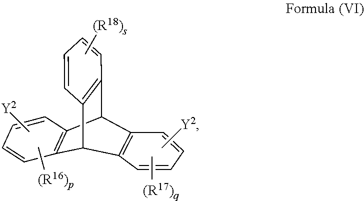

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 43. The method of embodiment 42, wherein in the second monomer having the structure of Formula (VI):
each R¹⁶ is independently selected from the group consisting of H, NO₂, F, Cl, Br, I, CF₃, CN, NO, optionally substituted alkyl, OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl; OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁸⁴R⁹⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl; OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 44. The method of embodiment 37, wherein the first monomer is:

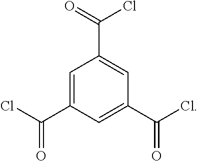 [SMILES: O=C(Cl)c1cc(C(=O)Cl)cc(C(=O)Cl)c1]

Embodiment 45. The method of embodiment 37, wherein the second monomer is:

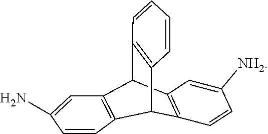 [SMILES: Nc1ccc2c(c1)C1c3ccccc3C2c2ccc(N)cc21]

Embodiment 46. A method for desalination of water, the method comprising: providing a polymer membrane of embodiment 5, and water, wherein the water comprises at least one salt; and passing the water through the polymer membrane to desalinate the water.

Embodiment 47. The method of embodiment 46, wherein the water is sea water.

Embodiment 48. A method for desalination of water, the method comprising: providing a polymer membrane of embodiment 27, and water, wherein the water comprises at least one salt, and passing the water through the polymer membrane to desalinate the water.

Embodiment 49. The method of embodiment 48, wherein the water is sea water.

Additional embodiments include:

In various embodiments the present invention provides a polymer, comprising: a first monomer, and a second monomer, wherein the second monomer has a structure of Formula (III):
Formula (III)

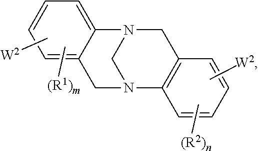

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments, the first monomer comprises at least two acyl halides. In some embodiments, the first monomer comprises at least three acyl halide functional groups. In some embodiments, the acyl halide functional groups are acyl bromide or acyl chloride. In some embodiments, the acyl halide functional groups are acyl chloride.

In some embodiments, the first monomer has a structure of Formula II):

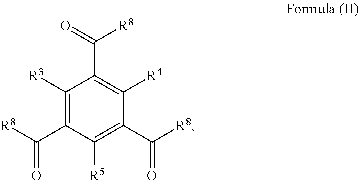

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl. In some embodiments, the first monomer having the structure of Formula (II):
R³ is selected from the group consisting of H, NO₂, F, Cl, Br, I, CF₃, CN, NO, optionally substituted alkyl; OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and NR⁵⁹NR⁶⁰, wherein each R⁵⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
NR⁶²NR⁶³, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁶³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR⁶⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R⁸ is independently Cl, Br, or OR⁹, where each R⁹ is independently H or optionally substituted alkyl.

In some embodiments, the second monomer having the structure of Formula (III):
each R¹ is independently selected from the group consisting of H, NO₂, F, Cl, Br, I, CF₃, CN, NO, optionally substituted alkyl, OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR³⁶R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl, OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, C(═O)NR⁴⁹R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments the first monomer is:

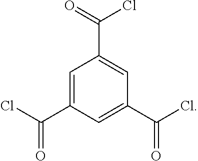 [SMILES: O=C(Cl)c1cc(C(=O)Cl)cc(C(=O)Cl)c1]

In some embodiments the second monomer is:

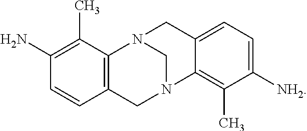 [SMILES: Cc1c(N)ccc2c1N1Cc3ccc(N)c(C)c3N(C2)C1]

In various embodiments, the present invention provides a polymer membrane comprising a polymer of the present invention. In some embodiments, the polymer membrane further comprising a substrate. In some embodiments the substrate is polyacrylonitrile. In some embodiments, the polymer membrane is a composite membrane or a composite polymer membrane. In some embodiments, the substrate comprises polyacrylonitrile, polyvinylidene fluoride, nylon, polysulfone, polyethersulfone, polycarbonate, polybenzimidizole, cellulose, silica, siloxane, ceramic, glass, metal, or a fibrous membrane, or any combination thereof. In some embodiments, the polymer membrane is a desalination membrane. In some embodiments, the composite membrane is a desalination membrane. In some embodiments, the composite polymer membrane is a desalination membrane.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate, or applying the second monomer composition to the substrate;
(c) rinsing the substrate with the first solvent;
(d) applying the first monomer composition to the substrate, or applying the second monomer composition to the substrate, and
(e) rinsing the substrate with the second solvent.

In some embodiments, a polymerization reaction between the first monomer and the second monomer occurs, thereby forming a polymer membrane on at least a portion of the substrate surface.

In some embodiments, steps (b)-(e) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

In some embodiments, a polymerization reaction between the first monomer and the second monomer occurs, thereby forming a polymer membrane on at least a portion of the substrate surface.

In some embodiments, steps (c) and (d) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In some embodiments, the present invention provides a method for desalination of water, the method comprising: providing a polymer membrane of the present invention, and water, wherein the water comprises at least one salt; and passing the water through the polymer membrane to desalinate the water. In some embodiments, the water is sea water.

Additional embodiments include:

In various embodiments the present invention provides a polymer, comprising: a first monomer, and a second monomer, wherein the second monomer has a structure of Formula (VI):

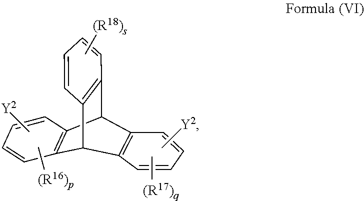

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments, the first monomer comprises at least two acyl halide functional groups. In some embodiments, the first monomer comprises at least three acyl halide functional groups. In some embodiments, the acyl halide functional groups are acyl bromide or acyl chloride. In some embodiments, the acyl halide functional groups are acyl chloride.

In some embodiments, the first monomer has a structure of Formula (V):

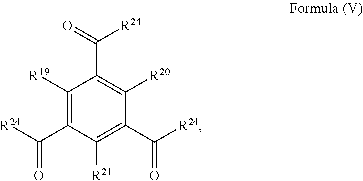

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl.

Tn some embodiments, the first monomer having the structure of Formula (V):
R¹⁹ is selected from the group consisting of H, NO₂, F, Cl, Br, I, CF₃, CN, NO, optionally substituted alkyl; OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CF₃, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl; OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R²⁴ is independently Cl, Br, or OR²⁵, where each R²⁵ is independently H or optionally substituted alkyl.

In some embodiments, the second monomer having a structure of Formula (VI):
each R¹⁶ is independently selected from the group consisting of H, NO₂, F, Cl, Br, I, CF₁, CN, NO, optionally substituted alkyl, OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl; OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl; OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR¹⁰¹, wherein each R¹⁰¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments the first monomer is:

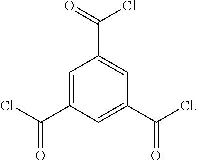 [SMILES: O=C(Cl)c1cc(C(=O)Cl)cc(C(=O)Cl)c1]

In some embodiments the second monomer is:

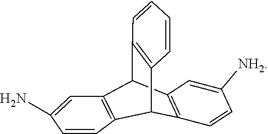 [SMILES: Nc1ccc2c(c1)C1c3ccccc3C2c2ccc(N)cc21]

In various embodiments, the present invention provides a polymer membrane comprising a polymer of the present invention. In some embodiments, the polymer membrane further comprising a substrate. In some embodiments the substrate is polyacrylonitrile. In some embodiments, the polymer membrane is a composite membrane or a composite polymer membrane. In some embodiments, the substrate comprises polyacrylonitrile, polyvinylidene fluoride, nylon, polysulfone, polyethersulfone, polycarbonate, polybenzimidizole, cellulose, silica, siloxane, ceramic, glass, metal, or a fibrous membrane, or any combination thereof. In some embodiments, the polymer membrane is a desalination membrane. In some embodiments, the composite membrane is a desalination membrane. In some embodiments, the composite polymer membrane is a desalination membrane.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate, or applying the second monomer composition to the substrate;
(c) rinsing the substrate with the first solvent;
(d) applying the first monomer composition to the substrate, or applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface.

In some embodiments, steps (b)-(e) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

In some embodiments, a polymerization reaction between the first monomer and the second monomer occurs, thereby forming a polymer membrane on at least a portion of the substrate surface.

In some embodiments, steps (c) and (d) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In various embodiments, the present invention provides a method for desalination of water, the method comprising: providing a polymer membrane of the present invention; and water, wherein the water comprises at least one salt; and passing the water through the polymer membrane to desalinate the water. In some embodiments, the water is passed through the polymer membrane under conditions effective to desalinate the water. In some embodiments, the water is sea water. In some embodiments, the water is brackish water. In some embodiments, the desalinated water is suitable for human consumption (i.e., drinking water). In some embodiments, the desalinated water is suitable for irrigation (e.g., watering of crops).

In various embodiments, the present invention provides a method for removing at least a portion of at least one salt from water, the method comprising: providing a polymer membrane of the present invention; and water, wherein the water comprises at least one salt; and passing the water through the polymer membrane to remove at least a portion of the at least one salt from the water. In some embodiments, the water is passed through the polymer membrane under conditions effective to remove at least a portion of the at least one salt from the water. In some embodiments, the water is sea water. In some embodiments, the water is brackish water. In some embodiments, the treated water is suitable for human consumption (i.e., drinking water). In some embodiments, the treated water is suitable for irrigation (e.g., watering of crops).

Additional embodiments include:

In various embodiments the present invention provides a polymer comprising repeat units derived from polymerization of a first monomer, and a second monomer, wherein the second monomer has a structure of Formula (III):

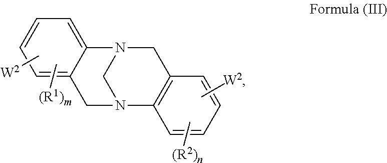

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments, the first monomer comprises at least two acyl halide functional groups. In some embodiments, the first monomer comprises at least three acyl halide functional groups. In some embodiments, the acyl halide functional groups are acyl bromide or acyl chloride. In some embodiments, the acyl halide functional groups are acyl chloride.

In some embodiments, the first monomer has a structure of Formula (II):

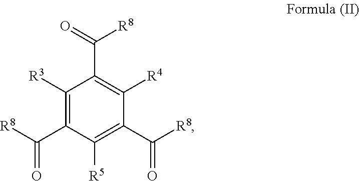

wherein:
R³ is H, an electron withdrawing group, or an electron donating group;
R⁴ is H, an electron withdrawing group, or an electron donating group;
R³ is H, an electron withdrawing group, or an electron donating group; and
each R⁸ is independently Cl, Br, or OR⁹, where each R⁹ is independently H or optionally substituted alkyl. In some embodiments, the first monomer having the structure of Formula (II):
R³ is selected from the group consisting of H, NO₂, F, Cl, Br, I, CF₃, CN, NO, optionally substituted alkyl, OR⁵⁸, wherein each R⁵⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁵⁹NR⁶⁰, wherein each R¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁴ is selected from the group consisting of H, NO₂, F, Cl, Br, I, CF₃, CN, NO, optionally substituted alkyl; OR⁶¹, wherein each R⁶¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶²NR⁶¹, wherein each R⁶² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R⁵ is selected from the group consisting of H, NO₂, F, Cl, Br, I, CF₃, CN, NO, optionally substituted alkyl; OR¹¹⁴, wherein each R⁶⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR⁶⁵NR⁶⁶, wherein each R⁶⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁶⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R⁸ is independently Cl, Br, or OR⁹, where each R⁹ is independently H or optionally substituted alkyl.

In some embodiments, the second monomer having the structure of Formula (III):
each R¹ is independently selected from the group consisting of H, NO₂, F, Cl, Br, I, CF₃, CN, NO, optionally substituted alkyl; OR³², wherein each R³² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR³³NR³⁴, wherein each R³³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R³⁵, wherein each R³⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR³⁶R³⁷, wherein each R³⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R³⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R³⁸, wherein each R³⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R³⁹, wherein each R³⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁴⁰, wherein each R⁴⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁴¹R⁴², wherein each R⁴¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁴³R⁴⁴, wherein each R⁴³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁴⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R² is independently selected from the group consisting of H, NO₂, F, Cl, Br, I, CF₃, CN, NO, optionally substituted alkyl; OR⁴⁵, wherein each R⁴⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁴⁶NR⁴⁷, wherein each R⁴⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁴⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁴⁸, wherein each R⁴⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁴⁹R⁵⁰, wherein each R⁴⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, C(═O)R⁵¹, wherein each R⁵¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁵², wherein each R⁵² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁵³, wherein each R⁵³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁵⁴R⁵⁵, wherein each R⁵⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁵⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁵⁶R⁵⁷, wherein each R⁵⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁵⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

In some embodiments the first monomer is:

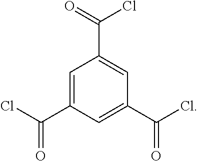 [SMILES: O=C(Cl)c1cc(C(=O)Cl)cc(C(=O)Cl)c1]

In some embodiments the second monomer is:

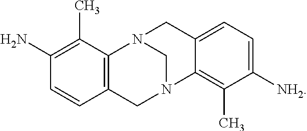 [SMILES: Cc1c(N)ccc2c1N1Cc3ccc(N)c(C)c3N(C2)C1]

In various embodiments, the present invention provides a polymer membrane comprising a polymer of the present invention. In some embodiments, the polymer membrane further comprising a substrate. In some embodiments the substrate is polyacrylonitrile. In some embodiments, the polymer membrane is a composite membrane or a composite polymer membrane. In some embodiments, the substrate comprises polyacrylonitrile, polyvinylidene fluoride, nylon, polysulfone, polyethersulfone, polycarbonate, polybenzimidizole, cellulose, silica, siloxane, ceramic, glass, metal, or a fibrous membrane, or any combination thereof. In some embodiments, the polymer membrane is a desalination membrane. In some embodiments, the composite membrane is a desalination membrane. In some embodiments, the composite polymer membrane is a desalination membrane.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate, or applying the second monomer composition to the substrate;
(c) rinsing the substrate with the first solvent;
(d) applying the first monomer composition to the substrate, or applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface.

In some embodiments, steps (b)-(e) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

In some embodiments, a polymerization reaction between the first monomer and the second monomer occurs, thereby forming a polymer membrane on at least a portion of the substrate surface.

In some embodiments, steps (c) and (d) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In some embodiments, the present invention provides a method for desalination of water, the method comprising: providing a polymer membrane of the present invention, and water, wherein the water comprises at least one salt; and passing the water through the polymer membrane to desalinate the water. In some embodiments, the water is sea water.

Additional embodiments include:

In various embodiments the present invention provides a polymer comprising repeat units derived from polymerization of a first monomer, and a second monomer, wherein the second monomer has a structure of Formula (VI):

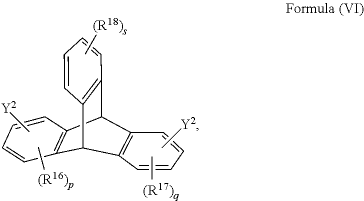

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments, the first monomer comprises at least two acyl halide functional groups. In some embodiments, the first monomer comprises at least three acyl halide functional groups. In some embodiments, the acyl halide functional groups are acyl bromide or acyl chloride. In some embodiments, the acyl halide functional groups are acyl chloride.

In some embodiments, the first monomer has a structure of Formula (V);

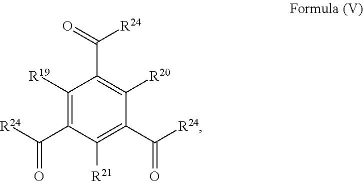

wherein:
R¹⁹ is H, an electron withdrawing group, or an electron donating group;
R²⁰ is H, an electron withdrawing group, or an electron donating group;
R²¹ is H, an electron withdrawing group, or an electron donating group, and each R²⁴ is independently Cl, Br, or OR²⁵, where each R²⁵ is independently H or optionally substituted alkyl.

In some embodiments, the first monomer having the structure of Formula (V):
R¹⁹ is selected from the group consisting of H, NO₂, F, Cl, Br, I, CF₃, CN, NO, optionally substituted alkyl; OR¹⁰⁶, wherein each R¹⁰⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹⁰⁷NR¹⁰⁸, wherein each R¹⁰⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²⁰ is selected from the group consisting of H, NO₂, F, Cl, Br, I, CFs, CN, NO, optionally substituted alkyl; OR¹⁰⁹, wherein each R¹⁰⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹⁰NR¹¹¹, wherein each R¹¹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
R²¹ is selected from the group consisting of H, NO₂, F, Cl, Br, I, CF₃, CN, NO, optionally substituted alkyl, OR¹¹², wherein each R¹¹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and NR¹¹³NR¹¹⁴, wherein each R¹¹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹¹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each R²⁴ is independently Cl, Br, or OR²⁵, where each R²⁵ is independently H or optionally substituted alkyl.

In some embodiments, the second monomer having a structure of Formula (VI):

each R¹⁶ is independently selected from the group consisting of H, NO₂, F, Cl, Br, I, CF₃, CN, NO, optionally substituted alkyl; OR⁶⁷, wherein each R⁶⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, NR⁶⁸NR⁶⁹, wherein each R⁶⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁶⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁷⁰, wherein each R⁷⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁷¹R⁷², wherein each R⁷¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl, and wherein each R⁷² is independently selected from the group consisting of H, optionally substituted alkyl, optionally substituted heteroalkyl, optionally substituted aryl, optionally substituted heteroaryl, optionally substituted cyclyl, or optionally substituted heterocyclyl, C(═O)R⁷³, wherein each R⁷³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁷⁴, wherein each R⁷⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁷⁵, wherein each R⁷⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁷⁶R⁷⁷, wherein each R⁷⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁷⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁷⁸R⁷⁹, wherein each R⁷⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁷⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁷ is independently selected from the group consisting of H, NO₂, F, Cl, Br, I, CF₃, CN, NO, optionally substituted alkyl, OR⁸⁰, wherein each R⁸⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁸¹NR⁸², wherein each R⁸¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁸³, wherein each R⁸³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁸⁴R⁸⁵, wherein each R⁸⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁸⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁸⁶, wherein each R⁸⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R⁸⁷, wherein each R⁸⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR⁸⁸, wherein each R⁸⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR⁸⁹R⁹⁰, wherein each R⁸⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R⁹¹R⁹², wherein each R⁹¹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R⁹² is independently selected from the group consisting of H, optionally substituted alkyl, optionally substituted heteroalkyl, optionally substituted aryl, optionally substituted heteroaryl, optionally substituted cyclyl, or optionally substituted heterocyclyl;
each R¹⁸ is independently selected from the group consisting of H, NO₂, F, Cl, Br, I, CF₃, CN, NO, optionally substituted alkyl; OR⁹³, wherein each R⁹³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; NR⁹⁴NR⁹⁵, wherein each R⁹⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R₉₅ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; CO₂R⁹⁶, wherein each R⁹⁶ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)NR⁹⁷R⁹⁸, wherein each R⁹⁷ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R⁹⁸ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; C(═O)R⁹⁹, wherein each R⁹⁹ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂R¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂OR¹⁰⁰, wherein each R¹⁰⁰ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; SO₂NR¹⁰²R¹⁰³, wherein each R¹⁰² is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and wherein each R¹⁰³ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and PO₃R¹⁰⁴R¹⁰⁵, wherein each R¹⁰⁴ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; wherein each R¹⁰⁵ is independently selected from the group consisting of H, optionally substituted alkyl, optionally substituted heteroalkyl, optionally substituted aryl, optionally substituted heteroaryl, optionally substituted cyclyl, or optionally substituted heterocyclyl; and
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

In some embodiments the first monomer is:

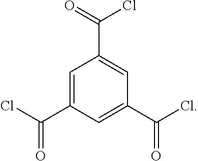 [SMILES: O=C(Cl)c1cc(C(=O)Cl)cc(C(=O)Cl)c1]

In some embodiments the second monomer is:

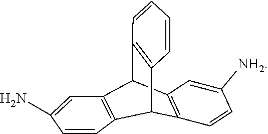 [SMILES: Nc1ccc2c(c1)C1c3ccccc3C2c2ccc(N)cc21]

In various embodiments, the present invention provides a polymer membrane comprising a polymer of the present invention. In some embodiments, the polymer membrane further comprising a substrate. In some embodiments the substrate is polyacrylonitrile. In some embodiments, the polymer membrane is a composite membrane or a composite polymer membrane. In some embodiments, the substrate comprises polyacrylonitrile, polyvinylidene fluoride, nylon, polysulfone, polyethersulfone, polycarbonate, polybenzimidizole, cellulose, silica, siloxane, ceramic, glass, metal, or a fibrous membrane, or any combination thereof. In some embodiments, the polymer membrane is a desalination membrane. In some embodiments, the composite membrane is a desalination membrane. In some embodiments, the composite polymer membrane is a desalination membrane.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate;
(c) rinsing the substrate with the first solvent;
(d) applying the second monomer composition to the substrate; and
(e) rinsing the substrate with the second solvent.

In various embodiments, the present invention provides a method of making a polymer membrane the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to the substrate, or applying the second monomer composition to the substrate;
(c) rinsing the substrate with the first solvent;
(d) applying the first monomer composition to the substrate, or applying the second monomer composition to the substrate; and
(e) rinsing the substrate with the second solvent.

In some embodiments, a polymerization reaction between the first monomer and the second monomer occurs, thereby forming a polymer membrane on at least a portion of the substrate surface.

In some embodiments, steps (b)-(e) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate; and
(d) electrospraying the second monomer composition onto the surface of the substrate.

In some embodiments, a polymerization reaction between the first monomer and the second monomer occurs, thereby forming a polymer membrane on at least a portion of the substrate surface.

In some embodiments, steps (c) and (d) are repeated at least once, thereby adding one or more additional layers of polymer to the polymer membrane.

In various embodiments, the present invention provides a method of making a polymer membrane, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

In some embodiments, a polymerization reaction between the first monomer and the second monomer occurs, thereby forming a polymer membrane on at least a portion of the substrate surface. In some embodiments, steps (c) and (d) are repeated at least once, thereby adding one or more additional layers of polymer to the polymer membrane.

In various embodiments, the present invention provides a method for desalination of water, the method comprising: providing a polymer membrane of the present invention; and water, wherein the water comprises at least one salt; and passing the water through the polymer membrane to desalinate the water. In some embodiments, the water is passed through the polymer membrane under conditions effective to desalinate the water. In some embodiments, the water is sea water. In some embodiments, the water is brackish water. In some embodiments, the desalinated water is suitable for human consumption (i.e., drinking water). In some embodiments, the desalinated water is suitable for irrigation (e.g., watering of crops).

In various embodiments, the present invention provides a method for removing at least a portion of at least one salt from water, the method comprising: providing a polymer membrane of the present invention; and water, wherein the water comprises at least one salt; and passing the water through the polymer membrane to remove at least a portion of the at least one salt from the water. In some embodiments, the water is passed through the polymer membrane under conditions effective to remove at least a portion of the at least one salt from the water. In some embodiments, the water is sea water. In some embodiments, the water is brackish water. In some embodiments, the treated water is suitable for human consumption (i.e., drinking water). In some embodiments, the treated water is suitable for irrigation (e.g., watering of crops).

Additional embodiments include:

Embodiment 50. A polymer comprising repeat units, wherein the repeat units have a structure of Formula (I):

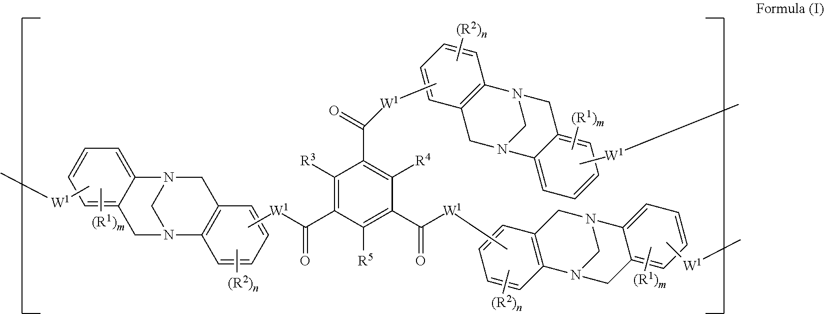

wherein:
each R¹ is independently selected from the group consisting of H, an electron withdrawing group, and an electron donating group;
each R² is independently selected from the group consisting of H, an electron withdrawing group, and an electron donating group;
R³ is H, an electron withdrawing group, or an electron donating group;
R⁴ is H, an electron withdrawing group, or an electron donating group;
R⁵ is H, an electron withdrawing group, or an electron donating group;
each W¹ is independently O or NR⁶, wherein each R⁶ is independently H or optionally substituted alkyl;
m is 3; and
n is 3.

Embodiment 51. The polymer of embodiment 50, wherein the structure of Formula (I) is a structure of Formula (I-A):

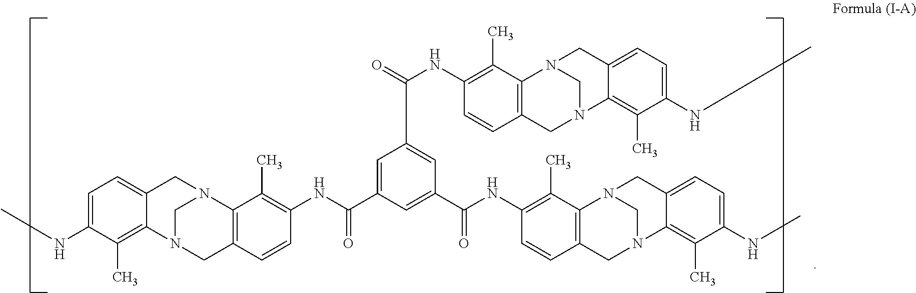

Embodiment 52. A polymer membrane comprising a polymer of embodiment 50.

Embodiment 53. A method of making a polymer membrane of embodiment 52, the method comprising: (a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

Embodiment 54. A method of making a polymer membrane of embodiment 52, the method comprising.
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

Embodiment 55. The method of embodiment 53 or embodiment 54, wherein a polymerization reaction between the first monomer and the second monomer occurs, thereby forming a polymer membrane on at least a portion of the substrate surface.

Embodiment 56. The method of embodiment 53 or embodiment 54, wherein the first monomer has a structure of Formula (II):

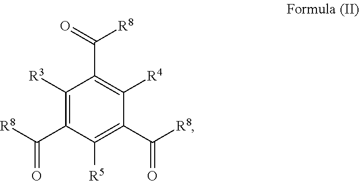

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl; and
wherein the second monomer has a structure of Formula (III):

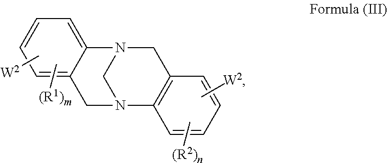

wherein:
each R¹ is independently selected from the group consisting of H, an electron withdrawing group, and an electron donating group:
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

Embodiment 57. A method for desalination of water, the method comprising: providing a polymer membrane of embodiment 52, and water, wherein the water comprises at least one salt; and passing the water through the polymer membrane to desalinate the water.

Embodiment 58. A polymer comprising repeat units, wherein the repeat units have a structure of Formula (IV):

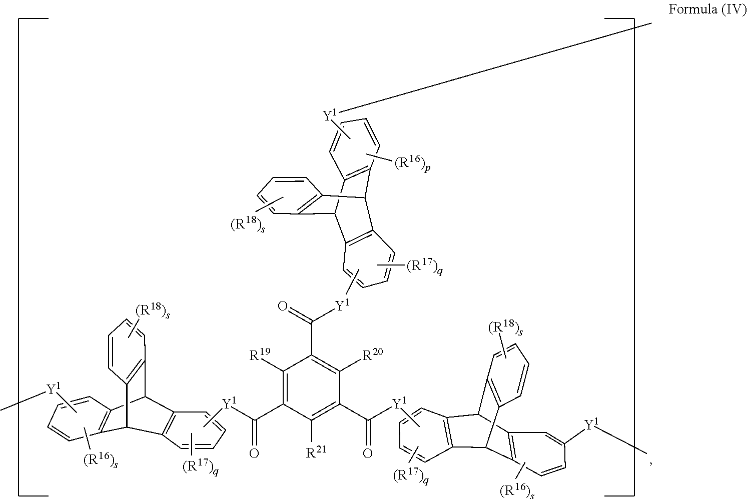

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
R¹⁹ is H, an electron withdrawing group, or an electron donating group;
R²⁰ is H, an electron withdrawing group, or an electron donating group;
R²¹ is H, an electron withdrawing group, or an electron donating group;
each Y¹ is independently O or NR²², wherein each R²² is independently H or optionally substituted alkyl;
p is 3;
q is 3; and
s is 4.

Embodiment 59. The polymer of embodiment 58, wherein the structure of Formula (IV) is a structure of Formula (IV-A):

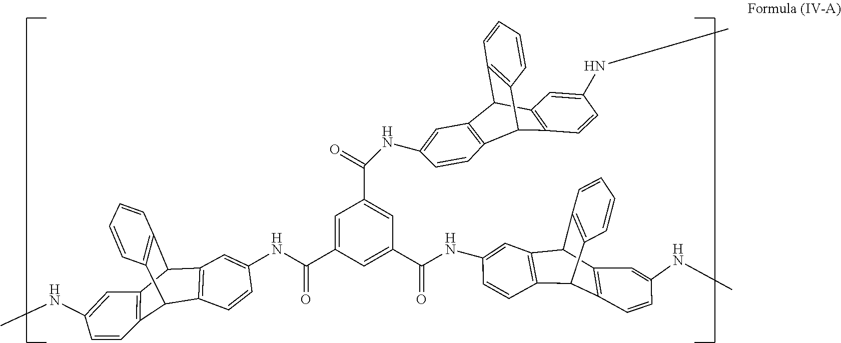

Embodiment 60. A polymer membrane comprising a polymer of embodiment 58.

Embodiment 61. A method of making a polymer membrane of embodiment 60, the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

Embodiment 62. A method of making a polymer membrane of embodiment 60, the method comprising.
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate:
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

Embodiment 63. The method of embodiment 61 or embodiment 62, wherein a polymerization reaction between the first monomer and the second monomer occurs, thereby forming a polymer membrane on at least a portion of the substrate surface.

Embodiment 64. The method of embodiment 61 or embodiment 62, wherein the first monomer has a structure of Formula (V):

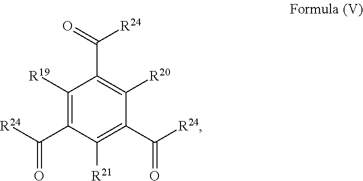

wherein:
R¹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl; and
wherein the second monomer has a structure of Formula (VI):

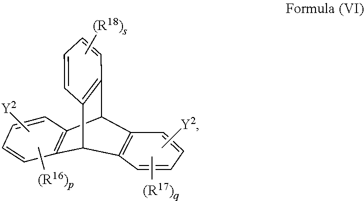

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 65. A method for desalination of water, the method comprising: providing a polymer membrane of embodiment 60, and water, wherein the water comprises at least one salt; and passing the water through the polymer membrane to desalinate the water.

Additional embodiments include:

Embodiment 66. A polymer comprising repeat units, wherein the repeat units have a structure of Formula (I):

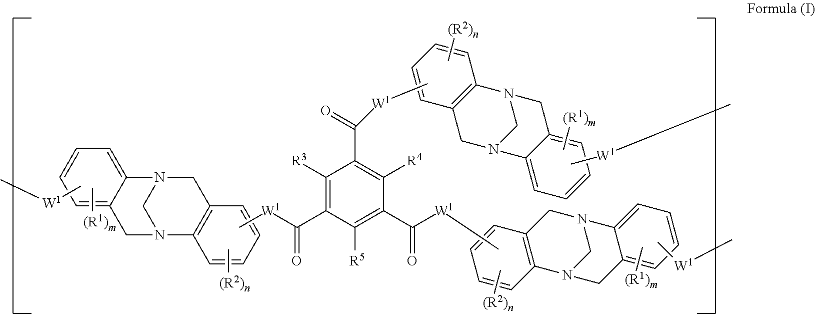

wherein:
each R¹ is independently selected from the group consisting of H, an electron withdrawing group, and an electron donating group;
each R² is independently selected from the group consisting of H, an electron withdrawing group, and an electron donating group;
R³ is H, an electron withdrawing group, or an electron donating group;
R⁴ is H, an electron withdrawing group, or an electron donating group;
R⁵ is H, an electron withdrawing group, or an electron donating group;
each W¹ is independently O or NR⁶, wherein each R⁶ is independently H or optionally substituted alkyl;
m is 3; and
n is 3.

Embodiment 67. The polymer of embodiment 66, wherein the structure of Formula (I) is a structure of Formula (I-A).

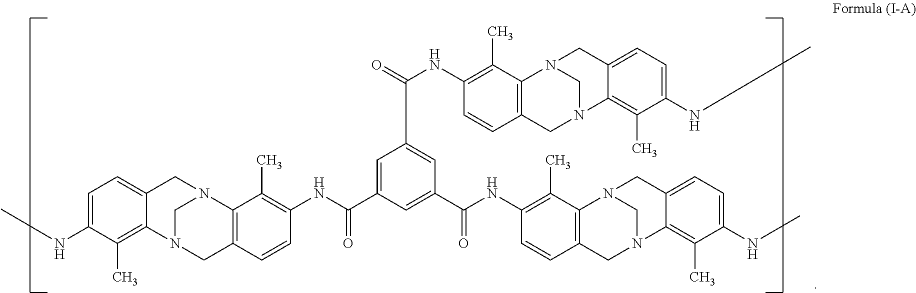

Embodiment 68. A polymer membrane comprising a polymer of embodiment 66.

Embodiment 69. A method of making a polymer membrane of embodiment 68, the method comprising: (a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

Embodiment 70. The method of embodiment 69, wherein a polymerization reaction between the first monomer and the second monomer occurs, thereby forming a polymer membrane on at least a portion of the substrate surface.

Embodiment 71. The method of embodiment 69, wherein steps (b)-(e) are repeated at least once, thereby adding one or more additional layers of polymer to the polymer membrane.

Embodiment 72. The method of embodiment 69, wherein the first monomer has a structure of Formula (II):

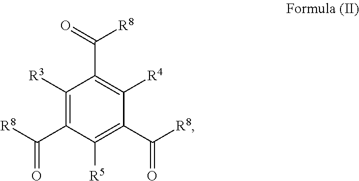

wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl; and
wherein the second monomer has a structure of Formula (III):

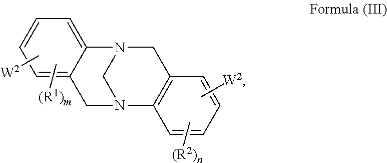

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

Embodiment 73. A method of making a polymer membrane of embodiment 68, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

Embodiment 74. The method of embodiment 73, wherein a polymerization reaction between the first monomer and the second monomer occurs, thereby forming a polymer membrane on at least a portion of the substrate surface.

Embodiment 75. The method of embodiment 73, wherein steps (c) and (d) are repeated at least once, thereby adding one or more additional layers of polymer to the polymer membrane.

Embodiment 76. The method of embodiment 73, wherein the first monomer has a structure of Formula (II):

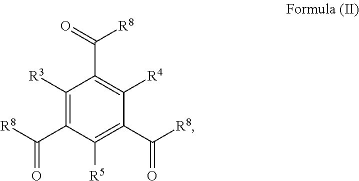

wherein
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl; and
wherein the second monomer has a structure of Formula (III).

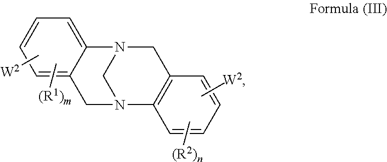

wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

Embodiment 77. A method for desalination of water, the method comprising: providing a polymer membrane of embodiment 68, and water, wherein the water comprises at least one salt; and passing the water through the polymer membrane to desalinate the water.

Embodiment 78. A polymer comprising repeat units, wherein the repeat units have a structure of Formula (IV):

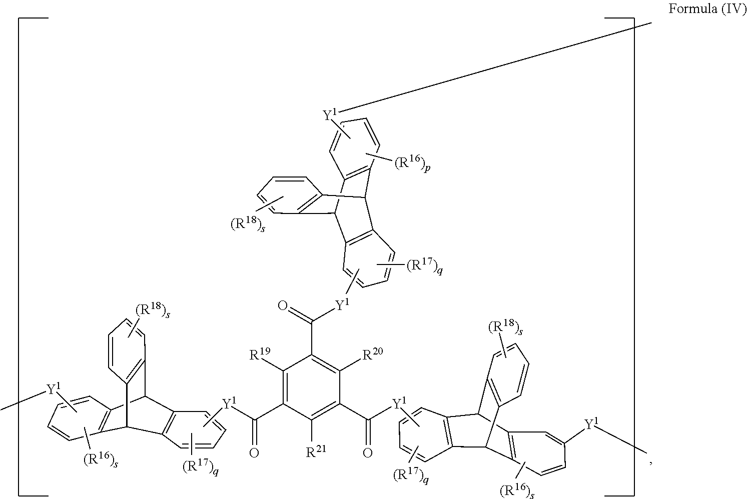

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group:
R¹⁹ is H, an electron withdrawing group, or an electron donating group;
R²⁰ is H, an electron withdrawing group, or an electron donating group;
R²¹ is H, an electron withdrawing group, or an electron donating group;
each Y¹ is independently O or NR²², wherein each R²² is independently H or optionally substituted alkyl;
p is 3;
q is 3; and
s is 4.

Embodiment 79. The polymer of embodiment 78, wherein the structure of Formula (IV) is a structure of Formula (IV-A):

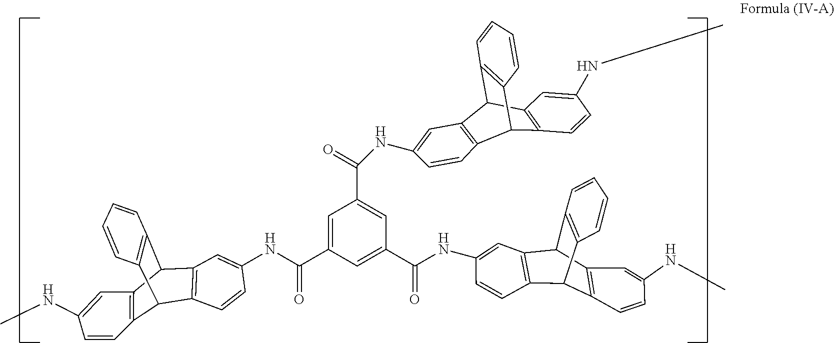

Embodiment 80. A polymer membrane comprising a polymer of embodiment 78.

Embodiment 81. A method of making a polymer membrane of embodiment 80, the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

Embodiment 82. The method of embodiment 81, wherein a polymerization reaction between the first monomer and the second monomer occurs, thereby forming a polymer membrane on at least a portion of the substrate surface.

Embodiment 83. The method of embodiment 81, wherein steps (b)-(e) are repeated at least once, thereby adding one or more additional layers of polymer to the polymer membrane.

Embodiment 84. The method of embodiment 81, wherein the first monomer has a structure of Formula (V):

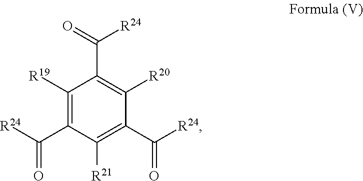

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl; and
wherein the second monomer has a structure of Formula (VI):

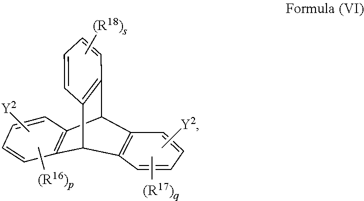

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 85. A method of making a polymer membrane of embodiment 80, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

Embodiment 86. The method of embodiment 85, wherein a polymerization reaction between the first monomer and the second monomer occurs, thereby forming a polymer membrane on at least a portion of the substrate surface.

Embodiment 87. The method of embodiment 85, wherein steps (c) and (d) are repeated at least once, thereby adding one or more additional layers of polymer to the polymer membrane.

Embodiment 88. The method of embodiment 85, wherein the first monomer has a structure of Formula (V):

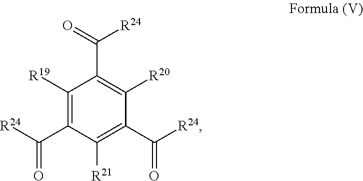

wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl; and
wherein the second monomer has a structure of Formula (VI):

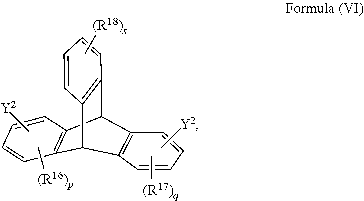

wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

Embodiment 89. A method for desalination of water, the method comprising: providing a polymer membrane of embodiment 80, and water, wherein the water comprises at least one salt; and passing the water through the polymer membrane to desalinate the water.

### EXAMPLES

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

### Example 1—Contorted Polyamide Membranes from Monophasic Polymerization with a Tröger's Base Diamine Monomer

Here we report that we synthesized polyamide (PA) polymers and membranes using sterically contorted “Tröger's base” diamine monomers, introducing enhanced free volume and microporosity compared to polyamide (PA) polymers synthesized with the conventional m-phenylenediamine monomer. Fabrication of polyamide (PA) films by a monophasic assembly process demonstrated control over film thickness and surface roughness, and importantly, illustrated that the formation of a reaction interface between an aqueous and an organic solution is not necessary for fabrication of polyamide (PA) membranes, thus broadening the polyamide (PA) chemistries that can be integrated into the membrane selective layer. The resulting contorted polyamide (PA) membranes exhibited a five-fold enhancement in water permeance compared to conventional polyamide (PA) membranes while maintaining excellent salt rejection.

### Work Performed:

### Synthesis of Contorted TBD Diamine Monomer and Polyamide Polymer

Sterically contorted, shape-persistent Tröger's base diamine (TBD) monomer was synthesized by facile and scalable two step synthetic route using a previously reported procedure (Z. Wang, D. Wang, F. Zhang, J. Jin, ACS Macro Lett. 2014, 3, 597). Polyamide polymer solids were prepared through monophasic reactions of TBD and TMC monomers in toluene. TMC and TBD solutions (0.4% wt/vol) were prepared separately and were combined in a flask to initiate the IP polycondensation reaction, which proceeded for 15 mins. After washing with acetone and drying, the PA solids were used for further characterizations. Polyamide powder from m-phenylenediamine (MPD) and TMC monomers, which are conventionally used and well characterized in the literature, was synthesized as a reference material.

### Fabrication of Contorted Polyamide Membranes

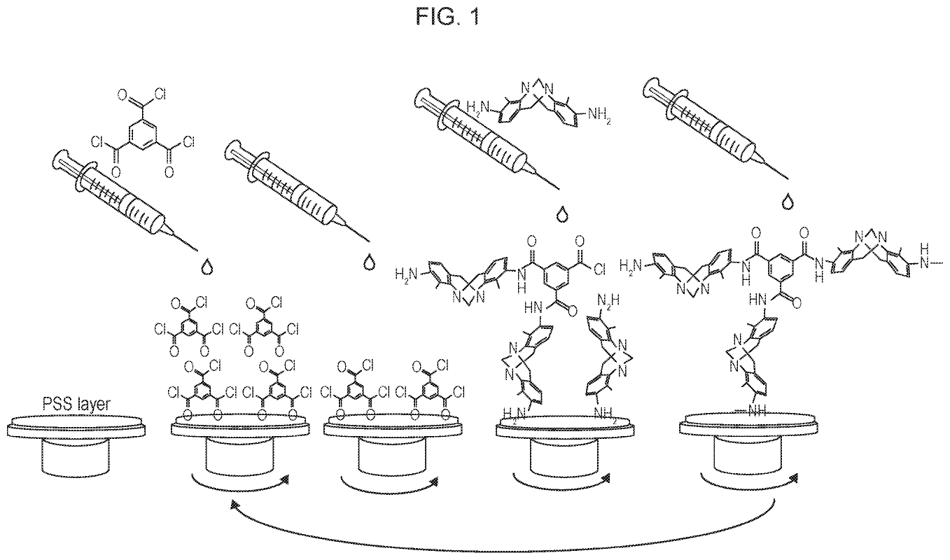

The ultrathin polyamide films were fabricated via a spin-assisted molecular layer-by-layer (mLbL) deposition process, (E. P. Chan, J.-H. Lee, J. Y. Chung, C. M. Stafford, Rev. Sci. Instrum. 2012, 83, 114102) as shown in FIG. 1.

The mLbL process enabled polyamide (PA) films to be fabricated by interfacial polymerization (IP) from mutually soluble, monophasic monomers, in contrast to the conventional interfacial polymerization (IP) method that relies upon the reaction of orthogonally soluble monomers at an immiscible aqueous-organic interface. A monophasic fabrication strategy is important for expanding polyamide (PA) chemistry beyond the MPD monomer to water-insoluble diamine monomers. Cleaned silicon wafers coated with 1.5% polystyrene sulfonic acid (PSS) in ethanol were used as substrates for polyamide film deposition. TMC and TBD or MPD monomer solutions were prepared as 0.4% wt/vol in toluene, loaded into gas-tight syringes, and deposited layer-by-layer onto the silicon wafer substrate inside a spin coater. One deposition cycle consisted of sequential deposition of TMC onto the substrate, rinsing by dry toluene, deposition of TBD or MPD monomer solution, and finally rinsing by dry acetone. After depositing a prescribed number of polyamide (PA) layers, the PA-coated silicon substrate was immersed in water bath where the polyamide (PA) film detached from silicon wafer due to dissolution of the PSS release layer. The free-standing polyamide (PA) film was captured on either a polyacrylonitrile (PAN) support membrane to form a thin-film composite membrane or on a silicon substrate for further characterization.

### Characterization of Contorted Polyamide Polymers and Membranes

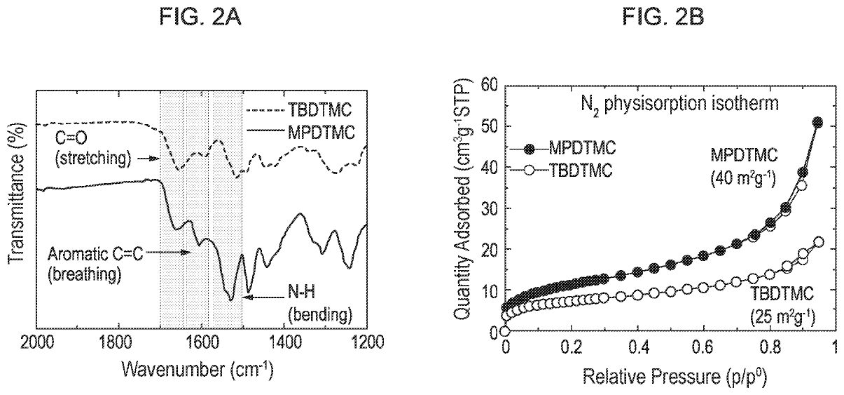

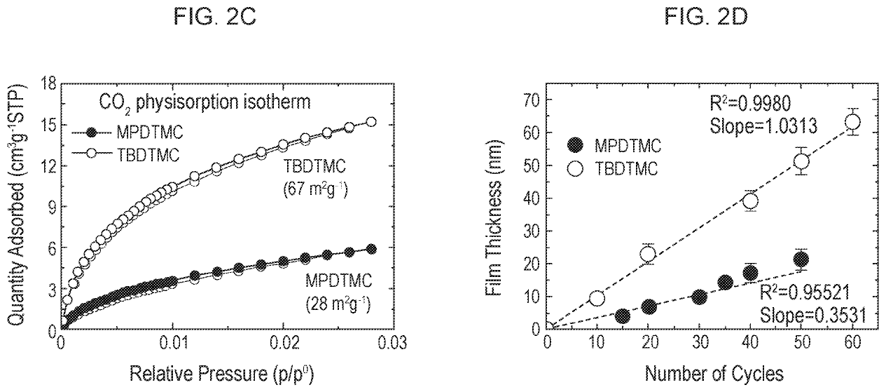

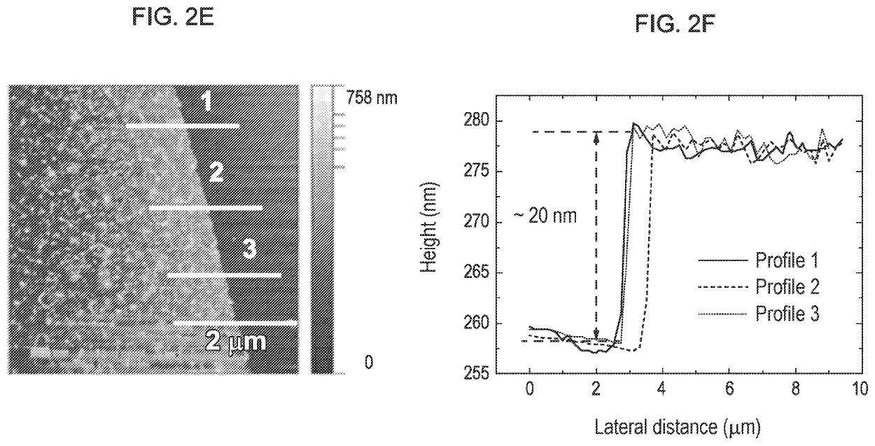

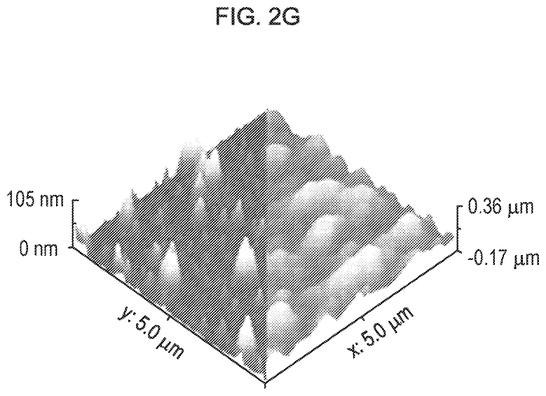

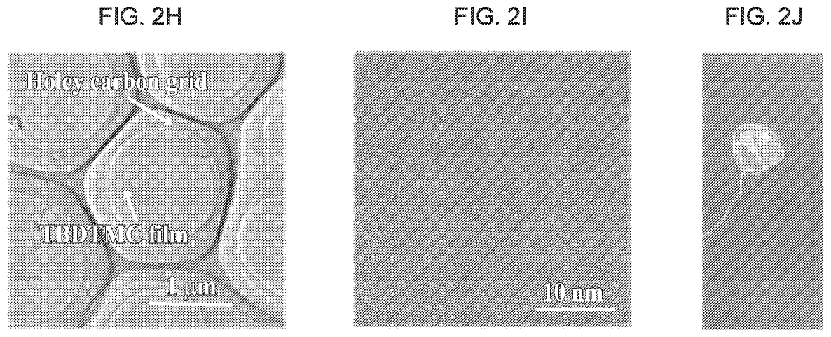

The successful formation of polyamide (PA) polymers was confirmed from the Fourier transform-infrared (FT-IR) spectra, as shown in FIG. 2A. In comparison to the spectra of the starting monomers, the polyamide (PA) polymers showed the disappearance of the C═O stretching peaks for TMC at 1738-1777 cm⁻¹, the emergence of C═O stretching peaks at 1661 cm⁻¹ that are characteristic of the amide bond, and the appearance of an amide N—H bending peak at 1541 cm⁻¹. The porosity of the fabricated polyamide (PA) polymer powders was assessed by measuring gas adsorption isotherms for N₂ at 77K and for CO₂ at 273K and calculating the associated Brunauer-Emmett-Teller (BET) surface areas (FIG. 2B, FIG. 2C). The CO₂ adsorption isotherms are most indicative of the BET surface areas of the polymer networks because CO₂ has a smaller kinetic diameter than N₂ (3.3 Å and 3.64 Å, respectively), enabling CO₂ molecules to access more of the polymer microporous structure. Additionally, the higher temperature used for CO₂ adsorption imparts a significant kinetic energy to the molecules, enabling them to enter into the narrow pores (H. Qian, J. Zheng, S. Zhang, Polymer 2013, 54, 557). The CO₂ adsorption isotherm for contorted TBDTMC polyamide displayed more than double the accessible surface area (67 m² g⁻¹) than the conventional MPDTMC polyamide (28 m² g⁻¹), which is attributed to increased free volume in the polymer resulting from the contorted geometry of the Tröger's base molecule. The measured surface area of TBDTMC polyamide is substantially smaller than the reported surface areas of classical PIMs (~800 m² g⁻¹ calculated from N₂ adsorption isotherm) (Z. Ali, B. S. Ghanem, Y. Wang, F. Pacheco, W. Ogieglo, H. Vovusha, G. Genduso. U. Schwingenschlögl, Y. Han, I. Pinnau, Adv. Mater. 2020, 32, 2001132). However, the enhanced free volume in TBDTMC polyamide compared to its more conventional MPDTMC polyamide counterpart resulted in significantly increased water permeance while maintaining excellent salt rejection.

The growth rates of the TBDTMC and MPDTMC polyamide films by the mLbL deposition process were measured by interferometry. Both polyamide (PA) films exhibited a linear growth rate as a function of the number of cycles (FIG. 2D), with the MPDTMC growth rate of 0.35 nm/cycle (D. L. Shaffer, K. E. Feldman, E. P. Chan, G. R. Stafford, C M. Stafford, J. Membr. Sci. 2019, 583, 248). Varying the diamine monomer backbone from a phenyl ring in MPD to a more rigid and contorted Troger's base structure in TBD resulted in significant increase in the growth rate from 0.35 to 1.05 nm/cycle. The molecular layer deposition chemistries with more flexible backbones exhibit a greater number of terminations than more rigid backbones resulting in overall reduction in their growth rate (D. S. Bergsman, R G. Closser, C. J. Tassone, B. M. Clemens, D. Nordlund, S F. Bent, Chem. Mater. 2017, 29, 1192). The linear growth rates demonstrated that ultrathin (<20 nm) functional polyamide (PA) films with targeted thicknesses can be fabricated by mLbL deposition. To compare their separation performance, thin-film composite membranes with similar thicknesses of MPDTMC and TBDTMC selective layers (~22.5 nm for MPDTMC and ~20 nm for TBDTMC) were fabricated.

The thickness and surface morphology of the polyamide (PA) nanofilms were measured by atomic force microscopy (AFM) (FIG. 2E, FIG. 2F). Film thickness was measured as the height difference between the silicon wafer substrate and upper nanofilm surface, and surface roughness of the films was measured by AFM software. Due to the controlled nature of the mLbL deposition process, MPDTMC and TBDTMC polyamide (PA) films have a root mean squared (RMS) surface roughness an order of magnitude less than that of commercial interfacial polymerization (IP) desalination membranes (FIG. 2G). Low and high-resolution transmission electron microcopy (TEM) images (FIG. 2H, FIG. 2I) provided further insight into the structure of the TBDTMC film. The films were transparent compared to a carbon support, and high-resolution images (FIG. 2I) indicated a smooth, continuous, dense film. The selected area electron diffraction pattern from TEM indicated the amorphous, rather than crystalline, structure of both the MPDTMC and TBDTMC polyamides for these cross-linked network polymers.

### Contorted Polyamide Membrane Desalination Performance

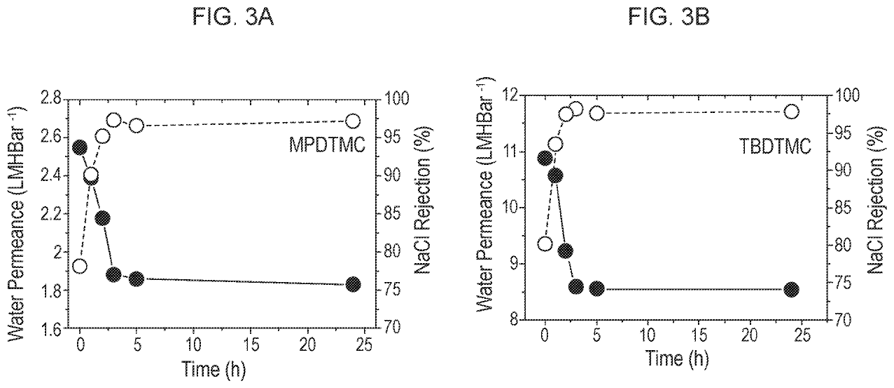

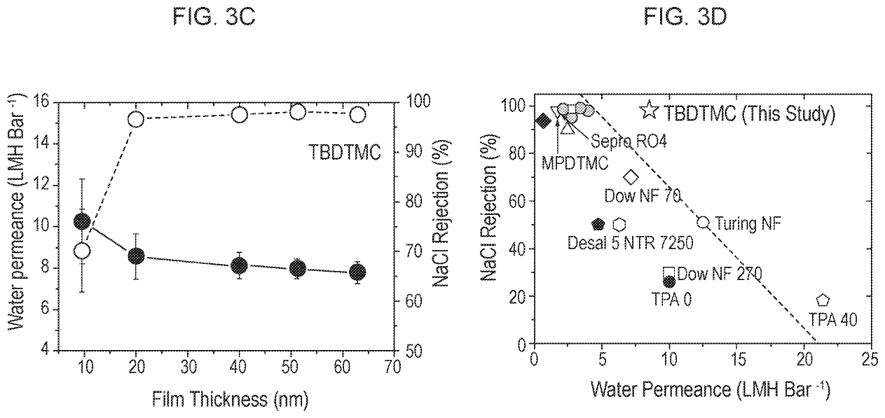

The desalination performance of both the MPDTMC and TBDTMC thin-film composite polyamide (PA) membranes (supported on PAN) was assessed by dead-end filtration testing with a 2,000 mg L⁻¹ aqueous NaCl solution at pressures ranging from 15-20 bar. The time-dependent water permeances and salt rejections for ~20 nm thick TBDTMC and MPDTMC membranes are shown in FIG. 3A, FIG. 3B. The water permeances for both polyamide (PA) membranes rapidly decreased within first 4-5 hours of testing to stable values, while salt rejection increased over the same period. This initial period of permeance decline and increasing salt rejection indicates compaction of the polyamide (PA) film structures under applied hydraulic pressure. The TBDTMC membrane fabricated with the bulkier, sterically contorted Tröger's base diamine monomer demonstrated a significantly higher water permeance of 8.6 L m⁻² h⁻¹ bar⁻¹ compared to the 1.8 L m⁻² h⁻¹ bar⁻¹ permeance of the conventional MPDTMC membrane. Surprisingly the contorted TBDTMC polyamide achieved this five-fold increase in permeance while maintaining excellent salt rejection of 97.8%, similar to the 97.2% rejection observed for the MPDTMC membrane. Without being bound by theory, the higher permselectivity of the TBDTMC membrane compared to the conventional MPDTMC membrane is attributed to its increased free volume in the polyamide film, which increased the transport of water but maintained the exclusion of larger hydrated ions (Z. Ali, B. S. Ghanem, Y. Wang, F. Pacheco, W. Ogieglo, H. Vovusha, G. Genduso, U. Schwingenschlögl, Y. Han, I. Pinnau, Adv. Mater. 2020, 32, 2001132).

The water permeance and salt rejection of the TBDTMC membrane was also measured as a function of the thickness of the polyamide (PA) selective layer (FIG. 3C). As the selective layer thickness increased from 20 nm to 60 rnm, water permeance gradually decreased from 8.5 to 8.0 L m-2 h⁻¹ bar⁻¹ while NaCl rejection maintained constant at 96.9% to 97.3%. The results reinforce the improved permselectivity of TBDTMC membranes compared to conventional polyamide (PA) desalination membranes, and they indicate that a minimum selective layer thickness of 20 nm is required to achieve desalination performance. When compared to the water permeances and salt rejections of current state-of-the-an commercial desalination membranes (FIG. 3D), the 20 nm thick contorted TBDTMC polyamide membrane achieves a significantly higher permselectivity, as illustrated by its plotted position far exceeding the current permeability selectivity tradeoff line for water permeance and NaCl rejection.

### Implications of Preliminary Studies for Development of Contorted Polyamide Membranes

The successful interfacial polymerization (IP) synthesis of polyamide (PA) polymers and thin films from contorted Tröger's base diamine (TBD) monomer demonstrates the feasibility of expanding polyamide chemistry beyond conventional MPD diamine to include alternative diamine monomers that are water insoluble but are amenable to monophasic IP processes. The preliminary studies establish that monophasic polymer assembly processes like mLbL deposition can achieve smooth, ultrathin PA films with controlled thicknesses. The increased BET surface area of the contorted TBDTMC polymer compared to the conventional MPDTMC polymer confirms the increased free volume imparted by the sterically contorted, shape-persistent TBD monomer. This free volume translates to significantly higher water permeance for the TBDTMC polyamide (PA) membrane with equivalent salt rejection to the conventional MPDTMC polyamide (PA) membrane, with a resulting permselectivity that exceeds the permeability-selectivity tradeoff of commercial desalination membranes. The approach demonstrated in the preliminary studies provides a platform for using bulky, contorted monomers to enhance free volume in polyamide (PA) films and to create defect-free, larged-area contorted PA membranes with improved permselectivity for higher throughput and enhanced desalination performance.

### Example 2—Control Polyamide Free Volume Through Incorporation of Sterically Hindered Contorted Monomers

### Goals/Work Outline

The conventional interfacial polymerization (IP) process for synthesizing polyamide desalination membranes relies solely on water soluble diamine monomers, such as MPD, which excludes potential water insoluble monomers that may outperform the state-of-the-art polyamide (PA) membrane chemistry. Alternative polyamide membranes fabricated from water insoluble contorted diamine monomers have not been demonstrated for desalination applications. Research in Objective #1 will address this knowledge gap by employing contorted diamine monomers to systematically vary the free volume in polyamide (PA) membranes fabricated by monophasic (in a single solvent system) polymerization. The working hypothesis is that direct integration of contorted monomers into the polyamide (PA) network will enhance the free volume, ultimately increasing the water permeance of the fabricated polyamide (PA) membranes. The outcomes of Objective #1 are a fundamental understanding of the influence of monomer structure on polyamide (PA) polymer free volume and network structure.

### Task 1A—Design and Synthesize Contorted Monomers and Polyamide Polymers.

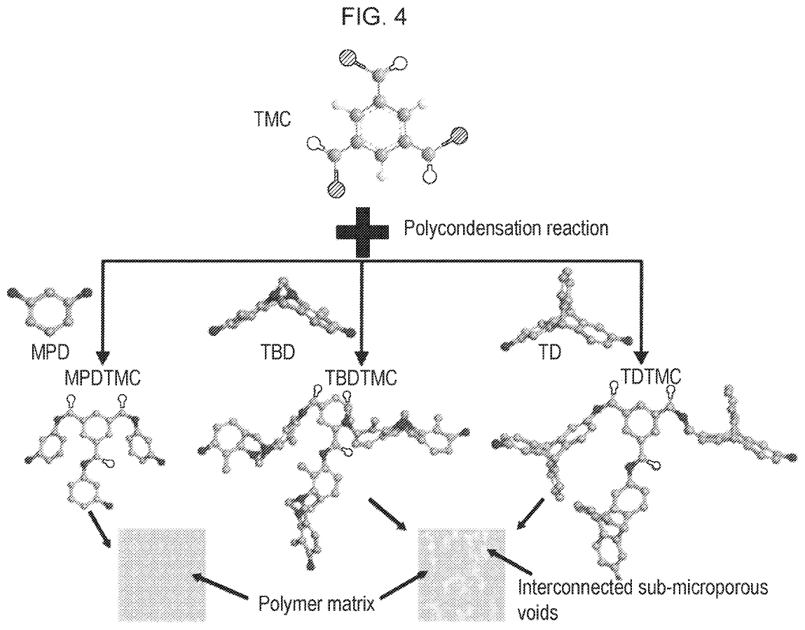

Triptycene, a member of the iptycene family, and Tröger's base are the most promising monomer building blocks currently employed in the design of microporous polymers because of their uniformly structured internal fractional free volume (Z. Wang, D. Wang, F. Zhang, J. Jn, ACS Macro Lent. 2014, 3, 597). The diamines derived from these units will be synthesized by facile and scalable two step synthetic route from inexpensive starting materials as reported in the literature (S. Mondal, N. Das, RSC Adv. 2014, 4, 61383). Powdered polyamide solids will be prepared through monophasic reactions described in the Preliminary Studies (Section 2.6.1) for use in further polymer characterizations. Conventional polyamide synthesized from MPD monomer will serve as a control. The syntheses of these polyamides are illustrated in FIG. 4.

### Task 1B—Characterize Synthesized Contorted Monomers and Polymers.

The chemical structures and purity of the synthesized monomers and polyamide (PA) polymers will be assessed by FT-IR and nuclear magnetic resonance (NMR) spectroscopy. Nitrogen (N₂) and carbon dioxide (CO₂) physisorption experiments will be conducted to determine the porosity in the bulk polyamide (PA) polymers and to calculate their BET surface areas. The porous structural characteristics will be further characterized by X-ray diffraction (XRD) analysis of the powdered polymer samples, conducted with 20 ranging from 10 to 40° The average chain spacing (dsp) will be calculated using Bragg's law to compare the structures of polyamide (PA) polymers synthesized from contorted (TBD and TD) and non-contorted (MPD) diamine monomers. The degree of cross-linking in the polyamides will be estimated from XPS measurements of their atomic compositions. Characterization results will be used to confirm synthesis of the MPDTMC, TBDTMC, and TDTMC polyamide polymers. Free volume in the contorted polyamide polymers is correlated with BET surface areas and calculated average chain spacings, which are hypothesized to increase for increasingly contorted diamine structures: MPDTMC<TBDTMIC<TDTMC.

### Example 3—Fabricate Contorted Polyamide Membranes by Monophasic Electrospray Deposition (MED)

### Goals/Work Outline

The expansion of polyamide membrane chemistry to include contorted diamine monomers must be accompanied by scalable processes to translate these new chemistries into functional membrane materials. The tasks in Objective #2 will optimize conditions for fabricating contorted polyamide (PA) membranes using an electrospray deposition process that can accommodate monophasic systems, such as the contorted polyamide (PA) polymers synthesized in Objective #1. The effects of process parameters and reaction conditions on polyamide (PA) film properties will be quantified. The structures properties of contorted polyamide (PA) membranes will be characterized and their desalination performance will be assessed for subsequent transport modeling.

### Task 2A—Optimize Monophasic Electrospray Deposition (MED) Process Parameters.

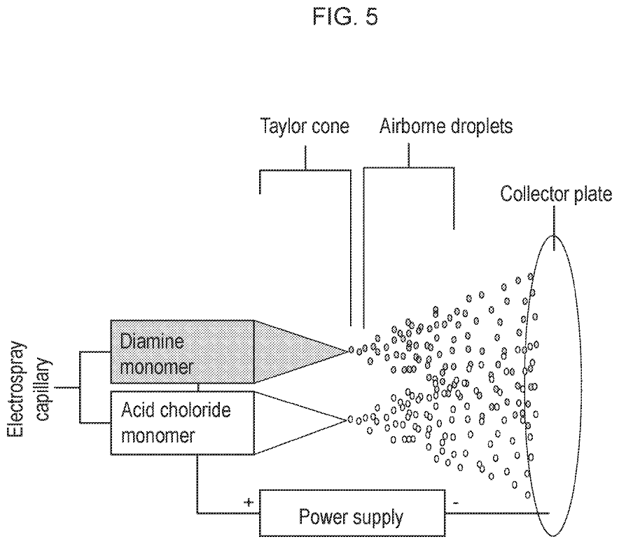

Large-area polymer films will be fabricated using a solution-based monophasic electrospray deposition (MED) process incorporating sequential steps of alternating monomer solution deposition. Electrospray deposition has been previously reported for nanofiltration, (L. Shan, J. Gu, H. Fan, S. Ji, G. Zhang, ACS Appl. Mater. Interfaces 2017, 9, 44820), pervaporation, (R. Wang, L. Shan, G. Zhang, S. Ji, J. Membr. Sci. 2013, 432, 33), and reverse osmosis membranes (X.-H. Ma, Z. Yang, Z.-K. Yao, H. Guo, Z.-L. Xu, C. Y. Tang, Environ. Sci. Technol. Lett. 2018, 5, 117). Compared to liquid deposition or substrate immersion approaches, the monophasic electrospray deposition (MED) process will allow monomers to be used more effectively with less waste, allowing for a more sustainable production process. Analogous to the mLbL deposition process, the monophasic electrospray deposition (MED) method will enable the fabrication of smooth, ultrathin polyamide films by controlling the diffusion of monomers by phase interface engineering. Films will be fabricated using a custom-built electrospray deposition apparatus with monomer solutions sequentially discharged from syringes across an air gap with an applied potential to deposit on a rotating drum or flat plate collector. A schematic of the solution-based electrospraying process for fabricating large-area contorted polyamide films is shown in FIG. 5.

The improved dispersion of the monomers in fine microdroplets during electrospray polymerization will enable the creation of an ultrathin polyamide selective layer with smooth surface. The thickness of selective layer will be affected by the applied potential across the air gap, the distance between the syringe discharge and the collector, and the electrospray deposition time. The monophasic electrospray deposition (MED) process parameters will be systematically varied to determine the optimal conditions for controlled deposition of uniform polyamide films.

### Task 2B—Quantify Effects of Monomer Concentrations and Deposition Rates on Contorted Polyamide Film Thickness.

In addition to the monophasic electrospray deposition (MED) process parameters explored in Task 2A, the monomer solution concentrations and monomer solution discharge rates are hypothesized to influence the thickness and uniformity of the deposited polyamide (PA) films. In Task 2B, the thickness and surface roughness of MPDTMC, TBDTMC, and TDTMC polyamide films deposited under systematically varied monomer solution concentrations and discharge rates will be measured by AFM. Film properties will be correlated to reaction conditions to quantify the effects of monomer concentration and electrospray rate on polyamide (PA) film properties. The information gained will provide a better understanding of the monophasic electrospray deposition (MED) process for fabricating contorted polyamide (PA) films and will identify mechanisms to control deposited film thicknesses within the optimal monophasic electrospray deposition (MED) process parameters defined in Task 2A. Equivalent polyamide (PA) film thicknesses will be targeted for desalination membranes fabricated from the MPDTMC, TBDTMC, and TDTMC polyamide chemistries to provide an equivalent basis for their comparison.

### Task 2C—Characterize the Structure and Properties of Contorted Polyamide Membranes.

Thin-film composite membranes will be fabricated from contorted polyamide (PA) films created using the optimized monophasic electrospray deposition (MED) process and reactions conditions. Polyamide films will either be directly deposited by monophasic electrospray deposition (MED) onto supporting membrane substrates that are adhered to the collector, or they will be fabricated by transferring the deposited polyamide (PA) film from the collector onto the supporting membrane. Potential transfer techniques include floating the film on a water bath, or by direct transfer of the polyamide (PA) film from a non-adhering substrate, such as aluminum foil, onto a membrane support. The resulting contorted polyamide (PA) membranes will be characterized using the techniques as described above herein, including determining BET surface area and average distance between polymer chains from XRD analysis as indicators of polyamide free volume. In addition, water contact angles will be measured to assess the hydrophilicity of the different contorted polyamide (PA) membranes, and streaming potential will used to measure membrane surface charge by the Helmholtz-Smoluchowski equation. The structure and property characterizations performed in Task 2C will be correlated to estimates of contorted polyamide (PA) membrane free volume to better understand the changes in free volume that dictate performance.

### Task 2D—Demonstrate the Desalination Performance of Contorted Polyamide Membranes.

The permselectivities of the contorted polyamide (PA) membranes will be assessed by measuring their permeances and salt rejections when desalinating aqueous solutions of NaCl and different divalent salts such as MgCl₂, MgSO₄, Na₂SO₄, and CaCl₂ at concentrations of 2,000 mg L⁻¹. A cross-flow filtration system with an effective membrane area (A) of 20 cm² will be used for performance testing. After steady-state flow conditions have reached, permeances (L m⁻² h⁻¹ bar¹) will calculated as the permeate fluxes normalized by the applied hydraulic pressure. Salt rejection will be determined from the NaCl concentration in the feed (Cf) and the permeate (Cp), using the equation: Salt rejection (%)=100×(1−(Cp/Cf), where NaCl concentrations will be measured by correlation to a conductivity measurement. The effect of polyamide (PA) selective layer thickness (obtained by variation in monomer concentration and electrospray rate) on water permeance and salt rejection of membrane will be investigated to optimize these variables to achieve contorted polyamide (PA) membranes with high permselectivities. Long-term continuous performance of water permeance and salt rejection will also be studied to assess membrane stability. The measured permeabilities and salt rejections of the contorted polyamide (PA) membranes will be correlated to the membrane structures and properties characterized in Task 2D to establish the hypothesized role of polyamide free volume in enhancing membrane desalination performance.

### Example 4—Relate the Permeability-Selectivity Performance of Contorted Polyamide Membranes to Solution-Diffusion Transport

The controlled thicknesses and tunable free volumes of contorted polyamide (PA) membranes present an opportunity to relate observed membrane permeability-selectivity performance to structural characteristics of the polyamide selective layer. The tasks in Example 4 will model desalination performance data for contorted polyamide (PA) membranes to provide insight into solution diffusion transport behavior in polyamide membranes.

Task 3A—Measure Water and Salt Permeabilities of Contorted Polyamide Membranes with Controlled Thicknesses.

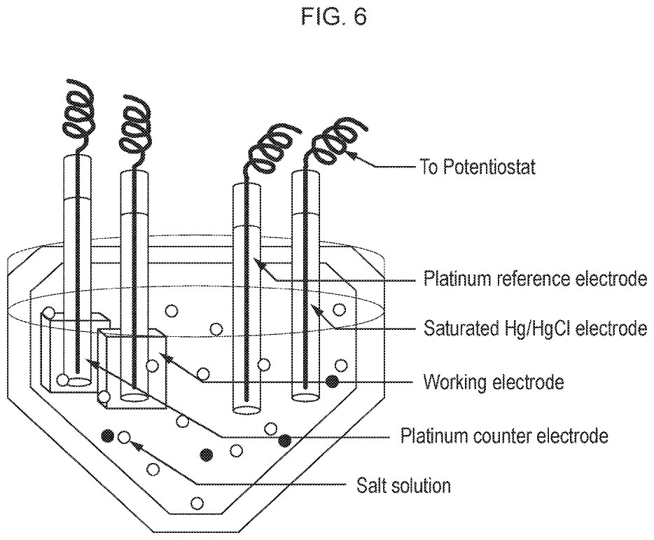

In solution-diffusion transport through polyamide desalination membranes, the diffusive component governs water and salt transport through the polyamide (PA) selective layer, rather than the solubility component (G. M. Geise, H. B. Park, A. C. Sagle, B. D. Freeman, J. E. McGrath, J. Membr. Sci. 2011, 369, 130). However, a mechanistic understanding of how polymer network properties affect diffusivity selectivity is lacking because of the inherent challenges in measuring salt transport through thin films at diffusion timescales. In Task 3A, an electrochemical impedance spectroscopy technique will be used to directly measure salt permeability through contorted PA thin films (D. L. Shaffer, K. E. Feldman, E P. Chan, G. R. Stafford, C. M. Stafford, J. Membr. Sci. 2019, 583, 248). Polyamide (PA) films of known thickness will be directly deposited on gold working electrodes and immersed in electrolyte solution. The impedance of the films will be interrogated across a range of frequencies at a constant applied voltage. The impedance results may be modeled with an equivalent circuit to identify a unique resistance attributed to the polyamide (PA) film (S. Bason, Y. Oren, V. Freger, J. Membr. Sci. 2007, 302, 10). From this resistance, salt permeability can be calculated assuming simple planar dielectric behavior The direct measurement of salt permeability, rather than salt rejection or salt passage, will be combined with conventionally measured water permeabilities for contorted polyamide (PA) membranes of known thicknesses and varying free volumes. The results will be used to provide insight into how free volume influence salt diffusivity and resulting membrane permselectivity. See FIG. 6.

Task 3B—Describe the Permeability-Selectivity Tradeoff in Contorted Polyamide Membranes with a Free-Volume Solution-Diffusion Model.

Free volume models of water and salt diffusivity in swollen polymer networks will be fit to the experimental data set of structural characteristics and measured water and salt permeabilities for the contorted polyamide thin films and membranes (H. Zhang, G. M. Geise, J. Membr. Sci. 2016, 520, 790). With well characterized polyamide free volumes and measured diffusivity-dominated salt permeabilities, the free volume model of salt permeability can be simplified to a single parameter model whose fit to experimental data provides insights into the size of the diffusing salt. Similarly, free volume models of water diffusivity-driven transport can identify characteristic volume parameters for the different contorted polyamide (PA) membranes that provides insight into the diffusive jump path lengths for diffusing water molecules (H. Zhang, G. M. Geise, J. Membr. Sci. 2016, 520, 790). When combined, these free volume models can provide insight into the polyamide structural characteristics that dictate its solution-diffusion transport and observed permeability-selectivity tradeoff. The results of solution-diffusion modeling will provide guidance for further expanding the chemistry of desalination membrane materials to improve permselectivity.

### Equipment

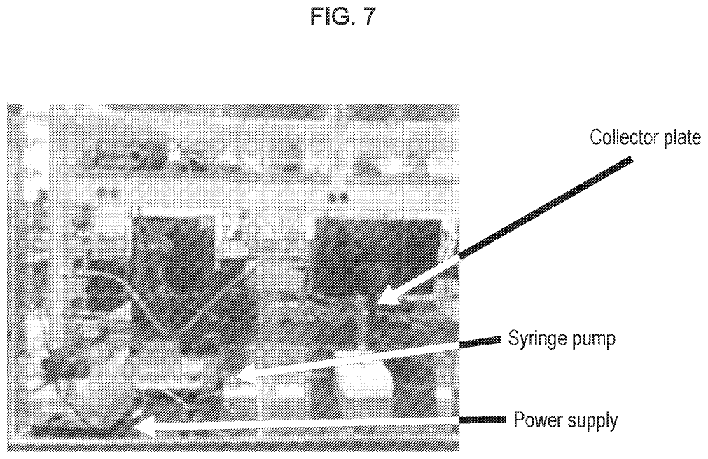

Monophasic electrospray deposition technique: A custom-built electrospray setup will be modified for polyamide (PA) fabrication (FIG. 7). Pumps mounted with syringes containing different monomer solutions will be used to fabricate thin polyamide (PA) films. The distance between collector plate, syringe pumps as well as applied voltage and concentration will be optimized during fabrication. The collector plate will be replaced with rotating drum for lab-scale roll-to-roll manufacturing of polyamide (PA) films.

Spin-assisted, solution-based, molecular layer-by-layer deposition system: A custom-built spin-assisted, solution-based, molecular layer deposition (MLD) system will be used to fabricate thin polymer films. The system comprises a spin processor (WS-650, Laurel Technologies) with four syringe pumps (NE-500, New Era Pump Systems) mounted to the spin processor lid. Control of the spin processor and pumps is integrated with a LabView program that enables coordination of solution depositions and substrate spinning with adjustable spin speeds and deposition and spin times.

Fourier transform-infrared (FT-IR) spectroscopy: The FT-IR measurement of monomers and polymers proposed in Objectives #1 will be carried out on the FT-IR instrument. The spectrometer has range of 7800 cm⁻¹ to 350 cm⁻¹ and capable of direct analysis of films, powders and liquids.

Streaming potential analyzer: The AntonPaar SurPASS3 streaming potential analyzer equipped with adjustable gap cell assembly employs streaming potential and streaming current methods for analysis of the zeta potential of solid surfaces. The instrument software calculates surface zeta potential from streaming potential measurements using the Helmholtz-Smoluchowski equation. Streaming potential measurements are proposed in Task 2B for estimating the surface charge PA membranes.

Contact angle goniometer: The hydrophilicity of various polyamide (PA) membranes proposed in Task 2C will be assessed by contact angle goniometer consisting Basler CMOS digital cameras equipped with magnifying lens. Digital images are captured using Pylon camera software. Contact angles are measured by image analysis using the Contact Angle plugin for ImageJ software.

High-pressure dead-end membrane filtration testing system: A stainless steel, high-pressure dead-end filtration system consists of a Sterlitech HP4750 stirred cell that is pressurized from a compressed gas cylinder. For testing proposed in Objective #1 and #2, membranes supported on a porous metal frit, are pressurized and the collected permeate volume is measured overtime. The active membrane area for testing is either 14.6 cm² or 2.24 cm².

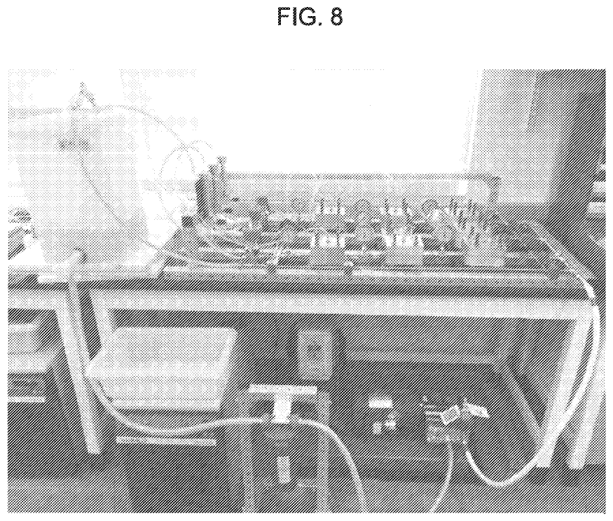

High-pressure cross-flow filtration system for membrane filtration testing: The high-pressure cross-flow filtration system (FIG. 8) is custom-built and six membranes may be characterized simultaneously from three parallel pressurized lines that are fed from a common header. A 20 L reservoir feeds solution to a positive displacement pump equipped with variable frequency drive to control pump speed. Pressure sustaining valves maintain pressure in the system, which is rated for operation up to 500 psi. Cross flow rate is adjusted by adjusting pump speed and modulating the flow through a bypass valve. The flowrate from each line can be automatically measured by connecting the permeate line to a Tovatech 2000 liquid flowmeter, which has a measurement range of 0.05-25 mL/min. Use of the high-pressure cross-flow membrane filtration system is proposed in Task 2D for evaluation desalination performance of polyamide (PA) membranes.

### Electrochemical Impedance Spectroscopy (EIS) System

The system consists of a potentiostat (1010E, Gamry Instruments) and three-probe measurement cell. The potentiostat measures impedance in the frequency range 10 Hz-2 MHz at applied potentials ±12 V. Gold-coated silicon wafers will be used as the working electrode, platinum wire will be the counter electrode, and silver-silver chloride will serve as the reference electrode.

X-ray powder diffraction analysis (XRD) as proposed in Objective I will be carried out on X-ray scattering (SAXS) measurements made using a Rigaku S-Max 3000 instrument whereas Physisorption studies proposed in Task 1B will be conducted on Micromeritics 3-Flex instrument with VacPrep degassing system.

Nuclear magnetic resonance (NMR) spectroscopy (JEOL-ECX-400P 400 MHz NMR spectrometer, Chemistry Department) will be used for monomer characterization as proposed in Task 1A. X-ray photoelectron spectroscopy (XPS) (PHI 5700 XPS spectrometer with a monochromatic Al Kα X-ray source, Department and Earth and Atmospheric Sciences Department) will be used for membrane characterization as proposed in Task 1B.

### Overview and Objectives of Example 5-Example 7

The proposed research aims to overcome the permeability-selectivity tradeoff that performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable monophasic electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by monophasic electrospray deposition (MED); Task #3—Relate the permeability-selectivity performance of contorted polyamide membranes to solution-diffusion transport.

### Example 5—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

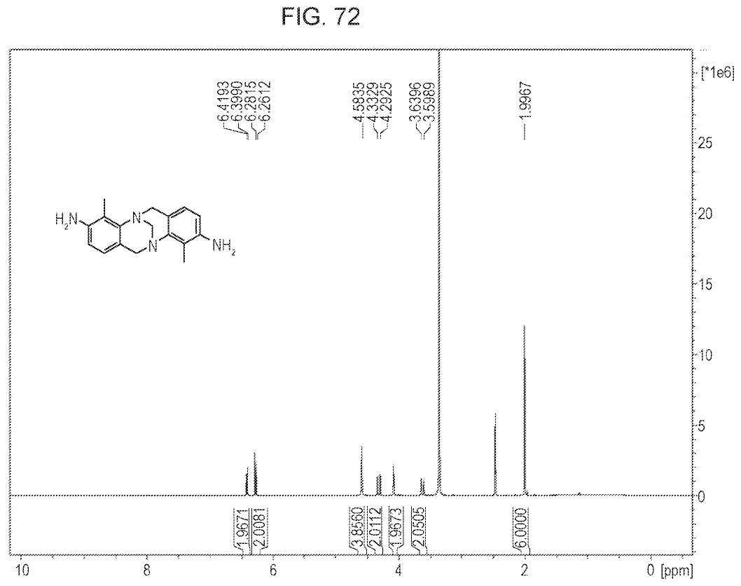

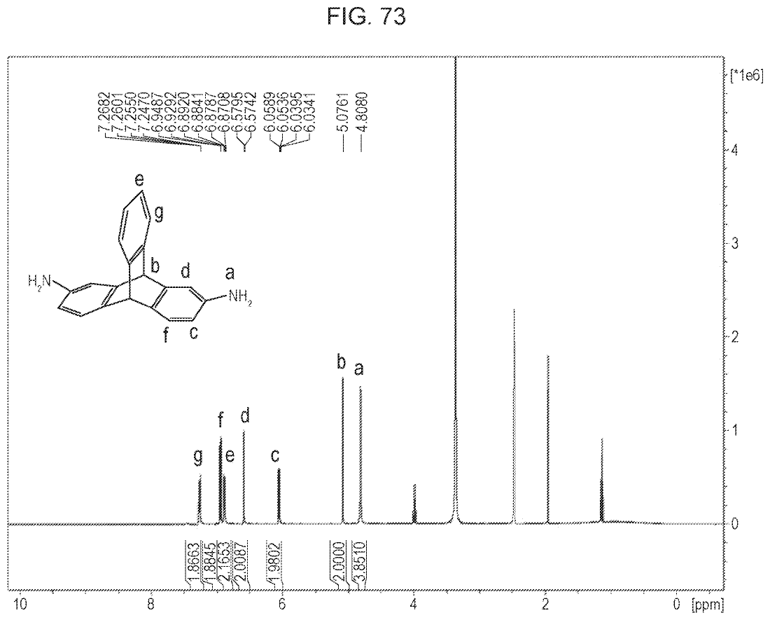

The synthesis of custom contorted diamine monomers (TBD and TYD) was completed. The chemical composition of the contorted diamine monomers (TBD and TYD) was verified by NMR spectroscopy. The NMR spectra are shown in FIG. 72 and FIG. 73.

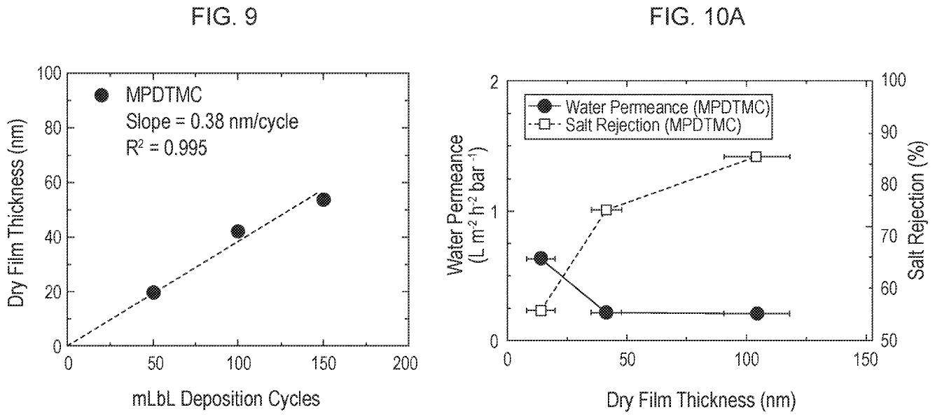

Commercially available MPD monomer was used to fabricate conventional MPDTMC polyamide thin films using a monophasic solution-based mLbL deposition process. Polyamide thin films with controlled thicknesses will be used for measuring water and salt permeabilities, and the conventional MPDTMC polyamide will serve as a reference to which to compare the properties of the contorted polyamide films. The MPDTMC film growth rate in the solution based mLbL deposition process was measured as 0.38 nm/cycle, as illustrated in FIG. 9.

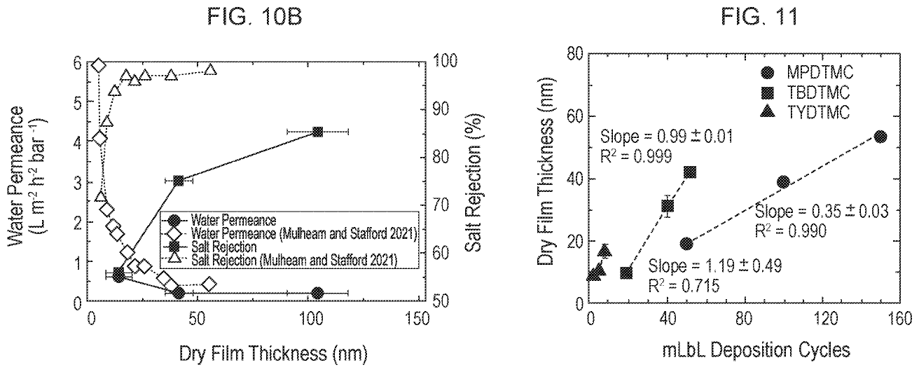

Thin-film composite MPDTMC membranes were fabricated by capturing free-standing MPDTMC films from a water bath onto a polyacrylonitrile porous support. The water permeance and salt (sodium chloride) rejection were measured for the MPDTMC membranes in a crossflow membrane filtration system, and the results are shown in FIG. 10A as a function of MPDTMC film thickness. Desalination performance of the MPDTMC membranes are compared in FIG. 10B to recently published results from Mulhearn and Stafford (ACS Appl. Polym. Mater. 2021, 3, 116-121) who fabricated membranes using a similar solution-based mLbL deposition process and identical MPDTMC chemistry but tested the membranes in a dead-end filtration cell.

Water permeance decreases and salt rejection increases as a function of MPDTMC membrane thickness (FIG. 10A), for the solution-diffusion transport of water and salt penetrants through the dense MPDTMC polyamide film. The permselectivity of the MPDTMC membranes is less than that of similar membranes reported by Mulhearn and Stafford.

As shown in FIG. 10B, the MPDTMC membranes from this work have lower water permeability and lower salt rejection than membranes of equivalent thickness reported by Mulhearn and Stafford. The reduced permselectivity of the MPDTMC membranes compared to previous literature results could be the result of defects in the mLbL-fabricated MPDTMC films or possible damage to the membranes during testing in the cross-flow filtration system. Additional MPDTMC films will be fabricated and characterized to achieve MPDTMC membranes with better desalination performance and to optimize the fabrication and testing techniques prior to experimenting with contorted TBDTMC and TDTMC polyamides.

### Example 6—Fabricating Membranes by Monophasic Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed:

Initial tests were performed to begin optimizing the monophasic electrospray deposition process. Thin films of conventional MPDTMC polyamide were fabricated by electrospraying MPD and TMC solutions of 0.2% by mass of monomer in toluene solvent. A single needle emitter was used for each solution. Electrospraying was performed at a monomer solution discharge rate of 20 uL/min with an applied voltage of 11 kV. The electrosprayed polyamide was collected on aluminum foil mounted to a drum collector rotating at 50 rpm.

The resulting electrosprayed MPDTMC film was visually non-uniform with a thick region of deposited polyamide film near the fixed needle emitters, and thinner incomplete polyamide film deposition far from the fixed emitters. Varying the monomer solution discharge rates and applied voltage did not improve the uniformity of the deposited polyamide film. To achieve more uniform deposition of the electrosprayed polyamide, a motor-driven linear slide will be acquired and installed. The monomer solution emitters will be mounted to the slide for controlled motion along the length of the rotating collector drum during electrospraying. The conventional MPDTMC polyamide system will continue to be used to optimize the monophasic electrospray deposition process before experimenting with TBDTMC and TYDTMC contorted polyamides.

### Example 7—Relating Membrane Performance to Solution-Diffusion Transport

### Continuing Work:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport.

When combined, these free volume models will relate the structural characteristics of the polyamide selective layer to solution-diffusion transport behavior. Transport modeling will commence when desalination performance data are collected for the contorted polyamide membranes.

### Overview and Objectives of Example 8—Example 10

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable monophasic electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by monophasic electrospray deposition (MED); Task #3—Relate the permeability-selectivity performance of contorted polyamide membranes to solution-diffusion transport.

### Example 8—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

Growth rates for TBDTMC and TYDTMC polyamide films were quantified by measuring the thickness of films deposited on silicon wafer substrates at different mLbL cycle numbers. TBDTMC and TYDTMC films were fabricated from 0.2% wt monomer solutions to conserve material; whereas, conventional MPDTMC films were fabricated from 1% wt monomer solutions. Thickness measurements were made by interferometry, and refractive index was described by the Cauchy equation (A=1.601 and B=0.02564). Growth rates for the TBDTMC and TYDTMC films are compared to the previously measured MPDTMC film in FIG. 11 and Table 5.

TABLE 5
Solvent systems used in molecular used in molecular
layer-by-layer (mLbL) fabrication of polyamide films
and corresponding growth rate of dry film thickness.

| Polyamide | Monomer Solvent/ | Growth Rate |
|---|---|---|
| Film | Rinse Solvent | (nm cycle⁻¹) |
| MPDTMC | toluene/acetone | 0.35 +/− 0.03 |
| TBDTMC | toluene/acetone | 0.99 +/− 0.01 |
| TYDTMC | toluene + N,N- | 1.19 +/− 0.49 |
| | dimethylformamide/ | |
| | acetone | |

The contorted TBDTMC and TYDTMC polyamides exhibit a higher growth rate than the MPDTMC film, due to the larger size of the diamine monomers and the increased free volume of the resulting polyamide films. Some challenges were encountered with TYD monomer solubility. TYD was not completely soluble in toluene, and N,N-dimethylformamide (DMF) cosolvent was added to toluene at approximately 5% volume to dissolve the TYD.

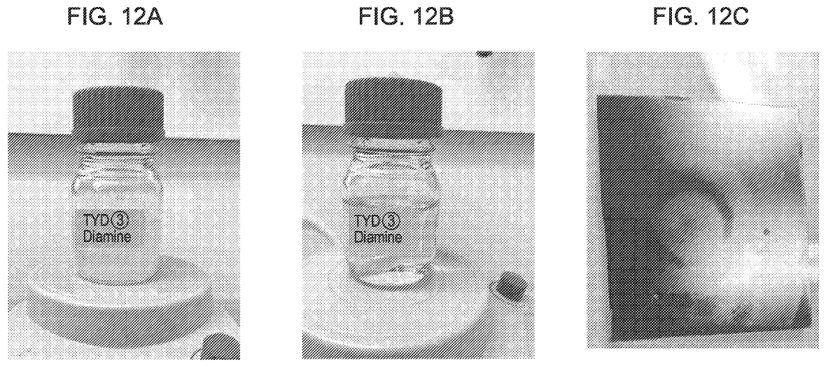

Photographs of the 0.2% wt TYD monomer solutions in toluene with and without DMF cosolvent are compared in FIG. 12A and FIG. 12B, respectively. Effective rinsing of the TYDTMC films during the mLbL fabrication process remains a challenge. TYDTMC polyamide films fabricated with more than 10 mLbL cycles appear cloudy, indicating incomplete monomer rinsing, as shown in the photograph in FIG. 12C. Transparent TYDTMC films were fabricated at relatively low mLbL cycle numbers, and thickness measurements from these films were used to quantify the growth rate. Work continues to optimize the rinsing of the TYDTMC films during mLbL fabrication by using a rinsing cosolvent.

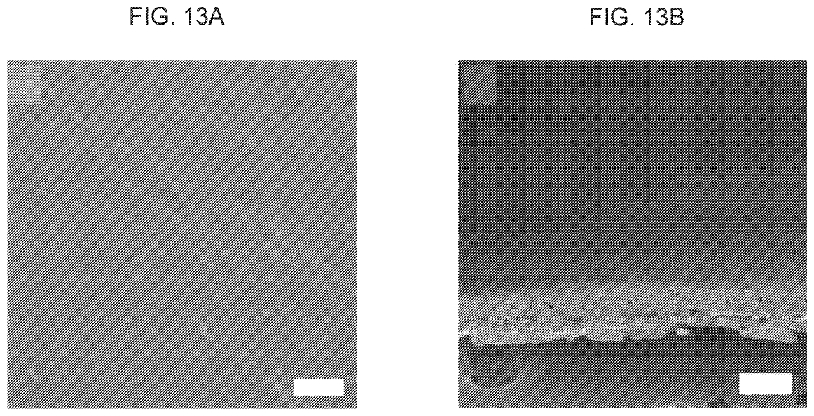

Thin-film composite MPDTMC membranes were fabricated by capturing free-standing mLbL MPDTMC films from a water bath onto a polyacrylonitrile porous membrane support. Three new membranes were prepared from MPDTMC films that ranged in thickness from approximately 20 nm to 55 nm. Scanning electron microscopy (SEM) micrographs of a representative MPDTMC thin-film composite membrane are shown in FIG. 13A-FIG. 13B. The MPDTMC selective layers of the membranes appear smooth and free of defects at the micron scale.

The water permeance and salt (NaCl) rejection of MPDTMC membranes were measured in dead-end filtration cell tests. Previous testing of MPDTMC membranes was conducted in a cross-flow filtration system, and the permselectivity of the membranes was less than that reported by Mulhearn and Stafford (ACS Appl. Polym. Mater. 2021, 3, 116-121) for similar MPDTMC membranes tested under dead-end filtration. The purpose of this additional dead-end filtration testing of MPDTMC membranes was to demonstrate membrane performance equivalent to that reported by Mulhearn and Stafford prior to experimenting with contorted TBDTMC and TDTMC polyamide membranes.

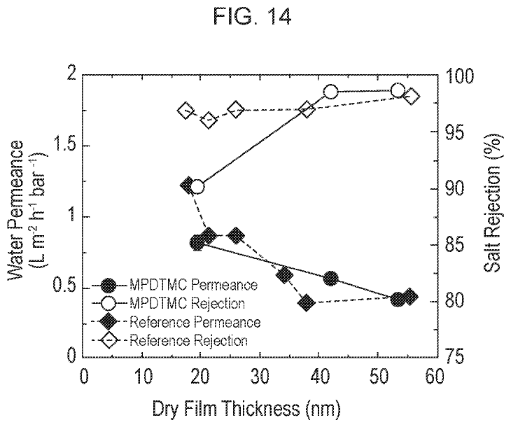

Measured water permeances and salt (NaCl) rejections of the MPDTMC membranes fabricated by mLbL deposition are compared in FIG. 14 to the performance of similar mLbL MPDTMC membranes reported by Mulhearn and Stafford. The MPDTMC membranes exhibited a comparable permselectivity. For solution-diffusion desalination membranes, water permeance decreases and salt rejection increases as a function of MPDTMC membrane thickness. Increasing MPDTMC polyamide film thickness from approximately 40 nm to approximately 55 nm resulted in a significant reduction in water permeability from 0.57±0.01 L m⁻² h⁻¹ bar⁻¹ to 0.42±0.02 L m⁻² h⁻¹ bar⁻¹ with no significant change in salt rejection from 98.5% to 98.6%. These results indicate that an optimum thickness for maximizing the permselectivity of MPDTMC polyamide membranes is approximately 40 nm.

### Continuing Work:

Continuing research on Task #1 will be focused on fabrication and characterization of TBDTMC and TYDTMC contorted polyamide membranes using mLbL deposition. Using established film growth rates, TBDTMC and TYDTMC membranes will be fabricated with equivalent thicknesses to the studied MPDTMC membranes. Water permeance and salt rejection of the contorted polyamide membranes will be compared to the conventional MPDTMC polyamide membrane as a reference.

Characterization of contorted TBDTMC and TYDTMC polyamide films will continue, with powder X-ray diffraction (XRD) measurements currently underway. The results of XRD measurements will be interpreted to quantify an average polymer chain spacing as a measure of tree volume in the contorted polyamide polymers. Nitrogen (N₂) and carbon dioxide (CO₂) physisorption measurements will also be made to quantify porosity and calculate surface area as indicators of polymer free volume.

### Example 9—Fabricating Membranes by Monophasic Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed

The monophasic electrospray deposition (MED) system was modified to incorporate a motor-driven linear actuator to which the syringe pump was mounted, as shown in FIG. 15A. The linear actuator provides consistent, programmable control over horizontal syringe pump movement to achieve better electrospray coverage across the rotating collector. Initial experiments with the MPDTMC polyamide system electrosprayed in toluene using both the rotating collector and the horizontal linear motion of the syringe pump resulted in good polymer film coverage across a polyacrylonitrile support membrane substrate (FIG. 15B).

Monophasic electrospray deposition (MED) experiments were conducted to investigate the effects of electrospray parameters, such as solution discharge rate and deposition time (represented as the number of passes of syringe pump across the collector) on MPDTMC polyamide film coverage and thickness. MPDTMC polyamide was deposited onto silicon substrates (FIG. 15C) from monomer solutions in toluene. After 100, 200, and 300 electrospray passes, substrates were removed from the collector for subsequent thickness measurements. Initial monophasic electrospray deposition (MED) experiments with the MPDTMC system showed non-uniform deposition and some dripping of deposited solution across the substrate. Consequently, the solution discharge rate was reduced from the previous 20 uL min⁻¹ to 10 uL min⁻¹ for the optimization experiments. Additional parameters for the monophasic electrospray deposition (MED) system tests are summarized in Table 6.

TABLE 6
Operating parameters for monophasic electrospray
deposition (MED) system testing.

| | |
|---|---|
| Parameter | Value |

| Monomer solutions | MPD | TMC |
|---|---|---|
| Solvent | toluene | toluene |
| Mass of monomer solution | 1 | 1 |
| deposited (g) | | |
| Diamine to TMC monomer | 4 | 1 |
| molar ratio | | |
| Monomer solution | 0.200 | 0.123 |
| concentration (% wt) | | |
| Monophasic electrospray | | |
| deposition (MED) parameters: | | |
| Monomer solution discharge | 10 | |
| rate (uL min⁻¹) | | |
| Needle-to-collector distance | 2-3 | |
| (cm) | | |
| Applied voltage (kV) | 30-32 | |
| Substrate | Silicon wafer | |
| Collector rotation speed (rpm) | 110-150 | |
| Duration of each syringe pump | 6 | |
| pass across the collector (sec) | | |

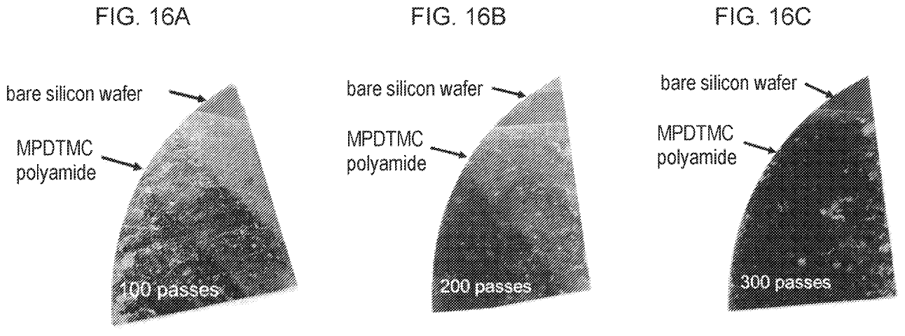

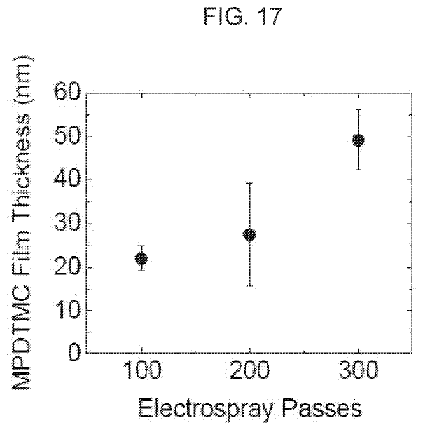

Thicknesses of the MPDTMC films deposited after 100, 200, and 300 electrospray passes were measured by profilometry. Photographs of the MPDTMC polyamide films on silicon substrates are shown in FIG. 16A-FIG. 16B. Film thicknesses are compared in FIG. 17.

The growth in MPDTMC film thickness as a function of deposition time (number of electrospray passes in the MED process) is non-linear, as seen in FIG. 17. The thickness of the 100-pass MPDTMC film was 21.9±2.9 nm, and this film appeared to be non-continuous in some areas, as seen in FIG. 16A. Increasing electrospray passes from 100 to 200 passes increased film thickness by approximately 5 nm to 27.4±11.7 nm. At 300 electrospray passes, MPDTMC film thickness significantly increased to 49.2±6.9 nm, a thickness increase of 27.3 nm from the 100-pass film. Without being bound by theory, the initially slow growth in MPDTMC film thickness could be the result of an initial conditioning of the silicon wafer substrate that occurred before uniform polyamide coverage and film growth occurred.

### Continuing Work:

In Task #2 we will continue to optimize the monophasic electrospray deposition (MED) system parameters to achieve uniform polyamide films and to quantify the effects of deposition parameters on film thickness. Optimization will continue with the MPDTMC polyamide system before studying the contorted polyamides. MPDTMC polyamide film growth rate will be measured for a larger number of electrospray passes and will be measured for support membrane substrates to determine if the observed non-linear film growth continues at larger numbers of passes and for substrates other than silicon wafers. Monomer solution concentrations will also be varied to study the effect of solution concentration on polyamide film properties. The electrosprayed polyamide films will be characterized by XRD and nitrogen (N₂) and carbon dioxide (CO₂) physisorption, similar to the films fabricated by mLbL deposition.

Polyamide membrane fabrication by monophasic electrospray deposition (MED) will begin with the MPDTMC polyamide system electrosprayed onto polyacrylonitrile support membranes. The water permeances and salt rejections of membranes with different polyamide layer thicknesses will be measured under cross-flow filtration conditions to identify an optimum thickness for maximizing the permselectivity of these membranes.

### Example 10—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior

### Work Performed

Group contribution theory was applied to theoretical contorted polyamide structures to estimate the fractional free volume (FFV) in these materials. Specifically, fractional free volume (FFV) was calculated from Equation 15 using polymer van der Waals volumes (V_{W}) estimated from structural groups present in the polymer networks (A. X. Wu, S. Lin, K. Mizrahi Rodriguez. F. M. Benedetti, T. Joo, A. F. Grosz, K. R. Storme, N. Roy, D. Syar, Z. P. Smith, Revisiting group contribution theory for estimating fractional free volume of microporous polymer membranes, Journal of Membrane Science. 636 (2021) 119526):

$$FFV = \frac{{V}_{f}}{V} = 1 - \frac{1.3 {V}_{W}}{V} = 1 - \frac{1.3 ρ {V}_{W}}{M W} \qquad Equation 15$$

In Equation 15, free volume V_{f} is calculated as 1.3 V_{W} (cm3 mol-1), and molar volume of the polymer V (mol cm⁻¹) will be calculated from the measured density ρ (g cm⁻³) of fabricated polyamide films and the estimated molecular weight MW (g min⁻¹). A single TMC monomer bonded to three diamine monomers (MPD, TBD, or TYD) was used as the molecular unit for calculating polymer V_{W} and MW values. Calculation results are summarized in Table 7.

TABLE 7
Calculated van der Waals volumes and molecular
weights for contorted polyamides.

| | | Calculated van der | Calculated |
|---|---|---|---|
| | Diamine | Waals Volume, V_{w} | Molecular Weight, |
| Polyamide | Monomer | (cm³ mol⁻¹) | MW (g mol⁻¹) |
| MPDTMC | m-phenylene | 244.17 | 426.34 |
| | diamine | | |
| TBDTMC | Troger's base | 513.00 | 840.71 |
| | diamine | | |
| TYDTMC | Triptycene | 512.10 | 858.72 |
| | diamine | | |

### Continuing Work:

The fractional free volume (FFV) of polyamide films calculated from measured film densities according to Equation 15 will serve as a basis of comparison for experimental characterizations of fractional free volume (FFV) from XRD and gas physisorption measurements. Modeling of solution-diffusion transport in contorted polyamide membranes will incorporate polymer fractional free volume (FFV) to describe desalination performance and solution diffusion transport in these membranes.

### Overview and Objectives of Example 11—Example 13 (Qtr 2 Tpr 7-26-2022)

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable monophasic electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by monophasic electrospray deposition (MED); Task #3—Relate the permeability-selectivity performance of contorted polyamide membranes to solution-diffusion transport.

### Example 11—Controlling Polyamide Free Volume

### Goals/Work Outline:

Research efforts in Task #1 will synthesize polyamide polymers from water-insoluble contorted diamine monomers (Troger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

### Polyamide Thin Film Synthesis and Membrane Fabrication

MPDTMC, TBDTMC, and TYDTMC films were characterized by Fourier transform-infrared (FT-IR) spectroscopy, powder X-ray diffraction (XRD), and zeta potential measurements. Additional solubility studies were performed with TYD monomer, and alternative strategies were investigated to synthesize TYDTMC polyamide films by solution based mLbL deposition. Water permeance and salt rejection were measured for TBDTMC and TYDTMC contorted polyamide membranes fabricated from mLbL polyamide thin films.

The TYD monomer was only soluble in toluene, the solvent used to dissolve MPD and TBD diamine monomers, when N,N-dimethylformamide (DMF) cosolvent was added at 5% volume. Poor rinsing was apparent for TYDTMC films synthesized with TYD dissolved in toluene+DMF with an acetone rinse. As a result, only films with low mLbL cycle numbers could be synthesized. Additional solubility investigations with the TYD monomer revealed that TYD+TMC reaction time for polycondensation was longer than for the MPD/TBD+TMC systems. Aggressive solvent rinsing in the mLbL process after TYD monomer deposition appeared to negatively affect TYDTMC film growth. In response to these observations, we changed the TYD solvent to acetone; we increased the dwell time in the mLbL process for deposited TYD monomer to react with TMC monomer from 20 sec to 120 sec; and we used only high-speed spinning and no solvent to remove excess TYD monomer after the TYD+TMC reaction step in the mLbL process. With these changes, TYDTMC polyamide films could be fabricated at higher mLbL cycle numbers when the silicon wafer substrate was coated with a sacrificial polystyrene sulfonic acid (PSS) layer.

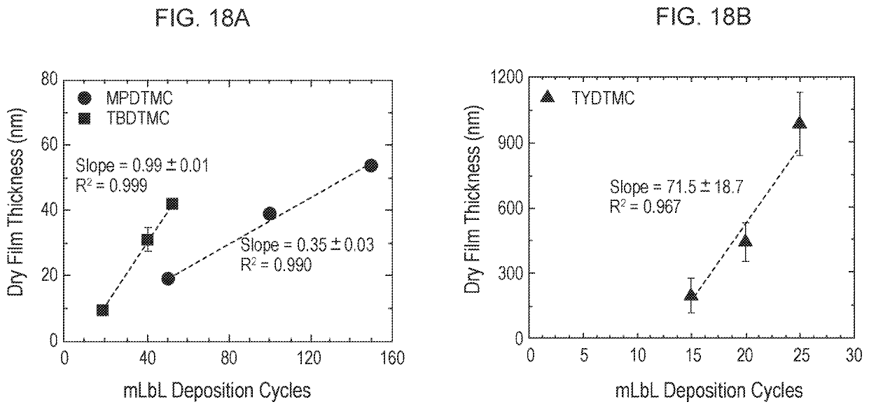

TYDTMC films were synthesized by mLbL deposition onto PSS-coated silicon wafer substrates using 0.2% wt monomer solutions in acetone solvent. The synthesized films were then immersed in a water bath to dissolve the PSS layer and release the film. Floated TYDTMC films were then captured on silicon substrates for thickness measurements using surface profilometry. The growth rate of the TYDTMC film is shown in FIG. 18B, and the previously determined growth rates for the MPDTMC and TBDTMC films are shown in FIG. 18A. Growth rates for the three polyamide systems are compared in Table 8.

TABLE 8
Solvent systems used in molecular layer-by-layer
(mLbL) fabrication of polyamide films and corresponding
growth rate of dry film thickness.

| Polyamide | Monomer Solvent/ | Growth Rate |
|---|---|---|
| Film | Rinse Solvent | (nm cycle⁻¹) |
| MPDTMC | toluene/acetone | 0.35 +/− 0.03 |
| TBDTMC | toluene/acetone | 0.99 +/− 0.01 |
| TYDTMC | toluene/acteon (TMC) | 71.5 +/− 18.7 |
| | acetone/no rinse (TYD) | |

The growth rate for the TYDTMC polyamide films is two orders of magnitude greater than the growth rates for MPDTMC and TBDTMC films, and the resulting TYDTMC films are hundreds of nanometers thick. Films made at 10 deposition cycles or less were not continuous and broke apart during the process of floating the film on a water bath. These observations suggest that at least 10 mLbL deposition cycles are required for formation of a continuous TYDTMC film, after which, the film rapidly grows in thickness. A faster growth rate was hypothesized for the TYDTMC films because of the relatively large size of the TYD monomer compared to TBD and MPD monomers. However, the increased growth rate of TYDTMC is not proportional to the relative size of the TYD monomer compared to the other diamines. Without being bound by theory, the apparent reduced reactivity of the TYD+TMC system may be affecting the crosslink density of the TYDTMC polymer and increasing the polymer free volume, resulting in the higher film growth rate.

Thin-film composite TBDTMC and TYDTMC membranes were fabricated by capturing floating polyamide films from a water bath onto polyacrylonitrile porous membrane supports, as previously reported for MPDTMC membranes. Three membranes were prepared for each contorted polyamide. TBDTMC membranes ranged in thickness from approximately 8 nm to 25 nm. TYDTMC membranes ranged in thickness from approximately 190 nm to 980 nm.

### Characteristics of Contorted Polyamide Polymers

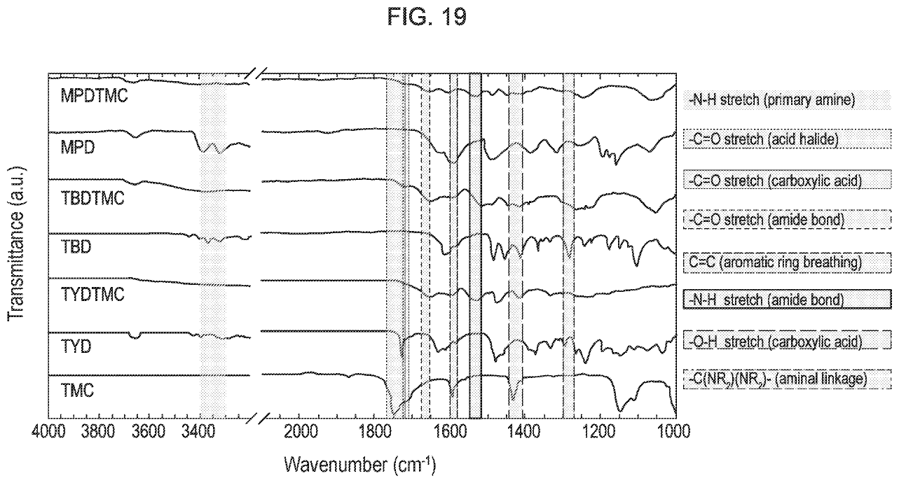

The chemistry of the polyamide polymers was confirmed by analysis of the FT-IR spectra of polyamide powders and starting monomers. Polyamide powders were fabricated by combining precursor diamine and TMC monomer solutions in a common solvent. Powders were washed repeatedly in ethanol and dried at room temperature before analysis. The IR spectra of the polyamide powders and the constituent monomers are compared in FIG. 19.

The formation of polyamides is indicated by characteristic absorbance peaks at wavenumbers in the amide I (1600-1800 cm⁻¹), amide II (1470-1570 cm-1), amide III (1250-1350 cm-1), and amide A (3300-3500 cm⁻¹) bands (D. Surblys, T. Yamada, B. Thomsen, T. Kawakami, I. Shigemoto, J. Okabe, T. Ogawa, M. Kimura, Y. Sugita. K. Yagi, Amide A band is a fingerprint for water dynamics in reverse osmosis polyamide membranes, Journal of Membrane Science. 596 (2020) 117705). Specifically, in the amide I band, the emergence of absorbance peaks in the polyamide spectra at 1667 cm⁻¹ indicate C═O stretching from amide bonds (T. J. Zimudzi, K. E. Feldman, J. F. Sturnfield, A. Roy, M. A. Hickner, C. M. Stafford, Quantifying Carboxylic Acid Concentration in Model Polyamide Desalination Membranes via Fourier Transform Infrared Spectroscopy, Macromolecules. 51 (2018) 6623-6629; T. J. Zimudzi, S. E. Sheffield, K. E. Feldman, P. A. Beaucage, D. M. DeLongchamp, D. I. Kushner, C. M. Stafford, M. A. Hickner, Orientation of Thin Polyamide Layer-by-Layer Films on Non-Porous Substrates, Macromolecules. 54 (2021) 11296-11303: S. Dai, R. Liao, H. Zhou, W. Jin, Synthesis of triptycene-based linear polyamide membrane for molecular sieving of N2 from the VOC mixture, Separation and Purification Technology. 252 (2020) 117355). Simultaneously, the loss of the absorbance peak attributed to C═O stretching for acid halide (1725-1760 cm-1) (T. J. Zimudzi, K. E. Feldman, J. F. Sturnfield, A. Roy, M. A. Hickner, C. M. Stafford, Quantifying Carboxylic Acid Concentration in Model Polyamide Desalination Membranes via Fourier Transform Infrared Spectroscopy, Macromolecules. 51 (2018) 6623-6629; Y. Li, Z. Guo, S. Li, B. Van der Bruggen, Interfacially Polymerized Thin-Film Composite Membranes for Organic Solvent Nanofiltration, Advanced Materials Interfaces. 8 (2021) 2001671) and the reduction of the peak attributed to C═O stretching for carboxylic acid (1710 cm⁻¹) in the TMC monomer (S. Dai, R. Liao, H. Zhou, W. Jin, Synthesis of triptycene-based linear polyamide membrane for molecular sieving of N2 from the VOC mixture, Separation and Purification Technology. 252 (2020) 117355; Y. Jin, W. Wang, Z. Su, Spectroscopic study on water diffusion in aromatic polyamide thin film, Journal of Membrane Science. 379 (2011) 121-130; Z. Wang, D. Wang, F. Zhang, J. Jin, Tröger's Base-Based Microporous Polyimide Membranes for High-Performance Gas Separation, ACS Macro Lett. 3 (2014) 597-601; A. Yerzhankyzy, B. S. Ghanem, Y. Wang, N. Alaslai, I. Pinnau, Gas separation performance and mechanical properties of thermally-rearranged polybenzoxazoles derived from an intrinsically microporous dihydroxyl-functionalized triptycene diamine-based polyimide. Journal of Membrane Science. 595 (2020) 117512) indicates the consumption of acyl chloride functional groups in TMC to form amide bonds in the polyamides. Absorption peaks attributed to the N—H stretch (3300-3400 cm⁻¹) from primary amine groups in MPD, TBD, and TYD are diminished in the corresponding polymers, indicating the consumption of free amine functional groups in the diamine monomers to form amide bonds in the polyamides. In the amide II band, the polyamides exhibit an absorbance peak associated with the N—H stretch from the amide bond (1541 cm⁻¹) (M. F. Jimenez Solomon, Y. Bhole, A. G. Livingston, High flux membranes for organic solvent nanofiltration (OSN)—Interfacial polymerization with solvent activation, Journal of Membrane Science 423-424 (2012) 371-382; L. Shen, R. Cheng, M. Yi, W.-S. Hung, S. Japip, L. Tian, X. Zhang, S. Jiang, S. Li, Y. Wang, Polyamide-based membranes with structural homogeneity for ultrafast molecular sieving, Nat Commun. 13 (2022) 500; B. Khorshidi, T. Thundat, B. A. Fleck, M. Sadrzadeh, A Novel Approach Toward Fabrication of High Performance Thin Film Composite Polyamide Membranes, Sci Rep. 6 (2016) 22069) that is not present in the diamine and TMC monomers.

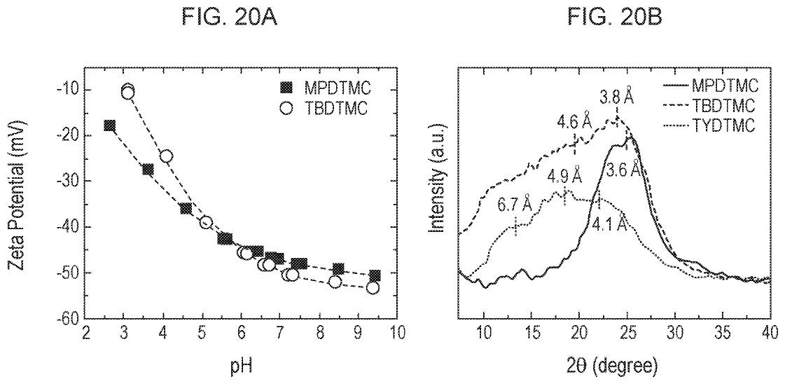

A strong absorbance peak attributed to 0-H stretching from carboxylic acid (1420-1440 cm⁻¹) is present in the spectra for TMC monomer, indicating that some acyl chloride functional groups in TMC were hydrolyzed to carboxylic acid. A small absorbance peak for this O—H stretch is also present in the polyamides, indicating that some acyl chloride groups from TMC remained unreacted and were hydrolyzed. In the TBD and TBDTMC spectra, an absorbance peak that is unique to the aminal linkages in Troger's base is evident at 1270-1300 cm⁻¹ wavenumbers (A. Hassan, A. Alam, M. Ansari, N. Das, Hydroxy functionalized triptycene based covalent organic polymers for ultra-high radioactive iodine uptake, Chemical Engineering Journal. 427 (2022) 130950). In the spectra for all monomers and polyamides, the absorbance peak for C═C aromatic breathing is present at 1580-1600 cm⁻¹ (J. S. Lee, J. A. Seo, H. H. Lee, S. K. Jeong, H. S. Park, B. R. Min, Simple method for preparing thin film composite polyamide nanofiltration membrane based on hydrophobic polyvinylidene fluoride support membrane, Thin Solid Films. 624 (2017) 136-143; C. Y. Tang, Y.-N. Kwon, J. O. Leckie, Effect of membrane chemistry and coating layer on physiochemical properties of thin film composite polyamide RO and NF membranes: I. FTIR and XPS characterization of polyamide and coating layer chemistry, Desalination. 242 (2009) 149-167; Z. Ali, B S. Ghanem, Y. Wang, F. Pacheco, W. Ogieglo, H. Vovusha, G. Genduso, U. Schwingenschlögl, Y. Han, I. Pinnau. Finely Tuned Submicroporous Thin-Film Molecular Sieve Membranes for Highly Efficient Fluid Separations, Advanced Materials. 32 (2020) 2001132; Z. Zhu, J. Zhu, J. Li, X. Ma, Enhanced Gas Separation Properties of Tröger's Base Polymer Membranes Derived from Pure Triptycene Diamine Regioisomers, Macromolecules. 53 (2020) 1573-1584; J. Deng, Z. Dai, L. Deng, H2-selective Troger's base polymer based mixed matrix membranes enhanced by 2D MOFs, Journal of Membrane Science. 610 (2020) 118262). The chemistry of the MPDTMC and TBDTMC membranes was also characterized by zeta potential measurements, which are compared in FIG. 20A. Zeta potential of the membranes was estimated by applying the Helmholtz-Smoluchowski equation to streaming potential measurements made across a range of electrolyte pH. Zeta potential values are not included for TYDTMC membranes because measurements must be repeated as a result of apparent damage to the membrane during the measurement.

Zeta potential values for the MPDTMC and TBDTMC membranes are similar as a function of electrolyte pH. TBDTMC films exhibit a slightly more negative zeta potential at high pH1 and a slightly more positive zeta potential at low pH, compared to MPDTMC films. Without being bound by theory this result suggests a lower degree of crosslinking and the presence of more unreacted amine and carboxylic acid functional groups in the TBDTMC compared to the MPDTMC. The unreacted amine groups from the diamine monomer (pKa=9.5 to 11.0) would increase zeta potential at low solution pH, and the unreacted carboxylic acid groups (pKa=5.2) from hydrolyzed acyl chloride functional groups in the TMC monomer would result in a more negative zeta potential at high solution pH (M E. Tousley, D L. Shaffer, J.-H. Lee, C. O. Osuji, M. Elimelech, Effect of Final Monomer Deposition Steps on Molecular Layer-by-Layer Polyamide Surface Properties, Langmuir. 32(2016) 10815-10823).

The size of free volume elements in the polyamide powders was estimated from powder XRD measurements. Measurements were made using a diffracted beam over 10°-40° diffraction angle (20), and the average polymer chain d-spacing in the polyamide powders was calculated from Bragg's Law assuming an incident radiation wavelength of λ=1.54 Å (T. N. Kim, J. Lee, J.-H. Choi, J.-H. Ahn, E. Yang, M.-H. Hwang, K.-J. Chae, Tunable atomic level surface functionalization of a multi-layered graphene oxide membrane to break the permeability-selectivity trade-off in salt removal of brackish water, Separation and Purification Technology. 274 (2021) 119047). The XRD patterns for the MPDTMC, TBDTMC, and TYDTMC polymer powders are presented in FIG. 20B. The calculated d-spacings associated with intensity peaks are identified in FIG. 20B and summarized in Table 9.

TABLE 9
Calculated d-spacing from intensity peaks in
powder XRD patterns for polyamide powders.

| Polyamide | XRD Peak Value, | d-spacing |
|---|---|---|
| Films | 2θ (degree) | (Å) |
| MPDTMC | 24.96 | 3.6 |
| TBDTMC | 23.96 | 3.8 |
| | 19.54 | 4.6 |
| TYDTMC | 22.00 | 4.1 |
| | 18.44 | 4.9 |
| | 13.28 | 6.7 |

The contorted TBDTMC and TYDTMC polyamides show multiple intensity peaks in their XRD patterns, and the calculated d-spacings of these peaks are larger than the d-spacing of conventional MPDTMC. Increased d-spacing indicates increased distance between polymer chains and increase free polymer free volume (Z. Ali, Y. Wang, W. Ogieglo, F. Pacheco, H. Vovusha, Y. Han, I. Pinnau, Gas separation and water desalination performance of defect-free interfacially polymerized para-linked polyamide thin-film composite membranes, Journal of Membrane Science. 618 (2021) 118572), for polyamides containing the larger, shape-persistent TBD and TYD monomers.

### Desalination Performance of Contorted Polyamide Membranes

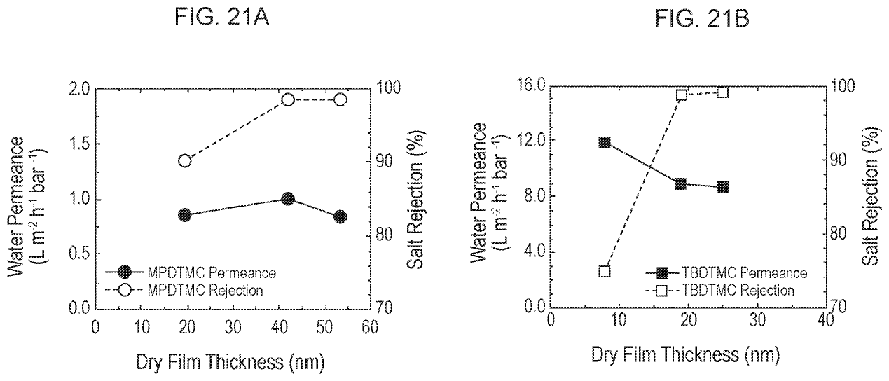

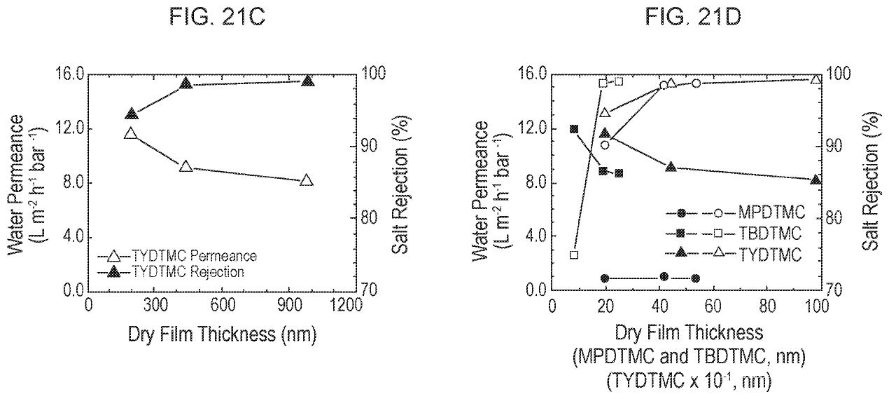

The water permeance and salt (NaCl) rejection of TBDTMC and TYDTMC contorted polyamide membranes of different thicknesses were measured in dead-end filtration cell tests for comparison to previous measurements of MPDTMC membranes. Water permeance measurements were made with DI water at pressures ranging from 8.3-20.7 bar, and salt rejection measurements were made with 50 mmol L⁻¹ NaCl solution. Measured water permeances and NaCl rejections of the MPDTMC, TBDTMC, and TYDTMC membranes fabricated by mLbL deposition are presented in FIG. 21A, FIG. 21B, and FIG. 21C, respectively. The desalination performance of the three polyamide membranes is compared on the same water permeance and salt rejection scales in FIG. 21D.

For solution-diffusion desalination membranes, water permeance decreases and salt rejection increases as a function of membrane thickness for all three polyamide membranes. At an equivalent NaCl rejection of ~99%, the contorted TBDTMC and TYDTMC membranes exhibit water permeances of 8.6±0.0 L m⁻² h⁻¹ bar⁻¹ and 8.1±0.2 L m⁻¹ h⁻¹ bar⁻¹, respectively, which are an order of magnitude greater than that of the conventional MPDTMC membrane (0.84±0.04 L m⁻² h⁻¹ bar⁻¹) at 99% rejection. The performance data for the TBDTMC and TYDTMC membranes supports the hypothesis that the free volume of polyamide membranes can be controlled through the introduction of sterically hindered monomers and that increased free volume enhances membrane permselectivity.

### Continuing Work:

Continuing research will be focused on final characterizations of TBDTMC and TYDTMC contorted polyamide membranes. Zeta potential measurements will be repeated for TYDTMC membranes. X-ray photoelectron spectroscopy (XPS) will also be used to characterize the chemistry and degree of crosslinking in the polyamide films. Nitrogen (N₂) and carbon dioxide (CO₂) physisorption measurements will also be made to quantify porosity and calculate surface area as indicators of polymer free volume. Longer duration desalination performance tests will be conducted for TBDTMC and TYDTMC contorted polyamide membranes that demonstrated ~99% NaCl rejections in preliminary performance tests.

### Example 12—Fabricating Membranes by Monophasic Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed:

Electrospray parameters for the monophasic electrospray deposition (MED) system were optimized to reduce solution sputtering and produce a more uniform polyamide films. To achieve more uniform electrospraying cones and to eliminate sputtering of the solution on the substrate, dimethyl acetamide (DMAc) was explored as a monophasic electrospray deposition (MED) solvent because of its higher viscosity compared to toluene. DMAc monomer solutions were successfully and uniformly electrosprayed. However, the compatibility of the intended polyacrylonitrile (PAN) membrane substrate and the DMAc solvent was a concern. Additional solvent testing with PAN-compatible solvents resulted in the selection of ethanol as an effective solvent for all contorted polyamide monomers (TMC, MPD, TBD, and TYD). The ethanol monomer solutions were successfully electrosprayed onto PAN and silicon wafer substrates without sputtering, though a reduction in monomer solution discharge rate from the previously tested 10 uL min⁻¹ to 10 uL h⁻¹ was necessary. Polyacrylonitrile (PAN) membrane substrates showed no apparent degradation when saturated with the ethanol solvent. Ethanol is also a green solvent alternative to toluene and DMAc with less negative impacts to human health and the environment (C. Capello, U. Fischer, K. Hungerbühler, What is a green solvent? A comprehensive framework for the environmental assessment of solvents, Green Chem. 9 (2007) 927-934).

Monophasic electrospray deposition (MED) operating parameters were further optimized by adjusting collector rotation speed, needleto-collector distance, and applied voltage. These parameters were adjusted to reduce solution sputtering from the needle to the substrate, achieve a uniform solvent discharge cone, and obtain uniform polymer coverage on the substrate, all of which were assessed by visual inspection. The optimized monophasic electrospray deposition (MED) parameters are summarized in Table 10. Compared to the previously reported parameters for toluene solvent-based monophasic electrospray deposition (MED), the operating parameters for the ethanol-based monophasic electrospray deposition (MED) system have slower discharge rates, lower applied voltage, greater needle-to-collector distance, and slower collector rotation speed.

TABLE 10
System parameters for monophasic electrospray
deposition (MED) of polyamide films.

| Parameter | | | | |
|---|---|---|---|---|
| Monomer | Value | | | |
| solutions | MPD | TBD | TYD | TMC |
| Monomer | 108.14 | 840.71 | 858.72 | 265.48 |
| molecular | | | | |
| weight (g mol − 1) | | | | |
| Solvent | ethanol | ethanol | ethanol | ethanol |
| Mass of | 10 | 26 | 26 | 6 |
| monomer | | | | |
| solution | | | | |
| deposited (mg) | | | | |
| Diamine to TMC | 4 | 4 | 4 | — |
| monomer molar | | | | |
| ratio | | | | |
| Monomer | 0.20 | 0.20 | 0.20 | 0.12 |
| solution | | | | |
| concentration | | | | |
| (% wt) | | | | |
| Monophasic | | | | |
| electrospray | | | | |
| deposition | | | | |
| (MED) | | | | |
| parameters: | | | | |

| | |
|---|---|
| Monomer | 10 |
| solution | |
| discharge rate | |
| (uL h − 1) | |
| Needle-to- | 4 |
| collector | |
| distance (cm) | |
| Applied voltage | 15 |
| (kV) | |
| Substrate | silicon wafer, polyacrylonitrile membrane |
| Collector | 80-100 |
| rotation speed | |
| (rpm) | |
| Number of | 50-200 |
| electrospray | |
| passes | |

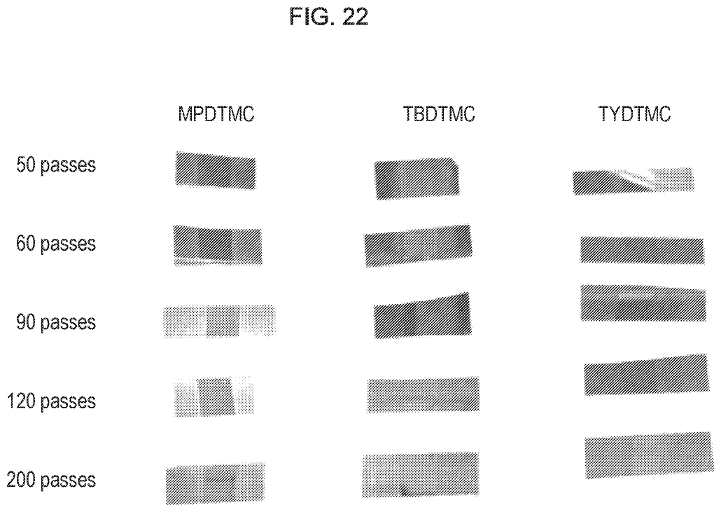

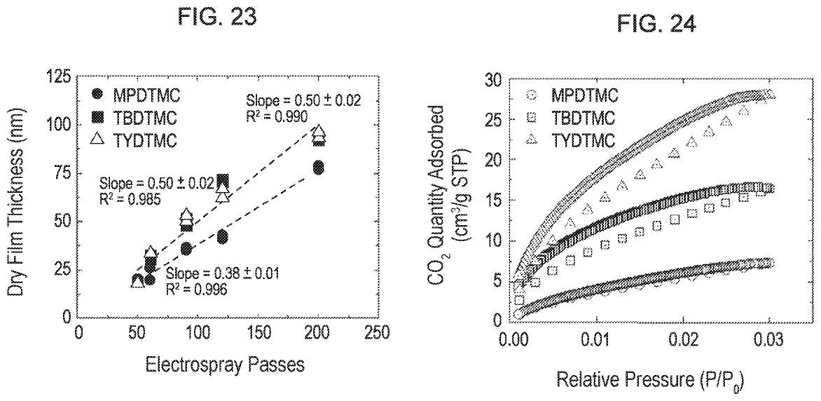

MPDTMC, TBDTMC, and TYDTMC polyamide films were electrosprayed onto silicon wafer substrates for subsequent measurement of film growth rate. MPDTMC was also deposited onto polyacrylonitrile (PAN) support membranes to assess solvent compatibility with the substrate and uniformity of the resulting polyamide membrane. Photographs of the polyamide films electrosprayed onto silicon wafers at different numbers of electrospray passes are shown in FIG. 22. One pass consists of pump travel across the distance of the collector and back to return to the pump starting position. Thicknesses of the polyamide films deposited after 50-200 electrospray passes in the ethanol-based monophasic electrospray deposition (MED) system were measured by profilometry. Film thicknesses are compared in FIG. 23, and the growth rates determined from linear fits to the thickness data are summarized in Table 11.

TABLE 11
Growth rate of polyamide dry film thickness for
polyamides deposited on silicon wafer substrates
by monophasic electrospray deposition (MED).

| Polyamide | Monomer | Growth Rate |
|---|---|---|
| Film | Solvent | (nm pass⁻¹) |
| MPDTMC | ethanol | 0.38 +/− 0.01 |
| TBDTMC | ethanol | 0.50 +/− 0.02 |
| TYDTMC | ethanol | 0.50 +/− 0.02 |

The growth in MPDTMC film thickness as a function of deposition time (number of electrospray passes in the monophasic electrospray deposition (MED) process) is linear for the ethanol-based monophasic electrospray deposition (MED) system, unlike the non-linear growth curve previously reported for this film in a toluene-based system. The thickest MPDTMC film was 78 nm after 200 passes and appeared as an opaque white film, as seen in FIG. 22. TBDTMC and TYDTMC films grew in thickness at the same rate for the monophasic electrospray deposition (MED) conditions investigated. The thickest films at 200 electrospray passes were 93 nm and 95 nm for TBDTMC and TYDTMC, respectively.

### Continuing Work:

In Task #2 will study the ethanol solvent-based monophasic electrospray deposition (MED) system to quantify the effects of deposition parameters on polyamide film thickness. Monomer solution concentrations will also be varied to study the effect of solution concentration on polyamide film properties. The electrosprayed polyamide films will be characterized by XRD and nitrogen (N₂) and carbon dioxide (CO₂) physisorption, similar to the films fabricated by mLbL deposition. Polyamide membranes will be fabricated by monophasic electrospray deposition (MED) for the TBDTMC and TYDTMC systems in addition to the MPDTMC polyamide system. The water permeances and salt rejections of membranes with different polyamide layer thicknesses will be measured under cross-flow filtration conditions to identify an optimum thickness for maximizing the permselectivity of these membranes.

### Example 13—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior.

### Work Performed:

Group contribution theory was applied to theoretical contorted polyamide structures to estimate the fractional free volume (FFV) from measured film densities.

### Continuing Work:

Film densities will be measured and fractional free volume (FFV) calculated from theory. The calculated fractional free volume (FFV) of polyamide films will serve as a basis of comparison for experimental characterizations of fractional free volume (FFV) from XRD and gas physisorption measurements.

### Overview and Objectives of Example 14—Example 16 (Qtr 3 Tpr 10-31-2022)

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable monophasic electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are. Task #1—Control polyamide free volume through incorporation of sterically hindered contorted monomers; Task #2—Fabricate contorted polyamide membranes by monophasic electrospray deposition (MED); Task #3—Relate the permeability-selectivity.

### Example 14—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

### Polyamide Thin Film Synthesis and Membrane Fabrication

As discussed above herein, we reported the solvent systems used in mLbL fabrication of polyamide films and the corresponding growth rates of film thickness. We fabricated thin-film composite MPDTMC, TBDTMC, and TYDTMC membranes by capturing floating polyamide films from a water bath onto polyacrylonitrile (PAN) porous membrane supports. Three membranes were prepared at different thicknesses for each polyamide chemistry. Now we report one each of MPDTMC, TBDTMC, and TYDTMC membranes were prepared on polyacrylonitrile (PAN) supports for longterm desalination performance testing.

### Characteristics of Contorted Polyamide Polymers

The free volume fractions of the contorted TBDTMC and TYDTMC polyamides of the present invention, and the conventional MPDTMC polyamide were characterized by CO₂ adsorption-desorption isotherm measurements. As discussed above herein, d-spacings (from powder X-ray diffraction (XRD) patterns) were reported for the polyamide powders as estimates of the size of free volume elements. Now we report, zeta potential measurements were completed for TYDTMC films for comparison to previously reported zeta potentials of MPDTMC and TBDTMC films. Chemistry of the polyamide films was previously characterized by FT-IR spectroscopy.

Polyamide powders were fabricated for CO₂ adsorption-desorption isotherm measurements by combining precursor diamine and TMC monomer solutions in a common solvent. Before the measurement, powders were washed in ethanol and were degassed overnight at 100° C. under vacuum. The CO₂ sorption measurements were made at 0° C. (273 K) with a Micrometrics instrument using an ice water bath for cooling. The adsorption-desorption isotherms for the polyamide powders are compared in FIG. 24.

The Langmuir surface areas of the polyamide powders were calculated by the instrument software assuming Langmuir adsorption behavior (single-layer of CO₂ molecules adsorbed at active sites), and they are compared to previously measured d-spacings from powder XRD in Table 12. The Langmuir surface areas of contorted TBDTMC (80.1 m² g⁻¹) and TYDTMC (143 m² g⁻¹) polyamides are double and triple, respectively, the surface area of the conventional MPDTMC polyamide (39.5 m² g⁻¹). These increased Langmuir surface areas are attributed to increased free volume in the polymers resulting from the contorted geometry of the TBD and TYD monomers.

TABLE 12
Calculated d-spacing from intensity peaks in powder
XRD patterns and Langmuir surface areas from CO₂
sorption isotherms for polyamide powders.

| Polyamide | d-spacing | Langmuir Surface |
|---|---|---|
| Powder | (Å) | Area (m²g⁻¹) |
| MPDTMC | 3.6 | 39.5 |
| TBDTMC | 3.8, 4.6 | 80.1 |
| TYDTMC | 4.1, 4.9, 6.7 | 143 |

The chemistry of the TYDTMC membrane was also characterized by streaming potential measurements. The calculated zeta potential of TYDTMC polyamide film is compared in FIG. 25 to the previously measured zeta potentials for MPDTMC and TBDTMC films.

Zeta potential values for the TYDTMC film are less negative than the MPDTMC and TBDTMC films at electrolyte pH greater than pH 5. Without being bound by theory, the slightly less negative zeta potential values and flatter zeta potential curve for the TYDTMC polyamide may indicate a higher degree of crosslinking and reduced presence of unreacted amine and carboxylic acid functional groups compared to the MPDTMC and TBDTMC films.

### Desalination Performance of Contorted Polyamide Membranes

As discussed above herein, the water permeances and NaCl rejections of MPDTMC, TBDTMC, and TYDTMC membranes fabricated by mLbL deposition were compared as a function of polyamide film thickness. As a result of their increased free volume, the TBDTMC and TYDTMC contorted polyamide membranes showed enhanced permselectivity compared to the conventional MPDTMC polyamide membrane. Specifically, at an equivalent NaCl rejection of ~99%, the TBDTMC and TYDTMC membranes exhibited water permeances of 8.6±0.0 L m⁻² h⁻¹ bar⁻¹ and 8.1±0.2 L m⁻¹ h⁻¹ bar⁻¹, respectively, which were an order of magnitude greater than that of the MPDTMC membrane (0.84±0.04 L m⁻² h⁻¹ bar⁻¹) at 99% rejection, as shown in FIG. 26.

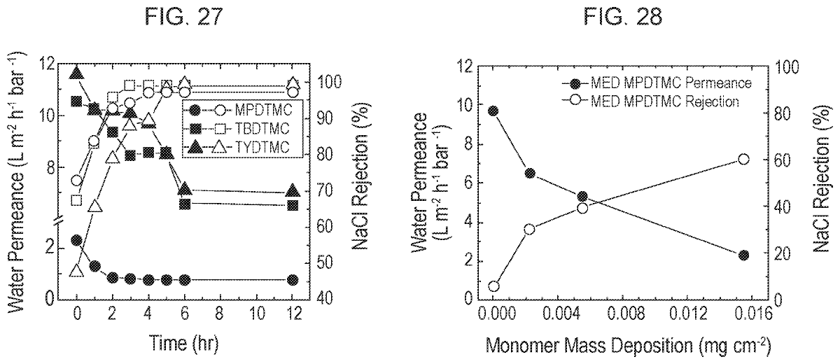

Now we report that longer duration desalination performance tests were conducted for the mLbL fabricated polyamide membranes to verify long-term performance. Water permeance and salt rejection results reported in FIG. 26 were measured after 10 mL of water permeated through each membrane (approximately 2 hours of operation). For the longer duration performance tests, contorted polyamide membranes that demonstrated ~99% NaCl rejections in preliminary performance tests were tested for 12 hours at pressures ranging from 100-200 psi. Specifically, a 100-cycle (~35 nm thick) MPDTMC membrane was tested at 150 psi pressure; a 25-cycle (~25 nm thick) TBDTMC membrane was tested at 100 psi pressure; and a 25-cycle (~880 nm thick) TYDTMC membrane was tested at 200 psi. Water permeance and NaCl rejection measurements were made hourly for the first 6 hours and then measurements were made again at 12 hours. Results are compared in FIG. 27 for all three polyamide membranes over the 12-hour period.

All three polyamide membranes exhibited a decline in water permeance and an increase in NaCl rejection over the first 6 hours of measurements. Measurements made after 12 hours of testing were similar to measurements made at 6 hours, indicating the membranes had reached an equilibrium condition. Without being bound by theory, the initial declines in water permeance may be the result of compaction of the porous polyacrylonitrile membrane support or a compaction of the polyamide film itself. The significant increases in NaCl rejection observed over the initial 6 hours of the experiments indicate that the polyamide films compacted under hydraulic pressure, reducing their free volume and increasing salt rejection, in accordance with solution-diffusion transport behavior. After 12 hours of testing, water permeances for the TBDTMC (6.6±0.3 L m⁻² h⁻¹ bar⁻¹) and TYDTMC (7.2±0.0 L m⁻² h⁻¹ bar⁻¹) were an order of magnitude greater than the 0.76±0.01 L m⁻² h⁻¹ bar⁻¹ water permeance of the conventional MPDTMC polyamide membrane. NaCl rejections for the TBDTMC, TYDTMC, and MPDTMC membranes were similar at 99.0%, 99.2%, and 97.4% rejection, respectively. The long-term desalination performance of the contorted polyamide membranes supports the hypothesis that permselectivity of polyamide membranes can be enhanced by tuning the free volume in the polyamide network through the introduction of contorted TBD and TYD monomers.

### Continuing Work:

Continuing research on Task #1 will include final characterizations of TBDTMC and TYDTMC contorted polyamide membranes by X-ray photoelectron spectroscopy (XPS) to evaluate the degree of crosslinking and ellipsometry measurements to estimate polyamide film densities.

### Example 15—Fabricating Membranes by Monophasic Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed:

As discussed above herein, the optimization of electrospray parameters for the monophasic electrospray deposition (MED) system with the goal of producing consistent polyamide films with controllable thickness. Monophasic electrospray deposition (MED) operating parameters were optimized for ethanol monomer solutions by adjusting collector rotation speed, needle-to-collector distance, and applied voltage to achieve a uniform solvent discharge cone and uniform polymer coverage.

Now we report that the transport properties were measured for MPDTMC membranes fabricated at different thicknesses by monophasic electrospray deposition (MED), and electrospraying parameters were further modified to improve the desalination performance of the membranes. This optimization was performed for the conventional MPDTMC membrane chemistry, and the resulting monophasic electrospray deposition (MED) parameters will be applied to contorted TBDTMC and TYDTMC chemistries. The goal of this work was to fabricate MPDTMC membranes by that demonstrated equivalent desalination performance to MPDTMC membranes fabricated by mLbL deposition.

MPDTMC membranes fabricated with 50-100 passes in MED exhibited relatively low NaCl rejection and high water permeance, indicating that the polyamide film was not completely formed or defects were present. When water permeance and NaCl rejection are plotted as a function of monomer mass deposition, as shown in FIG. 28, it is apparent that insufficient monomer mass has been deposited on the membrane to achieve the targeted permselectivity (equivalent to approximately 0.80 L m⁻¹ h⁻¹ bar⁻¹ and 99% rejection for the mLbL MPDTMC membrane).

Two strategies were pursued to increase the monomer mass deposition. Monomer concentrations were increased, but the TMC monomer solution began to crystallize at the tip of the electrospray needle, which inhibited the monophasic electrospray deposition (MED) process. Simply extending the duration of the monophasic electrospray deposition (MED) electrospraying was a more successful strategy. Membrane fabrication by this extended duration monophasic electrospray deposition (MED) is ongoing, with performance results to be reported. Additionally, the applied voltage in the monophasic electrospray deposition (MED) process was reduced from 15 kV to 11 kV. The updated monophasic electrospray deposition (MED) system operating parameters are summarized in Table 13.

A TBDTMC polyamide membrane was also fabricated by monophasic electrospray deposition (MED) to demonstrate proof of concept for this contorted polyamide chemistry. At a monomer mass deposition of 0.265 mg cm-2 the TBDTMC membrane had an average water permeance of 108 L m⁻² h⁻¹ bar⁻¹ and 469% NaCl rejection. Additional TBDTMC membranes will be fabricated at higher monomer mass depositions to improve NaCl rejection.

TABLE 13
System parameters for monophasic electrospray
deposition (MED) of polyamide films

| Parameter | | | | |
|---|---|---|---|---|
| Monomer | Value | | | |
| solutions | MPD | TBD | TYD | TMC |
| Monomer | 108.14 | 840.71 | 858.72 | 265.48 |
| molecular | | | | |
| weight (g mol − 1) | | | | |
| Solvent | ethanol | ethanol | ethanol | ethanol |
| Diamine to TMC | 4 | 4 | 4 | — |
| monomer molar | | | | |
| ratio | | | | |
| Monomer | 0.20 | 0.20 | 0.20 | 0.12 |
| solution | | | | |
| concentration | | | | |
| (% wt) | | | | |
| Monophasic | | | | |
| electrospray | | | | |
| deposition | | | | |
| (MED) | | | | |
| parameters: | | | | |

| | |
|---|---|
| Monomer | 10 |
| solution | |
| discharge rate | |
| (uL h − 1) | |
| Needle-to- | 4 |
| collector | |
| distance (cm) | |
| Applied voltage | 11 |
| (kV) | |
| Substrate | Silicon wafer, polyacrylonitrile membrane |
| Collector | 80-100 |
| rotation speed | |
| (rpm) | |
| Monomer mass | >0.005 mg cm − 3 |
| deposition | |

### Confirming Work:

Work on Task #2 will continue to fabricate MPDTMC and contorted polyamide membranes by monophasic electrospray deposition (MED). The membranes will be fabricated with high masses of deposited monomers to match the desalination performance of mLbL polyamide membranes. When equivalent desalination performance has been achieved, the monophasic electrospray deposition (MED) polyamide membranes will be characterized by powder XRD and carbon dioxide (CO₂) physisorption, similar to the films fabricated by mLbL deposition. Polyamide membranes will be fabricated by monophasic electrospray deposition (MED) for the TBDTMC and TYDTMC systems in addition to the MPDTMC polyamide system.

### Example 16—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior

### Work Performed:

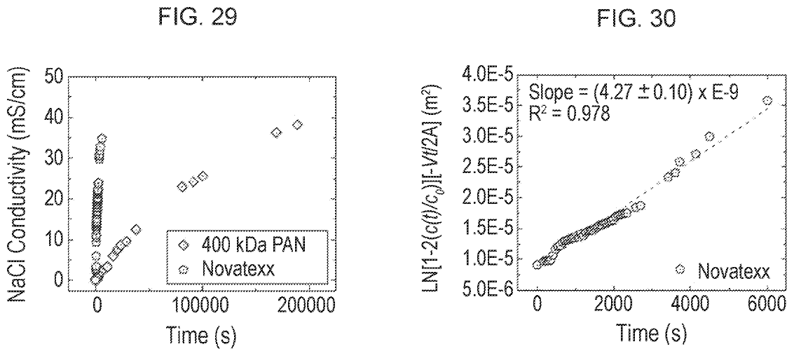

As discussed above herein, initial salt diffusion tests were conducted to measure the salt permeabilities of commercial membranes that are used as support layers for the fabricated contorted polyamide membranes. Salt permeability Ps was measured directly using a diffusion cell, as described by Luo, Geise et al. (ACS Applied Materials & Interfaces, 2018, 10, 4102-4112). A membrane support was sealed between a stirred donor chamber with an initial NaCl salt conductivity of 90 mS/cm and a stirred receiver chamber filled with an equivalent volume of deionized water. The change in the conductivity of the receiver chamber was monitored over time. FIG. 29 compares the measured conductivities for two different membrane support materials: 400 kDa polyacrylonitrile (PAN) and Novatexx, an unwoven polypropylene fabric.

The NaCl conductivity of the 400 kDa PAN membrane, upon which mLbL and monophasic electrospray deposition (MED) polyamide membranes are fabricated, was much lower than the conductivity of the Novatexx nonwoven material. The low NaCl conductivity of the polyacrylonitrile (PAN) membrane could potentially interfere with salt permeability measurements for the polyamide films. Consequently, all salt permeability measurements for polyamide films will be made for films supported on Novatexx fabric.

The salt permeability Ps of the Novatexx fabric was calculated by application of Equation 16 from Luo, Geise et al. (ACS Applied Materials & Interfaces, 2018, 10, 4102-4112):

$$ln [ 1 - 2 \frac{{c}_{R} ( t )}{{c}_{D} ( 0 )} ] [ - \frac{Vl}{2 A} ] = {P}_{s} t \qquad Equation 16$$

where c_{R}(t) is the conductivity of the receiving diffusion cell chamber over time
c_{D}(0) is the initial conductivity of the donor diffusion cell chamber
V is the volume of the donor and receiver cells
l is the membrane thickness
A is the membrane area
t is time.

The slope of a linear fit to the concentration expression on the left-hand side of Equation 16 versus time is the salt permeability Ps. Fitting Equation 16 to the conductivity data for the Novatexx support membrane, as shown in FIG. 30, yields a salt permeability of Ps=(4.27±0.10)×10⁻⁹ m² s⁻¹.

### Continuing Work:

Measurements of salt permeabilities for MPDTMC and contorted TBDTMC and TYDTMC polyamide films will be made using the diffusion cell test method. Measurements will be made for polyamide films at thickness that are hypothesized to yield >99% NaCl rejection. Measured film densities (via ellipsometry) will be used to calculate theoretical fractional free volumes (FFV) for the different polyamide materials. The calculated fractional free volumes (FFV) of polyamide films will serve as a basis of comparison for experimental characterizations of fractional free volumes (FFV) from powder XRD and CO₂ sorption isotherm measurements. Fractional free volumes (FFV) values will also be used to fit diffusivity transport models to measured water and salt permeabilities.

### Overview and Objectives of Example 17—Example 19 (Qtr 4 Tpr 1-31-2023)

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable monophasic electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by monophasic electrospray deposition (MED); Task #3—Relate the permeability-selectivity performance of contorted polyamide membranes to solution-diffusion transport.

### Example 17—Controlling Polyamide Free Volume

### Goals/Work Outline:

Research efforts in Task #1 will synthesize polyamide polymers from water-insoluble contorted diamine monomers (Trager's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

### Polyamide Thin Film Synthesis and Membrane Fabrication

As discussed above herein, we reported the solvent systems used in mLbL fabrication of polyamide films and the corresponding growth rates of film thickness. The chemistry and free volume of the polyamide films were characterized. We fabricated thin-film composite MPDTMC, TBDTMC, and TYDTMC membranes by capturing floating polyamide films from a water bath onto polyacrylonitrile (PAN) porous membrane supports. The desalination performances of membranes prepared from the three polyamide chemistries were evaluated as a function of polyamide film thickness and were evaluated in long-term desalination performance testing. Now we report that additional polyamide film characterizations were made with X-ray photoelectron spectroscopy.

### Characteristics of Contorted Polyamide Polymers

As discussed above herein, d-spacings (from powder X-ray diffraction (XRD) patterns) were reported for the polyamide powders as estimates of the size of free volume elements. These relative d-spacings were consistent with Langmuir surface areas calculated for the polyamides from CO₂ adsorption-desorption isotherm measurements, as summarized in Table 14. As discussed above herein, chemistry of the polyamide films was previously characterized by FT-IR spectroscopy and by measured surface zeta potentials.

TABLE 14
Calculated d-spacing from intensity peaks in powder
XRD patterns and Langmuir surface areas from CO₂
sorption isotherms for polyamide powders.

| Polyamide | d-spacing | Langmuir Surface |
|---|---|---|
| Powder | (Å) | Area (m²g⁻¹) |
| MPDTMC | 3.6 | 39.5 |
| TBDTMC | 3.8, 4.6 | 80.1 |
| TYDTMC | 4.1, 4.9, 6.7 | 143 |

Now we report that the chemistry and degree of crosslinking of the polyamide films were further characterized by X-ray photoelectron spectroscopy (XPS). XPS measurements were made at Argonne National Laboratory, and argon sputtering was employed to clean the surfaces of the polyamide films before the measurement. The resulting XPS survey spectra for the conventional MPDTMC and contorted TBDTMC and TYDTMC polyamide films are shown in FIG. 31A, FIG. 31B, and FIG. 31C, respectively. The elemental compositions of the films (% weight) as measured by XPS are summarized in Table 15.

TABLE 15
Polyamide elemental composition (% weight)
from X-ray photoelectron spectroscopy.

| | | | | | Theoretical | Theoretical |
|---|---|---|---|---|---|---|
| Polyamide | Carbon | Oxygen | Nitrogen | O/N | O/N (Fully | O/N (Fully |
| Film | (%) | (%) | (%) | (Calculated) | Crosslinked) | Linear) |
| MPDTMC | 74.7 | 12.3 | 13.0 | 0.95 | 1 | 2 |
| TBDTMC | 79.3 | 8.83 | 11.8 | 0.75 | 0.5 | 1 |
| TYDTMC | 89.0 | 5.62 | 5.39 | 1.04 | 1 | 2 |

XPS results indicate that the polyamide films are entirely composed of carbon, oxygen, and nitrogen. The degree of crosslinking can be estimated by comparing the calculated O/N elemental ratio to the theoretical ratios that would be measured for fully crosslinked and fully linear polyamide films of the same chemistry. Calculated O/N ratios for MPDTMC and TYDTMC films are near the theoretical ratio O/N=1 for a fully crosslinked film. The calculated ratio O/N=0.75 for TBDTMC polyamide is between the theoretical values for a fully linear (O/N=1) and fully crosslinked (0/N=0.5). The baseline of the XPS spectrum for the TBDTMC film shows some impurity peaks, which may have contributed to the calculated O/N ratio less than the hypothesized value for a fully crosslinked TBDTMC film. We intend to repeat the XPS measurement for the TBDTMC film to confirm this observation.

### Desalination Performance of Contorted Polyamide Membranes

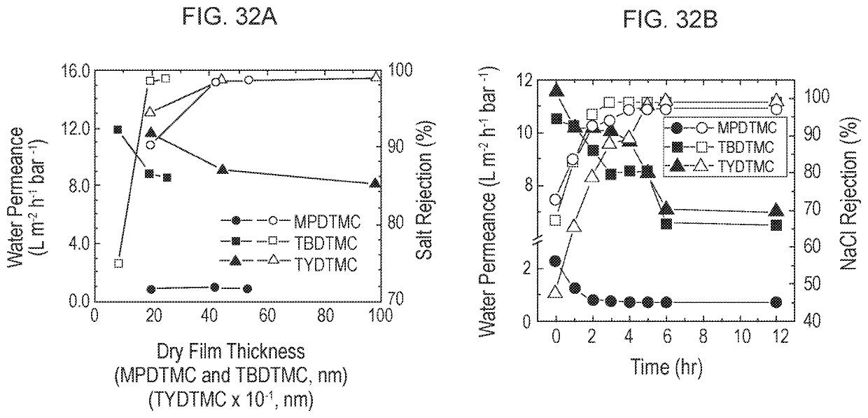

As discussed above herein, the water permeances and NaCl rejections of MPDTMC, TBDTMC, and TYDTMC membranes fabricated by mLbL deposition were compared as a function of polyamide film thickness. As a result of their increased free volume, the TBDTMC and TYDTMC contorted polyamide membranes of the present invention showed enhanced permselectivity compared to the conventional MPDTMC polyamide membrane, as shown in FIG. 32A. Longer duration desalination performance tests, shown in FIG. 32B, were also conducted for the mLbL fabricated polyamide membranes that demonstrated ~99% NaCl rejections in preliminary performance tests to verify long-term performance.

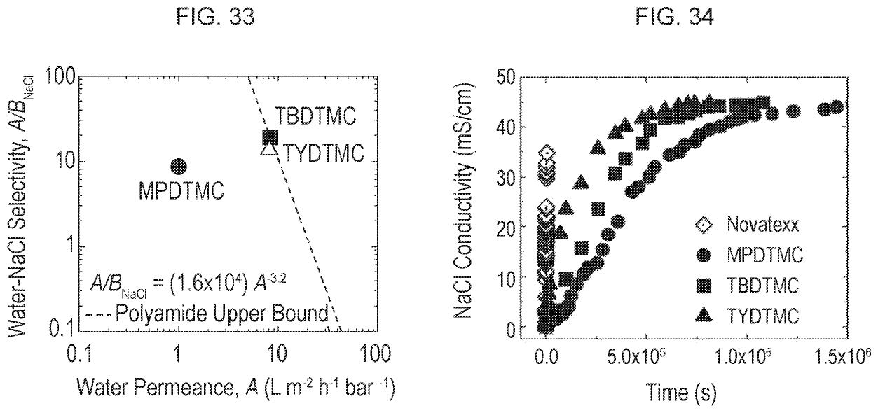

The permselectivity of the mLbL polyamide membranes that achieved 99% NaCl rejection (FIG. 32A) is compared to the reported “upper bound” of permselectivity for polyamide desalination membranes in FIG. 33. The selectivity of the membranes is represented by the ratio of water permeance, A (L m⁻¹ h⁻¹ bar⁻¹) and NaCl permeance, B_{NaCl} (L m⁻² h⁻¹). NaCl permeance was calculated from measured water flux and NaCl rejection according to the solution-diffusion model.

$${B}_{NaCl} = {J}_{w} ( \frac{1}{{R}_{NaCl}} - 1 ) \qquad ( Equation 17 )$$

When selectivity A/B_{NaCl} is plotted against water permeance, A, the well-documented permeability-selectivity tradeoff is observed. The upper bound of this permselectivity for polyamide membranes was defined by Yang, Guo, and Tang (Z. Yang, H. Guo, C. Y. Tang, The upper bound of thin-film composite (TFC) polyamide membranes for desalination, Journal of Membrane Science. 590 (2019) 117297) from an analysis of over 1,200 reported experimental observations of NaCl rejection and water permeance, as shown in FIG. 33.

The TBDTMC membrane has the highest permselectivity of the three polyamide membranes studied. At a water permeance of 8.62 L m⁻² h⁻¹ bar⁻¹, the selectivity of the TBDTMC polyamide membrane (A/B_{NaCl}=19.3 bar⁻¹) exceeds the polyamide upper bound, which would predict a selectivity of 16.2 bar⁻¹. The TYDTMC membrane also exhibits high permselectivity near the polyamide upper bound. The selectivities of the MPDTMC, TBDTMC, and TYDTMC membranes are compared to the corresponding selectivities predicted by the upper bound in Table 16.

TABLE 16
Water-NaCl selectivity of MPDTMC, TBDTMC, and TYDTMC
membranes compared to the polyamide upper bound.

| | | | Polyamide |
|---|---|---|---|
| | | Observed | Upper Bound |
| | Water Permeance, | Selectivity | Selectivity, |
| Polyamide | A (L m − 2 h − 1 | A/BNaCl | A/BNaCl |
| Membrane | bar − 1) | (bar − 1) | (bar − 1) |
| MPDTMC | 1.01 | 8.84 | 15700 |
| TBDTMC | 8.62 | 19.3 | 16.2 |
| TYDTMC | 8.14 | 14.1 | 19.5 |

### Continuing Work:

Continuing research on Task #1 will include a duplicate characterization of TBDTMC contorted polyamide membrane by X-ray photoelectron spectroscopy (XPS) to evaluate the degree of crosslinking. Additionally, we have secured beam time at the Advanced Photon Source (APS) at Argon National Lab to conduct small-angle X-ray scattering (SAXS) and X-ray reflectivity (XRR) experiments for a series of MPDTMC and TBDTMC polyamide films with thicknesses ranging from ~10 nm to ~80 nm. For the experiments, films must be deposited directly on silicon wafer substrates, which was a challenge for the TYDTMC films, and thus, TYDTMC polyamide is excluded from the measurements. The results of these experiments will be measurements of the densities and thicknesses of the MPDTMC and TBDTMC films.

### Example 18—Fabricating Membranes by Monophasic Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed:

As discussed above herein the optimization of electrospray parameters for the monophasic electrospray deposition (MED) system with the goal of producing consistent polyamide films with controllable thickness. Monophasic electrospray deposition (MED) operating parameters were optimized for MPDTMC membrane fabrication from ethanol monomer solutions by adjusting collector rotation speed, needle-to-collector distance, and applied voltage to achieve a uniform solvent discharge cone and uniform polymer coverage. The fabricated MPDTMC membranes exhibited relatively low NaCl rejection and high water permeance, indicating that the polyamide film was not completely formed or defects were present.

Now we report that monophasic electrospray deposition (MED) membrane fabrication efforts continued with the goal of fabricating MPDTMC membranes with 99% NaCl rejection to match the performance of MPDTMC membranes fabricated by mLbL deposition. After extensive testing for electrospraying polyamide membranes using a monophasic system of monomer solutions in ethanol, we have determined that two different monomer solutions that can form an interface are necessary to successfully fabricate salt-rejecting polyamide films by electrospray deposition. This conclusion is consistent with published work electrospraying polyamide membranes with two immiscible phases (X.-H. Ma, Z. Yang, Z.-K. Yao, H. Guo, Z.-L. Xu, C. Y. Tang, Interfacial Polymerization with Electrosprayed Microdroplets: Toward Controllable and Ultrathin Polyamide Membranes, Environ. Sci. Technol. Lett. 5 (2018) 117-122; M. Ostwal, E. Wazer, M. Pemberton, J. R. McCutcheon, Scaling electrospray based additive manufacturing of polyamide membranes, Journal of Membrane Science Letters. 2 (2022) 100035). Without being bound by theory, we hypothesize that the monophasic system successfully fabricates polyamide films by mLbL deposition because a reaction interface is introduced in the mLbL system with every monomer deposition cycle. In the monophasic electrospray deposition (MED) system, we observed polyamide powders forming more readily than polyamide films, indicating a reaction in the bulk solution. For the electrospray deposition conditions we have optimized, an ethanol organic solvent is still used to help solubilize the bulky contorted TBD and TYD diamine monomers and because of its excellent properties as an electrosprayable solvent. We found that dissolving the diamine monomer a water/ethanol cosolvent mixture (⅕ volumetric ratio) and dissolving the TMC monomer in hexane yielded the most consistent polyamide films by visual inspection. The updated electrospray deposition system operating parameters are summarized in Table 17.

TABLE 17
System parameters for electrospray deposition of polyamide films

| Parameter | | | | |
|---|---|---|---|---|
| Monomer | Value | | | |
| solutions | MPD | TBD | TYD | TMC |
| Monomer | 108.14 | 840.71 | 858.72 | 265.48 |
| molecular | | | | |
| weight | | | | |
| (g mol − 1) | | | | |
| Solvent | Water/ | Water/ | Water/ | hexane |
| | ethanol (⅕ | ethanol (⅕ | ethanol (⅕ | |
| | volumetric | volumetric | volumetric | |
| | ratio | ratio | ratio | |
| Diamine to TMC | 4 | 4 | 4 | — |
| monomer molar | | | | |
| ratio | | | | |
| Monomer | 2.0 | 2.0 | — | 1.2 |
| solution | | | | |
| concentration | | | | |
| (% wt) | | | | |
| Miscible-phase | | | | |
| electrospray | | | | |
| deposition | | | | |
| (MED) | | | | |
| parameters: | | | | |

| | |
|---|---|
| Monomer | 3 |
| solution | |
| discharge rate | |
| (ML h − 1) | |
| Needle-to- | 3 |
| collector | |
| distance (cm) | |
| Applied voltage | 12 |
| Substrate | Polyacrylonitrile membrane |
| Collector | 80-100 |
| rotation speed | |
| (rpm) | |
| Monomer mass | 0.375 mg cm − 2 |
| deposition | |

### Continuing Work:

Work on Task #2 will continue to fabricate MPDTMC and contorted TBDTMC and TYDTMC polyamide membranes by electrospray deposition using the water/ethanol cosolvent for diamine monomer solutions. We are confident that previous challenges with electropraying the polyamide have been overcome, and, we are working to produce electrosprayed polyamide membranes that have equivalent desalination performance to mLbL polyamide membranes. When equivalent desalination performance has been achieved, the electrosprayed polyamide membranes will be characterized by powder XRD and carbon dioxide (CO₂) physisorption, similar to the films fabricated by mLbL deposition.

### Example 19—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior

### Work Performed:

As discussed above herein, initial salt diffusion tests were conducted to measure the salt permeabilities of commercial membranes, which was the basis for selecting Novatexx fabric as the support layer for salt permeability measurements of polyamide films. The salt permeability P, was calculated from diffusion cell tests by application of Equation 18 from Luo, Geise et al. (H. Luo, J. Aboki, Y. Ji, R. Guo, G. M. Geise, Water and Salt Transport Properties of Triptycene-Containing Sulfonated Polysulfone Materials for Desalination Membrane Applications, ACS Appl. Mater. Interfaces. 10 (2018) 4102-4112).

$$ln [ 1 - 2 \frac{{c}_{R} ( t )}{{c}_{D} ( 0 )} ] [ - \frac{Vl}{2 A} ] = {P}_{s} t \qquad ( Equation 18 )$$

where c_{R}(t) is the conductivity of the receiving diffusion cell chamber over time
c_{D}(0) is the initial conductivity of the donor diffusion cell chamber
V is the volume of the donor and receiver cells
l is the membrane thickness
A is the membrane area
t is time
   The slope of a linear fit to the concentration expression on the left-hand side of Equation 18 versus time is the salt permeability Pₛ.

Now we report that the salt permeability Pₛ was measured for MPDTMC, TBDTMC, and TYDTMC polyamide films at thicknesses hypothesized to yield 99% NaCl rejection based on desalination performance testing. Polyamide films were supported on Novatexx fabric and sealed between a stirred donor chamber with an initial NaCl salt conductivity of 90 mS/cm and a stirred receiver chamber filled with an equivalent volume of deionized water. The change in the conductivity of the receiver chamber were monitored over time. The measured conductivities of the receiver chamber are compared over time in FIG. 34 for the three polyamide films.

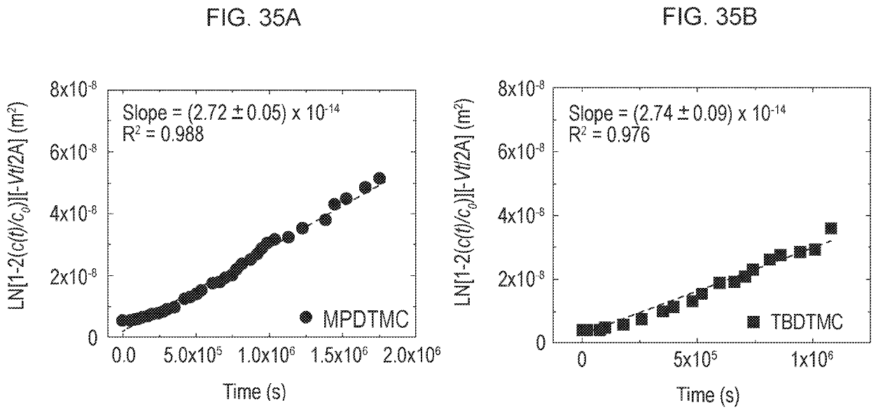

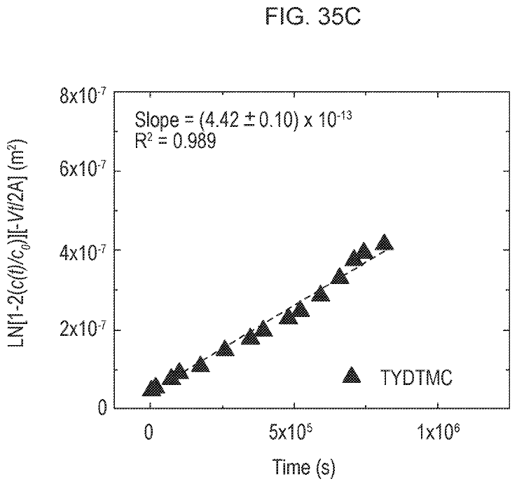

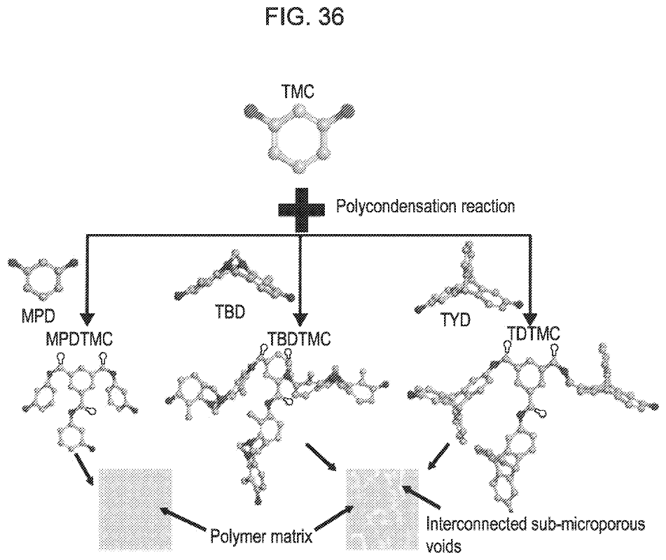

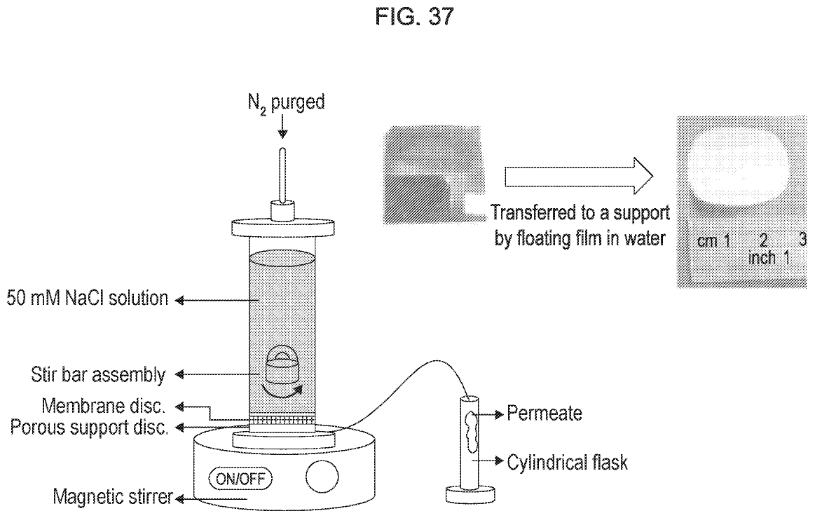

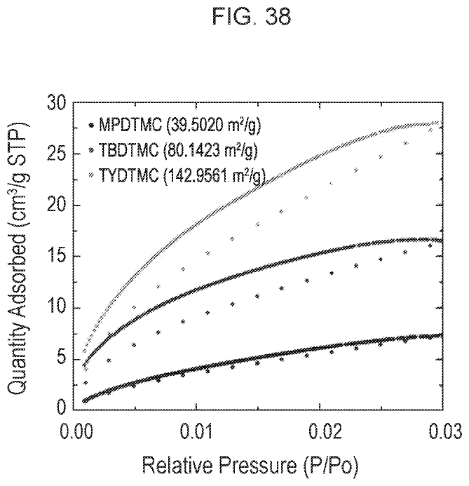

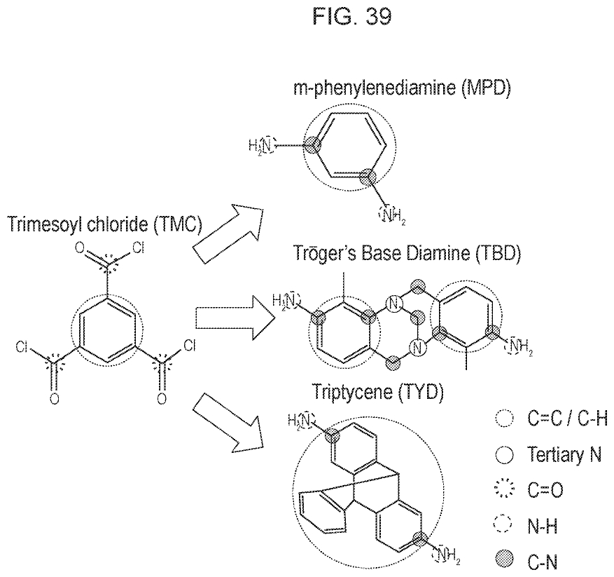

Fitting Equation 18 to the conductivity data for the three polyamide films yielded the NaCl permeabilities, Pₛ, as shown in FIG. 35A-FIG. 35C. The estimated salt permeabilities for the MPDTMC, TBDTMC, and TYDTMC polyamide films are summarized in Table 18 and compared to the Novatexx support and to NaCl bulk diffusion for reference.

TABLE 18
NaCl permeabilities of polyamide films measured from
diffusion tests compared to reference materials.

| Polyamide | Estimated Film | NaCl Permeability, |
|---|---|---|
| Film | Thickness (nm) | Ps (m² s⁻¹) |
| MPDTMC | 38 | (2.72 +/− 0.05) × 10⁻¹⁴ |
| TBDTMC | 25 | (2.74 +/− 0.09) × 10⁻¹⁴ |
| TYDTMC | 980 | (4.42 +/− 0.10) × 10⁻¹³ |
| Novatexx Support | — | (4.27 +/− 0.10) × 10⁻⁰⁹ |
| NaCl bulk diffusion | | 1.5 × 10⁻⁰⁹ |

### Continuing Work:

During the next reporting period, free volume-based transport modeling will commence. We are working to have measured film densities via SAXS and XRR experiments at APS. These densities will be used to calculate theoretical fractional free volumes (FFV) for the different polyamide materials. The calculated fractional free volume (FFV) of polyamide films will serve as a basis of comparison for experimental characterizations of fractional free volume (FFV) from powder XRD and CO₂ sorption isotherm measurements. Fractional free volume (FFV) values will be used to fit diffusivity transport models to measured water and salt permeabilities.

### Overview and Objectives of Example 20—Example 22

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers. Task #2—Fabricate contorted polyamide membranes by electrospray deposition. Task #3—Relate the permeability-selectivity performance of contorted polyamide membranes to solution-diffusion transport.

### Example 20—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

As discussed above herein, we reported the solvent systems used in mLbL fabrication of polyamide films and the corresponding growth rates of film thickness. As discussed above herein, we reported challenges in adhering TYDTMC films to a silicon wafer substrate during mLbL fabrication. By changing the TYD monomer solvent to acetone (rather than toluene) and eliminating the TYD rinsing step, films were successfully deposited on silicon wafer substrates coated with a sacrificial polystyrene sulfonic acid (PSS) coating. After floating the TYDTMC polyamide films on a water bath, they were captured on silicon wafers, allowed to air dry, and film thickness measurements were made using surface profilometry. The resulting TYDTMC growth rate of 71.5±18.7 nm/cycle was two orders of magnitude greater than the growth rates for MPDTMC and TBDTMC films.

Now we report that we were able to directly deposit TYDTMC polyamide films on silicon wafer substrates by first functionalizing the wafer with (3-aminopropyl)triethoxysilane (APTES) amino-silane agent. Cleaned silicon wafers were submerged into a 1% v/v solution of APTES in anhydrous toluene for 1 h, washed with ethanol and toluene, and dried overnight in a vacuum oven at 90° C. The functionalization enriched the surfaces of the silicon wafers in amino functional groups. These amino groups formed amine bonds with deposited TMC monomer during the mLbL process, thus anchoring the growing TYDTMC polyamide film to the silicon wafer substrate.

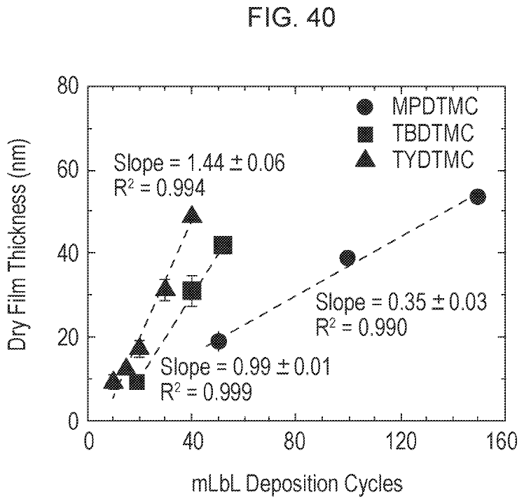

A new growth rate curve for TYDTMC polyamide was constructed by measuring the thicknesses of five films deposited with 10-40 mLbL cycles on APTES-functionalized silicon wafers. Thickness measurements were made by interferometry, and the refractive index was described by the Cauchy equation (A=1.601 and B=0.02564). The new growth rate for the TYDTMC film is compared to the previously established growth rates for MPDTMC and TBDTMC polyamide films in FIG. 40.

We fabricated thin-film composite MPDTMC, TBDTMC, and TYDTMC membranes by capturing floating polyamide films from a water bath onto polyacrylonitrile (PAN) porous membrane supports. The desalination performances of membranes prepared from the three polyamide chemistries were evaluated as a function of polyamide film thickness and were evaluated in long-term desalination performance testing.

### Characteristics of Contorted Polyamide Polymers

As discussed above herein, d-spacings (from powder X-ray diffraction (XRD) patterns) were reported for the polyamide powders as estimates of the size of free volume elements. These relative d-spacings were consistent with Langmuir surface areas calculated for the polyamides from CO₂ adsorption-desorption isotherm measurements. The chemistry of the polyamide films was previously characterized by FT-IR spectroscopy and by measured surface zeta potentials.

As discussed above herein, the chemistry and degree of crosslinking of the polyamide films were characterized by X-ray photoelectron spectroscopy (XPS) measurements made at Argonne National Laboratory. The degree of crosslinking of the polyamides was estimated by comparing the calculated O/N elemental ratio to the theoretical ratios that would be measured for fully crosslinked and fully linear polyamide films of the same chemistry. The baseline of the XPS spectrum for the TBDTMC film showed some impurity peaks, which may have contributed to its calculated O/N ratio less than the hypothesized value for a fully crosslinked TBDTMC film.

Now we report that we have repeated the XPS measurement for the TBDTMC film to confirm the degree of crosslinking. The XPS survey spectrum was analyzed for a TBDTMC film whose baseline did not show evidence of impurity peaks. The new TBDTMC XPS survey spectrum is compared to the spectra for conventional MPDTMC and contorted TYDTMC polyamide films in FIG. 31A-FIG. 31C. The elemental compositions of the films (% weight) and degree of polyamide network crosslinking are summarized in Table 19, including the updated TBDTMC polyamide measurement.

TABLE 19
Polyamide elemental composition (% weight)
from X-ray photoelectron spectroscopy.

| | | | | | Theoretical | Theoretical |
|---|---|---|---|---|---|---|
| Polyamide | Carbon | Oxygen | Nitrogen | O/N | O/N (Fully | O/N (Fully |
| Film | (%) | (%) | (%) | (Calculated) | Crosslinked) | Linear) |
| MPDTMC | 74.7 | 12.3 | 13.0 | 0.95 | 1 | 2 |
| TBDTMC | 85.4 | 4.97 | 9.61 | 0.52 | 0.5 | 1 |
| TYDTMC | 89.0 | 5.62 | 5.39 | 1.04 | 1 | 2 |

The new calculated O/N ratio for the TBDTMC film is 0.52, which is near the theoretical ratio O/N=0.5 for a fully crosslinked film. The previously determined O/N ratio was 0.75 for a TBDTMC film that showed evidence of contamination. The calculated O/N ratios summarized in Table 19 are all within 5% of the respective theoretical values for fully crosslinked networks, indicating monomer reactivity is maintained and near complete monomer conversion to crosslinked polymer is achieved in the mLbL deposition process.

### Desalination Performance of Contorted Polyamide Membranes

As discussed above herein, the water permeances and NaCl rejections of MPDTMC, TBDTMC, and TYDTMC membranes fabricated by mLbL deposition were compared as a function of polyamide film thickness. As a result of their increased free volume, the TBDTMC and TYDTMC contorted polyamide membranes showed enhanced permselectivity compared to the conventional MPDTMC polyamide membrane. Long-duration (12 h) performance tests were also conducted for the mLbL fabricated polyamide membranes that demonstrated ~99% NaCl rejections in preliminary performance tests.

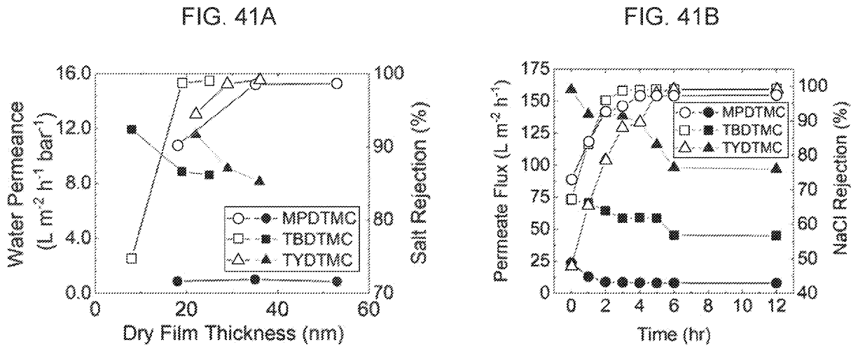

In FIG. 41A, as discussed above herein desalination results as a function of polyamide film thickness are updated with the new thicknesses of TYDTMC membranes determined with the newly established TYDTMC growth curve (FIG. 40). In FIG. 41B long-term desalination testing data are compared for the MPDTMC (~35 nm thick), TBDTMC (~25 nm thick), and TYDTMC (~36 nm thick) membranes that exhibited 99% NaCl rejection. Permeate flux and NaCl rejection are reported hourly for the 12 h performance test. FIG. 41B has been updated to show permeate flux data collected at the same time as salt rejection data, rather than showing water permeance results from a separate long-term desalination test.

As discussed above herein, we compared the permselectivity of the mLbL polyamide membranes that achieved 99% NaCl rejection (FIG. 41A) to the reported “upper bound” of permselectivity for polyamide desalination membranes. The selectivity of the membranes is represented by the ratio A/B_{NaCl} (bar⁻¹) of water permeance, A (L m⁻¹ h⁻¹ bar⁻¹) and NaCl permeance, B_{NaCl} (L m⁻² h⁻¹). NaCl permeance B_{NaCl} was calculated from measured permeate flux and NaCl rejection (FIG. 41A) according to the solution-diffusion model.

$${B}_{NaCl} = J ( \frac{1}{{R}_{NaCl}} - 1 ) \qquad ( Equation 19 )$$

where J is the permeate flux with NaCl feed solution, and R_{NaCl} is the measured NaCl rejection with the same NaCl feed solution. When selectivity A/B_{NaCl} is plotted against water permeance, A, the well-documented permeability-selectivity tradeoff is observed. The reported upper bound of this permselectivity for polyamide membranes has been defined from an analysis of over 1,200 experimental observations of NaCl rejection and water permeance Z. Yang, H. Guo, C. Y. Tang, The upper bound of thin-film composite (TFC) polyamide membranes for desalination, Journal of Membrane Science. 590 (2019) 117297.

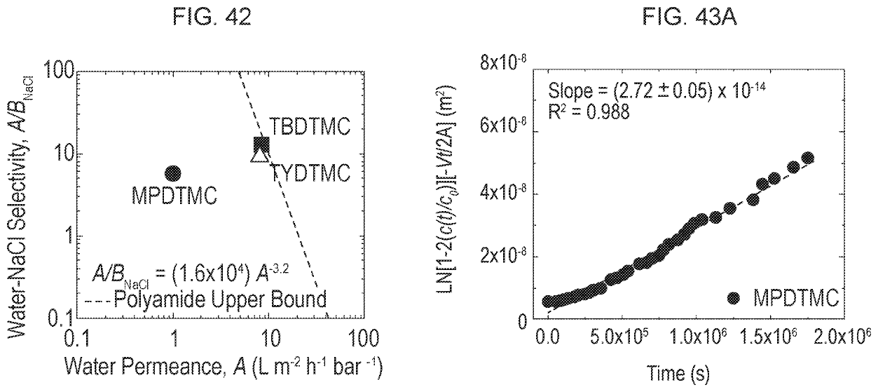

Unfortunately, incorrect BNaCl values calculated from Equation 19 were reported previously due to a spreadsheet calculation error that resulted in smaller values than the correct BNaCl values. This resulted in overestimation of the A/BNaCl selectivities for the polyamide membranes. Previously reported A/BNaCl selectivities were overestimated by approximately 52%. The corrected A/BNaCl selectivities for the polyamide membranes are compared to the polyamide permselectivity upper bound in FIG. 42. Previously reported and newly corrected BNaCl values and A/BNaCl selectivities are summarized in Table 20.

Permselectivities for the TBDTMC and TYDTMC membranes approach the established polyamide upper bound. The TBDTMC membrane permselectivity is the highest of the three polyamide membranes studied with a selectivity A/BNaCl=12.7 bar⁻¹ at a water permeance of 8.62 L m⁻² h⁻¹ bar⁻¹, which approaches the polyamide upper bound that would predict a selectivity of 16.2 bar⁻¹. The TBDTMC permselectivity does not exceed the polyamide upper bound as reported in the previous quarter. The TYDTMC membrane also exhibits high permselectivity near the polyamide upper bound, with observed selectivity of 9.23 bar⁻¹ compared to an upper bound prediction of 19.5 bar⁻¹.

TABLE 20
Updated corrected water-NaCl selectivity
of MPDTMC, TBDTMC, and TYDTMC membranes
compared to the polyamide upper bound.

| | | Updated | Previously | Polyamide |
|---|---|---|---|---|
| | Water | Corrected | Reported | Upper Bound |
| | Permeance, A | Selectivity, | Incorrect | Selectivity, |
| Polyamide | (L m⁻² h⁻¹ | A/BNaCl | Selectivity | A/BNaCl |
| Membrane | bar⁻¹) | (bar⁻¹) | A/BNaCl | (bar⁻¹) |
| MPDTMC | 1.01 | 5.81 | 8.84 | 15700 |
| TBDTMC | 8.62 | 12.7 | 19.3 | 16.2 |
| TYDTMC | 8.14 | 9.23 | 14.1 | 19.5 |

### Continuing Work:

As discussed above herein, small-angle X-ray scattering (SAXS) and X-ray reflectivity (XRR) measurements were made at the Advanced Photon Source (APS) at Argon National Lab for a series of MPDTMC, TBDTMC, and TYDTMC polyamide films with thicknesses ranging from ~10 nm to ~80 nm. Continuing work on Task #1 we will analyze the XRR and SAXS data to estimate the densities, thicknesses, and water volume fractions of the measured polyamide films.

The desalination performance of commercial polyamide membranes, specifically Dow FilmTec SW30 reverse osmosis membrane and Dow FilmTec NF270 nanofiltration membrane, will be measured for comparison to the mLbL polyamide membranes synthesized in this work described herein. Water and salt permeances of the SW30 and NF270 membranes will be calculated and included on the permselectivity plot as commercial material references.

### Example 21—Fabricating Membranes by Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed:

As discussed above herein, the optimization of electrospray parameters for the monophasic electrospray deposition system with the goal of producing consistent polyamide films with controllable thickness. Previous efforts to optimize monophasic electrospray deposition system operating parameters were focused on conventional MPDTMC membranes. These membranes exhibited relatively low NaCl rejection and high water permeance, indicating that the polyamide film was not completely formed or defects were present. After further experimentation, we determined that two different monomer solutions that can form an interface were necessary to successfully fabricate salt-rejecting polyamide films by electrospray deposition, as reported in the literature (X.-H. Ma, Z. Yang, Z.-K. Yao, H. Guo, Z.-L. Xu, C. Y. Tang, Interfacial Polymerization with Electrosprayed Microdroplets: Toward Controllable and Ultrathin Polyamide Membranes, Environ. Sci. Technol. Lett. 5 (2018) 117-122; M. Ostwal, E. Wazer, M. Pemberton, J. R. McCutcheon, Scaling electrospray based additive manufacturing of polyamide membranes, Journal of Membrane Science Letters. 2 (2022)100035).

As discussed above herein, we described a shift to a two-phase electrospray deposition system using a water/ethanol cosolvent mixture (⅕ volumetric ratio) for the diamine monomers and hexane solvent for TMC monomer solution.

Now we report that we continued work on Task #2 to fabricate MPDTMC and contorted TBDTMC and TYDTMC polyamide membranes by electrospray deposition using the water/ethanol cosolvent for diamine monomer solutions. Initial efforts have focused on fabrication and performance testing of conventional MPDTMC polyamide membranes on polyacrylonitrile (PAN) porous supports. We have not yet produced electrosprayed MPDTMC membranes that have equivalent desalination performance (99% NaCl rejection) to the mLbL polyamide membranes. Optimization of the electrospray deposition process will continue, and experimentation will begin with TBDTMC and TYDTMC polyamides in addition to MPDTMC. When equivalent desalination performance has been achieved, the electrosprayed polyamide membranes will be characterized by powder XRD and carbon dioxide (CO₂) physisorption, similar to the films fabricated by mLbL deposition.

### Example 22—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior

### Work Performed:

### Salt Permeability of Polyamide Films

As discussed above herein, initial salt diffusion tests were conducted in a dual chamber diffusion cell to measure the salt permeabilities of commercial porous support membranes, which was the basis for selecting Novatexx fabric as the support layer for salt permeability measurements of polyamide films due to its relatively high NaCl permeability. The salt permeability, Pₛ (m^{2 s-1}), was calculated from diffusion cell tests by application of a model described by Luo, Geise et al (H. Luo, J. Aboki, Y. Ji, R. Guo, G. M. Geise, Water and Salt Transport Properties of Triptycene-Containing Sulfonated Polysulfone Materials for Desalination Membrane Applications, ACS Appl. Mater. Interfaces. 10 (2018) 4102-4112). NaCl salt permeability Ps was measured for MPDTMC, TBDTMC, and TYDTMC polyamide films at thicknesses hypothesized to yield 99% NaCl rejection based on desalination performance testing.

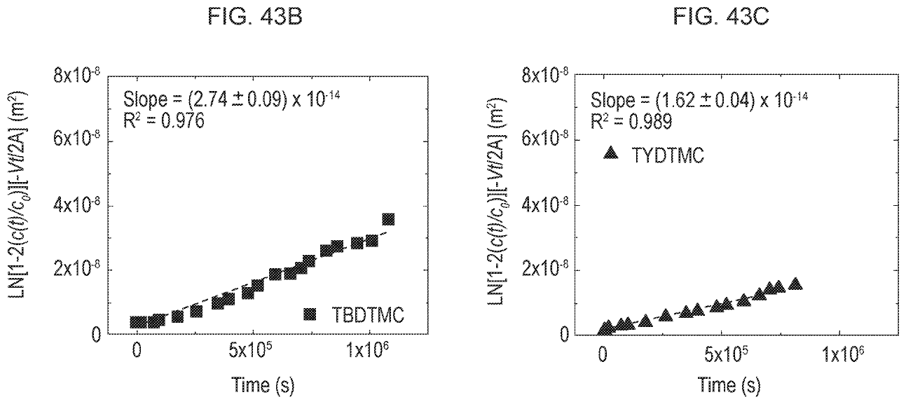

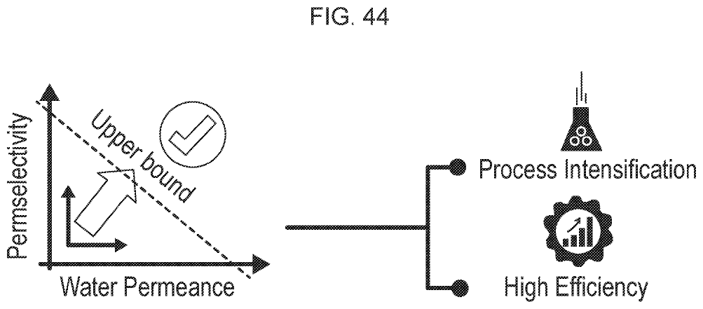

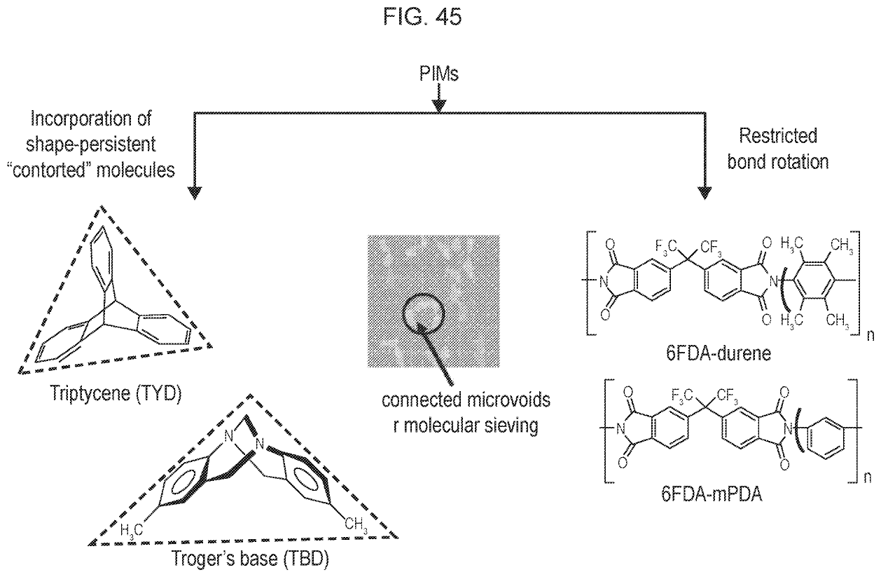

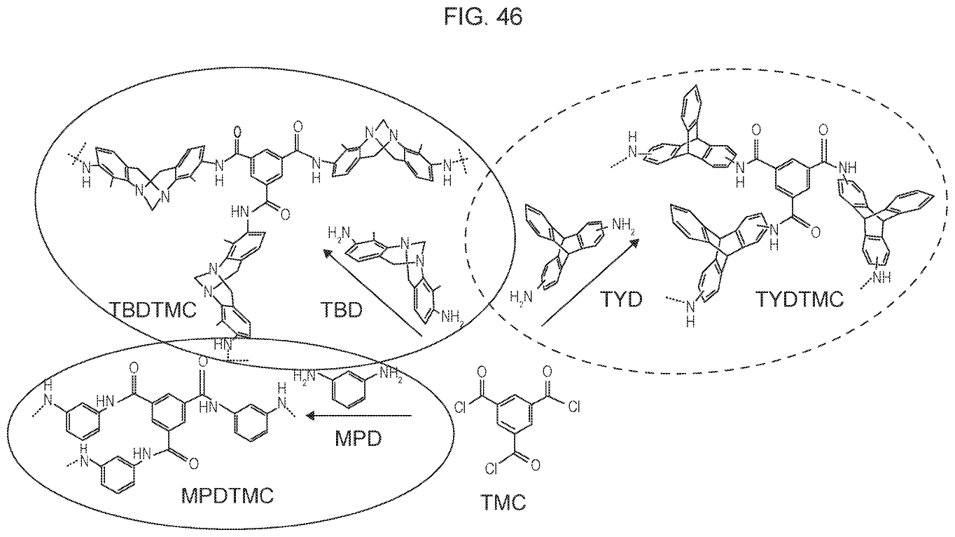

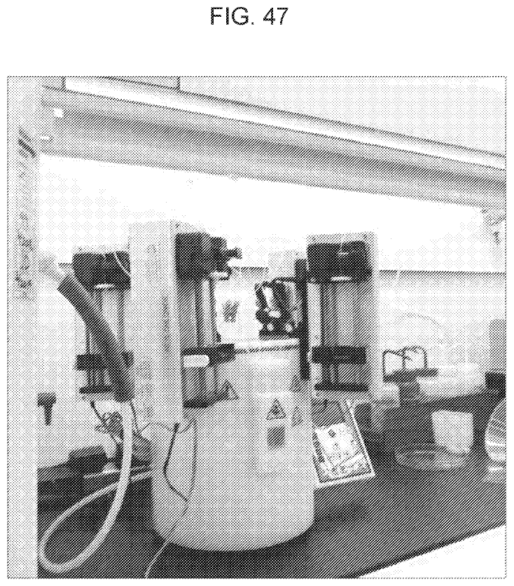

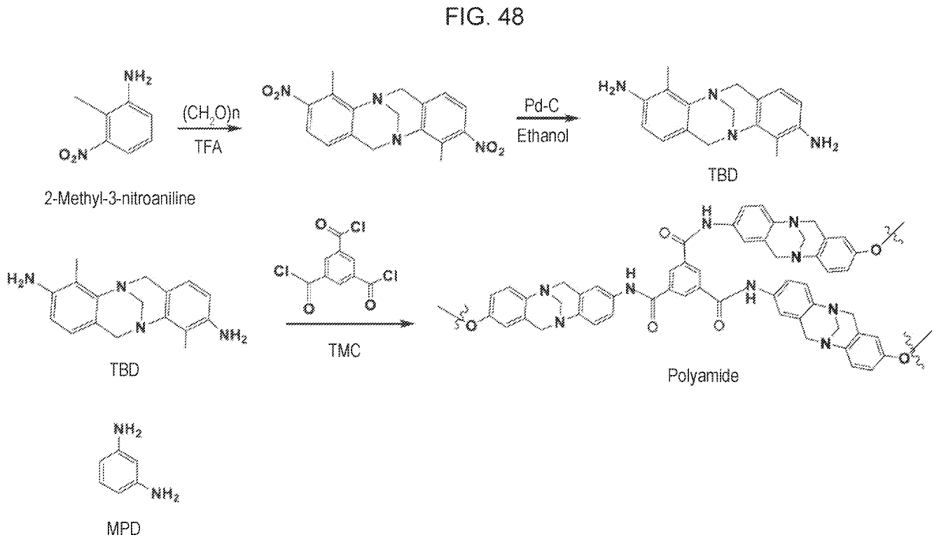

Salt permeability calculations incorporate the estimated thickness of polyamide film being measured. Thus, the calculated P, value previously reported for TYDTMC polyamide has been updated to use the new mLbL thickness growth curve measured for TYDTMC (FIG. 40). The updated NaCl permeability P, for TYDTMC polyamide is shown in FIG. 43C and is compared to the previously reported permeabilities for MPDTMC polyamide (FIG. 43A) and TBDTMC polyamide (FIG. 43B). The estimated salt permeabilities for the three polyamide films are summarized in Table 21 and compared to the Novatexx support and NaCl bulk diffusion for reference.

TABLE 21
NaCl permeabilities of polyamide films measured from
diffusion tests compared to reference materials.

| Polyamide | Estimated Film | NaCl Permeability, |
|---|---|---|
| Film | Thickness (nm) | Ps (m² s⁻¹) |
| MPDTMC | 38 | (2.72 +/− 0.05) × 10⁻¹⁴ |
| TBDTMC | 25 | (2.74 +/− 0.09) × 10⁻¹⁴ |
| TYDTMC | 36 | (1.62 +/− 0.04) × 10⁻¹⁴ |
| Novatexx Support | — | (4.27 +/− 0.10) × 10⁻⁰⁹ |
| NaCl bulk diffusion | | 1.5 × 10⁻⁰⁹ |

### Solution-Diffusion Transport Modeling

Now we report that diffusivity-dominated free volume-based transport models were applied to measured water and NaCl permeabilities to relate the observed transport behavior of the MPDTMC, TBDTMC, and TYDTMC polyamide films to their structural characteristics. Modeling results are still preliminary, but the modeling approach is described herein. Water and salt transport modeling was based on the classic solution diffusion model that describes penetrant permeability, P, of the polyamide films as the product of a solubility or partitioning coefficient, K, and the penetrant diffusion coefficient in the polymer network, D. For water, the solution diffusion model is expressed in Equation 20, where the subscript w refers to water, and the superscript D refers to diffusion.

$${P}_{w}^{D} = {K}_{w} {D}_{w} \qquad ( Equation 20 )$$

In Equation 20, the diffusive water permeability P_{W}^{D} of each polyamide membrane was calculated from the hydraulic water permeability P_{W}^{H}, which is described by measured water permeance A and polyamide film thickness t:

$${P}_{w}^{H} = A \times t \qquad ( Equation 21 )$$

$${P}_{w}^{D} = {P}_{w}^{H} \frac{RT}{{\overline{V}}_{w}} ( 1 - {K}_{w} ) \qquad ( Equation 22 )$$

The calculation of diffusive water permeability P_{W}^{D} from Equation 22 includes the universal gas constant R, absolute temperature T, partial molar volume of water V_{w} (1.8E-05 n⁻¹ mol⁻¹), and water partitioning coefficient K_{w}. The water partitioning coefficient K_{w} is effectively the volume fraction of water in the polyamide (H. Zhang, G. M. Geise, Modeling the water permeability and water/salt selectivity tradeoff in polymer membranes, Journal of Membrane Science. 520 (2016) 790-800) or the free volume of the hydrated polymer network (H. Yasuda, C. Lamaze, A. Peterlin, Diffusive and hydraulic permeabilities of water in waterswollen

polymer membranes, Journal of Polymer Science Part A-2: Polymer Physics. 9 (1971) 1117-1131). For the conventional and contorted polyamide films, K_{w} was estimated as Kw=0.10. This estimated water volume fraction K_{w} value will be updated in the future based on the analysis of SAXS measurements made for polyamide films at different relative humidities.

With measured diffusive water permeability P_{W}^{D} and estimated water volume fraction K_{w}, a water diffusion coefficient D_{w} through each polyamide film was then calculated according to solution-diffusion theory (Equation 20). The measured water diffusion coefficients D_{w} were fit with a free-volume based transport model derived by Yasuda et al. (H. Yasuda, C. Lamaze, A. Peterlin, Diffusive and hydraulic permeabilities of water in waterswollen polymer membranes, Journal of Polymer Science Part A-2: Polymer Physics. 9 (1971) 1117-1131) and applied by Zhang and Geise (H. Zhang, G. M. Geise, Modeling the water permeability and water/salt selectivity tradeoff in polymer membranes, Journal of Membrane Science. 520 (2016) 790-800) to polyamide membranes.

$${D}_{w} = {D}_{w}^{0} exp ( - β ( \frac{1}{{V}_{F , m}} - \frac{1}{{V}_{F , w}} ) ) \qquad ( Equation 23 )$$

In Equation 23, D_{W}^{D} is the self-diffusion coefficient of water (2.8E-09 m⁻² s⁻¹), V_{F,m} is the free volume of the hydrated membrane, and V_{F,w} is the free volume of water. The β term is a characteristic volume parameter that is proportional to the cross-section and diffusional jump length of the diffusing water (H. Zhang, G. M. Geise, Modeling the water permeability and water/salt selectivity tradeoff in polymer membranes, Journal of Membrane Science. 520 (2016) 790-800; H. Yasuda, C. Lamaze, A. Peterlin, Diffusive and hydraulic permeabilities of water in waterswollen polymer membranes, Journal of Polymer Science Part A-2. Polymer Physics. 9

(1971) 1117-1131) and thus, it is descriptive of the polyamide network structure. The free volume of water V_{F,w} was estimated as the van der Waals volume V_{vdw}, assuming a spherical shape and a van der Waals radius of 0.14 nm (M. Shen, S. Keten, R. M. Lueptow, Dynamics of water and solute transport in polymeric reverse osmosis membranes via molecular dynamics simulations, Journal of Membrane Science. 506(2016)95-108). The membrane free volume V_{F,m} was calculated from the water volume fraction Kw and free volume of the dry polymer V_{F,p} according to Equation 24:

$${V}_{F , m} = {V}_{F , w} {K}_{w} + {V}_{F , p} ( 1 - {K}_{w} ) \qquad ( Equation 24 )$$

The dry polymer free volume V_{F,p} in Equation 24 was calculated from the polymer specific volume Vₚ and the occupied volume V_{oc}, which was estimated from the van der Waals volume V_{vdw}, according to Equation 25. The van der Waals volume of each polymer V_{vdw} was estimated from structural groups present in the polymer networks using group contribution theory (A. X. Wu, S. Lin, K. Mizrahi Rodriguez, F. M. Benedetti, T. Joo, A. F. Grosz, K. R. Storme, N. Roy, D. Syar, Z. P. Smith, Revisiting group contribution theory for estimating fractional free

volume of microporous polymer membranes, Journal of Membrane Science. 636 (2021) 119526) as reported above herein. A single TMC monomer bonded to three diamine monomers (MPD, TBD, or TYD) was used as the molecular unit for calculating polymer V_{vdw} values.

$${V}_{F , p} = {V}_{p} - {V}_{oc} = {V}_{p} - 1.3 {V}_{vdw} \qquad ( Equation 25 )$$

The specific volume of the polymer Vₚ was calculated as the reciprocal of the estimated polyamide density ρₚ (Equation 26). Polyamide films densities were estimated as 1200 kg m⁻³, 1150 kg n, and 1100 kg m³ for MPDTMC, TBDTMC, and TYDTMC, respectively. These estimates will be updated in the future with densities determined from XRR measurements of the polyamide films.

$${V}_{p} = \frac{1}{{ρ}_{p}} \qquad ( Equation 26 )$$

Initial water diffusion modeling results using estimated K_{w} and ρₚ values yielded characteristic volume parameters β ranging from 0.60-1.5 times the free volume of water V_{F,w}. Volume parameters β larger than the free volume of water V_{F,w} are hypothesized for the assumed diffusivity dominated solution-diffusion transport.

The solution-diffusion model in Equation 27 was also applied to salt permeability measurements to understand the influence of contorted polyamide free volume on salt diffusion and membrane salt selectivity. In Equation 27, the subscript s refers to NaCl salt.

$${P}_{s} = {K}_{s} {D}_{s} \qquad ( Equation 27 )$$

Salt permeability Pₛ values were calculated from diffusion cell experiments, as summarized in Table 21. The partitioning coefficient for NaCl into polyamide, Kₛ, was estimated to be Kₛ=0.10 based on previously reported measurements (D. L. Shaffer, K. E. Feldman, E. P. Chan, G. R. Stafford, C M. Stafford, Characterizing salt permeability in polyamide desalination membranes using electrochemical impedance spectroscopy, Journal of Membrane Science. 583 (2019) 248-257). Measured salt diffusion coefficients Ds were then calculated from the measured salt permeability Ps values using Equation 27.

The measured NaCl salt diffusion coefficients D, were also fit with a free-volume based transport model derived by Yasuda et al. (H. Yasuda, C. E. Lamaze, L. D. Ikenberry. Permeability of solutes through hydrated polymer membranes. Part I. Diffusion of sodium chloride, Die Makromolekulare Chemie. 118 (1968) 19-35) and applied by Zhang and Geise (I. Zhang, G. M. Geise, Modeling the water permeability and water/salt selectivity tradeoff in polymer membranes, Journal of Membrane Science. 520 (2016) 790-800)

$${D}_{s} = {D}_{s}^{0} exp ( b ( 1 - \frac{1}{{K}_{w}} ) ) \qquad ( Equation 28 )$$

In Equation 28, Dₛ⁰ is the bulk diffusion coefficient of NaCl (1.5E-09 m^{2 s-1}), and K_{w} is the estimated free volume fraction of the hydrated polyamide membranes. The fitting parameter b is descriptive of the size of the diffusing salt penetrant and a characteristic volume required to accommodate the penetrant in the polyamide network (H. Zhang, G. M. Geise, Modeling the water permeability and water/salt selectivity tradeoff in polymer membranes, Journal of Membrane Science. 520 (2016) 790-800; H. Yasuda, C. E. Lamaze, L. D. Ikenberry, Permeability of solutes through hydrated polymer membranes. Part I. Diffusion of sodium chloride, Die Makromolekulare Chemie. 118 (1968) 19-35).

Preliminary solution-diffusion modeling results for NaCl permeability using the estimated Kw water volume fractions for the polyamide membranes yielded b values ranging from 0.90-1.1. These values are less than the value b=2.39±0.15 reported by Zhang and Geise (H. Zhang, G. M. Geise, Modeling the water permeability and water/salt selectivity tradeoff in polymer membranes, Journal of Membrane Science. 520 (2016) 790-800) for applying Equation 28 to conventional MPDTMC polyamide membranes.

### Continuing Work:

XRR and SAXS measurements of the MPDTMC, TBDTMC, and TYDTMC films will be analyzed to estimate the polymer density ρₚ and water volume fraction K_{w} at hydration for each polyamide. The β and b parameters that result from fitting the free-volume based diffusive transport models to measured water and NaCl permeabilities are hypothesized to change as the currently assumed ρₚ and K_{w} properties of the polyamide films are better defined. The β and b parameters will be compared to free volume characteristics of the polyamide films previously quantified by powder XRD and CO₂ sorption isotherm measurements. Relating diffusion-based free volume characteristics to measured polyamide network structure is hypothesized to provide insight into the improved permselectivity demonstrated by the contorted TBDTMC and TYDTMC polyamide membranes.

### Overview and Objectives of Example 23—Example 25

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are. Task #1—Control polyamide free volume through incorporation of sterically hindered contorted monomers; Task #2—Fabricate contorted polyamide membranes by electrospray deposition; Task #3—Relate the permeability-selectivity performance of contorted polyamide membranes to solution-diffusion transport.

### Example 23—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

### Polyamide Thin Film Synthesis and Membrane Fabrication

As discussed above herein, we reported the solvent systems used in mLbL fabrication of polyamide films and the corresponding growth rates of film thickness. MPDTMC and TBDTMC films were deposited directly onto silicon wafer substrates, and TYDTMC films were deposited onto silicon wafers that were functionalized with APTES amino-silane agent. Thickness measurements for each of the polyamide films were made by interferometry, and the refractive index was described by the Cauchy equation (A=1.601 and B=0.02564). The growth rates for the MPDTMC, TBDTMC, and TYDTMC films are compared in FIG. 40.

We fabricated thin-film composite MPDTMC, TBDTMC, and TYDTMC membranes by capturing floating polyamide films from a water bath onto polyacrylonitrile (PAN) porous membrane supports. The desalination performances of membranes prepared from the three polyamide chemistries were evaluated as a function of polyamide film thickness and were evaluated in long-term desalination performance testing.

### Characteristics of Contorted Polyamide Polymers

As discussed above herein, d-spacings (from powder X-ray diffraction (XRD) patterns) were reported for the polyamide powders as estimates of the size of free volume elements. These relative d-spacings were consistent with Langmuir surface areas calculated for the polyamides from CO₂ adsorption-desorption isotherm measurements. The chemistry of the polyamide films was previously characterized by FT-JR spectroscopy and by measured surface zeta potentials.

As discussed above herein, the chemistry and degree of crosslinking of the polyamide films were characterized by X-ray photoelectron spectroscopy (XPS) measurements made at Argonne National Laboratory. The degree of crosslinking of the polyamides was estimated by comparing the calculated O/N elemental ratio to the theoretical ratios that would be measured for fully crosslinked and fully linear polyamide films of the same chemistry. The elemental compositions of the films (% weight) and degree of polyamide network crosslinking are summarized in Table 22. The calculated O/N ratios summarized in Table 22 are all within 5% of the respective theoretical values for fully crosslinked networks, indicating monomer reactivity is maintained and near complete monomer conversion to crosslinked polymer is achieved in the mLbL deposition process.

TABLE 22
Polyamide elemental composition (% weight)
from X-ray photoelectron spectroscopy

| | | | | | Theoretical | Theoretical |
|---|---|---|---|---|---|---|
| Polyamide | Carbon | Oxygen | Nitrogen | O/N | O/N (Fully | O/N (Fully |
| Film | (%) | (%) | (%) | (Calculated) | Crosslinked) | Linear) |
| MPDTMC | 74.7 | 12.3 | 13.0 | 0.95 | 1 | 2 |
| TBDTMC | 85.4 | 4.97 | 9.61 | 0.52 | 0.5 | 1 |
| TYDTMC | 89.0 | 5.62 | 5.39 | 1.04 | 1 | 2 |

Now we report that the densities of the MPDTMC and TBDTMC films, which are measures of their free volume fractions, were measured using two techniques. The first technique was gravimetric measurement of dry film mass using a quartz crystal microbalance (QCM) (S. Karan, Z. Jiang, A. G. Livingston, Sub-10 nm polyamide nanofilms with ultrafast solvent transport for molecular separation, Science. 348 (2015) 1347-1351). Polyamide films were fabricated by mLbL deposition onto a silicon wafer coated with a polystyrenesulfonate release layer. The mLbL polyamide films were floated onto a water bath and then captured onto gold-coated QCM sensors (TAN06IG, Phillip Technologies, USA), such that the films completely covered the sensors. After transferring to the QCM sensors, the coated sensors were dried at room temperature for 3 h followed by oven drying at 80° C. for 2 h. For QCM measurements, sensors were loaded into a measurement chamber under vacuum and purged by pure nitrogen gas. Films were equilibrated under these conditions for 5 h before measurement. The resonant frequencies of the polyamide-coated sensor and a bare gold sensor were measured with a QCM instrument (Inficon, SQM-160). The density of each the deposited polyamide films (ρ_{film}) was calculated from the mass and volume of the film:

$${ρ}_{film} = \frac{m}{A \times t} \qquad ( Equation 29 )$$

where m is the mass of the polyamide film, A is the surface area of the polyamide film and QCM sensor (1.53 cm²), and I is the film thickness (t=75 nm for MPDTMC and t=52 nm for TBDTMC). The mass m of each film was calculated from the shift in resonant frequency (Δf) of the QCM sensor by application of the Sauerbrey equation:

$$Δ f = \frac{2 {f}_{0}^{2}}{\sqrt{{ρ}_{q} {μ}_{q}}} \frac{m}{A} \qquad ( Equation 30 )$$

In Equation 30, f₀ is the fundamental frequency of the bare quartz sensor (5.99 MHz), □_{q} is the density of the quartz sensor (2.648 g cm⁻¹), and □_{q} is the shear modulus of the quartz sensor (2.95×10¹¹ g cm⁻¹ s⁻²). The measured densities of the MPDTMC and TBDTMC films using the QCM technique are summarized in Table 23.

TABLE 23
Measured mass densities of conventional MPDTMC
and contorted TBDTMC polyamide films.

| | | Average |
|---|---|---|
| | Density | Density |
| Polyamide | Measured by | Measured by |
| Film | QCM (g cm⁻³) | XRR (g cm⁻³) |
| MPDTMC | 1.331 | 1.338 |
| TBDTMC | 1.042 | 0.968 |

The second technique used to determine polyamide film densities was based on X-ray reflectivity (XRR) measurements made at the Advanced Photon Source (APS) at Argon National Lab. XRR measurements were made for a series of MPDTMC and TBDTMC polyamide films with thicknesses ranging from ~5 nm to ~80 nm at APS Beamline 33-BM-C. The APS delivered a high energy X-ray source (wavelength □=0.6199 Å; 20 keV), and scattered X-ray intensities were measured at a scattering angle (2□) range from 0.050 to 2.26°. Data were processed to convert scattering angle to scattering vector q (Å⁻¹) by application of Equation 31 (S V. Orski, K. A. Page, E. P. Chan, K. L. Beers, Model Polymer Thin Films To Measure Structure and Dynamics of Confined, Swollen Networks, in: Gels and Other Soft Amorphous Solids, American Chemical Society, 2018: pp. 91-115):

$$q = \frac{4 π sin θ}{λ} \qquad ( Equation 31 )$$

The normalized scattering intensities (I/I₀₀) from the XRR measurements for each film were plotted as a function of scattering vector, q (Å⁻¹). The resulting reflectivity curves were modeled using the Reflectivity tool (A. Nelson, Co-refinement of multiple-contrast neutron/X-ray reflectivity data using MOTOFIT, Journal of Applied Crystallography. 39 (2006) 273-276)
within the Irena software package (version 2.71) (J. Ilavsky, P. R. Jemian, Irena: tool suite for modeling and analysis of small-angle scattering, Journal of Applied Crystallography. 42 (2009) 347-353) implemented in IgorPro software (Wavemetrics, version 9.0.2.4). The Reflectivity tool employs Parratt's formalism to fit the measured reflectivity curve for each film based on film thickness, roughness, and scattering length density, SLD or q_{c}² (Å⁻²). Multiple polyamide layers were implemented for each film to fit the XRR curve. FIG. 49A and FIG. 49B compare the experimental XRR curves to fits made with the Reflectivity tool for MPDTMC and TBDTMC films, respectively. Fits were not achieved for the 40 nm MPDTMC film because of scatter in the measured data or for the 80 nm TBDTMC film because of a lack of interference fringes. FIG. 49C and FIG. 49D show the SLDs of each polyamide layer used fit to the reflectivity curves for the MPDTMC and TBDTMC films, respectively.

Polyamide mass densities were then estimated from the SLDs using the NIST online SLD calculator (Kienzle, Paul, NIST Online Scattering Length Density Calculator, (2022) to fit the SLD by adjusting mass density for an assumed molecular formula for the polyamide films. The molecular formulas were determined from a 3:2 ratio of diamine monomer (MPD or TBD) to TMC acyl chloride monomer. The average density of each film was then calculated from the thickness-weighted densities of each layer used in the XRR fitting. The average densities for all MPDTMC and TBDTMC polyamides that were estimated from XRR measurements are included in Table 23, and the thickness-weighted densities of each of the MPDTMC and TBDTMC films are detailed in Table 24.

TABLE 24
Average densities of conventional MPDTMC and contorted
TBDTMC polyamide films measured by X-ray reflectivity.

| MPDTMC | | TBDTMC | |
|---|---|---|---|
| Polyamide | Average | Polyamide | Average |
| Films | Density | Films | Density |
| Thickness | Measured by | Thickness | Measured by |
| (nm) | XRR (g cm − 3) | (nm) | XRR (g cm − 3) |
| 4.9 | 1.444 | 19.8 | 0.979 |
| 10.2 | 1.392 | 39.6 | 0.964 |
| 20.0 | 1.243 | 60.4 | 0.963 |
| 59.8 | 1.274 | 100.0 | 0.964 |

The densities from XRR for the mLbL polyamide films decrease with increasing film thickness (Table 24). Without being bound by theory, this trend could reflect the growth behavior of mLbL polyamide films, where aromatic rings in deposited monomers have been observed to align parallel to the substrate at low cycle numbers and become more perpendicular to the substrate and more isotropic as film thickness increases (T. J. Zimudzi, S. E. Sheffield, K. E. Feldman, P. A. Beaucage, D. M. DeLongchamp, D. I. Kushner, C. M. Stafford, M. A. Hickner, Orientation of Thin Polyamide Layer-by-Layer Films on Non-Porous Substrates, Macromolecules 54 (2021) 11296-11303).

The calculated thickness-weighted densities of the MPDTMC and TBDTMC films from XRR are within 10% of the densities measured gravimetrically by QCM (Table 23). The lower density of contorted TBDTMC polyamide compared conventional MPDTMC polyamide reflects the increased free volume introduced by the contorted TBD monomer. The measured density of ~1.33 g cm⁻³ for our conventional mLbL MPDTMC polyamide is consistent with a dry film density of mLbL MPDTMC polyamide film in the range 1.301-1.358 g cm⁻³ that was predicted using atomistic molecular simulations (T. P. Liyana-Arachchi, J. F. Sturnfield, C. M. Colina, Ultrathin Molecular-Layer-by-Layer Polyamide Membranes. Insights from Atomistic Molecular Simulations, J. Phys. Chem. B. 120 (2016) 9484-9494) and with a dry density of interfacially polymerized MPDTMC in the range 1.21-1.32 g cm⁻³ as measured by neutron reflectivity (F. Foglia, S. Karan, M. Nania, Z. Jiang, A. E. Porter, R. Barker, A. G. Livingston, J. T. Cabral, Neutron Reflectivity and Performance of Polyamide Nanofilms for Water Desalination, Advanced Functional Materials. 27 (2017) 1701738).

### Desalination Performance of Contorted Polyamide Membranes

As discussed above herein, the water permeances and NaCl rejections of MPDTMC, TBDTMC, and TYDTMC membranes fabricated by mLbL deposition were compared as a function of polyamide film thickness. As a result of their increased free volume, the TBDTMC and TYDTMC contorted polyamide membranes showed enhanced permselectivity compared to the conventional MPDTMC polyamide membrane. Long-duration (12 h) performance tests were also conducted for the mLbL fabricated polyamide membranes that demonstrated ~99% NaCl rejections in preliminary performance tests.

The desalination test results are summarized in FIG. 41A as a function of polyamide film thickness, which was determined from the polyamide film growth curves (FIG. 40). In FIG. 41B, long-term desalination testing data are compared for the MPDTMC (~35 nm thick), TBDTMC (~25 nm thick), and TYDTMC (~36 nm thick) membranes that exhibited 99% NaCl rejection. Permeate flux and NaCl rejection are reported hourly for the 12 h performance test.

As discussed above herein, we also compared the permselectivity of the mLbL polyamide membranes that achieved 99% NaCl rejection (FIG. 41A) to the reported “upper bound” of permselectivity for polyamide desalination membranes. The selectivity of the membranes is represented by the ratio A/B_{NaCl} (bar⁻¹) of water permeance, A (L m⁻¹ h⁻¹ bar⁻¹) and NaCl permeance, B_{NaCl} (L m⁻² h⁻¹). When selectivity A/B_{NaCl} is plotted against water permeance, A, the well-documented permeability-selectivity tradeoff is observed. The reported upper bound of this permselectivity for polyamide membranes has been defined from an analysis of over 1,200 experimental observations of NaCl rejection and water permeance (Z. Yang, H. Guo, C Y. Tang, The upper bound of thin-film composite (TFC) polyamide membranes for desalination, Journal of Membrane Science. 590 (2019) 117297. https://doi.org/10.1016/j.memsci.2019.117297). Permselectivities for the TBDTMC and TYDTMC membranes approach the established polyamide upper bound. The permselectivities of the mLbL polyamide membranes are summarized in Table 25 and compared to the polyamide upper bound in FIG. 42.

TABLE 25
Water-NaCl selectivity of MPDTMC, TBDTMC, and TYDTMC
membranes compared to the polyamide bound.

| | Water | Water-NaCl | Polyamide Upper |
|---|---|---|---|
| | Permeance, A | Selectivity, | Bound Selectivity, |
| Polyamide | (L m⁻² h⁻¹ | A/B_{NaCl} | A/B_{NaCl} |
| Membrane | bar⁻¹) | (bar⁻¹) | (bar⁻¹) |
| MPDTMC | 1.01 | 5.81 | 15700 |
| TBDTMC | 8.62 | 12.7 | 16.2 |
| TYDTMC | 8.14 | 9.23 | 19.5 |

### Continuing Work:

Continuing work on Task #1 will analyze XRR measurements for TYDTMC films, similar to the analysis conducted for MPDTMC and TBDTMC films, to calculate the TYDTMC density. In addition to the XRR measurements made at APS, small-angle X-ray scattering (SAXS) measurements were also made at different relative humidities for a series of MPDTMC, TBDTMC, and TYDTMC polyamide films with thicknesses ranging from ~10 nm to ~80 nm. The SAXS data will be analyzed to estimate the water volume fractions K_{w} of the polyamide films. The measured K_{w} values will be used in diffusive transport modeling to replace the current estimated K_{w} values.

The desalination performance of commercial polyamide membranes, specifically Dow FilmTec SW30 reverse osmosis membrane and Dow FilmTec NF270 nanofiltration membrane, will be measured for comparison to the mLbL polyamide membranes synthesized in this work. Water and salt permeances of the SW30 and NF270 membranes will be calculated and included on the permselectivity plot as commercial material references.

### Example 24—Fabricating Membranes by Electrospray Deposition

### Goals/Work Outline:

The work in Task #2 will optimize conditions for fabricating contorted polyamide membranes using a scalable electrospray deposition process that can accommodate monophasic polymer systems. The effects of process parameters and reaction conditions on polyamide film properties will be quantified. The structures and properties of contorted polyamide membranes will be characterized and their desalination performance will be assessed.

### Work Performed:

As discussed above herein, the optimization of electrospray parameters for the monophasic electrospray deposition system with the goal of producing consistent polyamide films with controllable thickness. After extensive experimentation, we determined that two different monomer solutions that can form an interface were necessary to successfully fabricate salt-rejecting polyamide films by electrospray deposition, as reported by others (X.-H. Ma, Z. Yang, Z.-K. Yao, H. Guo, Z.-L. Xu, C Y. Tang, Interfacial Polymerization with Electrosprayed Microdroplets. Toward Controllable and Ultrathin Polyamide Membranes, Environ. Sci. Technol. Lett. 5 (2018) 117-122; M. Ostwal, E. Wazer, M. Pemberton, J. R. McCutcheon, Scaling electrospray based additive manufacturing of polyamide membranes, Journal of Membrane Science Letters. 2 (2022) 100035). As a result, we shifted to a two-phase electrospray deposition system using a water/ethanol cosolvent mixture for the diamine monomers and hexane solvent for TMC monomer solution.

Now we report that we continued work on Task #2 to fabricate MPDTMC and contorted TBDTMC and TYDTMC polyamide membranes by electrospray deposition using the water/ethanol cosolvent for diamine monomer solutions. The goal is to fabricate electrosprayed polyamide membranes that have equivalent desalination performance (99% NaCl rejection) to the mLbL, polyamide membranes. Initial efforts have focused on fabrication and performance testing of conventional MPDTMC polyamide membranes on PAN porous supports

### Electrosprayed Polyamide Membrane Fabrication and Desalination Performance.

The electrospray deposition process was optimized to fabricate conventional MPDTMC polyamide membranes. Desalination performance was tuned by changing the total mass of monomers deposited on the PAN support, according to the electrospray conditions summarized in Table 26.

TABLE 26
System parameters for electrospray deposition
of MPDTMC and TBDTMC polyamide membranes.

| Parameter | Value | | |
|---|---|---|---|
| Monomer solutions | MPD | TBD | TMC |
| Monomer molecular weight | 108.14 | 840.71 | 265.48 |
| (g mol⁻¹) | | | |
| Diamine monomer solvent | water/ | water/ | — |
| | ethanol | ethanol | |
| Diamine solvent volumetric | 9/1 | 1/11.5 | — |
| ratio | | | |
| Diamine to TMC monomer | 4 | 0.6 | — |
| molar ratio | | | |
| Acyl chloride monomer solvent | — | — | hexane |
| Monomer solution concentration | 2.0 | — | 1.2 |
| (% wt) | — | 1.0 | 0.5 |
| Monomer mass deposition at 99% | 0.19 | 0.97 | — |
| NaCl rejection (mg cm⁻²) | | | |

Electrospray deposition parameters:

| | | | |
|---|---|---|---|
| Monomer solution discharge rate | 2 | — | 2 |
| (mL h⁻¹) | — | 5 | 5 |

| | |
|---|---|
| Needle-to-collector distance (cm) | 5 |
| Applied voltage (kV) | 12 |
| Substrate | polyacrylonitrile membrane |
| | (400 kDa MWCO) |
| Collector rotation speed (rpm) | 80-100 |

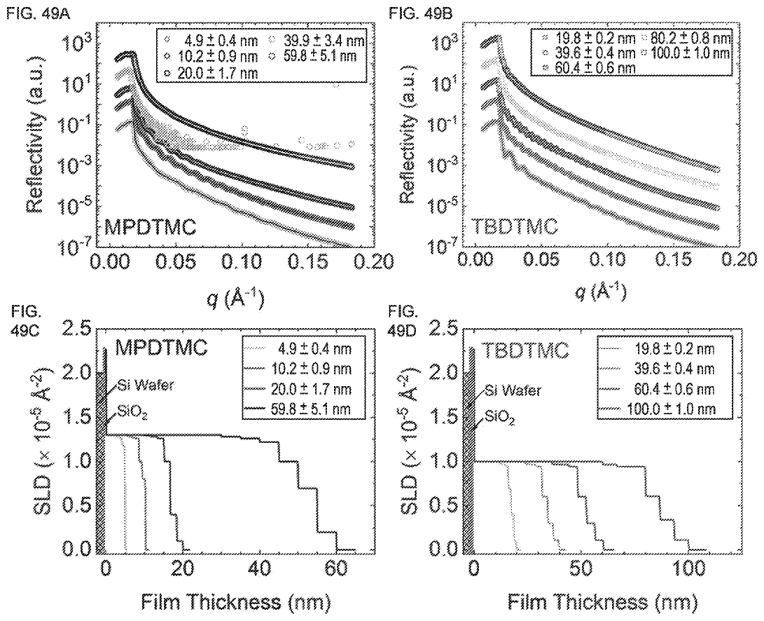

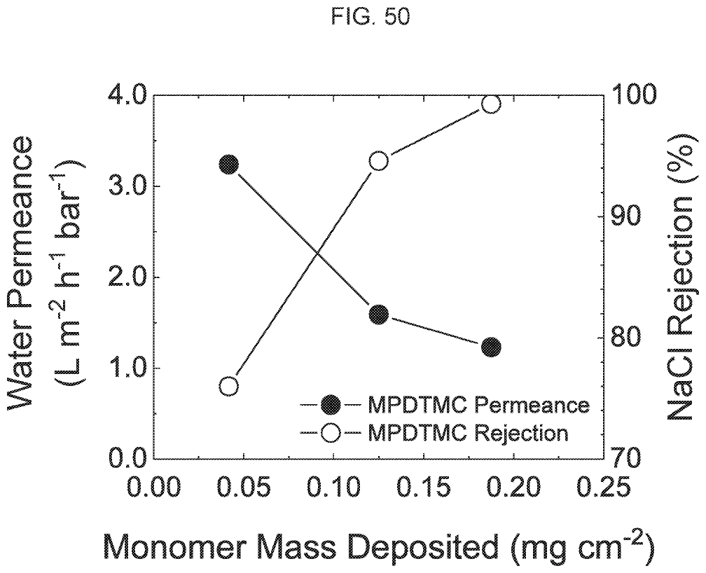

The water permeances and NaCl salt rejections of the electrosprayed MPDTMC membranes were measured in a cross-flow desalination testing system using DI water and ~50 mmol L⁻¹ NaCl feed solutions, respectively. The feed solution crossflow rate was 1 L min⁻¹, and the applied hydraulic pressure was 31 bar (450 psi). The desalination test results for MPDTMC membranes are summarized in FIG. 50 as a function of monomer mass deposited (mg cm⁻²) in the electrospray fabrication process.

Desalination results in FIG. 50 show that the performance of the electrosprayed MPDTMC membranes can be tuned by changing the mass of monomer deposited. The electrosprayed MPDTMC membranes exhibit a permeability-selectivity tradeoff, wherein higher salt rejection is achieved at the expense of lower water permeance. The desalination performance target of 99% NaCl rejection was achieved at an MPDTMC monomer mass deposition of 0.19 mg cm⁻². At this 99.3% salt rejection, the water permeance A of the electrosprayed MPDTMC is 1.23 L m⁻² h⁻¹ bar⁻¹, and the A/B_{NaCl} selectivity is 6.57 bar⁻¹ This performance exceeds the permeance of 1.01 L m⁻² h⁻¹ bar⁻¹ and A/B_{NaCl} selectivity of 5.81 bar⁻¹ that the mLbL MPDTMC membranes demonstrated at 99% salt rejection.

Electrosprayed TBDTMC polyamide membranes were tested under similar crossflow conditions to the MPDTMC membranes (feed solution ~65 mmol L⁻¹ NaCl, crossflow rate of 1 L min⁻¹, and hydraulic pressure of 31 bar). In initial desalination performance tests, some delamination of the TBDTMC layer from the PAN support was observed. As a result of this damage, water permeances were very high and NaCl rejection was very low. To address the delamination problem, some modifications to the electrospraying protocol were adopted to achieve better mechanical interlocking between the TBDTMC polyamide layer and the PAN support. The PAN supports were preconditioned before TBDTMC deposition by coating with an electrosprayed solution of TBD monomer in ethanol solvent (without water). This preconditioning was effective in eliminating polyamide film delamination, which we attribute to TBDTMC formation within the pores of the PAN support.

After implementing the preconditioning protocol, we fabricated and tested a contorted TBDTMC polyamide membrane that achieved the desalination performance target of 99% NaCl rejection. This TBDTMC membrane had a water permeance A of 6.90 L m⁻² h⁻¹ bar⁻¹, and A/B_{NaCl} selectivity of 7.23 bar⁻¹.

### Continuing Work:

Work will continue in Task #2 to establish the permeability-selectivity relationship for electrosprayed TBDTMC polyamide membranes. TBDTMC membranes will be fabricated at different monomer deposition masses to correlate the monomer mass deposited to water permeance and NaCl rejection. Electrospray conditions will also be optimized for fabricating TYDTMC polyamide membranes, and the desalination performance of the membranes will be assessed at different monomer deposition masses. When the desalination performance target of 99% NaCl rejection has been achieved, the electrosprayed polyamide membranes will be characterized by powder XRD and carbon dioxide (CO₂) physisorption, similar to the films fabricated by mLbL deposition. Electrosprayed polyamide film densities will be measured gravimetrically using the QCM technique.

### Example 25—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior.

### Work Performed:

### Salt Permeability of Polyamide Films

As discussed above herein, salt diffusion tests were conducted in a dual chamber diffusion cell to measure the salt permeabilities of Novatexx commercial porous support membranes and of mLbL polyamide films captured on Novatexx supports. NaCl salt diffusion tests were conducted for MPDTMC, TBDTMC, and TYDTMC polyamide films at thicknesses hypothesized to yield 99% NaCl rejection based on desalination performance testing. The NaCl salt permeability, Pₛ (m⁻² s⁻¹), was calculated from diffusion cell tests by application of a model described by Luo, Geise et al. (H. Luo, J. Aboki, Y. Ji, R. Guo, G. M. Geise, Water and Salt Transport Properties of Triptycene-Containing Sulfonated Polysulfone Materials for Desalination Membrane Applications, ACS Appl. Mater. Interfaces. 10 (2018) 4102-4112). The calculated salt permeabilities for the three polyamide films are summarized in Table 27 and compared to the Novatexx support and NaCl bulk diffusion for reference.

TABLE 27
NaCl permeabilities of mLbL polyamide films measured
from diffusion tests compared to reference materials.

| Polyamide | Estimated Film | NaCl Permeability, |
|---|---|---|
| Film | Thickness (nm) | Pₛ (m² s⁻¹) |
| MPDTMC | 38 | (2.72 ± 0.05) × 10⁻¹⁴ |
| TBDTMC | 25 | (2.74 ± 0.09) × 10⁻¹⁴ |
| TYDTMC | 36 | (1.62 ± 0.04) × 10⁻¹⁴ |
| Novatexx Support | — | (4.27 ± 0.10) × 10⁻⁰⁹ |
| NaCl bulk diffusion | | 1.5 × 10⁻⁰⁹ |

### Solution-Diffusion Transport Modeling

As discussed above herein, diffusivity-dominated free volume-based transport models were applied to measured water and NaCl permeabilities to relate the observed transport behavior of the MPDTMC, TBDTMC, and TYDTMC polyamide films to their structural characteristics. The water and salt transport modeling were based on the classic solution diffusion model that describes penetrant permeability, P, of the polyamide films as the product of a solubility or partitioning coefficient, K, and the penetrant diffusion coefficient in the polymer network, D. Solution-diffusion models were applied separately to water permeability measurements (H. Zhang, G. M. Geise, Modeling the water permeability and water/salt selectivity tradeoff in polymer membranes, Journal of Membrane Science. 520 (2016) 790-800; H. Yasuda, C. Lamaze, A. Peterlin, Diffusive and hydraulic permeabilities of water in water-swollen polymer membranes, Journal of Polymer Science Part A-2 Polymer Physics. 9 (1971) 1117-1131) and salt permeability measurements (H. Zhang, G. M. Geise, Modeling the water permeability and water/salt selectivity tradeoff in polymer membranes, Journal of Membrane Science. 520 (2016) 790-800; H. Yasuda, C. E. Lamaze, L. D. Ikenberry, Permeability of solutes through hydrated polymer membranes. Part 1. Diffusion of sodium chloride, Die Makromolekulare Chemie. 118 (1968) 19-35) to estimate two characteristic volume parameters that are descriptive of the polyamide network structures. From water permeability modeling, the f term was calculated as a characteristic volume parameter that is proportional to the cross-section and diffusional jump length of the diffusing water (H. Zhang, G. M. Geise, Modeling the water permeability and water/salt selectivity tradeoff in polymer membranes, Journal of Membrane Science. 520 (2016) 790-800; H. Yasuda, C. Lamaze, A. Peterlin, Diffusive and hydraulic permeabilities of water in water-swollen polymer membranes, Journal of Polymer Science Part A-2: Polymer Physics. 9 (1971) 1117-1131). From salt permeability modeling, a fitting parameter b was defined that is descriptive of the size of the diffusing salt penetrant and a characteristic volume required to accommodate the penetrant in the polyamide network (H. Zhang, G. M. Geise, Modeling the water permeability and water/salt selectivity tradeoff in polymer membranes, Journal of Membrane Science. 520 (2016) 790-800; H. Yasuda, C. E. Lamaze, L. D. Ikenberry, Permeability of solutes through hydrated polymer membranes. Part I. Diffusion of sodium chloride, Die Makromolekulare Chemie. 118 (1968) 19-35).

Initial water permeability modeling results yielded characteristic volume parameters ranging from 0.60-1.5 times the free volume of water V_{F,w}, Preliminary modeling results for NaCl permeability of the polyamide membranes yielded b values ranging from 0.90-1.1, which are less than the value b=2.39±0.15 reported by Zhang and Geise (H. Zhang, G. M. Geise, Modeling the water permeability and water/salt selectivity tradeoff in polymer membranes, Journal of Membrane Science. 520 (2016) 790-800) for similar modeling of conventional MPDTMC polyamide membranes. These initial modeling results were obtained using estimated water partitioning coefficient K_{w} values (K_{w}=0.10) and assumed polyamide film density □ₚ values (ranging from 1100 kg m⁻³ to 1200 kg m⁻³). The partitioning coefficient for NaCl into polyamide, Kₛ, was estimated to be Kₛ=0.10 based on previously reported measurements (D. L. Shaffer, K. E. Feldman, E. P. Chan, G. R. Stafford, C. M. Stafford, Characterizing salt permeability in polyamide desalination membranes using electrochemical impedance spectroscopy, Journal of Membrane Science. 583 (2019) 248-257). The water partitioning coefficient K_{w} is effectively the volume fraction of water in the polyamide (H. Zhang, G. M. Geise, Modeling the water permeability and water/salt selectivity tradeoff in polymer membranes, Journal of Membrane Science. 520 (2016) 790-800) or the free volume of the hydrated polymer network (H. Yasuda, C. Lamaze, A. Peterlin, Diffusive and hydraulic permeabilities of water in water-swollen polymer membranes, Journal of Polymer Science Part A-2: Polymer Physics. 9 (1971) 1117-1131) and it is the characteristic feature of the contorted polyamide membranes that enhances their permselectivity.

Now we report, the polyamide densities rₚ calculated from XRR measurements (1338 kg m⁻³ and 968 kg m⁻³ for MPDTMC and TBDTMC polyamide, respectively) were used to update diffusive transport modeling of measured water and salt permeabilities for these polyamide membranes. The resulting b values for MPDTMC and TBTMC were 0.15 cm³ g⁻¹ and 1.24 cm³ g⁻¹, respectively, which are approximately 0.39 and 3.23 times the free volume of water. As a characteristic water diffusion volume, the b value is hypothesized to be larger than the free volume of water for the assumed diffusivity-dominated solution-diffusion transport, which is true for TBDTMC polyamide. Without being bound by theory, the lower b value for MPDTMC polyamide may result from the assumed water volume fraction K_{w}=0.10. The b fitting parameter from transport modeling is sensitive to K_{w} value, which will be updated in the future based on the analysis of SAXS measurements made for polyamide films at different relative humidities. The updated modeling results for NaCl permeability of the MPDTMC and TBDTMC polyamide membranes yielded a common b value of 0.96.

### Continuing Work:

SAXS measurements of the MPDTMC, TBDTMC, and TYDTMC films will be analyzed to estimate the water volume fraction K_{w} at hydration for each polyamide. XRR measurements will also be analyzed for TYDTMC films to calculate polymer density rₚ. The free-volume based diffusive transport models will be refit to measured water and NaCl permeabilities using the updated □ₚ and K_{w} properties of the polyamide films. The resulting □ and b parameters will be compared to free volume characteristics of the polyamide films previously quantified. Relating diffusion-based free volume characteristics to measured polyamide network structure is hypothesized to provide insight into the improved permselectivity demonstrated by the contorted TBDTMC and TYDTMC polyamide membranes.

### Overview and Objectives of Example 26—Example 28

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable electrospray deposition process. Successful completion of the project will be used to achieve control over free volume and enhanced permselectivity in polyamide desalination membranes. The higher throughput and enhanced separation performance of these contorted polyamide membranes are hypthesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by electrospray deposition: Task #3—Relate the permeability-selectivity performance of contorted polyamide membranes to solution-diffusion transport.

### Example 26—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

### Polyamide Thin Film Synthesis and Membrane Fabrication

As discussed above herein, the solvent systems used in mLbL fabrication of polyamide films and the corresponding growth rates of film thickness. MPDTMC and TBDTMC films were deposited directly onto silicon wafer substrates, and TYDTMC films were deposited onto silicon wafers that were functionalized with APTES amino-silane agent. Thickness measurements for each of the polyamide films were made by interferometry, and the refractive index was described by the Cauchy equation (A=1.601 and B=0.02564).

We fabricated thin-film composite MPDTMC, TBDTMC, and TYDTMC membranes by capturing floating polyamide films from a water bath onto polyacrylonitrile (PAN) porous membrane supports. The desalination performances of membranes prepared from the three polyamide chemistries were evaluated as a function of polyamide film thickness and were evaluated in long-term desalination performance testing

### Characteristics of Contorted Polyamide Polymers

As discussed above herein, d-spacings (from powder X-ray diffraction (XRD) patterns) were reported for the polyamide powders as estimates of the size of free volume elements. These relative d-spacings were consistent with Langmuir surface areas calculated for the polyamides from CO₂ adsorption-desorption isotherm measurements. The chemistry of the polyamide films was previously characterized by FT-IR spectroscopy and by measured surface zeta potentials.

The chemistry of the polyamide films was also previously characterized by X-ray photoelectron spectroscopy (XPS) measurements, and the degree of crosslinking of the polyamides was estimated by comparing the calculated O/N elemental ratio to the theoretical ratios that would be measured for fully crosslinked and fully linear polyamide films of the same chemistry. The calculated O/N ratios were all within 5% of the respective theoretical values for fully crosslinked networks, indicating monomer reactivity was maintained and near complete monomer conversion to crosslinked polymer was achieved in the mLbL deposition process.

As discussed above herein, the densities of the MPDTMC and TBDTMC films, which are indicative of their free volume fractions, were measured using a quartz crystal microbalance (QCM) technique (S. Karan, Z. Jiang, A. G. Livingston, Sub-10 nm polyamide nanofilms with ultrafast solvent transport for molecular separation, Science. 348 (2015) 1347-1351). The shift in the resonant frequency (A) of a QCM sensor coated with a polyamide film was used to calculate film mass (m) by application of the Sauerbrey equation. The density of each of the deposited polyamide films was then calculated from the mass and volume of the film. QCM densities measurements have not yet been made for TYDTMC polyamide films because of challenges adhering the films to the QCM sensor.

Polyamide film densities were also previously determined from X-ray reflectivity (XRR) measurements made at the Advanced Photon Source (APS) Beamline 33-BM-C at Argon National Lab. XRR measurements were made fora series of polyamide films with thicknesses ranging from ~5 nm to ~80 nm. The resulting reflectivity curves for MPDTMC and TBDTMC films were modeled using the Reflectivity tool (A. Nelson, Co-refinement of multiple-contrast neutron/X-ray reflectivity data using MOTOFIT, Journal of Applied Crystallography. 39 (2006) 273-276) within the Irena software package (version 2.71) (J. Ilavsky, P. R. Jemian, Irena: tool suite for modeling and analysis of small-angle scattering, Journal of Applied Crystallography. 42 (2009) 347-353) implemented in IgorPro software (Wavemetrics, version 9.0.2.4) to fit the measured reflectivity curve for each film based on film thickness, roughness, and scattering length density, SLD. Polyamide mass densities were then estimated from the SLDs using the NIST online SLD calculator (Kienzle, Paul, NIST Online Scattering Length Density Calculator, (2022), www.ncnr.nist.gov) to fit the SLDs by adjusting mass density for an assumed molecular formula for the polyamide films.

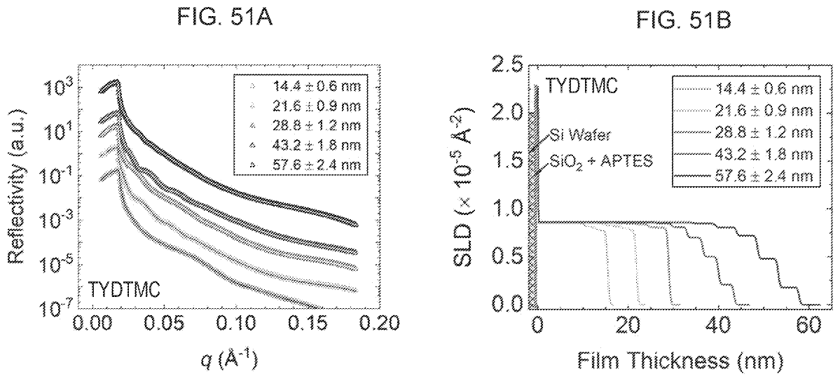

Now we report, the densities of the TYDTMC polyamide film series were similarly estimated from SLDs resulting from XRR measurements. Unlike the MPDTMC and TBDTMC films, the TYDTMC films were adhered to the silicon wafer substrates by first functionalizing the wafers with an APTES layer, which was accounted for in the XRR curve fitting. FIG. 51A compares the experimental XRR curves for TYDTMC films to fits made with the Reflectivity tool. The SLDs of each polyamide layer used fit to the reflectivity curves for the TYDTMC films are shown in FIG. 51B.

The polyamide mass densities for the TYDTMC films of different thicknesses that were estimated from the SLDs are compared to previous results for MPDTMC and TBDTMC polyamide films in Table 28. The average densities for the conventional MPDTMC and contorted TBDTMC and TYDTMC polyamide films are compared in Table 29.

TABLE 28
Average densities of conventional MPDTMC and contorted TBDTMC
and TYDTMC polyamide films measured by X-ray reflectivity.

| MPDTMC | | TBDTMC | | TYDTMC | |
|---|---|---|---|---|---|
| Polyamide Films | | Polyamide Films | | Polyamide Films | |
| | Average | | Average | | Average |
| | Density | | Density | | Density |
| Thickness | Measured by | Thickness | Measured by | Thickness | Measured by |
| (nm) | XRR (g cm⁻³) | (nm) | XRR (g cm⁻³) | (nm) | XRR (g cm⁻³) |
| 4.9 | 1.444 | 19.8 | 0.979 | 14.4 | 0.952 |
| 10.2 | 1.392 | 39.6 | 0.964 | 21.6 | 0.956 |
| 20.0 | 1.243 | 60.4 | 0.963 | 28.8 | 0.961 |
| 59.8 | 1.274 | 100.0 | 0.964 | 43.2 | 0.864 |
| | | | | 57.6 | 0.859 |

TABLE 29
Measured mass densities of conventional MPDTMC and
contorted TBDTMC and TYDTMC polyamide films.

| | | Average |
|---|---|---|
| | Density | Density |
| Polyamide | Measured by | Measured by |
| Film | QCM (g cm⁻³) | XRR (g cm⁻³) |
| MPDTMC | 1.331 | 1.338 |
| TBDTMC | 1.042 | 0.968 |
| TYDTMC | — | 0.918 |

The densities from XRR for the TYDTMC polyamide films decrease with increasing film thickness (Table 28), as observed previously for MPDTMC and TBDTMC films. Without being bound by theory this trend could result from anisotropic growth of the mLbL polyamide films, especially at low cycle numbers (T. J. Zimudzi, S. E. Sheffield, K. E. Feldman. P. A. Beaucage, D. M. DeLongchamp, D. I. Kushner, C. M. Stafford, M. A. Hickner, Orientation of Thin Polyamide Layer-by-Layer Films on Non-Porous Substrates, Macromolecules. 54 (2021) 11296-11303). The lower densities of contorted TBDTMC and TYDTMC polyamides compared conventional MPDTMC polyamide reflect the increased free volume introduced by the contorted TBD and TYD monomers. The trend of decreasing density (MPDTMC>TBDTMC>TYDTMC) is similar to the previously measured trends of increasing d-spacing and Langmuir surface areas for contorted versus conventional polyamide.

Swelling Ratios from Small Angle X-Ray Scattering (SAXS) Measurements

Swelling ratios for the conventional MPDTMC and contorted TBDTMC and TYDTMC films were calculated from SAXS measurements made at different humidity conditions at Beamline 12-ID-C at the APS. At very high ranges of scattering vector q (Å⁻¹), a scattering intensity correlation peak is present that is related to the d-spacing of the polyamide network (P. S. Singh, P. Ray, Z. Xie, M. Hoang, Synchrotron SAXS to probe cross-linked network of polyamide ‘reverse osmosis’ and ‘nanofiltration’ membranes, Journal of Membrane Science 421-422 (2012) 51-59) which we have used as a measure of network free volume. The swelling ratio S was calculated from the relative change in the intensity I of this d-spacing correlation peak from dry to humidified conditions, according to Equation 32:

$$S = \frac{{I}_{humidified}}{{I}_{dry}} \qquad ( Equation 32 )$$

Scattering intensities were measured for a series of films of each polyamide chemistry that were deposited on silicon wafers. MPDTMC films (29, 57, 114, 171 cycles) were estimated to range in thickness from 10.2-59.8 nm; TBDTMC films (10, 20, 40, 61 cycles) were estimated to range in thickness from 9.9-60.4 nm, and TYDTMC films (10, 20, 30, 40 cycles) were estimated to range in thickness from 14.4-57.6 nm. Measurements were made at 21 locations on each sample using source X-rays of 18 keV and exposure times of 1 second per measurement (Beamlines Information|Advanced Photon Source, (n.d.). www.aps.anl.gov).

For the measurements at Beamline 12-ID-C, four samples (three polyamide films and a Kapton tape blank) were mounted inside a custom humidity-controlled sample chamber sealed with Kapton windows. The sample chamber is described in detail in previous work from Beamline 12-ID-C (Y. Liu, J. L. Horan, G. J. Schlichting, B. R. Caire, M. W. Liberatore, S. J. Hamrock, G. M. Haugen, M. A. Yandrasits, S. Seifert, A. M. Herring, A Small-Angle X-ray Scattering Study of the Development of Morphology in Films Formed from the 3M Perfluorinated Sulfonic Acid Ionomer, Macromolecules. 45 (2012) 7495-7503). Humidity within the chamber was adjusted by regulating the flow of dry and humidified N₂ gas, which was generated by bubbling N₂ through deionized water within a humidifying apparatus. Dry N₂ gas was subsequently mixed with humidified N₂ gas to achieve target relative humidity (RH) percentages. Gas flow was regulated via mass flow controllers (MKS Mass-Flo RS-485), and dew points were monitored (Visala HMT337 sensors), which enabled RH to be calculated. To maintain target RH conditions within the chamber, it was heated using resistive heat tape. Temperature was initially adjusted manually to achieve the target RH, and RH was subsequently maintained by temperature regulation with a PID temperature controller (Y. Liu, J. L. Horan, G. J. Schlichting, B. R. Caire, M. W. Liberatore, S. J. Hamrock, G. M. Haugen, M. A. Yandrasits, S. Seifert, A. M. Herring, A Small-Angle X-ray Scattering Study of the Development of Morphology in Films Formed from the 3M Perfluorinated Sulfonic Acid Ionomer, Macromolecules. 45 (2012) 7495-7503). The chamber was not heated for 0% RH measurements with dry N₂ gas flow but was heated for all other RH conditions. Measurements targeting 90% RH conditions proved unstable, with poor control over temperature and RH. Consequently, 90% RH measurements were not used in the swelling ratio analysis.

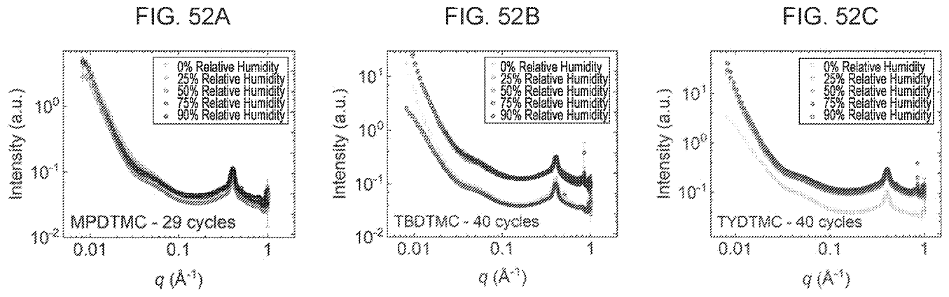

SAXS scattering intensities for each of the 21 repeated measurements of each sample at each RH condition were plotted in OriginPro software (OriginLab 2021b), and outlier measurements were identified as those with intensities that were orders of magnitude different or those that showed a completely different scattering curve shape compared to the rest of the measurements. These outliers were removed, and a mean intensity and standard deviation were calculated for the remaining measurements. Example plots of SAXS scattering intensities for MPDTMC, TBDTMC, and TYDTMC polyamide films at different RH conditions are shown in FIG. 52A, FIG. 52B, and FIG. 52C, respectively.

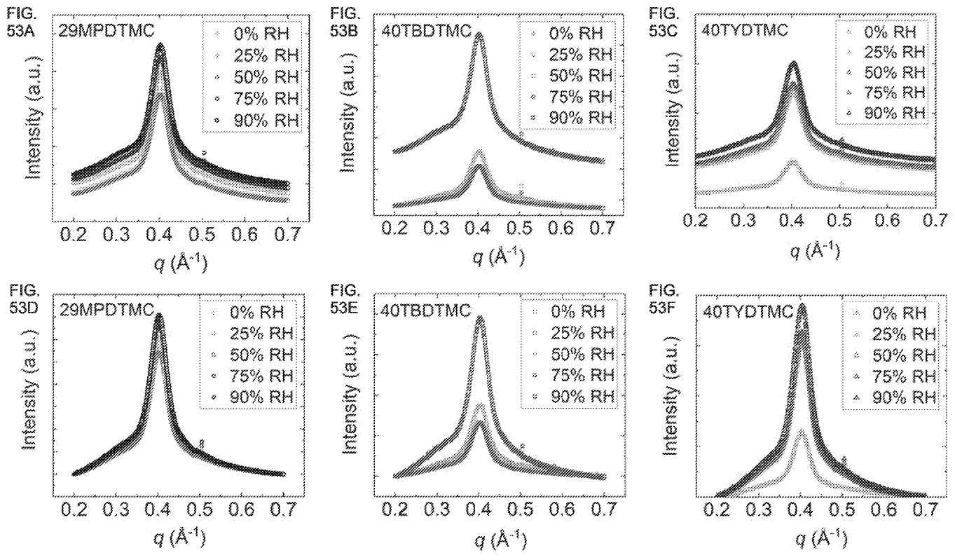

Scattering intensity data were further processed in OriginPro by trimming to scattering vector range 0.2 Å⁻¹≤q≤0.7 Å⁻¹ and adjusting the scattering curves to a common baseline. A linear baseline was defined and subtracted from each curve using the Peak Analyzer tool in OriginPro. Scattering intensity peak heights and peak positions were then determined with the Peak Analyzer tool. Examples of trimmed and baselined peak data are shown in FIG. 53A-FIG. 53C and FIG. 53D-FIG. 53F, respectively, for MPDTMC, TBDTMC, and TYDTMC polyamide films.

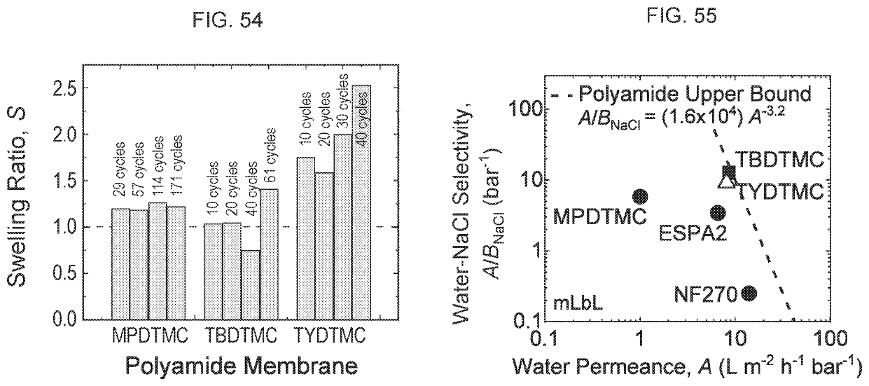

Swelling ratios were calculated for each polyamide film according to Equation 32 with reference to 0% RH as the dry condition. Because measurements made at 90% RH conditions were not stable and did not yield reproducible results across polyamide film thicknesses, the measurements at 75% RH were used as the humidified condition for calculating the swelling ratios. Calculated swelling ratios at 75% RH for the MPDTMC, TBDTMC, and TYDTMC films of different thicknesses are compared in FIG. 54.

For solution-diffusion transport modeling, swelling ratios from the 114-cycle MPDTMC film, 61-cycle TBDTMC film, and 20-cycle TYDTMC film were used to define the water volume fraction K. of the respective hydrated polyamide membranes.

### Desalination Performance of Contorted Polyamide Membranes

As discussed above herein, the water permeances and NaCl rejections of MPDTMC, TBDTMC, and TYDTMC membranes fabricated by mLbL deposition were compared as a function of polyamide film thickness. As a result of their increased free volume, the TBDTMC and TYDTMC contorted polyamide membranes showed enhanced permselectivity compared to the conventional MPDTMC polyamide membrane. Long-duration (12 h) performance tests were also conducted for the mLbL fabricated polyamide membranes that demonstrated ~99% NaCl rejections in preliminary performance tests.

Now we report, the desalination performance of two commercial polyamide membranes, specifically reverse osmosis membrane ESPA2 (Hydranautics) and nanofiltration membrane NF 270 (Dupont FilmTec), were measured in a dead-end cell for comparison to the mLbL polyamide membranes synthesized in this work. Commercial membranes were washed for 30 minutes in 25% volume isopropanol solution before testing to remove coatings and preservatives from the membrane surfaces. From measurements of pure water flux and of salt rejection from ~50 mmol L⁻¹ NaCl solution, water permeance, A (L m⁻¹ h⁻¹ bar⁻¹), NaCl permeance, B_{NaCl} (L m⁻¹h⁻¹), and water-NaCl selectivity. A/B_{NaCl} (bar⁻¹) values were calculated.

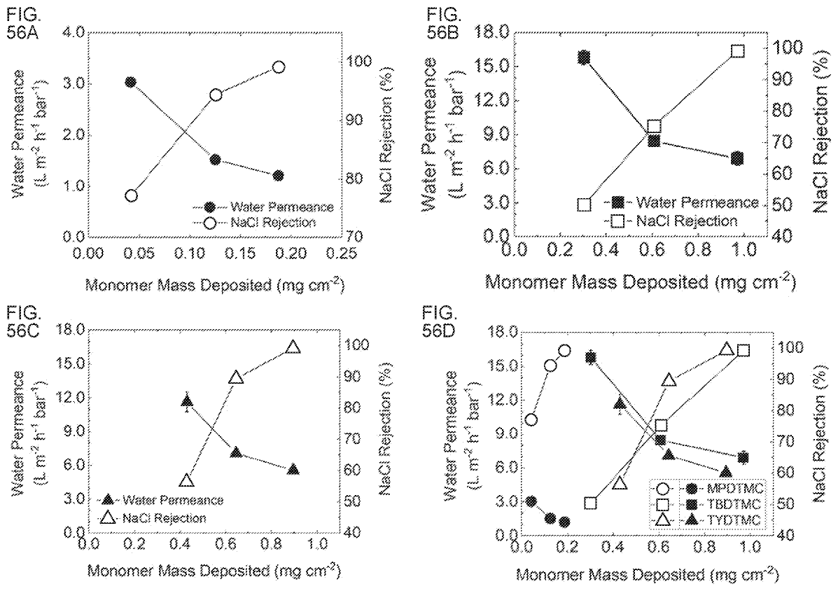

In the permeability-selectivity tradeoff plot in FIG. 55, the desalination performance of the commercial polyamide membranes is compared to that of the previously reported mLbL polyamide membranes that achieved 99% NaCl rejection. The “upper bound” of permselectivity for polyamide desalination membranes, which was defined from an analysis of over 1,200 experimental observations of NaCl rejection and water permeance (Z. Yang, H. Guo, C. Y. Tang, The upper bound of thin-film composite (TFC) polyamide membranes for desalination, Journal of Membrane Science. 590 (2019) 117297) is also included in FIG. 55. The permselectivities of the commercial and mLbL polyamide membranes are also summarized in Table 30.

TABLE 30
Water-NaCl selectivity of mLbL MPDTMC, TBDTMC, and
TYDTMC membranes compared to commercial polyamide
desalination membranes and the polyamide upper bound.

| | | | Polyamide |
|---|---|---|---|
| | Water | Water-NaCl | Upper Bound |
| | Permeance, A | Selectivity, | Selectivity, |
| Polyamide | (L m⁻² h⁻¹ | A/B_{NaCl} | A/B_{NaCl} |
| Membrane | bar⁻¹) | (bar⁻¹) | (bar⁻¹) |
| MPDTMC | 1.01 | 5.81 | 15700 |
| TBDTMC | 8.62 | 12.7 | 16.2 |
| TYDTMC | 8.14 | 9.23 | 19.5 |
| NF 270 | 14.0 | 0.25 | 3.40 |
| ESPA2 | 6.61 | 3.43 | 37.9 |

### Continuing Work:

Continuing work on Task #1 will seek to measure the desalination performance of other commercial polyamide desalination membranes for comparison to the contorted TBDTMC and TYDTMC polyamide membranes developed in this research.

### Example 27—Fabricating Membranes by Electrospray Deposition

### Goals/Work Outline:

The work in Task #2 will optimize conditions for fabricating contorted polyamide membranes using a scalable electrospray deposition process. The effects of process parameters and reaction conditions on polyamide film properties will be quantified. The structures and properties of contorted polyamide membranes will be characterized, and their desalination performance will be assessed. The goal of Task #2 is to fabricate conventional MPDTMC and contorted TBDTMC and TYDTMC polyamide membranes by electrospray deposition that have equivalent desalination performance (99% NaCl rejection) to the mLbL polyamide membranes reported in Task #1.

### Work Performed:

As described above herein, the optimization of electrospray parameters for the electrospray deposition system with the goal of producing consistent polyamide films with controllable thickness. After extensive experimentation, we determined that two different monomer solutions that can form an interface were necessary to successfully fabricate salt-rejecting polyamide films by electrospray deposition (X.-H. Ma, Z. Yang, Z.-K. Yao, H. Guo, Z.-L. Xu, C. Y. Tang, Interfacial Polymerization with Electrosprayed Microdroplets: Toward Controllable and Ultrathin Polyamide Membranes, Environ. Sci. Technol. Lett. 5 (2018) 117-122; M. Ostwal, E. Wazer, M. Pemberton, J. R. McCutcheon, Scaling electrospray based additive manufacturing of polyamide membranes, Journal of Membrane Science Letters. 2 (2022) 100035). As a result, we shifted to a two-phase electrospray deposition system using a water/ethanol cosolvent mixture for the diamine monomers and hexane solvent for TMC monomer solution

### Electrosprayed Polyamide Membrane Fabrication and Desalination Performance

As discussed above herein, we optimized the electrospray deposition process to fabricate conventional MPDTMC polyamide membranes on PAN supports. Desalination performance of the membranes was tuned by changing the total mass of monomers deposited on the PAN support, and the desalination target of 99% NaCl rejection was achieved.

Now we report, we determined the electrospray conditions for fabricating contorted TBDTMC and TYDTMC polyamide membranes, and we evaluated their desalination performance. The optimized electrospray conditions for all three polyamide membranes are summarized in Table 31. Before electrospray deposition of contorted TBDTMC and TYDTMC polyamide membranes, the PAN supports were preconditioned by saturating with an electrosprayed solution of TBD or TYD monomer in ethanol solvent (without water). This preconditioning step was implemented to encourage contorted polyamide film formation within the pores of the PAN support to achieve better mechanical interlocking between the polyamide layer and the support. The better interlocking between the polyamide and PAN eliminated problems with polyamide film delamination, which was observed during initial desalination testing of the contorted polyamide membranes. To prevent the formation of powder during electrospraying for the TYDTMC polyamide, the water/ethanol ratio for the diamine monomer solution was higher than that for the TBDTMC polyamide, as noted in Table 31.

TABLE 31
System parameters for electrospray deposition of
MPDTMC, TBDTMC and TYDTMC polyamide membranes.

| Parameter | Value | | | |
|---|---|---|---|---|
| Monomer solutions | MPD | TBD | TYD | TMC |
| Monomer molecular weight | 108.14 | 840.71 | 858.72 | 265.48 |
| (g mol⁻¹) | | | | |
| Solvent components | water/ethanol | water/ethanol | water/ethanol | hexane |
| Solvent components | 9/1 | 1/11.5 | 8/15 | 1 |
| volumetric ratio | | | | |
| Diamine to TMC monomer | 4 | 0.63 | 0.62 | — |
| molar ratio | | | | |
| Monomer solution | 2.0 | — | — | 1.2 |
| concentration (% wt) | — | 1.0 | — | 0.5 |
| | — | — | 1.0 | 0.5 |
| Total monomer mass | 0.19 (MPD + | 0.97 (TBD + | 0.89 (TYD + | — |
| deposition at 99% NaCl | TMC) | TMC) | TMC) | |
| rejection (mg cm⁻²) | | | | |
| Monomer solution discharge | 2 | — | — | 2 |
| rate (mL h⁻¹) | — | 5 | | 5 |
| | — | — | 5 | 5 |

| | |
|---|---|
| Needle-to-collector distance | 5 |
| (cm) | |
| Applied voltage (kV) | 12 |
| Substrate | Polyacrylonitrile (PAN) membrane |
| | (400 kDa MWCO) |
| Collector rotation speed (rpm) | 80-100 |

The water permeances and NaCl salt rejections of the electrosprayed contorted TBDTMC and TYDTMC membranes were measured in a cross-flow desalination testing system, similar to previous performance tests conducted for electrosprayed MPDTMC membranes. Additionally, the desalination performance of a commercial polyamide ESPA2 (Hydranautics) reverse osmosis membrane was measured for comparison. Three measurements each of DI water permeance and NaCl rejection (feed solutions ranging in concentration from 55-65 mmol L⁻¹ NaCl) were made for each membrane. During testing, the feed solution crossflow rate was 1 L min⁻¹, and the applied hydraulic pressure was 31 bar (450 psi). Feed solution temperatures were maintained at room temperature (21° C.±1° C.) using a recirculating chiller coil immersed in the feed solution reservoir.

The desalination test results for electrosprayed MPDTMC, TBDTMC, and TYDTMC membranes are summarized in FIG. 56A-FIG. 56D as a function of total monomer mass deposited (mg cm⁻²) during the electrospray fabrication process. For all three polyamide chemistries, membranes were fabricated that achieved the desalination performance target of 99% NaCl rejection.

Desalination results in FIG. 56A-FIG. 56D show that the performance of the electrosprayed polyamide membranes can be tuned by changing the mass of monomers deposited on the membrane support, which is an indication of membrane thickness. The water permeance decreases and salt rejection increases as a function of monomer mass (membrane thickness) for all three electrosprayed membranes. The desalination performance trends for the electrosprayed contorted polyamide membranes are similar to those observed for the contorted polyamide membranes fabricated by mLbL deposition. Together, the performance of TBDTMC and TYDTMC membranes fabricated by two different techniques confirms the hypothesis that the free volume of polyamide membranes can be controlled through the introduction of sterically hindered monomers and that increased free volume enhances membrane permselectivity.

The desalination performance target of 99% NaCl rejection was achieved for MPDTMC, TBDTMC, and TYDTMC polyamide membranes at monomer mass depositions of 0.19 mg cm⁻², 0.97 mg cm⁻², and 0.89 mg cm⁻², respectively. The greater monomer mass depositions required to achieve 99% NaCl rejection for the contorted polyamide membranes reflect the greater molecular weights of the bulky contorted TBD and TYD monomers compared to MPD monomer. At equivalent ~99% NaCl rejection, the TBDTMC membrane had a water permeance A of6.90±0.48 L m⁻² h⁻¹ bar⁻¹, which is greater than the TYDTMC membrane (A=5.55±0.17 L m⁻² h⁻¹ bar⁻¹) and conventional MPDTMC membrane (A=1.21±0.02 L m⁻² h⁻¹ bar⁻¹).

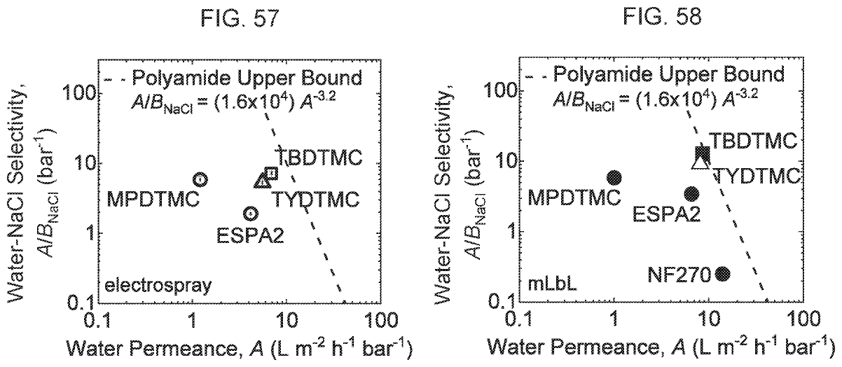

The permselectivities of the electrosprayed polyamide membranes that achieved 99% NaCl rejection are compared to the commercial ESPA2 polyamide membrane and to the polyamide permselectivity upper bound (Z. Yang, H. Cuo, C. Y. Tang, The upper bound of thin-film composite (TFC) polyamide membranes for desalination, Journal of Membrane Science. 590 (2019) 117297) in FIG. 57 and summarized in Table 32. The selectivity of the membranes is represented by the ratio of water permeance, A (L m⁻¹ h⁻¹ bar⁻¹) and NaCl permeance, B_{NaCl} (L m⁻² h⁻¹). As shown in FIG. 57, the permselectivities of the electrosprayed contorted TBDTMC and TYDTMC membranes exceeds those of conventional MPDTMC polyamide and commercial ESPA2 polyamide membranes, which was also observed for contorted polyamide membranes fabricated by mLbL deposition. The water-NaCl selectivities of the electrosprayed contorted TBDTMC and TYDTMC polyamide membranes are less than those measured for the mLbL contorted polyamide membranes (Table 30), which may be the result of a less uniform polyamide network synthesized by electrospray deposition. Without being bound by theory this reduction in polyamide network uniformity and associated water-NaCl selectivity may represent a tradeoff in membrane desalination performance that results from scaling up the membrane fabrication from the relatively slow, more controlled, solution-based mLbL deposition process to the more rapid, larger-area fabrication by electrospray deposition.

TABLE 32
Water-NaCl selectivity of electrosprayed MPDTMC, TBDTMC,
and TYDTMC membranes compared to a commercial polyamide
desalination membrane and the polyamide upper bound.

| | | | Polyamide |
|---|---|---|---|
| | Water | Water-NaCl | Upper Bound |
| | Permeance, A | Selectivity, | Selectivity, |
| Polyamide | (L m⁻² h⁻¹ | A/B_{NaCl} | A/B_{NaCl} |
| Membrane | bar⁻¹) | (bar⁻¹) | (bar⁻¹) |
| MPDTMC | 1.21 ± 0.02 | 5.86 ± 0.62 | 8660 |
| TBDTMC | 6.90 ± 0.48 | 7.23 ± 0.40 | 33.0 |
| TYDTMC | 5.55 ± 0.17 | 5.34 ± 0.27 | 66.3 |
| ESPA2 | 4.16 ± 0.02 | 1.92 ± 0.06 | 167 |

### Continuing Work:

Work will continue in Task #2 to characterize the properties of the electrosprayed polyamide membranes that achieved the desalination performance target of 99% NaCl rejection. The free volume content of the electrosprayed polyamides will be measured by powder XRD and carbon dioxide (CO₂) physisorption, similar to characterizations performed for films fabricated by mLbL deposition. Electrosprayed polyamide film densities will be measured gravimetrically using the QCM technique. The thicknesses of electrosprayed polyamide membranes will be correlated to total monomer mass deposition by profilometry measurements of thickness for a series of films of each polyamide chemistry. The desalination performance of other commercial polyamide desalination membranes will be measured for comparison to the electrosprayed contorted TBDTMC and TYDTMC polyamide membranes.

### Example 28—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated, free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior.

### Work Perform:

### Salt Permeability of Polyamide Films

As discussed above herein, salt diffusion tests were conducted in a dual chamber diffusion cell to measure the salt permeabilities of Novatexx commercial porous support membranes and of mLbL polyamide films captured on Novatexx supports. NaCl salt diffusion tests were conducted for MPDTMC, TBDTMC, and TYDTMC polyamide films at thicknesses hypothesized to yield 99% NaCl rejection based on desalination performance testing. The NaCl salt permeability, P, (m² s⁻¹), was calculated from diffusion cell tests by application of a model described by Luo, Geise et al. (H. Luo, J. Aboki, Y. Ji, R. Guo, G. M. Geise, Water and Salt Transport Properties of Triptycene-Containing Sulfonated Polysulfone Materials for Desalination Membrane Applications, ACS Appl. Mater. Interfaces. 10 (2018) 4102-4112). The calculated salt permeabilities for the three polyamide films are summarized in Table 33 and compared to the Novatexx support and NaCl bulk diffusion for reference.

TABLE 33
NaCl permeabilities of mLbL polyamide films measured
from diffusion tests compared to reference materials.

| | | NaCl |
|---|---|---|
| Polyamide | Estimated Film | Permeability, |
| Film | Thickness (nm) | Pₛ (m² s⁻¹) |
| MPDTMC | 38 | (2.72 ± 0.05) × 10⁻¹⁴ |
| TBDTMC | 25 | (2.74 ± 0.09) × 10⁻¹⁴ |
| TYDTMC | 36 | (1.62 ± 0.04) × 10⁻¹⁴ |
| Novatexx Support | — | (4.27 ± 0.10) × 10⁻⁰⁹ |
| NaCl bulk diffusion | | 1.5 × 10⁻⁰⁹ |

### Solution-Diffusion Transport Modeling

As discussed above herein, diffusivity-dominated, free volume-based transport models were applied to measured water and NaCl permeabilities to relate the observed transport behavior of the MPDTMC, TBDTMC, and TYDTMC polyamide films to their structural characteristics. The water and salt transport modeling were based on the classic solution diffusion model that describes penetrant permeability, P, of the polyamide films as the product of a solubility or partitioning coefficient, K, and the penetrant diffusion coefficient in the polymer network, D. Solution-diffusion models were applied separately to water permeability measurements (H. Zhang, G. M. Geise, Modeling the water permeability and water/salt selectivity tradeoff in polymer membranes, Journal of Membrane Science. 520 (2016) 790-800; H. Yasuda, C. Lamaze, A. Peterlin, Diffusive and hydraulic permeabilities of water in water-swollen polymer membranes, Journal of Polymer Science Part A-2. Polymer Physics 9 (1971) 1117-1131) and salt permeability measurements (H. Zhang, G. M. Geise, Modeling the water permeability and water/salt selectivity tradeoff in polymer membranes, Journal of Membrane Science. 520 (2016) 790-800: H. Yasuda, C. E. Lamaze, L. D. Ikenberry, Permeability of solutes through hydrated polymer membranes. Part I. Diffusion of sodium chloride, Die Makromolekulare Chemie. 118 (1968) 19-35) to estimate two characteristic volume parameters that are descriptive of the polyamide network structures. From water permeability modeling, the, term was calculated as a characteristic volume parameter that is proportional to the cross-section and diffusional jump length of the diffusing water (H. Zhang, G. M. Geise, Modeling the water permeability and water/salt selectivity tradeoff in polymer membranes, Journal of Membrane Science. 520 (2016) 790-800; H. Yasuda, C. Lamaze, A. Peterlin, Diffusive and hydraulic permeabilities of water in water-swollen polymer membranes, Journal of Polymer Science Part A-2: Polymer Physics. 9 (1971) 1117-1131). From salt permeability modeling, a fitting parameter b was defined that is descriptive of the size of the diffusing salt penetrant and a characteristic volume required to accommodate the penetrant in the polyamide network (H. Zhang, G. M. Geise, Modeling the water permeability and water/salt selectivity tradeoff in polymer membranes, Journal of Membrane Science. 520 (2016) 790-800; H. Yasuda, C. E. Lamaze, L. D. Ikenberry, Permeability of solutes through hydrated polymer membranes. Part I. Diffusion of sodium chloride, Die Makromolekulare Chemie. 118 (1968) 19-35). These initial modeling results were obtained using estimated water partitioning coefficient K_{w} values (K_{w}=0.10) and assumed polyamide film density □ₚ values (ranging from 1100 kg m⁻³ to 1200 kg m³). The partitioning coefficient for NaCl into polyamide, Kₛ, was estimated to be Kₛ=0.10 based on previously reported measurements (D. L. Shaffer, K E. Feldman, E. P. Chan, G R. Stafford, C M. Stafford, Characterizing salt permeability in polyamide desalination membranes using electrochemical impedance spectroscopy, Journal of Membrane Science. 583 (2019) 248-257).

Now we report, the polyamide densities □ₚ calculated from XRR measurements (1338 kg m³, 968 kg m³, and 918 kg m³ for MPDTMC, TBDTMC, and TYDTMC polyamides, respectively) were used to update diffusive transport modeling of measured water and salt permeabilities for these polyamide membranes. The water partitioning coefficient K_{w}, which is effectively the volume fraction of water in the polyamide (H. Zhang, G. M. Geise, Modeling the water permeability and water/salt selectivity tradeoff in polymer membranes, Journal of Membrane Science. 520 (2016) 790-800) or the free volume of the hydrated polymer network (H. Yasuda, C. Lamaze, A. Peterlin, Diffusive and hydraulic permeabilities of water in water-swollen polymer membranes, Journal of Polymer Science Part A-2: Polymer Physics. 9 (1971) 1117-1131), was calculated from the polyamide film swelling ratio, S, according to Equation 33:

$${K}_{w} = S - 1 \qquad ( Equation 33 )$$

Water partitioning coefficients, K_{w}, of 0.26, 0.40, and 0.58 were defined for MPDTMC, TBDTMC, and TYDTMC membranes, respectively, using the swelling ratios from the 114-cycle MPDTMC film, 61-cycle TBDTMC film, and 20-cycle TYDTMC film.

Diffusivity-dominated water transport modeling using these updated properties of the polyamide membranes resulted in □ values of 0.60 cm³ g⁻¹, 4.60 cm³ g⁻¹, and 17.0 cm³ g⁻¹ for MPDTMC, TBTMC, and TYDTMC, respectively. These characteristic volumes of diffusing water, □, are hypothesized to be larger than the free volume of water (0.38 cm³ g⁻¹) for the assumed diffusivity-dominated solution-diffusion transport. The □ values for contorted TBDTMC and TYDTMC membranes are significantly larger than that of conventional MPDTMC, which is also indicated by the higher pure water permeances of these contorted polyamide membranes compared to conventional MPDTMC. Though TBDTMC and TYDTMC polyamide membranes exhibited similar water permeances for mLbL membranes and for electrosprayed membranes, the □ value for TYDTMC (□=17.0 cm³ g⁻¹) is more than three times greater than that for TBDTMC (□=4.60 cm³ g⁻¹). The □□ fitting parameter from transport modeling is sensitive to the K_{w} value, calculated from swelling ratios. The S values for TYDTMC membranes from SAXS measurements ranged from 1.58-2.53, which were significantly greater (two-sided t-test, □=0.05) than the TBDTMC S values, which were in the range 0.75-1.40. We do not yet understand why the differences in observed swelling behavior for TBDTMC and TYDTMC did not result in more significant differences in water permeability. However, the larger □ value determined for TYDTMC polyamide is a result of this difference in swelling ratio S and associated water partitioning coefficient. K_{w}.

The updated modeling results for NaCl permeability of the MPDTMC and TBDTMC polyamide membranes yielded b values, which are descriptive of the characteristic volume of diffusing salt penetrant, of b=2.95 for MPDTMC, b=5.83 for TBDTMC, and h=12.8 for TYDTMC polyamides. The b value of 2.95 for our MPDTMC membrane is similar to the value of b=2.39±0.15 that was reported by Zhang and Geise (H. Zhang, G. M. Geise, Modeling the water permeability and water/salt selectivity tradeoff in polymer membranes, Journal of Membrane Science. 520 (2016) 790-800) for similar modeling of conventional MPDTMC polyamide membranes. The contorted TBDTMC and TYDTMC polyamide membranes have higher b values (5.83 and 12.8, respectively), which indicate the increased size of diffusing salt penetrants within the increased free volume of the water-swollen contorted polyamide networks. Despite the hypothesis of higher b values reducing NaCl diffusion through the polyamide membranes, the measured NaCl permeability of the contorted TBDTMC and TYDTMC polyamide films was similar to that of conventional MPDTMC polyamide (Table 33). Like the fitting parameter, the b fitting parameter from the diffusivity-dominated salt transport model is also sensitive to the K_{w} value, calculated from the swelling ratio. Thus, for the similar NaCl permeabilities of the different polyamide films, the differences in swelling behavior and K_{w} explain the different determined b values. Despite similar measured salt permeabilities, contorted TBDTMC and TYDTMC polyamides achieve higher water-NaCl selectivities compared to conventional MPDTMC polyamide because of their enhanced water permeability.

### Continuing Work:

During the next reporting period, we will continue to review the literature concerning diffusive penetrant transport in polymeric membranes. We seek to better understand and explain the differences in swelling behavior observed for the TYDTMC polyamide compared to TBDTMC and MPDTMC polyamides. Based on our findings, the diffusivity-dominated, free volume-based transport modeling will be modified accordingly, with the goal of providing insight into the improved selectivity demonstrated by the contorted TBDTMC and TYDTMC polyamide membranes.

### Overview and Objectives of Example 29—Example 31

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by electrospray deposition; Task #3—Relate the permeability-selectivity performance of contorted polyamide membranes to solution-diffusion transport.

### Example 29—Controlling Polyamide Free Volume

### Goals/Work Outline:

Research efforts in Task #1 will synthesize polyamide polymers from water-insoluble contorted diamine monomers (Troger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure.

### Work Performed:

### Polyamide Thin Film Synthesis and Membrane Fabrication

As discussed above herein, we reported the solvent systems used in mLbL fabrication of polyamide films and the corresponding growth rates of film thickness. MPDTMC and TBDTMC films were deposited directly onto silicon wafer substrates, and TYDTMC films were deposited onto silicon wafers that were functionalized with APTES amino-silane agent. Thickness measurements for each of the polyamide films were made by interferometry, and the refractive index was described by the Cauchy equation (A=1.601 and B=0.02564).

We fabricated thin-film composite MPDTMC, TBDTMC, and TYDTMC membranes by capturing floating polyamide films from a water bath onto polyacrylonitrile (PAN) porous membrane supports. The desalination performances of membranes prepared from the three polyamide chemistries were evaluated as a function of polyamide film thickness and were evaluated in long-term desalination performance testing.

### Characteristics of Contorted Polyamide Polymers

As discussed above herein, d-spacings (from powder X-ray diffraction (XRD) patterns) were reported for the polyamide powders as estimates of the size of free volume elements. These relative d-spacings were consistent with Langmuir surface areas calculated for the polyamides from CO₂ adsorption-desorption isotherm measurements. The chemistry of the polyamide films was previously characterized by FT-IR spectroscopy and by measured surface zeta potentials.

The chemistry of the polyamide films was also previously characterized by X-ray photoelectron spectroscopy (XPS) measurements, and the degree of crosslinking of the polyamides was estimated by comparing the calculated O/N elemental ratio to the theoretical ratios that would be measured for fully crosslinked and fully linear polyamide films of the same chemistry. The calculated O/N ratios were all within 5% of the respective theoretical values for fully crosslinked networks, indicating monomer reactivity was maintained and near complete monomer conversion to crosslinked polymer was achieved in the mLbL deposition process.

As discussed above herein, the densities of the MPDTMC and TBDTMC films, which are indicative of their free volume fractions, were measured using a quartz crystal microbalance (QCM) technique (S. Karan, Z. Jiang, A. G. Livingston, Sub-10 nm polyamide nanofilms with ultrafast solvent transport for molecular separation, Science 348 (2015) 1347-1351). The shift in the resonant frequency (Δf) of a QCM sensor coated with a polyamide film was used to calculate film mass (in) by application of the Sauerbrey equation. The density of each of the deposited polyamide films was then calculated from the mass and volume of the film. QCM densities measurements have not yet been made for TYDTMC polyamide films because of challenges adhering the films to the QCM sensor.

Polyamide film densities were also previously determined from X-ray reflectivity (XRR) measurements made at the Advanced Photon Source (APS) Beamline 33-BM-C at Argon National Lab. XRR measurements were made fora series of polyamide films with thicknesses ranging from ~5 nm to ~80 nm. The resulting reflectivity curves for MPDTMC, TBDTMC, and TYDTMC films were modeled to fit the measured reflectivity curve for each film based on film thickness, roughness, and scattering length density, SLD. Polyamide mass densities were then estimated from the SLDs using the NIST online SLD calculator (Kienzle, Paul, NIST Online Scattering Length Density Calculator, (2022). www.ncnr.nist.gov) to fit the SLDs by adjusting mass density for an assumed molecular formula for the polyamide films.

The densities from XRR for the all of the polyamide films decreased with increasing film thickness, a trend which could result from anisotropic growth of the mLbL polyamide films, especially at low cycle numbers (T. J. Zimudzi, S. E. Sheffield, K. E. Feldman, P. A. Beaucage, D. M. DeLongchamp, D. I. Kushner, C. M. Stafford, M. A. Hickner, Orientation of Thin Polyamide Layer-by-Layer Films on Non-Porous Substrates, Macromolecules 54 (2021) 11296-11303). The lower densities of contorted TBDTMC and TYDTMC polyamides compared to conventional MPDTMC polyamide reflect the increased free volume introduced by the contorted TBD and TYD monomers. The trend of decreasing density (MPDTMC>TBDTMC>TYDTMC) is similar to the previously measured trends of increasing d-spacing and Langmuir surface areas for contorted versus conventional polyamide.

Swelling Ratios from Small Angle X-Ray Scattering (SAXS) Measurements

As discussed above herein, swelling ratios for the conventional MPDTMC and contorted TBDTMC and TYDTMC films were calculated from SAXS measurements made at different relative humidity (RH) conditions: 0%, 25%, 50%, 75%, and 90%. SAXS measurements were made at Beamline 12-ID-C at the APS. At very high ranges of scattering vector q (Å⁻¹), a scattering intensity correlation peak is present that is related to the d-spacing of the polyamide network (P. S. Singh, P. Ray, Z. Xie, M. Hoang, Synchrotron SAXS to probe cross-linked network of polyamide ‘reverse osmosis’ and ‘nanofiltration’ membranes, Journal of Membrane Science 421-422 (2012) 51-59) which we have used as a measure of network free volume. The swelling ratio S was calculated from the relative change in the intensity I of this d-spacing correlation peak from dry to humidified conditions, according to Equation 34:

$$S = \frac{{I}_{humidified}}{{I}_{dry}} \qquad ( Equation 34 )$$

Swelling ratios were calculated for each polyamide film according to Equation 34 with reference to 0% RH as the dry condition. After processing the SAXS data in OriginPro software (OriginLab 2021b), it was apparent that measurements targeting 90% RH conditions were unstable, with poor control over temperature and RH. Consequently, the measurements at 75% RH were used as the humidified condition for calculating the swelling ratios. Calculated swelling ratios at 75% RH for the 114-cycle MPDTMC film, 61-cycle TBDTMC film, and 20-cycle TYDTMC film were used to define the water volume fraction K_{w} of the respective hydrated polyamide membrane for solution-diffusion transport modeling.

### Desalination Performance of Contorted Polyamide Membranes

As discussed above herein, the water permeances and NaCl rejections of MPDTMC, TBDTMC, and TYDTMC membranes fabricated by mLbL deposition were compared as a function of polyamide film thickness. From measurements of pure water flux and of salt rejection from ~50 mmol L⁻¹ NaCl solution, water permeance, A (L m⁻¹ h⁻¹ bar⁻¹), NaCl permeance, B_{NaCl} (L m⁻² h⁻¹), and water-NaCl selectivity, A B_{NaCl} (bar⁻¹) values were calculated. As a result of their increased free volume, the TBDTMC and TYDTMC contorted polyamide membranes showed enhanced permselectivity compared to the conventional MPDTMC polyamide membrane. The contorted polyamide membranes also demonstrated better permselectivity than a commercial polyamide reverse osmosis membrane ESPA2 (Hydranautics) and a nanofiltration membrane NF 270 (Dupont FilmTec). Long-duration (12 h) performance tests were also conducted for the mLbL fabricated polyamide membranes that demonstrated ~99% NaCl rejections in preliminary performance tests.

In the permeability-selectivity tradeoff plot in FIG. 58, the desalination performance of the previously reported mLbL polyamide membranes that achieved 99% NaCl rejection is compared to commercial polyamide membranes desalination membranes. The “upper bound” of permselectivity for polyamide desalination membranes, which was defined from an analysis of over 1,200 experimental observations of NaCl rejection and water permeance (Z. Yang, H. Guo, C. Y. Tang, The upper bound of thin-film composite (TFC) polyamide membranes for desalination, Journal of Membrane Science 590 (2019) 117297) is also included in FIG. 58.

### Continuing Work:

Continuing work on Task #1 we will seek to measure the desalination performance of other commercial polyamide desalination membranes for comparison to the contorted TBDTMC and TYDTMC polyamide membranes developed in this research.

### Example 30—Fabricating Membranes by Electrospray Deposition

### Goals/Work Outline:

The work in Task #2 will optimize conditions for fabricating contorted polyamide membranes using a scalable electrospray deposition process. The effects of process parameters and reaction conditions on polyamide film properties will be quantified. The structures and properties of contorted polyamide membranes will be characterized, and their desalination performance will be assessed. The goal of Task #2 is to fabricate conventional MPDTMC and contorted TBDTMC and TYDTMC polyamide membranes by electrospray deposition that have equivalent desalination performance (99% NaCl rejection) to the mLbL polyamide membranes reported in Task #1.

### Work Performed:

As discussed above herein, the optimization of electrospray parameters for the electrospray deposition system with the goal of producing consistent polyamide films with controllable thickness. After extensive experimentation, we determined that two different monomer solutions that can form an interface were necessary to successfully fabricate salt-rejecting polyamide films by electrospray deposition, as reported by others (X.-H. Ma, Z. Yang, Z.-K. Yao, H. Guo, Z.-L. Xu, C. Y. Tang, Interfacial Polymerization with Electrosprayed Microdroplets: Toward Controllable and Ultrathin Polyamide Membranes, Environ. Sci. Technol. Lett. 5 (2018) 117-122; M. Ostwal, E. Wazer, M. Pemberton, J R. McCutcheon, Scaling electrospray based additive manufacturing of polyamide membranes, Journal of Membrane Science Letters 2 (2022) 100035). As a result, we shifted to a two-phase electrospray deposition system using a water/ethanol cosolvent mixture for the diamine monomers and hexane solvent for TMC monomer solution.

### Electrosprayed Polyamide Membrane Fabrication and Desalination Performance

As discussed above herein, we optimized the electrospray deposition process to fabricate conventional MPDTMC polyamide membranes and contorted TBDTMC and TYDTMC polyamide membranes on PAN supports. Before electrospray deposition of contorted TBDTMC and TYDTMC polyamide membranes, the PAN supports were preconditioned by saturating with an electrosprayed solution of TBD or TYD monomer in ethanol solvent (without water) to improve adhesion between the contorted polyamide film and the PAN support. The optimized electrospray conditions for all three polyamide membranes are summarized in Table 34.

TABLE 34
System parameters for electrospray deposition of
MPDTMC, TBDTMC and TYDTMC polyamide membranes.

| Parameter | Value | | | |
|---|---|---|---|---|
| Monomer solutions | MPD | TBD | TYD | TMC |
| Monomer molecular weight | 108.14 | 840.71 | 858.72 | 265.48 |
| (g mol⁻¹) | | | | |
| Solvent components | water/ethanol | water/ethanol | water/ethanol | hexane |
| Solvent components | 9/1 | 1/11.5 | 8/15 | 1 |
| volumetric ratio | | | | |
| Diamine to TMC monomer | 4 | 0.63 | 0.62 | — |
| molar ratio | | | | |
| Monomer solution | 2.0 | — | — | 1.2 |
| concentration (% wt) | — | 1.0 | — | 0.5 |
| | — | — | 1.0 | 0.5 |
| Total monomer mass | 0.19 (MPD + | 0.97 (TBD + | 0.89 (TYD + | — |
| deposition at 99% NaCl | TMC) | TMC) | TMC) | |
| rejection (mg cm⁻²) | | | | |
| Monomer solution discharge | 2 | — | — | 2 |
| rate (mL h⁻¹) | — | 5 | | 5 |
| | — | — | 5 | 5 |

| | |
|---|---|
| Needle-to-collector distance | 5 |
| (cm) | |
| Applied voltage (kV) | 12 |
| Substrate | Polyacrylonitrile (PAN) membrane |
| | (400 kDa MWCO) |
| Collector rotation speed (rpm) | 80-100 |

The water permeances and NaCl salt rejections of a series of electrosprayed membranes were measured in a cross-flow desalination testing system and reported previously. Desalination performance of the membranes was tuned by changing the total mass of monomers deposited on the PAN support during the electrospraying process, and the desalination target of 99% NaCl rejection was achieved. Additionally, the desalination performance of a commercial polyamide ESPA2 (Hydranautics) reverse osmosis membrane was measured for comparison.

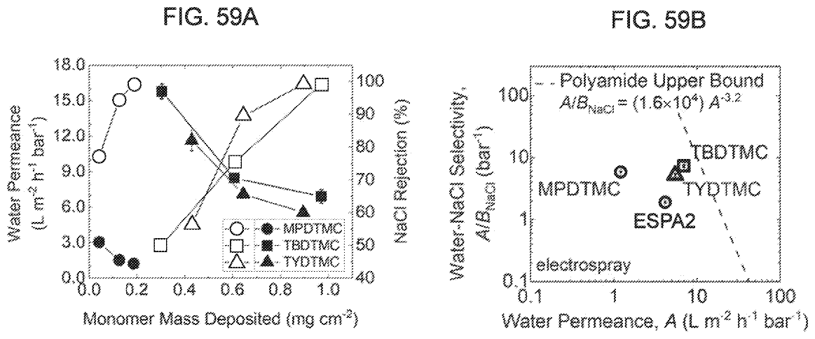

The desalination test results for electrosprayed MPDTMC, TBDTMC, and TYDTMC membranes are summarized in FIG. 59A as a function of total monomer mass deposited (mg cm⁻²) during the electrospray fabrication process. For all three polyamide chemistries, membranes were fabricated that achieved the desalination performance target of 99% NaCl rejection. The permselectivities of the electrosprayed polyamide membranes that achieved 99% NaCl rejection are compared to the commercial ESPA2 polyamide membrane and to the polyamide permselectivity upper bound (Z. Yang, H. Guo, C Y. Tang, The upper bound of thin-film composite (TFC) polyamide membranes for desalination, Journal of Membrane Science 590 (2019) 117297) in FIG. 59B.

Desalination results in FIG. 59A showed that the performance of the electrosprayed polyamide membranes can be tuned by changing the membrane thickness, indicated by monomer mass deposited on the membrane support. Water permeance decreases and salt rejection increases as a function of monomer mass (membrane thickness) for all three electrosprayed membranes, similar to the trends observed for the contorted polyamide membranes fabricated by mLbL deposition.

The permselectivities of the electrosprayed contorted TBDTMC and TYDTMC membranes shown in FIG. 59B exceed those of conventional MPDTMC polyamide and commercial ESPA2 polyamide membranes, which was also observed for contorted polyamide membranes fabricated by mLbL deposition. The water-NaCl selectivities of the electrosprayed contorted TBDTMC and TYDTMC polyamide membranes are less than those measured for the mLbL contorted polyamide membranes, which may be the result of a less uniform polyamide network synthesized by electrospray deposition. Together, the performance of TBDTMC and TYDTMC membranes fabricated by two different techniques confirms the hypothesis that the free volume of polyamide membranes can be controlled through the introduction of sterically hindered monomers and that increased free volume enhances membrane permselectivity.

### Characteristics of Electrosprayed Contorted Polyamide Polymers

Now we report additional characterizations were made for the electrosprayed polyamide membranes, including estimating free volume element sizes from X-ray diffraction (XRD) pattern measurements, and measuring thickness growth curves for electrosprayed films. Density measurements via QCM technique were attempted but were unsuccessful.

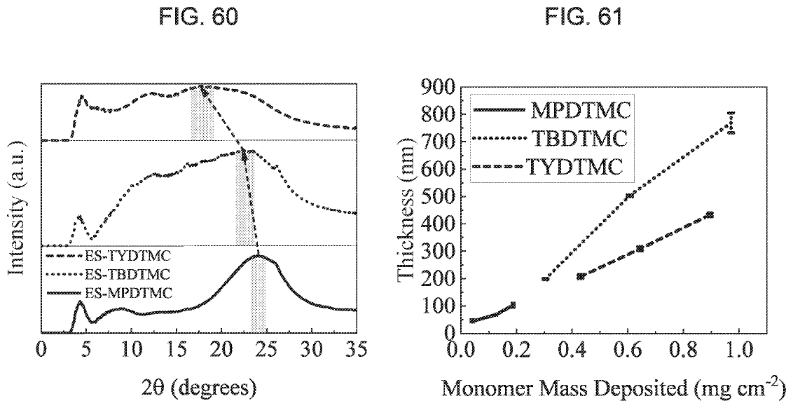

XRD patterns for the electrosprayed polyamide films were derived from Extended Wide Angle X-ray Scattering (EWAXS) measurements of electrosprayed conventional MPDTMC and contorted TBDTMC and TYDTMC films. The polyamide films were electrosprayed onto Kapton tape for the measurements, and the Kapton background was removed from the scattering spectra during data analysis. The electrosprayed films were washed in ethanol and oven-dried for 2 hours at 60° C. prior to EWAXS measurements. FIG. 60 compares the XRD patterns of the electrosprayed MPDTMC, TBDTMC, and TYDTMC films as a function of diffraction angle (2q). The intensity peak at large 20 values represents free volume within polymer matrix, and this peak shifts to lower 2q values (larger free volume element sizes) for contorted TBDTMC and TYDTMC polyamide compared to conventional MPDTMC. The observed shift in peak location indicates an increasing trend in free volume element sizes from MPDTMC to TBDTMC and TYDTMC, as observed for the mLbL polyamide films.

The thicknesses of a series of electrosprayed MPDTMC, TBDTMC and TYDTMC films were measured by profilometry to define thickness growth curves. For each polyamide chemistry, three films of different thicknesses were electrosprayed onto silicon wafer substrates for the profilometry measurements. The films were electrosprayed at monomer mass depositions (mg cm⁻²) equivalent to those of the electrosprayed polyamide membranes used for desalination performance testing. After electrospraying on silicon substrates, the films were air dried, rinsed in ethanol, and oven-dried at 60° C. for 1 hour prior to thickness measurements. For each film, three thickness step measurements were made across the film and onto the bare silicon wafer substrate that had been masked during electrospraying. The polyamide film thicknesses versus the total mass monomer deposited are reported in FIG. 61.

Density measurements of the electrosprayed films were attempted using the QCM technique that was used previously for mLbL films. This technique uses the change in resonant frequency of a QCM sensor to measure the mass of a polyamide film with known dimensions that is electrosprayed onto the sensor. Density is then calculated from the mass and volume of the electrosprayed films.

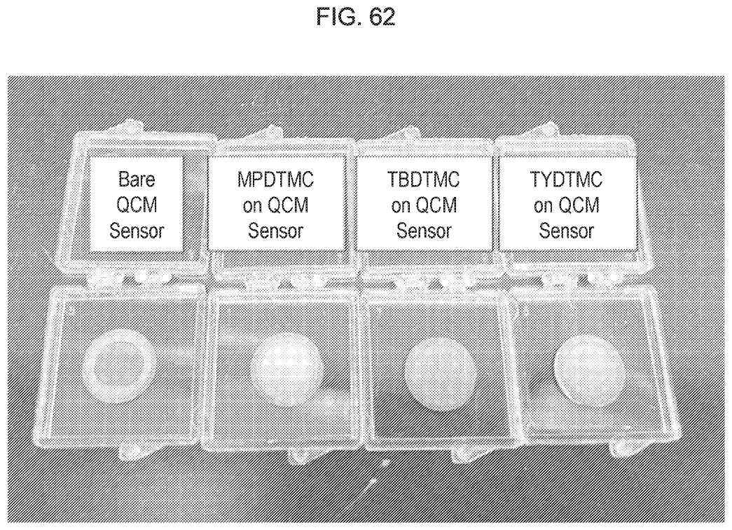

Fundamental frequency measurements were made for the bare QCM sensors before they were coated with polyamide. Polyamide films were successfully electrosprayed onto silicon oxide-coated QCM sensors, as shown in FIG. 62. After polyamide coating, the shift in resonant frequency was measured for each QCM sensor while the measurement chamber was purged with dry nitrogen gas.

The densities resulting from application of the Sauerbrey equation to the measured resonant frequency shifts were unrealistically high and were much greater than those calculated for the mLbL polyamide films. Without being bound by theory the unrealistic calculated densities may result from the relatively thick electrosprayed films (on the order of hundreds of nanometers thick), which may violate the “rigid film” assumptions of the Sauerbrey equation. The measurements will be repeated for thinner polyamide films (~50 nm thick) that better approximate the rigid film assumption.

### Continuing Work:

Work will continue in Task #2 to characterize the properties of the electrosprayed polyamide membranes that achieved the desalination performance target of 99% NaCl rejection. The d-spacing of the free volume element sizes measured by XRD will be quantified by application of Bragg's Law. Carbon dioxide (CO₂) physisorption measurements will be made to characterize electrosprayed polyamide surface areas, similar to characterizations performed for films fabricated by mLbL deposition. The densities of thinner (~50 nm thick) electrosprayed polyamide films will be measured gravimetrically using the QCM technique.

Desalination performance results for electrosprayed polyamide membranes will be presented as a function of film thickness rather than of total monomer mass deposition. The desalination performance of other commercial polyamide desalination membranes will be measured for comparison to the electrosprayed contorted TBDTMC and TYDTMC polyamide membranes.

### Example 31—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated, free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior

### Work Performed:

### Salt Permeability of Polyamide Films

As discussed above herein, salt diffusion tests were conducted in a dual chamber diffusion cell to measure the salt permeabilities of Novatexx commercial porous support membranes and of mLbL polyamide films captured on Novatexx supports. NaCl salt diffusion tests were conducted for MPDTMC, TBDTMC, and TYDTMC polyamide films at thicknesses hypothesized to yield 99% NaCl rejection based on desalination performance testing. The NaCl salt permeability, Pₛ (m² s⁻¹), was calculated from diffusion cell tests by application of a model described by Luo, Geise et al (H. Luo, J. Aboki, Y. Ji, R. Guo, G M. Geise, Water and Salt Transport Properties of Triptycene-Containing Sulfonated Polysulfone Materials for Desalination Membrane Applications, ACS Appl. Mater. Interfaces 10 (2018) 4102-4112). The calculated salt permeabilities for the three polyamide films were similar (approximately 2×10⁻¹ m² s⁻¹) despite the different measured water permeabilities of the membranes.

### Solution-Diffusion Transport Modeling

As discussed above herein, diffusivity-dominated, free volume-based transport models were applied to measured water and NaCl permeabilities to relate the observed transport behavior of the MPDTMC, TBDTMC, and TYDTMC polyamide films to their structural characteristics. The water and salt transport modeling were based on the classic solution diffusion model that describes penetrant permeability, P, of the polyamide films as the product of a solubility or partitioning coefficient, K, and the penetrant diffusion coefficient in the polymer network, D. Solution-diffusion models were applied separately to water permeability measurements (H. Zhang, G. M. Geise, Modeling the water permeability and water/salt selectivity tradeoff in polymer membranes, Journal of Membrane Science 520 (2016) 790-800; H. Yasuda, C. Lamaze, A. Peterlin, Diffusive and hydraulic permeabilities of water in water-swollen polymer membranes, Journal of Polymer Science Part A-2. Polymer Physics 9 (1971) 1117-1131) and salt permeability measurements (H. Zhang, G. M. Geise, Modeling the water permeability and water/salt selectivity tradeoff in polymer membranes, Journal of Membrane Science 520 (2016) 790-800, H. Yasuda, C. E. Lamaze, L. D. Ikenberry, Permeability of solutes through hydrated polymer membranes. Part I. Diffusion of sodium chloride, Die Makromolekulare Chemie 118 (1968) 19-35). To estimate two characteristic volume parameters that are descriptive of the polyamide network structures. From water permeability modeling, the β term was calculated as a characteristic volume parameter that is proportional to the cross-section and diffusional jump length of the diffusing water (H. Zhang, G. M. Geise, Modeling the water permeability and water/salt selectivity tradeoff in polymer membranes, Journal of Membrane Science 520 (2016) 790-800; H. Yasuda, C. Lamaze, A. Peterlin, Diffusive and hydraulic permeabilities of water in water-swollen polymer membranes, Journal of Polymer Science Part A-2: Polymer Physics 9 (1971) 1117-1131). From salt permeability modeling, a fitting parameter b was defined that is descriptive of the size of the diffusing salt penetrant and a characteristic volume required to accommodate the penetrant in the polyamide network (H. Zhang, G. M. Geise, Modeling the water permeability and water/salt selectivity tradeoff in polymer membranes, Journal of Membrane Science 520 (2016) 790-800; H. Yasuda, C. E. Lamaze, L. D. Ikenberry, Permeability of solutes through hydrated polymer membranes. Part I. Diffusion of sodium chloride, Die Makromolekulare Chemie 118 (1968) 19-35).

Solution-diffusion modeling incorporated the polyamide densities ρₚ calculated from XRR measurements (1338 kg m⁻³, 968 kg m⁻³, and 918 kg m⁻³ for MPDTMC, TBDTMC, and TYDTMC polyamides, respectively) and water partitioning coefficients, K_{w}, determined from SAXS measurements (0.26, 0.40, and 0.58 for MPDTMC, TBDTMC, and TYDTMC membranes, respectively). The water partitioning coefficient K_{w}, which is effectively the volume fraction of water in the polyamide (H. Zhang, G. M. Geise, Modeling the water permeability and water/salt selectivity tradeoff in polymer membranes, Journal of Membrane Science 520 (2016) 790-800) or the free volume of the hydrated polymer network (H. Yasuda, C. Lamaze, A. Peterlin, Diffusive and hydraulic permeabilities of water in water-swollen polymer membranes, Journal of Polymer Science Part A-2: Polymer Physics 9 (1971) 1117-1131) was calculated from the polyamide film swelling ratio, S, according to Equation 35:

$${K}_{w} = S - 1 \qquad ( Equation 35 )$$

Previously reported diffusivity-dominated water transport modeling for the polyamide membranes resulted in □ values of 0.60 cm³ g⁻¹, 4.60 cm³ g⁻¹, and 17.0 cm³ g⁻¹ for MPDTMC, TBTMC, and TYDTMC, respectively. These characteristic volumes of diffusing water, □, are hypothesized to be larger than the free volume of water (0.38 cm³ g⁻¹) for the assumed diffusivity-dominated solution-diffusion transport. The □ values for contorted TBDTMC and TYDTMC membranes are significantly larger than that of conventional MPDTMC, which is also indicated by the higher pure water permeances of these contorted polyamide membranes compared to conventional MPDTMC. The □□ fitting parameter from transport modeling was sensitive to the K_{w} value that was calculated from swelling ratios.

The modeling results for NaCl permeability of the MPDTMC and TBDTMC polyamide membranes yielded b values, which are descriptive of the characteristic volume of diffusing salt penetrant, of b=2.95 for MPDTMC, b=5.83 for TBDTMC, and b=12.8 for TYDTMC polyamides. The b value of 2.95 for our MPDTMC membrane is similar to the value of b=2.39±0.15 that was reported by Zhang and Geise (H. Zhang, G. M. Geise, Modeling the water permeability and water/salt selectivity tradeoff in polymer membranes, Journal of Membrane Science 520 (2016) 790-800) for similar modeling of conventional MPDTMC polyamide membranes. The contorted TBDTMC and TYDTMC polyamide membranes have higher b values (5.83 and 12.8, respectively), which indicate the increased size of diffusing salt penetrants within the increased free volume of the water-swollen contorted polyamide networks. Like the ft fitting parameter, the b fitting parameter from the diffusivity-dominated salt transport model was also sensitive to the K_{w} value calculated from the swelling ratio.

### Continuing Work:

We will continue to review the literature concerning diffusive penetrant transport in polymeric membranes. We seek to better understand and explain the differences in swelling behavior observed for the TYDTMC polyamide compared to TBDTMC and MPDTMC polyamides. Based on our findings, the diffusivity-dominated, free volume-based transport modeling will be modified accordingly, with the goal of providing insight into the improved selectivity demonstrated by the contorted TBDTMC and TYDTMC polyamide membranes.

### Overview and Objectives of Example 32—Example 34

The proposed research aims to overcome the permeability-selectivity tradeoff that limits the performance of conventional polymeric desalination membranes by developing contorted polyamide membranes with improved permselectivity. Without being bound by theory, a central hypothesis guiding the work is that control over polyamide free volume through the introduction of sterically contorted monomers will increase water permeability while maintaining or enhancing salt rejection. The work will characterize and model the performance of ultrathin polyamide membranes fabricated from a library of contorted monomers using a scalable electrospray deposition process. Successful completion of the project will be used to achieve control over free volume and enhanced permselectivity in polyamide desalination membranes. The higher throughput and enhanced separation performance of these contorted polyamide membranes are hypothesized to intensify desalination processes and improve their system energy efficiency, thus reducing overall desalination costs.

The three primary tasks to be completed for this work are: Task #1—Control polyamide free volume through incorporation of sterically hindered contorted monomers; Task #2—Fabricate contorted polyamide membranes by electrospray deposition; Task #3—Relate the permeability-selectivity performance of contorted polyamide membranes to solution-diffusion transport.

### Example 32—Controlling Polyamide Free Volume

### Goals/Work Outline:

Research efforts in Task #1 will synthesize polyamide polymers from water-insoluble contorted diamine monomers (Tröger's base diamine (TBD) and triptycene diamine (TYD)) to systematically vary their free volume. Powdered polyamide polymers will be synthesized by monophasic (in a single solvent system) polymerization with trimesoyl chloride (TMC) monomer, and polyamide thin films will be fabricated by a monophasic solution-based molecular layer-by-layer (mLbL) deposition process. The chemistry and structure of the resulting contorted polyamide polymers (TBDTMC and TYDTMC) will be characterized and compared to conventional polyamide synthesized from m-phenylene diamine (MPDTMC) to understand the influence of diamine monomer structure on polyamide polymer free volume and network structure

### Work Performed:

### Polyamide Thin Film Synthesis and Membrane Fabrication

As discussed above herein, we reported the solvent systems used in mLbL fabrication of polyamide films and the corresponding growth rates of film thickness. MPDTMC and TBDTMC films were deposited directly onto silicon wafer substrates, and TYDTMC films were deposited onto silicon wafers that were functionalized with APTES amino-silane agent. Thickness measurements for each of the polyamide films were made by interferometry, and the refractive index was described by the Cauchy equation (A=1.601 and B=0.02564).

We fabricated thin-film composite MPDTMC, TBDTMC, and TYDTMC membranes by capturing floating polyamide films from a water bath onto polyacrylonitrile (PAN) porous membrane supports. The desalination performances of membranes prepared from the three polyamide chemistries were evaluated as a function of polyamide film thickness and were evaluated in long-term desalination performance testing.

### Characteristics of Contorted Polyamide Polymers

As discussed above herein, d-spacings (from powder X-ray diffraction (XRD) patterns) were reported for the polyamide powders as estimates of the size of free volume elements. These relative d-spacings were consistent with Langmuir surface areas calculated for the polyamides from CO₂ adsorption-desorption isotherm measurements. The chemistry of the polyamide films was previously characterized by FT-IR spectroscopy and by measured surface zeta potentials.

The chemistry of the polyamide films was also previously characterized by X-ray photoelectron spectroscopy (XPS) measurements, and the degree of crosslinking of the polyamides was estimated by comparing the calculated O/N elemental ratio to the theoretical ratios that would be measured for fully crosslinked and fully linear polyamide films of the same chemistry. The calculated O/N ratios were all within 5% of the respective theoretical values for fully crosslinked networks, indicating monomer reactivity was maintained and near complete monomer conversion to crosslinked polymer was achieved in the mLbL deposition process.

As discussed above herein, the densities of the MPDTMC and TBDTMC films, which are indicative of their free volume fractions, were measured using a quartz crystal microbalance (QCM) technique (S. Karan, Z. Jiang, A. G. Livingston, Sub-10 nm polyamide nanofilms with ultrafast solvent transport for molecular separation, Science 348 (2015) 1347-1351). The shift in the resonant frequency (Δf) of a QCM sensor coated with a polyamide film was used to calculate film mass (m) by application of the Sauerbrey equation. The density of each of the deposited polyamide films was then calculated from the mass and volume of the film QCM densities measurements have not yet been made for TYDTMC polyamide films because of challenges adhering the films to the QCM sensor.

Polyamide film densities were also previously determined from X-ray reflectivity (XRR) measurements made at the Advanced Photon Source (APS) Beamline 33-BM-C at Argon National Lab. XRR measurements were made for a series of polyamide films with thicknesses ranging from ~5 nm to ~80 nm. The resulting reflectivity curves for MPDTMC, TBDTMC, and TYDTMC films were modeled to fit the measured reflectivity curve for each film based on film thickness, roughness, and scattering length density, SLD. Polyamide mass densities were then estimated from the SLDs using the NIST online SLD calculator (Kienzle, Paul, NIST Online Scattering Length Density Calculator, (2022). www.ncnr.nist.gov) to fit the SLDs by adjusting mass density for an assumed molecular formula for the polyamide films.

The densities from XRR for the all of the polyamide films decreased with increasing film thickness, a trend which could result from anisotropic growth of the mLbL polyamide films, especially at low cycle numbers (T. J. Zimudzi, S. E. Sheffield, K. E. Feldman, P. A. Beaucage, D. M. DeLongchamp, D. I. Kushner, C. M. Stafford. M. A. Hickner, Orientation of Thin Polyamide Layer-by-Layer Films on Non-Porous Substrates, Macromolecules 54 (2021) 11296-113030. The lower densities of contorted TBDTMC and TYDTMC polyamides compared to conventional MPDTMC polyamide reflect the increased free volume introduced by the contorted TBD and TYD monomers. The trend of decreasing density (MPDTMC>TBDTMC>TYDTMC) is similar to the previously measured trends of increasing d-spacing and Langmuir surface areas for contorted versus conventional polyamide.

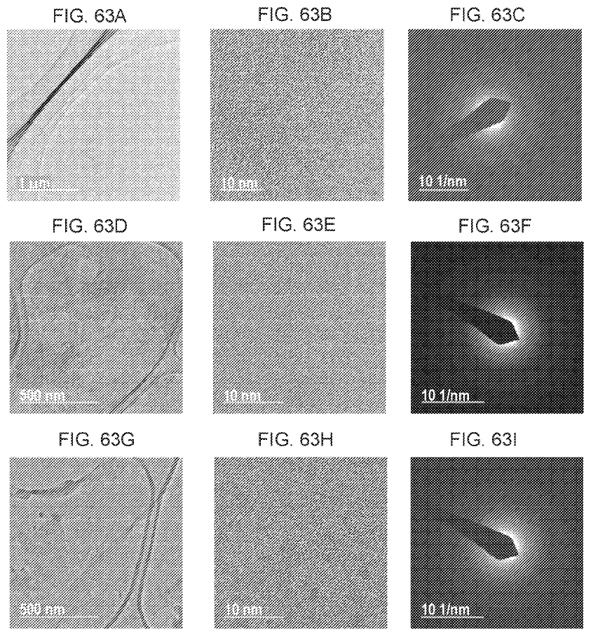

Now we report that, transmission electron microscopy (TEM) measurements were made to characterize polyamide thin films fabricated by mLbL deposition. MPDTMC, TBDTMC, and TYDTMC polyamide films were floated on a water bath and then directly lifted onto a holey carbon (LC200-Cu-150, Electron Microscopy Sciences) TEM grid. The samples were air dried before TEM measurements were made with a JEOL-JEM 2010F instrument. Selected area electron diffraction (SAED) patterns were also measured, as shown in FIG. 63A-FIG. 63I.

The large-area TEM images of the polyamide films show essentially featureless films lacking any discernable pores or channels for pore-flow transport. The SAED patterns from TEM (FIG. 63C, FIG. 63F, and FIG. 63I) indicate the amorphous, rather than crystalline, structure of the conventional MPDTMC and contorted TBDTMC and TYDTMC polyamide films, for these cross-linked network polymers (Z. Lyu, L. Yao, W. Chen, F. C. Kalutantirige, Q. Chen, Electron Microscopy Studies of Soft Nanomaterials, Chem. Rev. 123 (2023) 4051-4145).

Swelling Ratios from Small Angle X-Ray Scattering (SAXS) Measurements

As discussed above herein, swelling ratios for the conventional MPDTMC and contorted TBDTMC and TYDTMC films were calculated from SAXS measurements made at different relative humidity (RH) conditions: 0%, 25%, 50%, 75%, and 90%. SAXS measurements were made at Beamline 12-ID-C at the APS. At very high ranges of scattering vector q (Å⁻¹), a scattering intensity correlation peak is present that is related to the d-spacing of the polyamide network (P. S. Singh, P. Ray, Z. Xie, M. Hoang, Synchrotron SAXS to probe cross-linked network of polyamide ‘reverse osmosis’ and ‘nanofiltration’ membranes, Journal of Membrane Science 421-422 (2012) 51-59), which we have used as a measure of network free volume. The swelling ratio S was calculated from the relative change in the intensity I of this d-spacing correlation peak from dry (0% RH) to humidified conditions (75% RH). Calculated swelling ratios at 75% RH for the 114-cycle MPDTMC film, 61-cycle TBDTMC film, and 20-cycle TYDTMC film were used to define the water volume fraction K. of the respective hydrated polyamide membrane for solution-diffusion transport modeling.

### Desalination Performance of Contorted Polyamide Membranes

As discussed above herein, the water permeances and NaCl rejections of MPDTMC, TBDTMC, and TYDTMC membranes fabricated by mLbL deposition were compared as a function of polyamide film thickness. From measurements of pure water flux and of salt rejection from ~50 mmol L⁻¹ NaCl solution, water permeance, A (L m⁻¹ h⁻¹ bar⁻¹), NaCl permeance, B_{NaCl} (L m⁻² h⁻¹), and water-NaCl selectivity, A/B_{NaCl} (bar⁻¹) values were calculated. As a result of their increased free volume, the TBDTMC and TYDTMC contorted polyamide membranes showed enhanced permselectivity compared to the conventional MPDTMC polyamide membrane. The contorted polyamide membranes also demonstrated better permselectivity than a commercial polyamide reverse osmosis membrane ESPA2 (Hydranautics) and a nanofiltration membrane NF 270 (Dupont FilmTec). Long-duration (12 h) performance tests were also conducted for the mLbL fabricated polyamide membranes that demonstrated ~99% NaCl rejections in preliminary performance tests.

In the permeability-selectivity tradeoff plot in FIG. 55, the desalination performance of the previously reported mLbL polyamide membranes that achieved 99% NaCl rejection is compared to commercial polyamide membranes desalination membranes. The “upper bound” of permselectivity for polyamide desalination membranes, which was defined from an analysis of over 1,200 experimental observations of NaCl rejection and water permeance (Z. Yang, H. Guo, C. Y. Tang, The upper bound of thin-film composite (TFC) polyamide membranes for desalination, Journal of Membrane Science 590 (2019) 117297) is also included in FIG. 55.

### Continuing Work:

Continuing work on Task #1 will seek to further characterize the contorted polyamide membranes by imaging membrane cross-sections by scanning electron microscopy (SEM). Additionally, we aim to measure the desalination performance of other commercial polyamide desalination membranes for comparison to the contorted TBDTMC and TYDTMC polyamide membranes developed in this research.

### Example 33—Fabricating Membranes by Electrospray Deposition

### Goals/Work Outline:

The work in Task #2 will optimize conditions for fabricating contorted polyamide membranes using a scalable electrospray deposition process. The effects of process parameters and reaction conditions on polyamide film properties will be quantified. The structures and properties of contorted polyamide membranes will be characterized, and their desalination performance will be assessed. The goal of Task #2 is to fabricate conventional MPDTMC and contorted TBDTMC and TYDTMC polyamide membranes by electrospray deposition that have equivalent desalination performance (99% NaCl rejection) to the mLbL polyamide membranes reported in Task #1.

As discussed above herein, the optimization of electrospray parameters for the electrospray deposition system with the goal of producing consistent polyamide films with controllable thickness. Two different monomer solutions that can form an interface were determined to be necessary to successfully fabricate salt-rejecting polyamide films by electrospray deposition, as reported by others (X.-H. Ma, Z. Yang, Z.-K. Yao, H. Guo, Z.-L. Xu, C. Y. Tang, Interfacial Polymerization with Electrosprayed Microdroplets: Toward Controllable and Ultrathin Polyamide Membranes, Environ. Sci. Technol. Lett. 5 (2018) 117-122; M. Ostwal, E. Wazer, M. Pemberton, J. R. McCutcheon, Scaling electrospray based additive manufacturing of polyamide membranes, Journal of Membrane Science Letters 2 (2022) 100035). As a result, we adopted a two-phase electrospray deposition system using a water/ethanol cosolvent mixture for the diamine monomers and hexane solvent for TMC monomer solution.

### Electrosprayed Polyamide Membrane Fabrication and Desalination Performance

As discussed above herein, we optimized the electrospray deposition process to fabricate conventional MPDTMC polyamide membranes and contorted TBDTMC and TYDTMC polyamide membranes on PAN supports. Before electrospray deposition of contorted TBDTMC and TYDTMC polyamide membranes, the PAN supports were preconditioned by saturating with an electrosprayed solution of TBD or TYD monomer in ethanol solvent (without water) to improve adhesion between the contorted polyamide film and the PAN support. The optimized electrospray conditions for all three polyamide membranes are summarized in Table 35.

TABLE 35
System parameters for electrospray deposition of
MPDTMC, TBDTMC and TYDTMC polyamide membranes.

| Parameter | Value | | | |
|---|---|---|---|---|
| Monomer solutions | MPD | TBD | TYD | TMC |
| Monomer molecular weight | 108.14 | 280.38 | 284.36 | 265.48 |
| (g mol⁻¹) | | | | |
| Solvent components | water/ethanol | water/ethanol | water/ethanol | hexane |
| Solvent components | 9/1 | 1/11.5 | 8/15 | 1 |
| volumetric ratio | | | | |
| Diamine to TMC monomer | 4 | 0.63 | 0.62 | — |
| molar ratio | | | | |
| Monomer solution | 2.0 | — | — | 1.2 |
| concentration (% wt) | — | 1.0 | 1.0 | 0.5 |
| Total monomer mass | 0.19 (MPD + | 0.97 (TBD + | 0.89 (TYD + | — |
| deposition at 99% NaCl | TMC) | TMC) | TMC) | |
| rejection (mg cm⁻²) | | | | |
| Monomer solution discharge | 2 | — | — | 2 |
| rate (mL h⁻¹) | — | 5 | 5 | 5 |

| | |
|---|---|
| Needle-to-collector distance | 5 |
| (cm) | |
| Applied voltage (kV) | 12 |
| Substrate | Polyacrylonitrile (PAN) membrane |
| | (400 kDa MWCO) |
| Collector rotation speed (rpm) | 80-100 |

The water permeances and NaCl salt rejections of a series of electrosprayed membranes were measured in a cross-flow desalination testing system and reported previously. Desalination performance of the membranes was tuned by changing the total mass of monomers deposited on the PAN support during the electrospraying process, and the desalination target of99% NaCl rejection was achieved. Additionally, the desalination performance of a commercial polyamide ESPA2 (Hydranautics) reverse osmosis membrane was measured for comparison.

The desalination test results for electrosprayed MPDTMC, TBDTMC, and TYDTMC membranes are summarized in FIG. 64A as a function of dry thickness of the polyamide film, as estimated from the growth curves presented above. For all three polyamide chemistries, membranes were fabricated that achieved the desalination performance target of 99% NaCl rejection. The permselectivities of the electrosprayed polyamide membranes that achieved 99% NaCl rejection are compared to the commercial ESPA2 polyamide membrane and to the polyamide permselectivity upper bound (Z. Yang, H. Guo, C. Y. Tang, The upper bound of thin-film composite (TFC) polyamide membranes for desalination, Journal of Membrane Science 590 (2019) 117297) in FIG. 64B. As was observed for the mLbL polyamide membranes, the permselectivities of the electrosprayed contorted TBDTMC and TYDTMC membranes shown in FIG. 64B exceed those of conventional MPDTMC polyamide and commercial ESPA2 polyamide membranes.

### Characteristics of Electrosprayed Contorted Polyamide Polymers

Now we report that, additional characterizations were made for the electrosprayed polyamide membranes, including measuring and analyzing FT-IR spectra, additional analysis of free volume element sizes from X-ray diffraction (XRD) patterns, and density measurements by quartz crystal microbalance (QCM) technique.

The chemistry of electrosprayed MPDTMC, TBDTMC and TYDTMC polyamide films was verified by Fourier Transform Infrared (FT-IR) spectroscopy using a Thermo Scientific Nicolet iS5 FT-IR spectrometer with diamond iD7 ATR accessory. Free standing films were electrosprayed on aluminum foil and washed with water and ethanol multiple times and dried in oven at 60° C. for three hours before FT-IR measurements. Films were made using the electrospray parameters identified in Table 35. Measured FT-IR spectra for the starting monomers and electrosprayed polyamide films are compared in FIG. 65.

The synthesis of the polyamide films is indicated by characteristic absorbance peaks in the amide I (1600-1800 cm⁻¹), amide II (1470-1570 cm⁻¹), and amide III (1250-1350 cm⁻¹) bands (D. Surblys, T. Yamada, B. Thomsen, T. Kawakami, I. Shigemoto, J. Okabe, T. Ogawa, M. Kimura, Y. Sugita, K. Yagi, Amide A band is a fingerprint for water dynamics in reverse osmosis polyamide membranes, Journal of Membrane Science 596 (2020) 117705). The emergence of absorbance peaks in the polyamide spectra at 1667 cm⁻¹ in the amide I band indicates —C═O stretching from amide bonds (T. J. Zimudzi, S. E. Sheffield, K. E. Feldman, P. A. Beaucage, D. M. DeLongchamp, D. I. Kushner, C M. Stafford, M. A. Hickner, Orientation of Thin Polyamide Layer-by-Layer Films on Non-Porous Substrates, Macromolecules 54 (2021)11296-11303; T. J. Zimudzi, K. E. Feldman, J. F. Sturnfield, A. Roy, M. A. Hickner, C. M. Stafford, Quantifying Carboxylic Acid Concentration in Model Polyamide Desalination Membranes via Fourier Transform Infrared Spectroscopy, Macromolecules 51 (2018) 6623-6629; S. Dai, R. Liao, H. Zhou, W. Jin, Synthesis of triptycene-based linear polyamide membrane for molecular sieving of N2 from the VOC mixture, Separation and Purification Technology 252 (2020) 117355). The simultaneous disappearance of the peak attributed to —C═O stretching for acid halide (1725-1760 cm⁻¹) (T. J. Zimudzi, K. E. Feldman, J. F. Sturnfield, A. Roy, M. A. Hickner, C M. Stafford, Quantifying Carboxylic Acid Concentration in Model Polyamide Desalination Membranes via Fourier Transform Infrared Spectroscopy, Macromolecules 51 (2018) 6623-6629; Y. Li, Z. Guo, S. Li, B. Van der Bruggen, Interfacially Polymerized Thin-Film Composite Membranes for Organic Solvent Nanofiltration, Advanced Materials Interfaces 8 (2021) 2001671) and the reduction of the —C═O stretching peak for carboxylic acid (1710 cm-1) in the TMC monomer (S. Dai, R. Liao, H. Zhou, W. Jin, Synthesis of triptycene-based linear polyamide membrane for molecular sieving of N₂ from the VOC mixture, Separation and Purification Technology 252 (2020) 117355; Y. Jin, W. Wang, Z. Su, Spectroscopic study on water diffusion in aromatic polyamide thin film, Journal of Membrane Science 379 (2011) 121-130; Z. Wang, D. Wang, F. Zhang, J. Jin, Troger's Base-Based Microporous Polyimide Membranes for High-Performance Gas Separation, ACS Macro Lett 3 (2014) 597-601; A. Yerzhankyzy, B. S. Ghanem, Y. Wang, N. Alaslai, I. Pinnau, Gas separation performance and mechanical properties of thermally-rearranged polybenzoxazoles derived from an intrinsically microporous dihydroxyl-functionalized triptycene diamine-based polyimide, Journal of Membrane Science 595 (2020) 117512) indicates the bonding of TMC acyl chloride functional groups to form polyamides. The disappearance of absorption peaks attributed to the N—H stretch (3300-3400 cm⁻¹) from primary amine groups in MPD, TBD, and TYD monomers when compared to the corresponding polyamide polymers indicates that the free amine functional groups in the diamine monomers have formed amide bonds in the polyamides. The polyamides also exhibit an absorbance peak in the amide II band that is associated with the N—H stretch from the amide bond (1541 cm⁻¹) (M. F. Jimenez Solomon, Y. Bhole, A. G. Livingston, High flux membranes for organic solvent nanofiltration (OSN)—Interfacial polymerization with solvent activation, Journal of Membrane Science 423-424 (2012) 371-382; L. Shen, R. Cheng, M. Yi, W.-S. Hung, S. Japip, L. Tian, X. Zhang, S. Jiang, S. Li, Y. Wang, Polyamide-based membranes with structural homogeneity for ultrafast molecular sieving, Nat Commun 13 (2022) 500; B. Khorshidi, T. Thundat, B. A. Fleck, M. Sadrzadeh, A Novel Approach Toward Fabrication of High Performance Thin Film Composite Polyamide Membranes, Sci Rep 6 (2016) 22069) that is absent from the diamine and TMC monomers.

As discussed above herein, the thicknesses of electrosprayed MPDTMC, TBDTMC, and TYDTMC films were measured by profilometry to construct a growth curve of electrosprayed dry film thickness as a function of monomer mass deposited during the electrospray process. In this reporting period, we have made linear fits to the thickness data to quantify the different polyamide growth rates. The results are shown in FIG. 66.

For the electrosprayed polyamide films, the thickness growth rate is highest for TBDTMC, followed by MPDTMC and TYDTMC, which have similar growth rates. This is in contrast to the polyamide films fabricated by mLbL deposition, for which the contorted TBDTMC and TYDTMC polyamides had similar growth rates that were significantly higher than that of conventional MPDTMC.

XRD patterns for the electrosprayed polyamide films were derived from Extended Wide Angle X-ray Scattering (EWAXS) measurements of electrosprayed conventional MPDTMC and contorted TBDTMC and TYDTMC films, as previously reported. Measurements were made using a Rigaku S-MAX3000 beamline with incident beam wavelength λ=0.154 nm and a detector area of 1024×1024 pixels. Scattering intensities were measured over a wave vector range 0.0091 Å⁻¹, <q<2.1566 Å⁻¹.

Now we report that, the XRD data were further analyzed to calculate d-spacings associated with intensity peaks in the XRD spectra. The spectra were smoothed using three-point adjacent averaging after subtracting the Kapton tape background. Intensity peaks were identified using the peak analyzer tool in Origin software (OriginLab version 2021b). From the identified peaks, the average polymer chain d-spacings were calculated from application of Bragg's Law. The XRD patterns for electrosprayed MPDTMC, TBDTMC, and TYDTMC polyamide are compared in FIG. 67, and the d-spacings associated with intensity peaks are identified.

The intensity peaks at large 2θ values represent free volume within the polymer matrix. As was observed for the previously reported powder XRD measurements of these polyamide powders, the peaks shift to lower 2□ values (larger free volume element sizes) for contorted TBDTMC and TYDTMC polyamide compared to conventional MPDTMC. Additionally, the contorted TBDTMC and TYDTMC polyamides show multiple intensity peaks in their XRD patterns, indicating a range of free volume element sizes. This increased distribution of d-spacing indicates increased distance between polymer chains compared to MPDTMC and increased free polymer free volume (Z. Ali, Y. Wang, W. Ogieglo, F. Pacheco, H. Vovusha, Y. Han, I. Pinnau, Gas separation and water desalination performance of defect-free interfacially polymerized para-linked polyamide thin-film composite membranes, Journal of Membrane Science 618 (2021) 118572) which is hypothesized because of the larger, shape-persistent TBD and TYD monomers. The calculated d-spacings from XRD patterns are compared in Table 36 for polyamide powders and electrosprayed polyamide films.

TABLE 36
Calculated d-spacing from intensity peaks in powder XRD
patterns for polyamide powders and XRD patterns from
EWAXS measurements for electrosprayed polyamide films.

| | d-spacing (Å) | d-spacing (Å) |
|---|---|---|
| Polyamide | in polyamide | in electrosprayed |
| Film | powder | polyamide |
| MPDTMC | 3.6 | 3.7 |
| TBDTMC | 3.8 | 4 |
| | 4.6 | 5.5 |
| | | 7 |
| TYDTMC | 4.1 | 5 |
| | 4.9 | 7.2 |
| | 6.7 | |

The densities of the electrosprayed polyamide films were calculated from mass measurements made using a quartz crystal microbalance (QCM), as reported previously for mLbL films. In this technique, polyamide film mass was determined by the observed shift in the resonant frequency of silicon oxide-coated QCM sensors upon coating with electrosprayed polyamide films. Ultrathin polyamide films were electrosprayed on bare silicon oxide-coated sensors, and the film deposition was stopped immediately after a change in the color of the QCM sensors was apparent. Very thin electrosprayed films were sought to avoid previous measurement challenges with very thick films and to adhere to the “rigid film” assumption of the Sauerbrey equation.

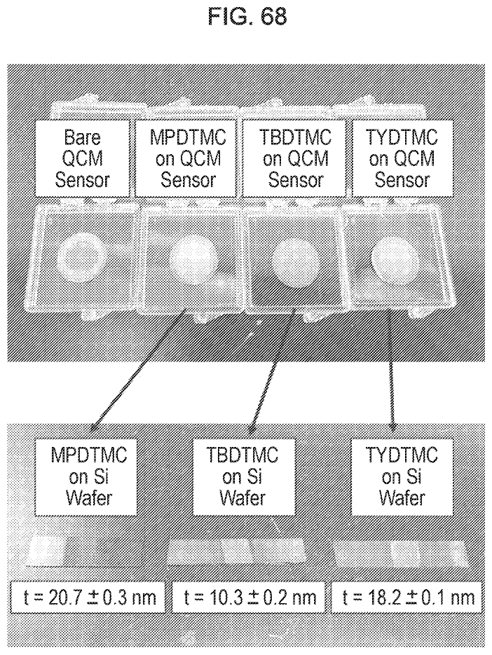

The thicknesses of the electrosprayed films were determined by measuring the thicknesses of films that were simultaneously deposited on silicon wafer substrates taped next to the QCM sensors on the electrospray collector. Film thicknesses were measured by profilometry as previously described. The electrospraying system parameters used were those reported in Table 35. Before the QCM measurement of polyamide-coated sensors, the sensors were air dried overnight followed by rinsing with water and ethanol to remove unreacted monomers. The sensors were then dried in oven at 60° C. for three hours before making the QCM measurements. During the measurements, the QCM sensors were purged with dry nitrogen gas. Photos of the polyamide-coated QCM sensors and silicon wafer substrates are included in FIG. 68.

Polyamide film masses were calculated from the QCM sensor frequency shifts (Df) by application of the Sauerbrey equation (Equation 36) to the third harmonic overtone of the fundamental frequency. This third overtone was used rather than the fundamental frequency to reduce measurement noise.

$$Δ f = \frac{2 {f}_{3}^{2}}{\sqrt{{ρ}_{q} {μ}_{q}}} \frac{m}{A} \qquad ( Equation 36 )$$

In Equation 36, f₃ is the third harmonic overtone of the fundamental frequency of the bare quartz sensor (14.86 MHz), ρ_{g} is the density of the quartz sensor (2.648 g cm⁻¹), and ρ_{q} is the shear modulus of the quartz sensor (2.95×10¹¹ g cm⁻¹ s⁻²).

Film densities were then calculated from measured masses with knowledge of the film volume, according to Equation 37:

$${ρ}_{film} = \frac{m}{A \times t} \qquad ( Equation 37 )$$

where m is the mass of the polyamide film, A is the surface area of the polyamide film and QCM sensor (1.53 cm²), and 1 is the film thickness (t=20.7 nm for MPDTMC; t=10.3 nm for TBDTMC; and t=18.2 nm for TYDTMC).

The resulting calculated densities for the MPDTMC, TBDTMC, and TYDTMC films were 1.094 g cm⁻³, 0.832 g cm⁻³, and 0.887 g cm⁻³, respectively. The measured densities by QCM of the electrosprayed polyamide films are compared to those measured for the mLbL films in Table 37

TABLE 37
Mass densities of conventional MPDTMC and contorted
TBDTMC and TYDTMC polyamide films measured by QCM.

| | mLbL | Electrosprayed |
|---|---|---|
| | Polyamide Density | Polyamide Density |
| Polyamide | Measured by QCM | Measured by QCM |
| Film | (g cm⁻³) | (g cm⁻³) |
| MPDTMC | 1.331 | 1.094 |
| TBDTMC | 1.042 | 0.832 |
| TYDTMC | — | 0.887 |

The electrosprayed films are less dense than the mLbL films measured by the same QCM technique. Without being bound by theory the relatively higher density of the mLbL films may reflect the opportunities for monomers to diffuse into the nascent polyamide film and react with unreacted monomers in the polyamide network, which are available because of the sequential deposition of monomer solutions during the mLbL process. In contrast, during electrospray deposition, solvent is almost entirely evaporated before monomer solutions contact the collector and polymerize. Similar opportunities for back-diffusion of monomers into the growing polyamide film are not as prevalent.

### Continuing Work:

Work will continue in Task #2 to characterize the properties of the electrosprayed polyamide membranes that achieved the desalination performance target of 99% NaCl rejection. Carbon dioxide (CO₂) physisorption measurements will be made to characterize electrosprayed polyamide surface areas, similar to characterizations performed for films fabricated by mLbL deposition. The desalination performance of other commercial polyamide desalination membranes will be measured for comparison to the electrosprayed contorted TBDTMC and TYDTMC polyamide membranes.

### Example 34—Relating Membrane Performance to Solution-Diffusion Transport

### Goals/Work Outline:

The research conducted in Task #3 will model desalination performance data for contorted polyamide membranes to provide insight into solution-diffusion transport behavior. Measured water and salt permeabilities for contorted polyamide membranes and thin films with controlled thicknesses will be fit with diffusivity-dominated, free volume-based transport models. Each diffusivity model has a single fitting parameter that is characteristic of the diffusional jump length of the water or salt penetrant and that provides insights into penetrant mass transport. When combined, these free volume models will relate the structural characteristics of the polyamide selective layer to solution-diffusion transport behavior.

### Work Performed:

### Salt Permeability of Polyamide Films

As discussed above herein, salt diffusion tests were conducted in a dual chamber diffusion cell to measure the salt permeabilities of Novatexx commercial porous support membranes and of mLbL polyamide films captured on Novatexx supports. NaCl salt diffusion tests were conducted for MPDTMC, TBDTMC, and TYDTMC polyamide films at thicknesses hypothesized to yield 99% NaCl rejection based on desalination performance testing. The NaCl salt permeability, Pₛ (m² s⁻¹), was calculated from diffusion cell tests by application of a model described by Luo, Geise et al. (H. Luo, J. Aboki, Y. Ji, R. Guo, G. M. Geise, Water and Salt Transport Properties of Triptycene-Containing Sulfonated Polysulfone Materials for Desalination Membrane Applications, ACS Appl. Mater. Interfaces 10 (2018) 4102-4112). The calculated salt permeabilities for the three polyamide films were similar (approximately 2×10⁻¹⁴ m² s⁻¹) despite the different measured water permeabilities of the membranes

### Solution-Diffusion Transport Modeling

As discussed above herein, diffusivity-dominated, free volume-based transport models were applied to measured water and NaCl permeabilities to relate the observed transport behavior of the MPDTMC, TBDTMC, and TYDTMC polyamide films to their structural characteristics. The water and salt transport modeling were based on the classic solution diffusion model that describes penetrant permeability, P, of the polyamide films as the product of a solubility or partitioning coefficient, K, and the penetrant diffusion coefficient in the polymer network, D. Solution-diffusion models were applied separately to water permeability measurements (H. Zhang, G. M. Geise, Modeling the water permeability and water/salt selectivity tradeoff in polymer membranes, Journal of Membrane Science 520 (2016) 790-800; H. Yasuda, C. Lamaze, A. Peterlin, Diffusive and hydraulic permeabilities of water in water-swollen polymer membranes, Journal of Polymer Science Part A-2: Polymer Physics 9 (1971) 1117-1131) and salt permeability measurements (H. Zhang, G. M. Geise, Modeling the water permeability and water/salt selectivity tradeoff in polymer membranes, Journal of Membrane Science 520 (2016) 790-800; H. Yasuda, C. E. Lamaze, L. D. Ikenberry, Permeability of solutes through hydrated polymer membranes. Part I. Diffusion of sodium chloride, Die Makromolekulare Chemie 118 (1968) 19-35) to estimate two characteristic volume parameters that are descriptive of the polyamide network structures. From water permeability modeling, the term was calculated as a characteristic volume parameter that is proportional to the cross-section and diffusional jump length of the diffusing water (H. Zhang, G. M. Geise, Modeling the water permeability and water/salt selectivity tradeoff in polymer membranes, Journal of Membrane Science 520 (2016) 790-800; H. Yasuda, C. Lamaze, A. Peterlin, Diffusive and hydraulic permeabilities of water in water-swollen polymer membranes, Journal of Polymer Science Part A-2: Polymer Physics 9 (1971) 1117-1131). From salt permeability modeling, a fitting parameter b was defined that is descriptive of the size of the diffusing salt penetrant and a characteristic volume required to accommodate the penetrant in the polyamide network (H. Zhang, G. M. Geise, Modeling the water permeability and water/salt selectivity tradeoff in polymer membranes, Journal of Membrane Science 520 (2016) 790-800; H. Yasuda, C. E. Lamaze, L. D. Ikenberry, Permeability of solutes through hydrated polymer membranes. Part I. Diffusion of sodium chloride, Die Makromolekulare Chemie 118 (1968) 19-35).

Solution-diffusion modeling incorporated the polyamide densities □ₚ calculated from XRR measurements (1338 kg m⁻³, 968 kg m⁻³, and 918 kg m⁻³ for MPDTMC, TBDTMC, and TYDTMC polyamides, respectively) and water partitioning coefficients, K_{w}, determined from SAXS measurements (0.26, 0.40, and 0.58 for MPDTMC, TBDTMC, and TYDTMC membranes, respectively). The water partitioning coefficient K_{w}, which is effectively the volume fraction of water in the polyamide (H. Zhang, G. M. Geise, Modeling the water permeability and water/salt selectivity tradeoff in polymer membranes, Journal of Membrane Science 520 (2016) 790-800) or the free volume of the hydrated polymer network (H. Yasuda, C. Lamaze, A. Peterlin, Diffusive and hydraulic permeabilities of water in water-swollen polymer membranes, Journal of Polymer Science Part A-2: Polymer Physics 9 (1971) 1117-1131) was calculated from the polyamide film swelling ratio, S.

As discussed above herein, diffusivity-dominated water transport modeling for the polyamide membranes resulted in β values of 0.60 cm³ g⁻¹, 4.60 cm³ g⁻¹, and 17.0 cm³ g⁻¹ for MPDTMC, TBTMC, and TYDTMC, respectively. These characteristic volumes of diffusing water, □, are hypothesized to be larger than the free volume of water (0.38 cm³ g⁻¹) for the assumed diffusivity-dominated solution-diffusion transport. The □ values for contorted TBDTMC and TYDTMC membranes are significantly larger than that of conventional MPDTMC, which is also indicated by the higher pure water permeances of these contorted polyamide membranes compared to conventional MPDTMC. The β fitting parameter from transport modeling was sensitive to the K_{w} value that was calculated from swelling ratios.

The modeling results for NaCl permeability of the MPDTMC and TBDTMC polyamide membranes yielded b values, which are descriptive of the characteristic volume of diffusing salt penetrant, of b=2.95 for MPDTMC, b=5.83 for TBDTMC, and b=12.8 for TYDTMC polyamides. The b value of 2.95 for our MPDTMC membrane is similar to the value of b=2.39±0.15 that was reported by Zhang and Geise (H. Zhang, G. M. Geise, Modeling the water permeability and water/salt selectivity tradeoff in polymer membranes, Journal of Membrane Science 520 (2016) 790-800) for similar modeling of conventional MPDTMC polyamide membranes. The contorted TBDTMC and TYDTMC polyamide membranes have higher b values (5.83 and 12.8, respectively), which indicate the increased size of diffusing salt penetrants within the increased free volume of the water-swollen contorted polyamide networks. Like the β fitting parameter, the b fitting parameter from the diffusivity-dominated salt transport model was also sensitive to the K_{w} value calculated from the swelling ratio.

### Continuing Work:

We will continue to review the literature concerning diffusive penetrant transport in polymeric membranes. We seek to better understand and explain the differences in swelling behavior observed for the TYDTMC polyamide compared to TBDTMC and MPDTMC polyamides. Based on our findings, the diffusivity-dominated, free volume-based transport modeling will be modified accordingly, with the goal of providing insight into the improved selectivity demonstrated by the contorted TBDTMC and TYDTMC polyamide membranes.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature, or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

It is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention is not limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

1. A polymer comprising repeat units, wherein the repeat units have a structure of Formula (I): 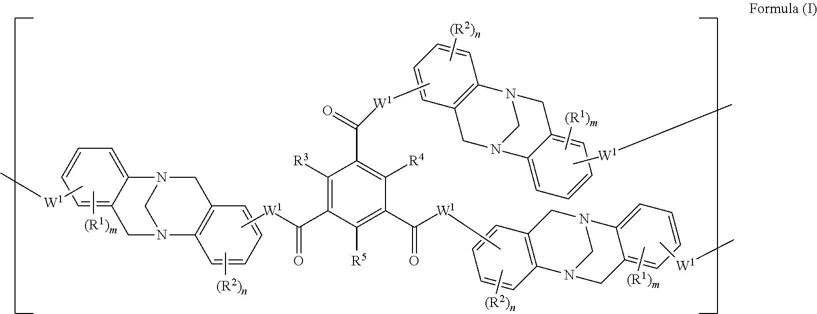
wherein:
each R¹ is independently selected from the group consisting of H, an electron withdrawing group, and an electron donating group;
each R² is independently selected from the group consisting of H, an electron withdrawing group, and an electron donating group;
R³ is H, an electron withdrawing group, or an electron donating group;
R⁴ is H, an electron withdrawing group, or an electron donating group;
R⁵ is H, an electron withdrawing group, or an electron donating group;
each W¹ is independently O or NR⁶, wherein each R⁶ is independently H or optionally substituted alkyl;
m is 3; and
n is 3.

2. The polymer of claim 1, wherein the structure of Formula (I) is a structure of Formula (I-A):

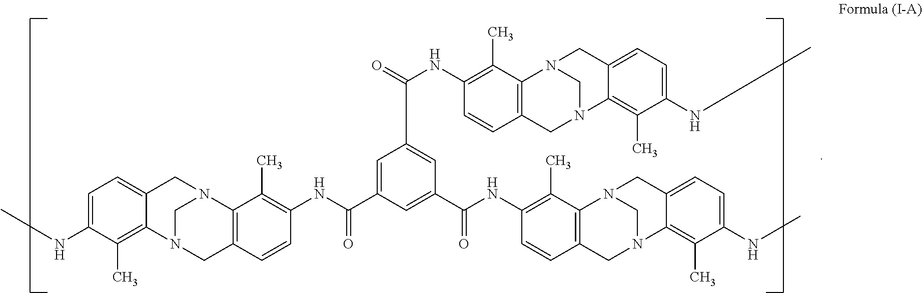

3. A polymer membrane comprising a polymer of claim 1.

4. A method of making a polymer membrane of claim 3, the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

5. A method of making a polymer membrane of claim 3, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

6. The method of claim 4, wherein a polymerization reaction between the first monomer and the second monomer occurs, thereby forming a polymer membrane on at least a portion of the substrate surface.

7. The method of claim 4, wherein the first monomer has a structure of Formula (II): 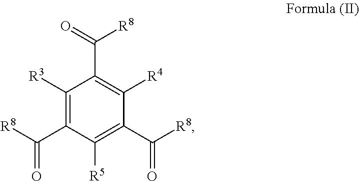
wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl; and
wherein the second monomer has a structure of Formula (III): 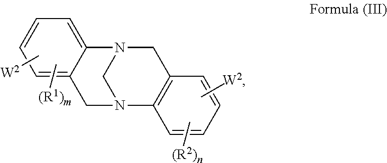
wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

8. A method for desalination of water, the method comprising:
providing a polymer membrane of claim 3, and water, wherein the water comprises at least one salt; and passing the water through the polymer membrane to desalinate the water.

9. A polymer comprising repeat units, wherein the repeat units have a structure of Formula (IV): 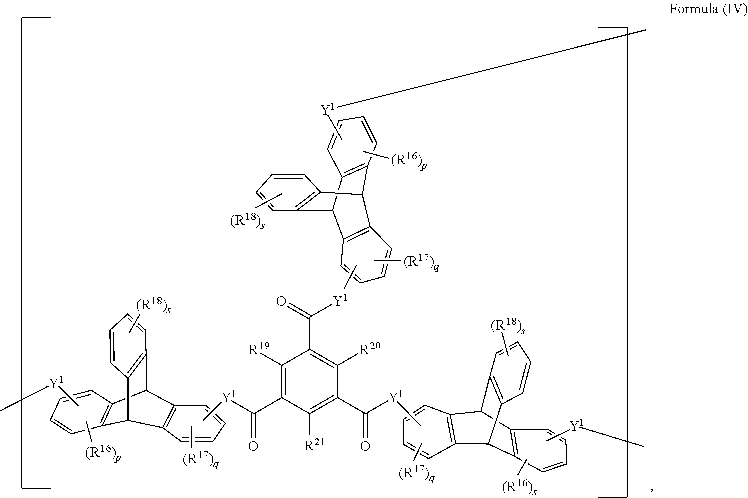
wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
R¹⁹ is H, an electron withdrawing group, or an electron donating group;
R²⁰ is H, an electron withdrawing group, or an electron donating group;
R²¹ is H, an electron withdrawing group, or an electron donating group;
each Y¹ is independently O or NR²², wherein each R²² is independently H or optionally substituted alkyl;
p is 3;
q is 3; and
s is 4.

10. The polymer of claim 9, wherein the structure of Formula (IV) is a structure of Formula (IV-A):

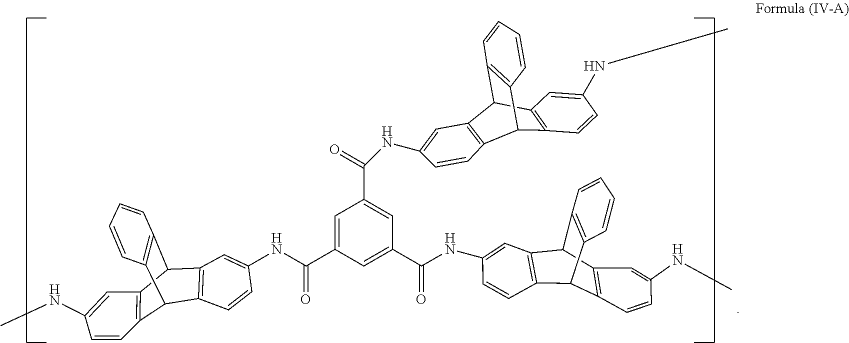

11. A polymer membrane comprising a polymer of claim 9.

12. A method of making a polymer membrane of claim 11, the method comprising:
(a) providing a substrate, a first monomer composition, a second monomer composition, a first solvent; and a second solvent, wherein the first monomer composition comprises a first monomer, and wherein the second monomer composition comprises a second monomer;
(b) applying the first monomer composition to a surface of the substrate, or applying the second monomer composition to a surface of the substrate;
(c) rinsing the substrate with the first solvent;
(d) applying the second monomer composition to the surface of the substrate, or applying the first monomer composition to the surface of the substrate; and
(e) rinsing the substrate with the second solvent.

13. A method of making a polymer membrane of claim 11, the method comprising:
(a) providing a substrate, a first monomer composition, and a second monomer composition, wherein the first monomer composition comprises a first monomer, and wherein the second monomer composition comprises a second monomer;
(b) optionally electrospraying the second monomer composition onto a surface of the substrate;
(c) electrospraying the first monomer composition onto the surface of the substrate, or electrospraying the second monomer composition onto the surface of the substrate; and
(d) electrospraying the second monomer composition onto the surface of the substrate, or electrospraying the first monomer composition onto the surface of the substrate.

14. The method of claim 12, wherein a polymerization reaction between the first monomer and the second monomer occurs, thereby forming a polymer membrane on at least a portion of the substrate surface.

15. The method of claim 12, wherein the first monomer has a structure of Formula (V): 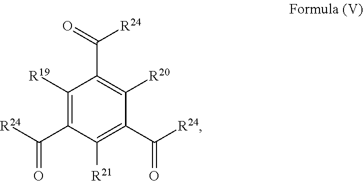
wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl; and
wherein the second monomer has a structure of Formula (VI): 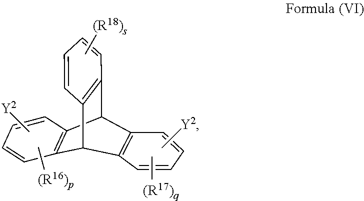
wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁶R²⁸, wherein each R²⁶ is independently H or optionally substituted alkyl, wherein each R²⁷ is independently H or optionally substituted alkyl, and wherein each R²⁸ is independently H or optionally substituted alkyl;
p is 3;
q is 3; and
s is 4.

16. A method for desalination of water, the method comprising:
providing a polymer membrane of claim 11, and water, wherein the water comprises at least one salt; and passing the water through the polymer membrane to desalinate the water.

17. The method of claim 5, wherein a polymerization reaction between the first monomer and the second monomer occurs, thereby forming a polymer membrane on at least a portion of the substrate surface.

18. The method of claim 5, wherein the first monomer has a structure of Formula (II): 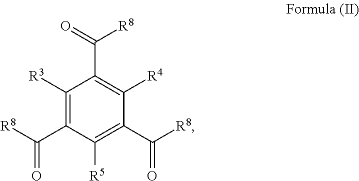
wherein:
R³ is H, an electron withdrawing group, or an electron donating group;
R⁴ is H, an electron withdrawing group, or an electron donating group;
R⁵ is H, an electron withdrawing group, or an electron donating group; and
each R⁸ is independently Cl, Br, or OR⁹, where each R⁹ is independently H or optionally substituted alkyl; and
wherein the second monomer has a structure of Formula (III): 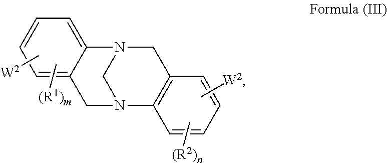
wherein:
each R¹ is independently selected from the group consisting of H, an electron withdrawing group, and an electron donating group;
each R² is independently selected from the group consisting of H, an electron withdrawing group, and an electron donating group;
each W² is independently OR¹⁰ or NR¹¹R¹², wherein each R¹⁰ is independently H or optionally substituted alkyl, wherein each R¹¹ is independently H or optionally substituted alkyl, and wherein each R¹² is independently H or optionally substituted alkyl;
m is 3; and
n is 3.

19. The method of claim 13, wherein a polymerization reaction between the first monomer and the second monomer occurs, thereby forming a polymer membrane on at least a portion of the substrate surface.

20. The method of claim 13, wherein the first monomer has a structure of Formula (V): 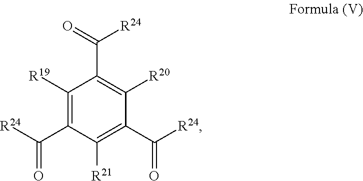
wherein:
R¹⁹ is H, an electron withdrawing group, or an electron donating group;
R²⁰ is H, an electron withdrawing group, or an electron donating group;
R²¹ is H, an electron withdrawing group, or an electron donating group; and
each R²⁴ is independently Cl, Br, or OR²⁵, where each R²⁵ is independently H or optionally substituted alkyl; and
wherein the second monomer has a structure of Formula (VI): 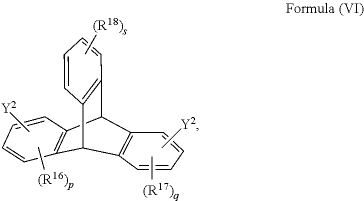
wherein:
each R¹⁶ is independently selected from the group consisting of H, an electron withdrawing group, and an electron donating group;
each R¹⁷ is independently selected from the group consisting of H, an electron withdrawing group, and an electron donating group;
each R¹⁸ is independently selected from the group consisting of H, an electron withdrawing group, and an electron donating group;
each Y² is independently OR²⁶ or NR²⁷R²⁸, wherein each R²⁶ is independently H or optionally substituted alkyl, wherein each R² is independently H or optionally substituted alkyl, and wherein each R²⁸ is independently H or optionally substituted alkyl;
p is 3;
q is 3; and
s is 4.
